(19) United States
(12) Patent Application Publication
(10) Pub. No.: US 2025/0082523 A1
(43) Pub. Date: Mar. 13, 2025

(54) PATIENT SUPPORT APPARATUS AND MATTRESS THEREFOR

(71) Applicant: UMANO MEDICAL INC., L'Islet (CA)

(72) Inventors: Martin LAVOIE, Lévis (CA); Steve BOLDUC, Beaumont (CA); Sylvain BEAULIEU, Lévis (CA); Philippe VERRET, Québec (CA); Florimond LAPORTE, St-Augustin-de-Desmaures (CA); Christian GAUVIN, Lévis (CA); Charly MARTINEAU, Québec (CA); Sylvain LACASSE, Québec (CA); Maxim ROBITAILLE-BEAUMIER, L'Ancienne Lorette (CA); Pierre-Luc PROVENCHER, Québec (CA); Jessica GAUTHIER, L’Ancienne-Lorette (CA); Jérôme MARCOTTE, Lévis (CA); Ali BEN ABDESSALEM, Québec (CA); Jimmy LAFLAMME LAROCHE, Lévis (CA); Antoine POULIOT, Lévis (CA); Sébastien BOISVERT, Terrebonne (CA); Pascal POULIN, St-Lambert-de-Lauzon (CA); Daniel QUINTERO, Québec (CA); Jasmine JOLY-DUMONT, Roxboro (CA); Lamia KACEM, Québec (CA); Ghislain DEMERS, Beaumont (CA); Thomas GREGOIRE, Sherbrook (CA); Anthony HADJEDJ, Saint Apollinaire (CA)

(21) Appl. No.: 18/580,248

(22) PCT Filed: Jul. 19, 2022
(86) PCT No.: PCT/IB2022/056645

§ 371 Date: Jan. 18, 2024

Related U.S. Application Data
(60) Provisional application No. 63/223,368, filed on Jul. 19, 2021.

(51) Int. Cl. A61G 7/018; A61G 7/012; A61G 7/015

(52) U.S. Cl. CPC A61G 7/018; A61G 7/012; A61G 7/015

(57) ABSTRACT

The invention relates to a patient support apparatus, and more particularly to an ICU bed. The invention also relates to a frame assembly and to a foot extension for such patient apparatus. The invention further relates to a mattress for a patient support apparatus, such as a therapeutic mattress for an ICU bed.

### CROSS-REFERENCE

The present application claims benefit to the U.S. Provisional Patent Application Ser. No. 63/223,368 filed on Jul. 19, 2021.

### TECHNICAL FIELD

The present invention generally relates to patient support apparatus such as hospital beds, and more specifically to an Intensive Care Unit (ICU) bed. The invention also generally relates to mattress, and more specifically to a therapeutic mattress usable with ICU beds.

### BACKGROUND OF THE ART

ICU beds are typically beds that are adapted to be used in intensive care environment.

Prior art provides several ICU beds. Some are more adapted for bariatric patients, other are more adapted for caregiver operations. There is no bed that is easy to operate while being well adapted for patient comfort and rehabilitation and still at an acceptable manufacturing cost.

ICU beds may be used in conjunction with therapeutic mattresses.

Therapeutic mattresses may come in various configurations. Non-powered mattresses are generally made of foam and/or gel material(s), while powered mattresses are generally made of inflatable fluid bladders powered by a fluid source. Therapeutic mattresses may also offer a wide array of functionalities to increase comfort and to provide therapies to the patient, such as skin therapy and/or pulmonary therapy.

Despite all the therapeutic mattresses known so far, there is no mattress which provides all the required therapies while providing a high level of comfort to the patient.

Therefore, it would be advantageous to be provided with a hospital bed which would overcome at least one of the above-identified drawbacks.

It would also be advantageous to be provided with a therapeutic mattress which would overcome at least one of the above-identified drawbacks.

### SUMMARY

According to a first broad aspect, there is provided patient support apparatus comprising:
a patient support surface for receiving a patient thereon;
an extension frame;
a first actuator mechanism comprising at least one actuator having a first end operatively coupled to the patient support surface and a second end operatively coupled to the extension frame, the at least one actuator of the first actuator mechanism being movable between a retracted position in which the extension frame is close to the patient support surface and an extended position in which the extension frame is away from the patient support surface;
a second actuator mechanism comprising at least one actuator having a first end operatively coupled to the extension frame and a second end operatively coupled to an extension, the at least one actuator of the second actuator mechanism being movable between a retracted position in which the extension is close to the extension frame and an extended position in which the extension is away from the extension frame;
at least one extension plate operatively coupled to the extension, the at least one being coplanar with the patient support surface and moving relative to the patient support surface when the first or second actuator mechanisms are operated; and
a control for controlling the movement of the linear actuators of the first and second actuator mechanisms between their respective retracted positions and extended positions.

In one feature, the patient support of claim further comprises at least one support mechanism operatively coupled to the patient support and to the extension. Preferably, the at least one support mechanism comprises a first support member having a first end pivotably and slidably connected to the patient support surface and a second end and a second support member having a first end pivotably connected to the second end of the first support member and a second end pivotably and slidably connected to the extension.

Alternatively, in one feature, the at least one support mechanism comprises a first support member having a first end pivotably coupled to the patient support surface and a second end pivotably and slidably coupled to the extension frame, and a second support member having a first end pivotably and slidably connected to the extension frame and a second end pivotably connected to the extension.

In one feature, the extension frame comprises a cross-member to which are attached the second end of the first support member and the first end of the second support member, the cross-member allowing sliding movement the second end of the first support member and the first end of the second support member in a direction transverse to a movement direction of the first and second actuator mechanisms.

In an additional feature, the at least one extension plate comprises a first extension plate having a first end slidably resting atop the patient support surface and a second end fixedly secured to the cross-member, and a second plate having a first end slidably resting atop the first plate and a second end fixedly secured to the extension.

In a further feature, wherein the at least one actuator of the first actuator mechanism comprises a first linear actuator and a second linear actuator, the first and second linear actuators extending parallel to one another and each having a first end operatively coupled to the patient support surface and a second end operatively coupled to the extension frame.

In still a further feature, each of the first and second linear actuators of the first actuator mechanism is provided with a pulley at its a second end for urging movement thereof between the extended position and the retracted position, the first actuator mechanism further comprising a first motor mounted to the extension frame, the first motor being operatively coupled to the pulleys of the first and second linear actuators for urging movement therefor between the extended position and the retracted position.

In another feature, the at least one actuator of the second actuator mechanism comprises a first linear actuator and a second linear actuator, the first and second linear actuators extending parallel to one another and each having a first end operatively to the extension frame and a second end operatively coupled to the extension.

In still another feature, each of the first and second linear actuators of the second actuator mechanism is provided with a pulley at its a first end for urging movement thereof between the extended position and the retracted position, the second actuator mechanism further comprising a second motor mounted to the extension frame, the second motor being operatively coupled to the pulleys of the first and second linear actuators of the second actuator mechanism for urging movement therefor between the extended position and the retracted position.

In a further feature, each of the first and second linear actuators of the second actuator mechanism is provided with a pulley at its a first end for urging movement thereof between the extended position and the retracted position, the at least one actuator of the second actuator mechanism further comprising a second motor mounted to the extension frame, the second motor being operatively coupled to the pulleys of the first and second linear actuators of the second actuator mechanism for urging movement therefor between the extended position and the retracted position.

In still a further feature, the controller is operatively coupled to the first and second motors. In another feature, the controller controls the operation of the first and second motors to simultaneously move the first and second actuator mechanisms between their respective extended position and retracted position.

In another feature, the patient support comprises a head end, a foot end and a longitudinal direction between the head end and the foot end, and wherein when the first and second actuator mechanisms are operated, the extension moves in the longitudinal direction.

In still another feature, the extension frame, the first and second actuator mechanisms, the extension and the at least one plate are provided at the foot end of the patient support surface.

In yet another feature, the extension frame is mounted underneath the patient support surface.

According to another broad aspect, there is provided a frame assembly for a patient support apparatus having a base and an elevation mechanism mounted to the base and supporting the frame assembly for raising and lowering the same, the frame assembly comprising:
a pair of spaced-apart sleeves extending longitudinally between a front end of the patient support apparatus and a foot end, each sleeve comprising an open head end and an open foot end;
a head sliding assembly attached to a head portion of the elevation mechanism and allowing a translation movement of the sleeves relative to the head portion of the elevation mechanism;
a foot sliding assembly comprising head sliding members, each foot sliding member having a head end and a foot end, each foot sliding member being slidably received into the foot end of a corresponding sleeve, from the head end of the foot sliding member to an intermediate location between the head end and the foot end thereof, each foot sliding member being capable of translation relative to its corresponding sleeve, the foot sliding assembly further comprising a stopper for stopping sliding movement of the foot sliding members into their corresponding sleeves;
a sliding mechanism connected to the sleeves proximal to the foot end thereof, the sliding mechanism attaching the sleeves to a foot portion of the elevation mechanism, the sliding mechanism comprising a spring element for biasing the foot portion of the elevation mechanism towards the foot end of the sleeves;
an actuator having a head end connected to the sleeves and a second end connected to the foot ends of the foot sliding members; the actuator being movable between an extended position and a retracted position;
wherein when the actuator is moved from the extended position towards the retracted position, the actuator forces the foot sliding members of the foot assembly into their corresponding sleeves until the stopper stops further movement of the foot sliding members into their corresponding sleeves, at which point further movement of the actuator toward the retracted position overcomes the biasing force of the spring element, thus causing the foot portion of the elevation mechanism to move towards the head end of the sleeve and the simultaneous movement of the sleeves towards the foot end and away from the head portion of the elevation mechanism.

In one feature, the frame assembly further comprises:
a first cross-member connecting the spaced-apart sleeves in an intermediate location between the head end and the foot end of the sleeves
a second cross-member connecting the spaced-apart sleeves at the foot end thereof,
a third cross-member secured to the foot ends of the foot sliding members for connecting the same together;
wherein the sliding mechanism connected to the sleeves proximal to the foot end thereof extends between the first cross-member and the second cross-member connecting the spaced-apart sleeves, and wherein the head end of the actuator is connected to the sleeves via the first cross-member and the foot end of the actuator is connected to foot ends of the foot sliding members via the third cross-member.

In another feature, the head sliding assembly comprises a pair of head sliding members, each head sliding member having a head end and a foot end, each head sliding member being slidably received into the head end of a corresponding sleeve, from the foot end of the head sliding member to an intermediate location between the foot end and the head end thereof, each head sliding member being capable of translation relative to its corresponding sleeve, the head end of the head sliding members protruding outwardly from the head end of the sleeves and attaching the head portion of the elevation mechanism, wherein when the actuator is moved from the extended position towards the retracted position, the actuator forces the foot sliding members of the foot assembly into their corresponding sleeves until the stopper stops further movement of the foot sliding members into their corresponding sleeves, at which point further movement of the actuator toward the retracted position overcomes the biasing force of the spring element, thus causing the foot portion of the elevation mechanism to move towards the head end of the sleeve and the simultaneous exit of the head sliding members from the head end of the sleeves.

In still another feature, each of the head portion of the elevation mechanism and the foot portion of the elevation mechanism comprises an elevation column or an elevation lever.

In yet another feature, the actuator comprises a linear actuator.

In a further feature, the frame assembly further comprises a fourth cross-member connecting the spaced-apart sleeves, at the head end thereof.

In another feature, each of the sleeves comprises a rectangular tube and each of the head and foot sliding members also comprises a rectangular tube, sized to slidably fit into the rectangular tubes of the sleeves.

According to another broad aspect, there is provided a barrier for a patient support apparatus comprising a patient support surface, the barrier comprising:
a main portion extending vertically relative to the patient support surface, the main portion having a bottom end adjacent to the patient support surface, a top end away from the patient support surface and a first hinge element provided at the top end of the main portion;
a shelf pivotably mounted to the main portion, the shelf comprising a tray portion for receiving objects thereon and a second hinge element, the second hinge element of the shelf collaborating with the first hinge element of the main portion to allow pivotal movement of the shelf relative to the main portion about a horizontal axis to move the shelf between a stowed position in which the shelf extends vertically along the main portion and an operation position in which the shelf extends generally horizontally, transverse the main portion.

In one feature, the barrier is selected from the group consisting of a siderail, a foot board and a headboard of a patient support apparatus.

In another feature, the main portion comprises a recess for receiving therein the shelf in the stowed position.

In still another feature, the first hinge element comprises a cylindrical rod extending horizontally on the top end of the main portion and the second hinge element comprises a sleeve defined on one end of the shelf and pivotably engaging the cylindrical rod.

In a further feature, the barrier further comprises a stopper provide on at least one of the main portion and the shelf to maintain the shelf in a horizontal position when the shelf is in the operation position.

According to another broad aspect, there is provided a mattress for a patient support apparatus, the mattress comprising:
a structural foam layer to be positioned atop a patient support surface of the patient support apparatus;
a support layer positioned atop the structural foam layer, the support layer comprising a plurality of inflatable support bladders;
a comfort layer mounted atop the support layer, the comfort layer comprising a lower sheet in contact with the support layer and including a plurality of inflatable lower comfort bladders and an upper sheet mounted onto the lower sheet and including a plurality of inflatable upper comfort bladders, the inflatable upper comfort bladders being positioned in quincunx relative to the inflatable lower comfort bladders;
a pneumatic system for independently controlling the presence of a fluid in the support bladders, the lower comfort bladders and the upper comfort bladders.

In one feature, the support layer comprises a plurality of sections, each sections including a plurality of support bladders.

In another feature, the plurality of sections of the support layer comprises a head section, a torso section, a seat section and a leg section.

In yet another feature, the support bladders the head section, the torso section the seat section and the leg section of the support layers are controlled independently by the pneumatic system.

In still another feature, the comfort layer comprises a plurality of sections, each sections including a plurality of lower comfort bladders and upper comfort bladders.

In a further feature, the plurality of sections of the comfort layer comprises a head section, a torso section, a seat section and a leg section.

In still a further feature, the lower comfort bladders and the upper comfort bladders of the head section, the torso section the seat section and the leg section of the comfort layers are controlled independently by the pneumatic system.

In yet a further feature, the mattress further comprises a pair of spaced-apart bolsters mounted to the structural foam layer and extending longitudinally on each side thereof, the support layer being positioned between the bolsters.

In one feature, the bolster and the support layer have a same thickness.

In another feature, the comfort layer extends onto the support layer and the bolsters.

In still another feature, the lower comfort layer and the upper comfort layer form a unitary structure defining a passage for a fluid between the lower comfort layer and the upper comfort layer.

In yet another feature, the upper comfort layer is provided with a plurality of pores allowing the fluid to flow from the passage to a top surface of the upper comfort layer.

In a further feature, the pneumatic system feeds the fluid into the passage of the comfort layer, the pneumatic system, the passage and the pores being adjusted such that the fluid flowing from the passage to the top surface of the upper comfort layer is a Low-Air-Loss (LAL) flow.

In yet a further feature, the mattress further comprises a layer of a 3D material in the passage defined between the lower comfort layer and the upper comfort layer.

In another feature, the mattress further comprises an inflatable foot extension section extending adjacent to a foot end of the structural foam layer.

In one feature, the pneumatic system is operable to control a fluid pressure of the lower comfort layer and a fluid pressure the upper comfort layer to provide an alternating pressure therapy.

In another feature, the mattress further comprises a pair of inflatable width extensions, each of the width extensions extending along a corresponding bolster.

In still another feature, the comfort layer comprises a pair of inflatable side extensions, each side extension extending along a side of the comfort layer and resting atop a corresponding width extension.

In yet another feature, the support bladders, the lower comfort bladders and the upper comfort bladders are made of fabric, fiber containing TPU or Vinyl material.

In another feature, the support bladders and comfort bladders are formed by radiofrequency (RF) welding or sewing.

### BRIEF DESCRIPTION OF THE DRAWINGS

Reference will now be made to the accompanying drawings, showing by way of illustration example embodiments thereof and in which:

FIG. 1 is a foot right perspective view of an ICU bed with the patient support assembly in a flat configuration and elevations columns in an extended position, in accordance with one embodiment;

FIG. 2 is a right side view of the ICU bed shown in FIG. 1;

FIG. 3 is a right side view of the ICU bed shown in FIG. 1, with the patient support assembly in a chair position and the elevation columns in a retracted position;

FIG. 4 is a foot right perspective view of a base of the ICU bed shown in FIG. 1, in accordance with one embodiment;

FIGS. 5A to 5E illustrate an exemplary activation sequence of an elevation column from a fully retracted position (FIG. 5A) to a fully extended position (FIG. 5E);

FIG. 6 is a head elevation view of an elevation column in a partially extended position, in accordance with one embodiment;

FIG. 7 is a cross-section view of the elevation column shown in FIG. 6, taken along line 7-7;

FIG. 8 is a right, foot perspective view of the elevation column shown in FIG. 7, still in cross-section;

FIG. 9 is an enlarged, partial view of a portion of the elevation column shown in FIG. 7, for better showing atop portion of the deployment mechanism, in accordance with one embodiment;

FIG. 10 is an enlarged, partial view of another portion of the elevation column shown in FIG. 7, for better showing a bottom portion of the deployment mechanism, in accordance with one embodiment;

FIG. 11 is a right perspective view of a driving system of an elevation column, in accordance with one embodiment;

FIG. 12 is an exploded view of the driving system shown in FIG. 11;

FIG. 13 is a right perspective view of a telescopic stage arrangement of an elevation column, in accordance with one embodiment;

FIG. 14A is a right side view of the ICU bed shown in FIG. 1, with the with the patient support assembly in a chair position, and with a head elevation column in extended position and a foot extension column in a retracted position;

FIG. 14B is an enlarged, partial right side view of a portion of the ICU bed shown in FIG. 14, for better showing the relationship between the mounting arrangement of the head elevation column and an inclined floor surface;

FIG. 15A is a head elevation view of an elevation column in a partially extended position, in accordance with one embodiment;

FIG. 15B is a cross-section view of the elevation column shown in FIG. 15A taken along lines 15B-15B, for better showing electrical wires routed internally through the elevation column;

FIG. 16 is a right, foot perspective view of the elevation column shown in FIG. 15B, still in cross-section;

FIG. 17 is a right, foot perspective view of an ICU bed in accordance with another embodiment, with the patient support assembly in a chair configuration and elevations columns in an extended position;

FIG. 18 is a right, head perspective view of the ICU bed shown in FIG. 17;

FIG. 19 is another right, foot perspective view of the ICU bed shown in FIG. 17, with the patient support assembly in a chair configuration, a foot elevation column in a retracted position a head elevation column in an extended position;

FIG. 20A is a head, right perspective view of an elevation column using a double configuration, in accordance with one embodiment;

FIG. 20B is a partially transparent, head right perspective view of the elevation column shown in FIG. 20A;

FIG. 20C is a transparent top plan view of the base of the elevation column shown in FIG. 20A;

FIG. 21A is a top perspective view of another elevation column, in accordance with another embodiment;

FIG. 21B is a bottom perspective, partially transparent view of the elevation column shown in FIG. 21A;

FIG. 21C is a partially cross-sectioned, head elevation view of the elevation column shown in FIG. 21A;

FIGS. 22A to 22C are partially transparent views of a double pivot system to be used on an upper portion of an elevation columns in various positions, in accordance with one embodiment;

FIGS. 23A to 23D are foot right perspective views of an expandable and retractable foot support panel in accordance with one embodiment with lateral extensions retracted, in a completely retracted position (FIG. 23A), partially extended positions (FIGS. 23B and 23C) and fully extended position (FIG. 23D);

FIGS. 24A to 24D are foot right perspective views of an expandable and retractable foot support panel in accordance with one embodiment with lateral extension extended, in a completely retracted position (FIG. 24A), partially extended positions (FIGS. 24B and 24C) and fully extended position (FIG. 24D);

FIG. 25 is a foot right perspective view of the foot support panel shown in FIG. 24D, with an upper main sheet and an upper extension sheet pivotally lifted, in accordance with one embodiment;

FIG. 26A is a foot right perspective view of the foot support panel shown in FIG. 25, with the upper main sheet and upper extension sheet removed;

FIG. 26B is a bottom, head right perspective view of the foot support panel shown in FIG. 26A;

FIG. 27A is a foot right perspective view of the foot support panel shown in FIG. 24D, with the upper extension sheet removed;

FIG. 27B is an enlarged, partial view of the foot support panel shown in FIG. 27A;

FIG. 27C is an enlarged, partial, head left perspective view of the foot support panel shown in FIG. 24D, with the upper extension sheet removed;

FIG. 27D is a head left perspective view of the foot support panel shown in FIG. 24C, with the upper extension sheet removed and the second motorized extension mechanism in retracted position;

FIG. 27E is a rear bottom left perspective view of the foot support panel shown in FIG. 24D, with the upper extension sheet removed and the second motorized extension mechanism in extended position;

FIG. 28A is a foot right perspective view of a portion of a foot support panel in accordance with another embodiment in most extended position, with an upper main sheet and an upper extension sheet removed;

FIG. 28B is an exploded view of the foot support panel shown in FIG. 28A;

FIG. 28C is a head left perspective view of an actuator assembly for a foot support panel, in accordance with one embodiment;

FIG. 28D is an enlarged, partial view of a portion of the actuator assembly shown in FIG. 28C, with a drive cover removed;

FIG. 29A is a head left perspective view of the foot support panel shown in FIG. 23C, with the upper extension sheet removed and the second motorized extension mechanism in retracted position;

FIG. 29B is a head left perspective view of the foot support panel shown in FIG. 24C, with the upper extension sheet removed and the second motorized extension mechanism in retracted position;

FIG. 29C is a bottom, head right perspective view of the foot support panel shown in FIG. 24A, with the upper extension sheet removed;

FIG. 30A is a foot right perspective view of an actuator assembly for a foot support panel, in accordance with one embodiment;

FIG. 30B is an enlarged, partial view of a portion of the actuator assembly shown in FIG. 30A, with a drive cover removed;

FIG. 31A is a right side view of the actuator assembly shown in FIG. 30A;

FIG. 31B is a cross-section view of the actuator assembly shown in FIG. 31A, taken along line 31B-31B;

FIG. 31C is an enlarged, partial view of a portion of the actuator assembly shown in FIG. 31A;

FIG. 31D is an enlarged, partial view of another portion of the actuator assembly shown in FIG. 31A;

FIG. 32 is a foot right perspective view of the foot support panel shown in FIG. 24D, with the upper main sheet pivotally lifted and the upper extension sheet removed, in accordance with one embodiment;

FIGS. 33A to 33D are foot right perspective views of an expandable and retractable foot support panel in accordance with one embodiment with lateral extensions retracted, in a completely retracted position (FIG. 33A), partially extended positions (FIGS. 33B and 33C) and fully extended position (FIG. 33D);

FIGS. 34A to 34D are foot right perspective views of an expandable and retractable foot support panel in accordance with one embodiment with lateral extension extended, in a completely retracted position (FIG. 34A), partially extended positions (FIGS. 34B and 34C) and fully extended position (FIG. 34D);

FIG. 35A is a foot right perspective view of the foot support panel shown in FIG. 34D, with an upper main sheet and an upper extension sheet removed, in accordance with one embodiment;

FIG. 35B is a bottom, foot left perspective view of the foot support panel shown in FIG. 35A;

FIG. 36 is a top plan view of the foot support panel shown in FIG. 35A;

FIG. 37 is a right side view of the foot support panel shown in FIG. 35A;

FIG. 38 is a right perspective view of the foot support panel shown in FIG. 35A;

FIG. 39A a is a head, left perspective view of the foot support panel shown in FIG. 35A;

FIG. 39B is a head, left perspective view of the foot support panel shown in FIG. 34A, with an upper main sheet and an upper extension sheet removed;

FIG. 40 is another foot right perspective view of the foot support panel shown in FIG. 34D, with an upper main sheet and an upper extension sheet removed;

FIG. 41 is an exploded view of the foot support panel shown in FIG. 40, with extension members removed;

FIG. 42 is a head left perspective view of an actuator assembly for a foot support panel, in accordance with one embodiment;

FIG. 43 is an enlarged, partial view of a portion of the actuator assembly shown in FIG. 42;

FIG. 44A is a right side view of the actuator assembly shown in FIG. 42;

FIG. 44B is a cross-section view of the actuator assembly shown in FIG. 44A, taken along line 44B-44B;

FIG. 44C is an enlarged, partial view of a portion of the actuator assembly shown in FIG. 44A;

FIG. 44D is an enlarged, partial view of another portion of the actuator assembly shown in FIG. 44A;

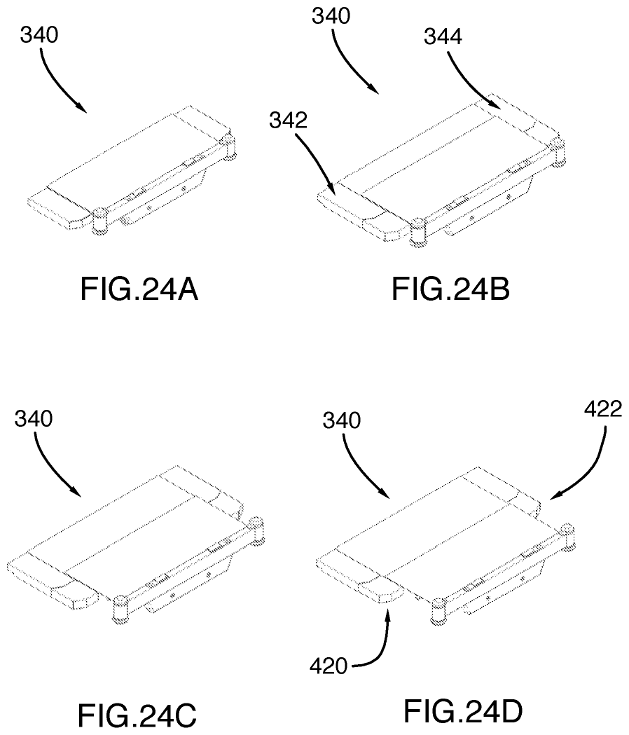

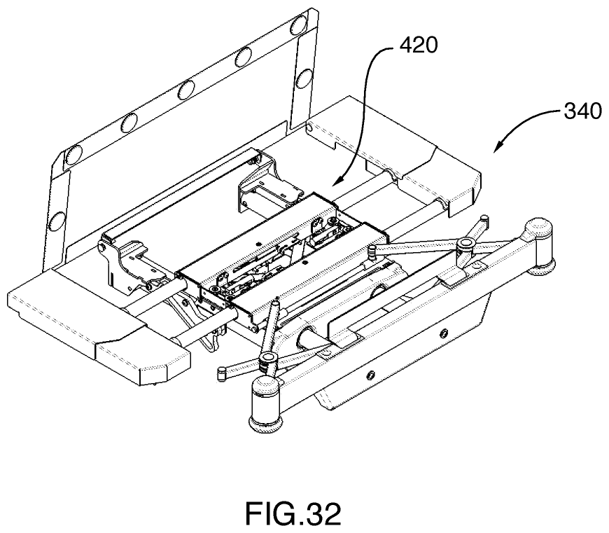

FIG. 32 is a foot right perspective view of the foot support panel shown in FIG. 24D, with the upper main sheet pivotally lifted and the upper extension sheet removed, in accordance with one embodiment;

FIG. 45A is a right side view of a frame of a ICU bed in accordance with one embodiment, showing the mounting of a foot support panel with a thigh support panel;

FIG. 45B is another right-side view of the frame of the ICU bed shown in FIG. 45A, for better showing a sliding movement of a sliding subframe assembly, according to one embodiment;

FIG. 45C is an enlarged, partial view of a portion of the frame of the ICU bed shown in FIG. 45B;

FIG. 46A is a front right perspective view of a frame assembly, in accordance with one embodiment;

FIG. 46B is a front right perspective view of a sliding subframe assembly with an actuator attached thereto, in accordance with one embodiment;

FIG. 46C is an enlarged, partial view of a portion of the sliding subframe assembly shown in FIG. 46B;

FIG. 46D is another enlarged, partial view of another portion of the sliding subframe assembly shown in FIG. 46B;

FIGS. 47 to 53 illustrate an operative sequence for moving an ICU bed from a typical flat bed position (FIG. 47) to a chair position (FIG. 53), in accordance with one embodiment;

FIG. 54A is a right side view of an ICU bed in a final full chair position, in accordance with one embodiment;

FIG. 54B is a foot, right perspective view of the ICU bed shown in FIG. 54A;

FIG. 55 is a right-side view of an ICU bed in an initial typical bed position before a cardiac chair sequence begins, in accordance with one embodiment;

FIG. 56 is a right-side view of the ICU bed shown in FIG. 55 during a first step of the cardiac chair sequence, where the backrest support panel is raised of 30 degrees while the thigh support panel is raised to 18 degrees, in accordance with one embodiment;

FIG. 57 is a right-side view of the ICU bed shown in FIG. 55 during a further step of a cardiac chair sequence, where the subframe assembly is only partially retracted inside the frame 160, in accordance with one embodiment;

FIG. 58 is a right-side view of the ICU bed shown in FIG. 55 during yet a further step of a cardiac chair sequence, where the elevation columns are operated to incline the frame of 16 degrees relative to the horizontal, in accordance with one embodiment;

FIG. 59A to 59G are partially cross-sectioned right side views of a main frame and a sliding subframe for showing movement of the frame and sliding subframe when a linear actuator is moved from a fully extended position (FIG. 59A) to a fully retracted position (FIG. 59F) and one of the elevations columns is moved from an extended position (FIG. 59A-59F) to a retracted position (FIG. 59G), in accordance with one embodiment.

FIG. 60A to 60H are right side views of a main frame and a sliding subframe for showing movement of the frame and sliding subframe when the linear actuator is moved from a fully extended position (FIG. 60A) to a fully retracted position (FIG. 60F) and one elevations column is moved from an extended position (FIG. 60A-FIG. 60F) to a retracted position (FIG. 60G), and when a second elevation column is moved from to a retracted position (FIG. 60H);

FIG. 61 is a foot right perspective view of a sliding subframe assembly, in accordance with one embodiment;

FIG. 62A is a right side view of the sliding subframe assembly shown in FIG. 61, with an actuator in a partially retracted position;

FIG. 62B is a cross-section vie of the sliding subframe shown in FIG. 62A;

FIG. 62C is an enlarged, partial view of a portion of the sliding subframe shown in FIG. 62A;

FIG. 63 is a foot right perspective view of a head sliding portion and a foot sliding portion of a sliding subframe, in accordance with one embodiment;

FIG. 64A is a foot right perspective view of a sliding subframe assembly with an actuator in a fully extended position, in accordance with one embodiment;

FIG. 64B is an enlarged, partial view of the sliding subframe assembly shown in FIG. 64A;

FIG. 64C is a head right perspective view of the sliding subframe assembly shown in FIG. 64A;

FIG. 64D is a top plan view of the sliding subframe assembly shown in FIG. 64A;

FIG. 64E is a right side view of the sliding subframe assembly shown in FIG. 64A;

FIG. 64F is a foot elevation view of the sliding subframe assembly shown in FIG. 64A;

FIG. 64G is a cross-section view of the sliding subframe shown in FIG. 64D, taken along lines G-G;

FIG. 65A is a foot right perspective view of a sliding subframe assembly with an actuator in a partially retracted position, in accordance with one embodiment;

FIG. 65B is an enlarged, partial view of the sliding subframe assembly shown in FIG. 65A;

FIG. 65C is a head right perspective view of the sliding subframe assembly shown in FIG. 65A;

FIG. 65D is a top plan view of the sliding subframe assembly shown in FIG. 65A;

FIG. 65E is a right side view of the sliding subframe assembly shown in FIG. 65A;

FIG. 65F is a foot elevation view of the sliding subframe assembly shown in FIG. 65A;

FIG. 65G is a cross-section view of the sliding subframe shown in FIG. 65D, taken along lines G-G;

FIG. 66A is a foot right perspective view of a sliding subframe assembly with an actuator in a fully retracted position, in accordance with one embodiment;

FIG. 66B is an enlarged, partial view of the sliding subframe assembly shown in FIG. 66A;

FIG. 66C is a head right perspective view of the sliding subframe assembly shown in FIG. 66A;

FIG. 66D is a top plan view of the sliding subframe assembly shown in FIG. 66A;

FIG. 66E is a right side view of the sliding subframe assembly shown in FIG. 66A;

FIG. 66F is a foot elevation view of the sliding subframe assembly shown in FIG. 66A;

FIG. 66G is a cross-section view of the sliding subframe shown in FIG. 66D, taken along lines G-G;

FIG. 67 is a foot right perspective view of an external base of an ICU bed provided with a CPR pedal mechanism for mechanically activating a CPR system, in accordance with one embodiment;

FIG. 68A is an enlarged, partial bottom right perspective view of a portion of the CPR pedal mechanism and external base of the ICU bed shown in FIG. 67;

FIG. 68B is a further enlarged, partial bottom right perspective view of a portion of the CPR pedal mechanism and external base of the ICU bed shown in FIG. 68A;

FIG. 68C is a foot right perspective view of the CPR pedal mechanism shown in FIG. 67;

FIG. 68D is a partial foot right perspective view of a gearbox of a CPR pedal mechanism, in accordance with one embodiment;

FIG. 69 is a foot right perspective view of a stage of a head elevation column provided with a telescopic guiding channel for receiving therein a vertical telescopic shaft of a CPR pedal mechanism, in accordance with one embodiment;

FIG. 70 is a head right, partially transparent perspective view of stages of a head elevation column provided with a telescopic guiding channel for receiving therein a vertical telescopic shaft of a CPR pedal mechanism in accordance with another embodiment;

FIG. 71A to 71D illustrate a CPR bed sequence of an ICU bed according to one embodiment, when the bed is in the full chair position (FIG. 71A) and is moved to the CPR position (FIG. 71D);

FIGS. 72A, 72B and 72C are right side views of a backrest support panel according to one embodiment, at an inclination of 70 degrees (FIG. 72A), 30 degrees (FIG. 72B) and 0 degree (FIG. 72C);

FIG. 72D is a foot right perspective view backrest support panel according to one embodiment, at an inclination of 70 degrees and with lateral extensions in a retracted position;

FIG. 73A another right perspective view backrest support panel shown in FIG. 72D, with the lateral extensions in an extended position;

FIG. 73B is another right perspective view backrest support panel shown in FIG. 72D, with the lateral extensions in extended position and with a pivoting support sheet pivoted, in accordance with one embodiment;

FIG. 74 is a head right perspective view of the backrest support panel shown in FIG. 73A;

FIGS. 75A, 75B and 75C are right side views of a backrest support panel according to another embodiment, at an inclination of 70 degrees (FIG. 75A), 30 degrees (FIG. 75B) and 0 degree (FIG. 75C);

FIG. 75D is a foot right perspective view backrest support panel according to one embodiment, at an inclination of 70 degrees and with lateral extensions in a retracted position;

FIG. 76A another right perspective view backrest support panel shown in FIG. 75D, with the lateral extensions in an extended position;

FIG. 76B is another right perspective view backrest support panel shown in FIG. 75D, with the lateral extensions in extended position and with a pivoting support sheet pivoted, in accordance with one embodiment;

FIG. 77A is a head right perspective view of the backrest support panel shown in FIG. 76A;

FIG. 77B is a head right perspective view of the backrest support panel shown in FIG. 76B;

FIG. 78A is a foot right perspective view of an ICU bed provided with a footboard equipped with a build-in pivotable shelf in an open position, in accordance with one embodiment;

FIG. 78B is enlarged perspective view of the footboard of the ICU bed shown in FIG. 78A, with the build-in pivotable shelf in a closed position;

FIG. 79A is a foot right perspective view of a footboard equipped with a build-in pivotable shelf in a closed position, in accordance with another embodiment;

FIG. 79B is a head left perspective view of the footboard shown in FIG. 79A;

FIG. 79C is a top plan view of the footboard shown in FIG. 79A;

FIG. 79D is head elevation view of the footboard shown in FIG. 79A;

FIG. 79E is a right side view of the footboard shown in FIG. 79A;

FIG. 79F is a foot elevation view of the footboard shown in FIG. 79A;

FIG. 80A is a foot right perspective view of a footboard equipped with a build-in pivotable shelf in an open position, in accordance with another embodiment;

FIG. 80B is a head left perspective view of the footboard shown in FIG. 80A;

FIG. 80C is a top plan view of the footboard shown in FIG. 80A;

FIG. 80D is head elevation view of the footboard shown in FIG. 80A;

FIG. 80E is a right side view of the footboard shown in FIG. 80A;

FIG. 80F is a foot elevation view of the footboard shown in FIG. 80A;

FIG. 81 is a foot left perspective view of a mattress provided with an external cover devised to be used on a supporting patient surface of a bed, in accordance with one embodiment;

FIG. 82 is a partially exploded view of the mattress shown in FIG. 81 with the external cover removed, in accordance with one embodiment;

FIG. 83 is another foot left perspective view of the mattress shown in FIG. 81, with the external cover removed;

FIG. 84 is another foot left perspective view of the mattress shown in FIG. 83 without width extensions, in accordance with one embodiment;

FIG. 85 is a foot left perspective view of a lower support layer for a mattress, in accordance with one embodiment;

FIG. 86 is a foot left perspective view a portion of the mattress shown in FIG. 83 without the lower support layer, in accordance with one embodiment;

FIG. 87 is partial, foot perspective view of a lower support layer and a portion of a foot extension, in accordance with one embodiment;

FIG. 88 is a foot right perspective view of an upper comfort layer for a mattress, in accordance with one embodiment;

FIG. 89 is another top right perspective view of the upper comfort layer shown in FIG. 88;

FIG. 90 is an enlarged, partial and cross-section view of the upper comfort layer shown in FIG. 88;

FIG. 91 is a foot left perspective view of a lower support layer of a mattress and an upper comfort layer mounted thereto, in accordance with one embodiment;

FIG. 92 is a partial head, left perspective view of the mattress shown in FIG. 83, for better showing an embodiment of a head section of the mattress in accordance with one embodiment;

FIG. 93 is a partial foot, left perspective view of the mattress shown in FIG. 83 with the lower support layer removed for better showing an embodiment of a head section of the mattress in accordance with one embodiment;

FIG. 94 is a partial foot, left perspective view of the mattress shown in FIG. 83, showing left longitudinal bolsters of the mattress, in accordance with one embodiment;

FIG. 95 is a partial foot, left perspective view of the mattress shown in FIG. 83, showing an inflatable foot bladder of the foot section of the mattress in accordance with one embodiment;

FIG. 96 is a partial foot, left perspective view of the mattress shown in FIG. 95, with the inflatable foot bladder of the foot section removed for better showing two longitudinal first foot attaching straps to attach a first foot extension bladder to a lower support layer, in accordance with one embodiment;

FIG. 97 is a partial foot, left perspective view of the mattress shown in FIG. 94, with the inflatable foot bladders of the foot section removed for better showing two longitudinal second foot attaching straps to attach a second foot extension bladder to a first foot extension bladder, in accordance with one embodiment;

FIG. 98 is atop plan view of a mattress devised to be used on a supporting patient surface of a bed, according to another embodiment;

FIG. 99 is a foot, left perspective view of the mattress shown in FIG. 98;

FIG. 100 is another top, foot left perspective view of the mattress shown in FIG. 83;

FIG. 101 is a head left perspective view of the mattress shown in FIG. 83;

FIG. 102 is a partial, foot left perspective view of the mattress shown in FIG. 83;

FIG. 103 is a foot left perspective view of a width extension for a mattress, in accordance with one embodiment;

FIG. 104 is a foot left perspective view of an external cover for a mattress, in accordance with one embodiment;

FIG. 105 is a foot left perspective view of the external cover shown in FIG. 104, with a lower support layer, an upper comfort layer and an inflatable foot bladder of the foot section received therein, in accordance with one embodiment;

FIG. 106 is a foot left perspective view of the mattress shown in FIG. 83, with the lower support layer and the upper comfort layer removed for better showing attaching straps, in accordance with one embodiment;

FIG. 107 is a bottom left, head perspective view of the mattress shown in FIG. 83;

FIG. 108 is a diagram illustrating a control of the inflation of a foot bladder and foot extension bladders, according to one embodiment;

FIG. 109 is a foot left perspective view of a mattress to be used on a supporting patient surface of a bed, in accordance with one embodiment;

FIG. 110 is another foot left perspective view of the mattress shown in FIG. 109, with a percussion and vibration assembly removed, in accordance with one embodiment;

FIG. 111 is a partially exploded view of the mattress shown in FIG. 110;

FIG. 112 is a foot left perspective view of the mattress shown in FIG. 111, with width extensions and side extensions deflated, in accordance with one embodiment;

FIG. 113 is a cross-section view of the mattress shown in FIG. 109, taken alon line 113-113;

FIG. 114 is a foot left perspective view of a support layer for a mattress, in accordance with one embodiment;

FIG. 115 is another perspective view of the mattress shown in FIG. 110, with a comfort layer and a support layer removed, in accordance with one embodiment;

FIG. 116 is a top plan view of the mattress shown in FIG. 115;

FIG. 117 is an enlarged, partial head left perspective view of the mattress shown in FIG. 110, with the comfort layer removed;

FIG. 118 is a foot left perspective view of a comfort layer for a mattress, in accordance with one embodiment;

FIG. 119 is a cross-section vie of the comfort layer shown in FIG. 118, taken along line 119-119;

FIG. 120 is an enlarged, partial foot right perspective view of the mattress shown in FIG. 110, with the comfort layer removed;

FIG. 121 is a foot left perspective view of an inflatable and deflatable foot extension section for a mattress, in accordance with one embodiment;

FIG. 122 is a foot left perspective view of a mattress to be used on a supporting patient surface of a bed with the comfort layer removed and right and left rotation bladders of a rotation assist layer in a deflated state, in accordance with one embodiment;

FIG. 123 is a foot right perspective view of the mattress shown in FIG. 122, with the right rotation bladder of the rotation assist layer in a deflated state and the left rotation bladder in an inflated state, in accordance with one embodiment;

FIG. 124 is atop plan view of the mattress shown in FIG. 123;

FIG. 125 is a foot right perspective view of the mattress shown in FIG. 123, with the rotation assist layer removed for showing a bed exit assist layer in a deflated state, in accordance with one embodiment;

FIG. 126 is a cross-section view of the mattress shown in FIG. 125, taken along line 126-126;

FIG. 127 is a foot left perspective view of the mattress shown in FIG. 110, with the comfort layer and the foot extension section removed;

FIG. 128 is a partial, head elevation view of a portion of the mattress shown in in FIG. 109;

FIG. 129 is a partial, head left perspective view of a portion of the mattress shown in in FIG. 110;

FIG. 130 is a foot right perspective view of the mattress shown in FIG. 115, with the foot extension section removed and side extension of the comfort layer resting atop width extensions, in accordance with one embodiment;

FIG. 131 is an enlarged, partial foot left perspective view of a portion of the mattress shown in FIG. 109;

FIG. 132 is an enlarged, partial head right perspective view of a portion of the mattress shown in FIG. 109;

FIG. 133 is a partial cross-section of the mattress shown in FIG. 115, taken along line 133-133;

FIG. 134 is a foot right perspective view of a bottom portion of an external cover for a mattress, in accordance with one embodiment;

FIG. 135 is a head right perspective view of the bottom portion of an external cover for a mattress shown in FIG. 134; and

FIG. 136 is an enlarged, partial head right perspective view of a portion of the bottom portion of an external cover for a mattress shown in FIG. 134.

### DETAILED DESCRIPTION

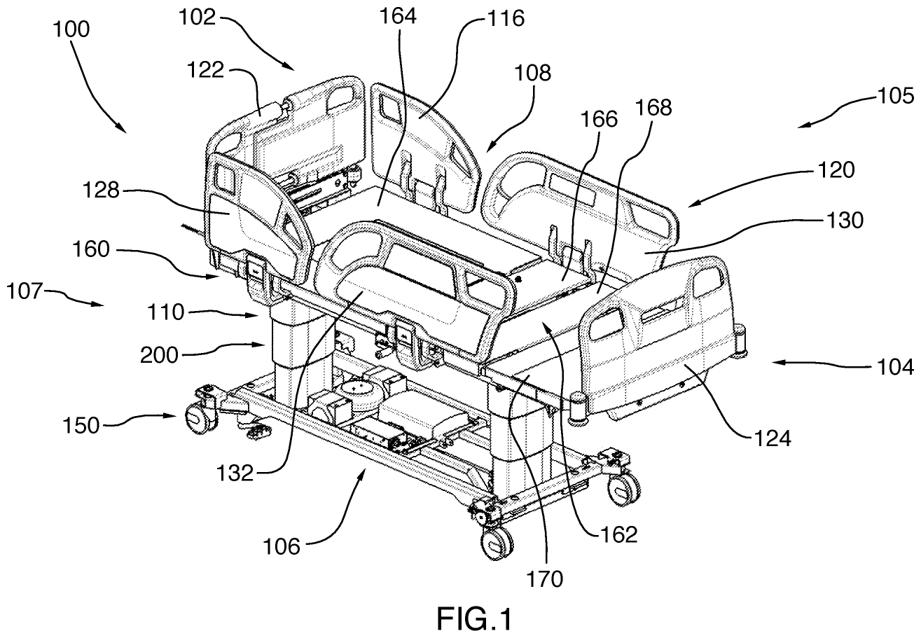

Referring to FIG. 1, there is shown a hospital bed 100, in accordance with one embodiment. The bed 100 comprises a head end 102, an opposite foot end 104 and spaced-apart left and right sides 105, 107 extending between the head end 102 and the foot end 104.

Some of the structural components of the bed 100 will be designated hereinafter as “right”, “left”, “head” and “foot” from the reference point of an individual lying on his/her back on the support surface of the mattress provided on the bed 100 with his/her head oriented toward the head end 102 of the bed 100 and his/her feet oriented toward the foot end 104 of the bed 100.

The bed 100 includes a base 106, a patient support assembly 108 and an elevation system 110 operatively coupling the patient support assembly 108 to the base 106. In the illustrated embodiment, the base 106 is provided with a displacement assembly which includes casters 150 connected to the base 106 by pivots (not shown), as known in the art. This displacement assembly allows the bed 100 to be moved and maneuvered along a floor. In one embodiment, the base 106 is at a distance of 5 or 6 inches from the floor for enabling the base of a night table to be freely inserted or positioned below the base. Alternatively, the base 106 could be higher or lower than 5 inches from the floor.

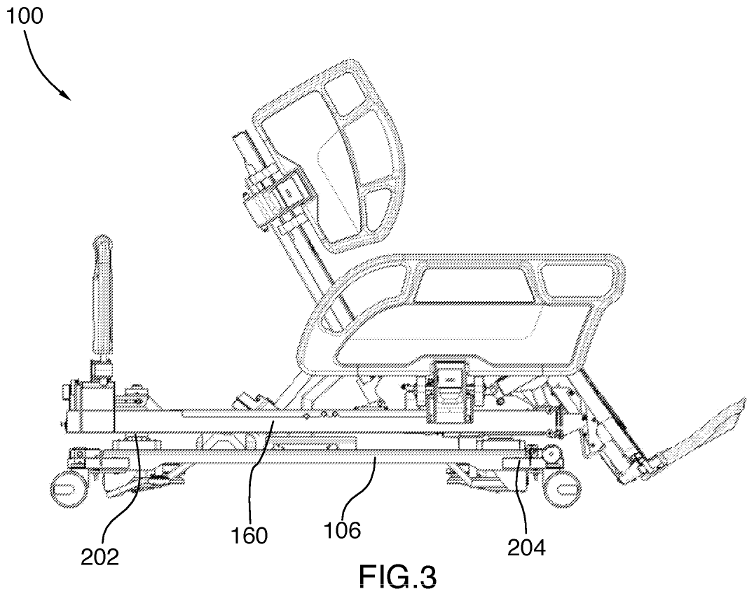

In the illustrated embodiment, the patient support assembly 108 includes a frame 160 and a patient support surface 162 supported by the frame 160. In the illustrated embodiment, the patient support surface 162 includes a plurality of adjacent body surfaces for supporting various parts of the body of the patient, including a backrest support surface or panel 164, a core support surface or panel 166 located adjacent the backrest support panel 164 for supporting the seat of the patient, a thigh support surface or panel 168 located adjacent the core support panel 166 for supporting the thighs of the patient, and a foot support surface or panel 170 located adjacent the thigh support panel 168 for supporting the foot of the patient. As better shown in FIG. 3 and described in more details below, the backrest support panel 164, the thigh support panel 168 and the foot support panel 170 can be angled relative to the other panels. In one embodiment, the core panel 166 is not movable and fixedly attached to the frame 160. A lying surface such as a mattress (not shown) is typically provided on the patient support surface 162 for receiving the patient thereon, as detailed thereinafter.

The bed 100 further includes a patient support barrier system 120 generally disposed around the patient support assembly 108. The barrier system 120 includes a plurality of barriers which extend generally vertically around the patient support assembly 108. In the illustrated embodiment, the plurality of barriers includes a headboard 122 located at the head end 102 and a footboard 124 disposed generally parallel to the headboard 122 and located at the foot end 104 of the bed 100. The plurality of barriers further includes spaced-apart left and right head siderails 116, 128 which are located adjacent the headboard 122 and spaced-apart left and right foot siderails 130, 132 which are respectively located between the left and right head siderails 116, 128 and the foot end 104 of the bed 100. Each one of the plurality of barriers is moveable between an extended or raised position for preventing the patient lying on the bed 100 from moving laterally out of the bed 100, and a retracted or lowered position for allowing the patient to move or be moved laterally out of the bed 100, as known in the art.

The bed 100 may further include a control interface (not shown) for controlling various features and positions of the bed 100. The control interface could be integrated into the footboard 124, into the headboard 122 or into one or more of the siderails 116, 128, 130, 132. Alternatively, the control interface could be provided as a separate unit located near the bed 100 or even at a location remote from the bed 100.

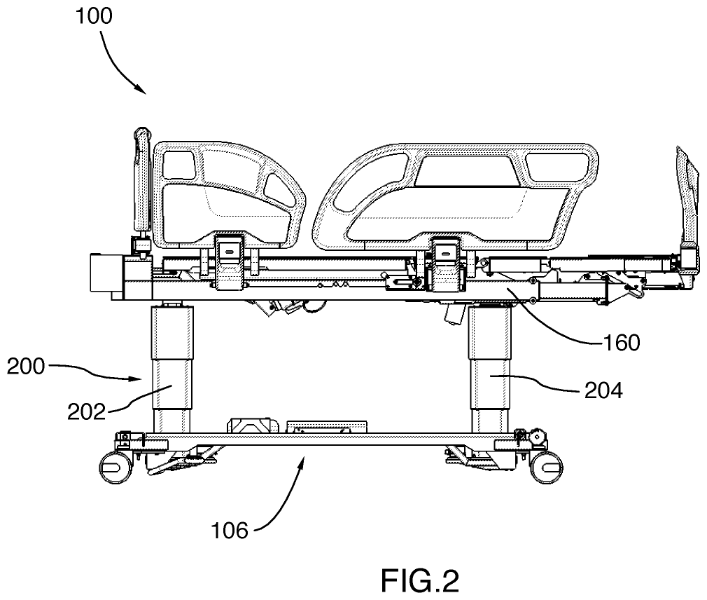

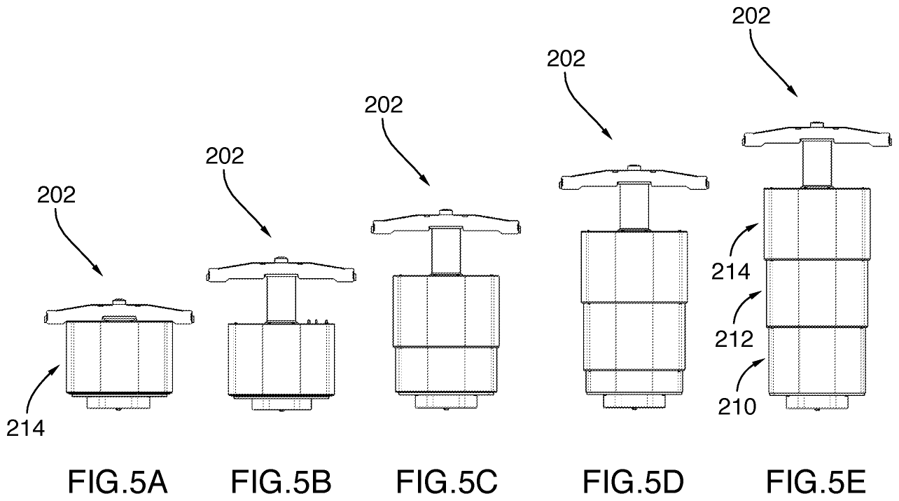

Referring now to FIGS. 1 to 16, the elevation system 110 will now be described in accordance with one embodiment of a first aspect. The elevation system 110 is mounted between the base 106 of the bed 100 and the frame 160 thereof, as better detailed below and is movable in different positions between an extended position, shown in FIGS. 1 and 2, in which the patient surface is positioned in the uppermost position, and a retracted position, shown in FIGS. 3 and 5A, in which the patient surface is positioned in the lowermost position. As shown in FIG. 3, the bed 100 of FIG. 2 can be positioned in a chair position, as it will be detailed thereinafter. In this chair position, the elevation columns 202, 204 are shown in an almost fully retracted position, and the frame 160 extends in a low position proximate its lowermost position.

In the illustrated embodiment, the elevation system 110 is provided with a head elevation column 202 extending proximate the head end of the bed 100 and a foot elevation column 204 extending proximate the foot end of the bed 100. In the illustrated embodiment, each of the head and foot elevation column 202, 204 extends along the longitudinal axis of the bed 100 (i.e. between the head end 102 and the foot end 104) to provide convenient stability thereto.

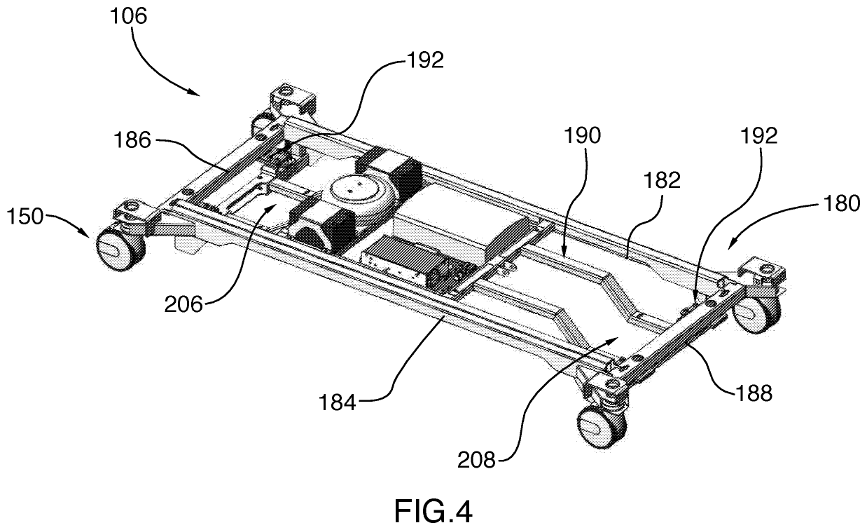

FIG. 4 illustrates an exemplary embodiment of a base 106 which can be used for mounting the head and foot elevation columns 202, 204. In this embodiment, the base 106 is provided with an external base 180 supported by the wheels 150 of the bed 100, this external base 180 being a non-weighed base. The external base 180 has two spaced-apart longitudinal members 182, 184 connected to their ends to a head transverse member 186 and a foot transverse member 188, the longitudinal and transverse members 182, 184, 186, 188 defining a generally rectangular structure. The external base 180 is mounted on the four casters 150, each caster 150 being provided at a corner of the external base 180. The base 106 also include an internal base 190 (also called weighed base) supported by the external base 180 via a plurality of load cells 192 devised to monitor the weight of the patient lying on the bed 100, as detailed below. The internal base 190 is adapted for receiving the elevation system 110 thereon. As best shown in FIG. 4, the illustrated base 106 defines two lowered compartments 206, 208 adapted for respectively receiving a lower portion of each the head and foot elevation columns 202, 204. These lowered compartments 206, 208 enable to mount the elevation columns 202, 204 at a very low position at the head end and the foot end of the bed while still providing space below the central portion of the base 106 and the floor (e.g. to receive a base of a night table), as it will become apparent below and as better shown in FIGS. 2 and 3.

FIGS. 5A to 5E illustrates an exemplary activation sequence of one of the head elevation column 202 and the foot elevation column 204 between the most retracted position (FIG. 5A) providing the lowermost position of the bed 100 and the most extended position (FIG. 5E) providing the uppermost position of the bed 100, as it will become apparent below. In the illustrated embodiment, the elevation column 202 or 204 is provided with a lower cover 210, an intermediate cover 212 and an upper cosmetic cover 214 able so slide in each other in a telescopic arrangement. In the illustrated embodiment, the lower cosmetic cover 210 is immovable relative to the base 106 while the intermediate and upper cosmetic covers 212, 214 are adapted to extend upwardly and linearly with a telescopic motion. In FIG. 5A, the elevation column 202 or 204 is in the most retracted position, only the upper cosmetic cover 214 being apparent while the intermediate and lower cosmetic covers 212, 210 are telescopically retracted inside the upper cosmetic cover 214. In FIG. 5B, the elevation column 202, 204 has been extended of approximately 5 inches but the cosmetic covers 210, 212, 214 are still in the same position. In FIG. 5C, the elevation column 202, 204 has been extended of approximately 10 inches, which leads the upper cosmetic cover 214 to move upwardly. At this point, the intermediate cosmetic cover 212 is at least partially apparent. In FIG. 5D, the elevation column 202, 204 has been extended of approximately 15 inches, which leads the upper cosmetic cover 214 to further move upwardly. The intermediate cosmetic cover 212 also moves upwardly with the upper cosmetic cover 214, leaving the lower portion of the lower cosmetic cover 210 partially visible. In FIG. 5E, the elevation column 202, 204 has been extended of 20 inches to its most extended position. The upper and intermediate cosmetic covers 214, 212 have been further moved upwardly, leaving the immovable lower cosmetic cover 210 fully visible.

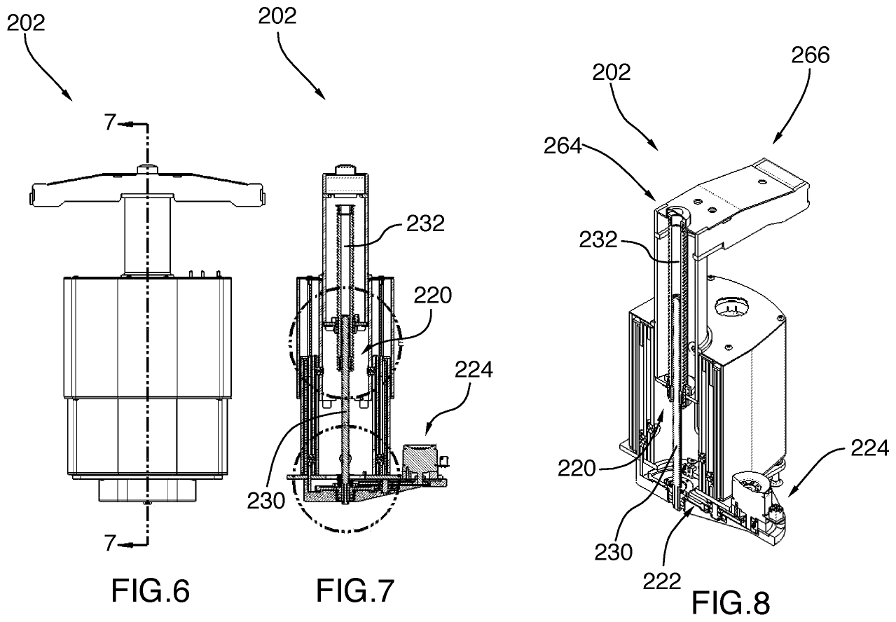

To extend and retract the elevation columns 202 and/or 204, a mechanical arrangement is provided. An embodiment of one such mechanical arrangement used for extending and retracting the elevation column 202, 204 will now be described with reference to FIGS. 6 to 13.

FIGS. 6 to 8 show an elevation column 202, according to one embodiment. It will be understood that the head and foot elevation columns 202, 204 are generally similar to each other although other arrangement may be considered for a specific application. As better shown in FIGS. 6 to 8, the elevation column 202 has a double stage telescopic lead screw 220 enabling the extension and retraction of the elevation column 202. The elevation column 202 also has a mounting base 222 for mounting the elevation column 202 in a corresponding compartment 206, 208 of the base 106 of the bed 100 (best shown in FIG. 4). The mounting base 222 is securable to the base 106 of the bed 100 and is adapted to be operatively coupled to the double stage telescopic lead screw 220. The mounting base 222 is further adapted for mounting a driving system 224 thereto, the driving system 224 being devised to drive the double stage telescopic lead screw 220.

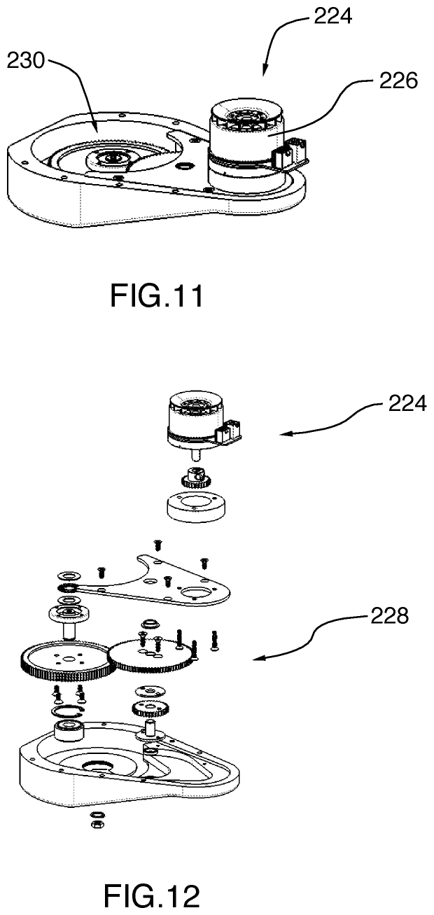

As better shown in FIGS. 11 and 12, in one embodiment, the driving system 224 is provided with an electrical motor 226 driving a gear assembly 228 operatively coupled to the double stage telescopic lead screw 220. A rotation of the electrical motor 226 in a first direction and in an opposed direction will drive the rotation of the double stage telescopic lead screw 220 accordingly through the gear assembly 228. The skilled addressee will appreciate that a bearing 231 is used to support the vertical load of the double stage telescopic lead screw 220. In the illustrated embodiment, the electrical motor 226 is mounted on the side of the double stage telescopic lead screw 220 to minimize the overall height of the elevation column 202.

Referring now to 7 to 10, the double stage lead screw 220 has a lower lead screw 230 coupled to the mounting base 222 and driven by the electrical motor 226 through the gear assembly 228. FIG. 10 shows the double stage lead screw 220 operatively attached to the gear assembly 228. The double stage lead screw 220 also has an upper lead screw 232 connected to the lower lead screw 230 through a telescopic assembly. The lower lead screw 230 has outer threads configured to cooperate with the inner threads of an inner treaded channel 234 of the upper lead screw 232 so that the lower lead screw 230 can move inside the upper lead screw 232. The upper lead screw 232 also has outer threads, which engage a corresponding threaded portion 252 of a first telescopic stage 240, as detailed below.

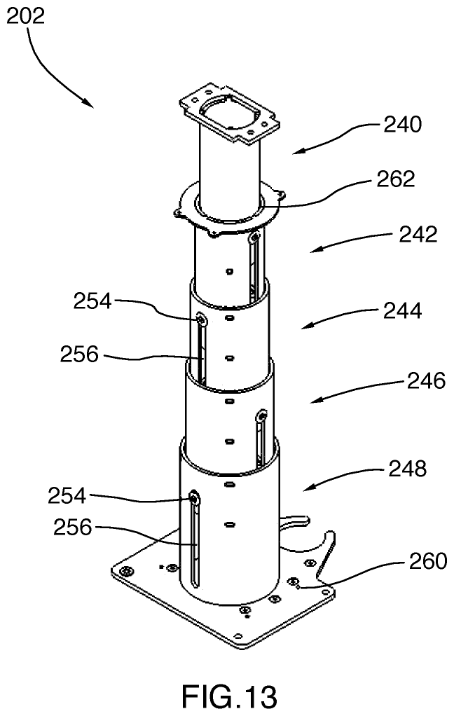

The elevation column 202 also has a plurality of telescopic stages 240, 242, 244, 246, 248 that are mounted inside one another in a telescopic arrangement and operatively connected to the double stage lead screw 220, as better shown in FIGS. 7 and 13. In the illustrated embodiment, 5 stages 240, 242, 244, 246, 248 are used. As it will become apparent below, a deployment mechanism 249 operatively connected to each of lower lead screw 230 and the upper lead screw 232 of the double stage lead screw 220 and also connected to the plurality of telescopic stages 240, 242, 244, 246, 248 enables to deploy or retract the stages 240, 242, 244, 246, 248 according to the desired height position.

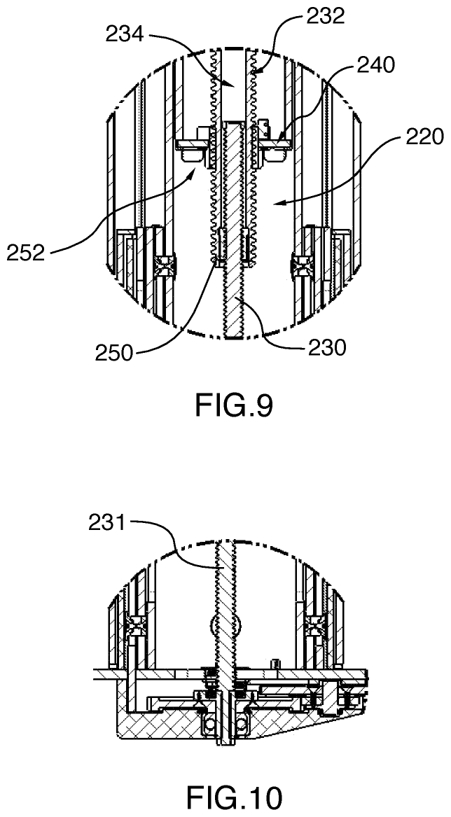

As better shown in FIG. 9, the deployment mechanism 249 has a threaded nut 250 mounted at the lower end of the upper lead screw 232 for threadingly receiving the lower lead screw 230 therethrough. As it become apparent, this threaded nut 250 enables to retract the upper lead screw 232 telescopically with the lower lead screw 230 when all of the stages 240, 242, 244, 246, 248 are retracted. This threaded nut 250 also enables to deploy the upper lead screw 232 upwardly away from the lower lead screw 230 first when all the stages are initially moved from the retracted position toward the extended position. The deployment mechanism also has a threaded portion 252 defined at the base of the innermost stage 240 for threadingly receiving the upper lead screw 232 therethrough. As it will become apparent, this threaded portion 252 allows to sequentially retract or deploy the plurality of stages 240, 242, 244, 246, 248 one after the other. The deployment mechanism also has a combination of stage stoppers 254 and corresponding elongated slots 256 extending on a plurality of respective stages for guiding the sequential deployment or retraction of the plurality of stages 240, 242, 244, 246, 248 one relative to the others, as better shown in FIG. 13.

A sequence of deploying the elevation column 202, 204 from the most retracted position to the most deployed position will now be described with reference to FIG. 13. First the upper lead screw 232 is deployed upwardly through the electrical motor 226 driving the gear box assembly 228 connected to the lower lead screw 230. This movement raise the innermost stage 240 to which the upper lead screw 232 is connected. When the innermost stage stopper 254 reaches the upper limit of the associated slot 256 on the second inner stage 242, the innermost stage stopper 254 pulls on the second inner stage 242. When the second inner stage stopper 254 reaches the upper limit of the associated slot 256 on the third stage 244, the first stage 240 pulls on the second stage 242 and the second stage 242 pulls on the third stage 244. The same process continues for the other stages.

As shown in FIG. 13, the double stage lead screw 220 and the stages assembly 240, 242, 244, 246, 248 is mounted on a mounting plate 260 securable to the base 106 of the bed 100, in the corresponding compartment 206, 208. The double stage lead screw 220 and the stages assembly 240, 242, 244, 246, 248 is also provided with a cosmetic cover mounting plate 262 fixed at the top of the second innermost stage 242 for mounting the top of the uppermost cosmetic cover 214 thereto. As it should now be appreciated, the deployment of the stages 240, 242, 244, 246, 248 will drive the deployment of the cosmetic covers 210, 212, 214 described above with reference to FIGS. 5A to 5E.

Referring again to FIG. 8, the double stage lead screw 220 may be provided with a top cover 264 allowing the double stage lead screw 220 to exceed the height of the elevation column 202, 204 to enable longer vertical range reading with a more compact build-in dimension. Moreover, the elevation column 202, 204 may also be provided with an upper mounting portion 266 that is modular for providing enlarged compatibility for mounting on various bed models and/or in the case the mounting of the head or foot elevation column 202, 204 are different for a specific application. For example, the upper mounting portion 266 may be configured for providing longitudinal and/or lateral tilting of the bed 100.

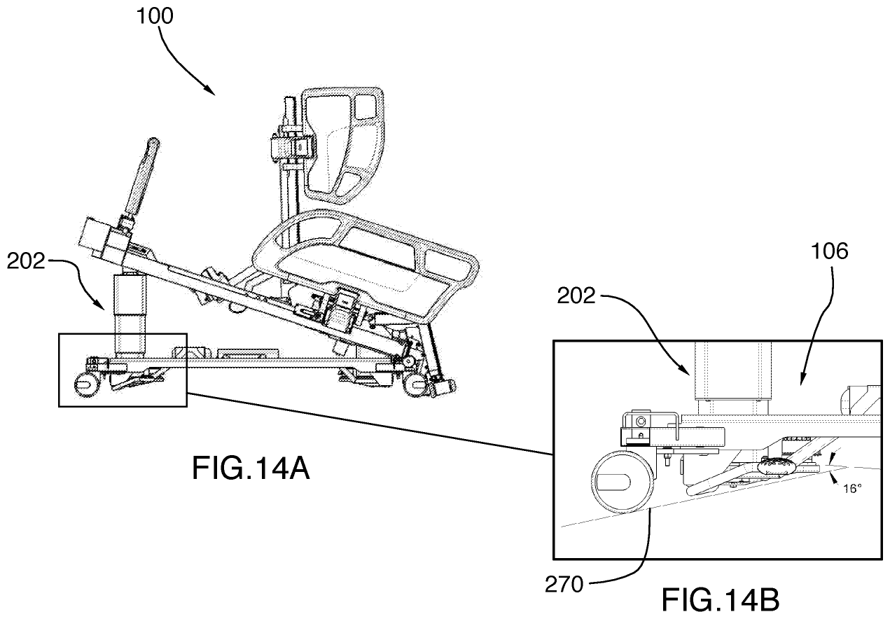

FIG. 14A shows a bed 100 equipped with the elevation columns 202, 204 previously described, the bed 100 being in a chair position with the foot elevation column 204 more retracted than the head elevation column 202. FIG. 14B is an enlarged view of the mounting arrangement used for mounting the elevation columns 202, 204 to the base 106 of the bed 100. As it could be appreciated, the lower portion of the mounting arrangement has been designed to permit transport of the bed 100 on an inclined surface 270 up to 16 degrees of inclination without interference with the ground.

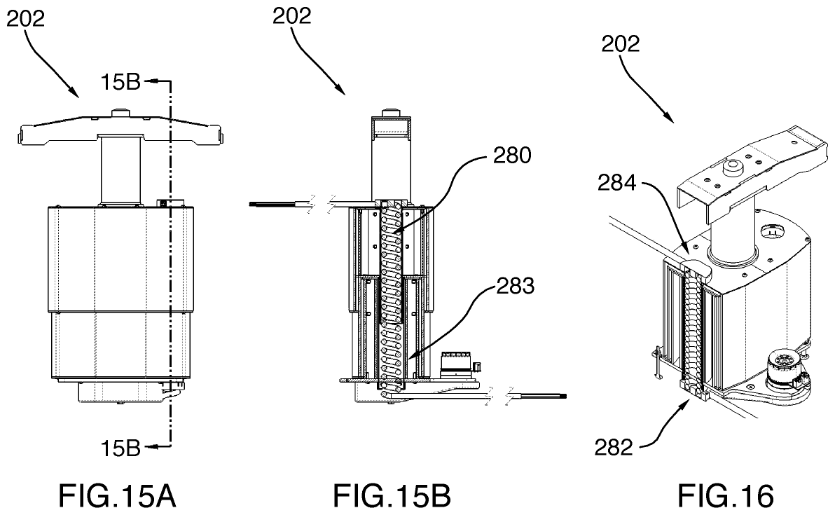

Reference is now made to FIGS. 15A to 16 which show electrical wires routed internally through the elevation column 202, according to one embodiment. As illustrated, a coiled power cable 280 is used for routing the electrical wires. The coiled power cable 280 is routed inside a telescopic guiding tubing 283 mounted inside the cosmetic covers 210, 212, 214 for guiding the power cable 280 during retraction and/or deployment of the elevation column 202. Coiled power cable strength reliefs 282, 284 are provided at the entrance and exit of the power cable 280 inside the cosmetic covers 210, 212, 214. Such arrangement provides a secure electrical connection between the base 106 of the bed 100 and the portions of the bed extending above the frame 160 without interference with the environment. This may be useful for power supply cables for various parts of the bed 100, as well as communication cables for exchanging data or information between a lower electrical circuit such as a PCB installed in the base 106 and a PCB installed in the backrest portion of the frame 160 for example.

In a further embodiment, the elevation columns 202, 204 may be provided with optical or mechanical limit switches (not shown) for detecting the upper and lower limits of the column movement. The electrical motor 226 may also have a build-in encoder for providing the control unit of the bed 100 with the height of each of the elevation columns 202, 204. The height of each elevation column 202, 204 may be further monitored during the raising and lowering of the patient support surface such that if an elevation column 202, 204 is raised faster than the other, the higher column speed will be reduced until the lower column catch up with the higher one. Of course, various alternative operation procedures may be considered for operating the deployment and retraction of the elevation columns 202, 204.

The skilled addressee will appreciate that the embodiment previously described offers an improved longer stroke with a reduced built-in height. This enables to reach a sufficiently high height in the most deployed position. This also enables to provide a bed 100 able to reach an improved predetermined low height which contributes to early patient mobility and allows easier rehabilitation.

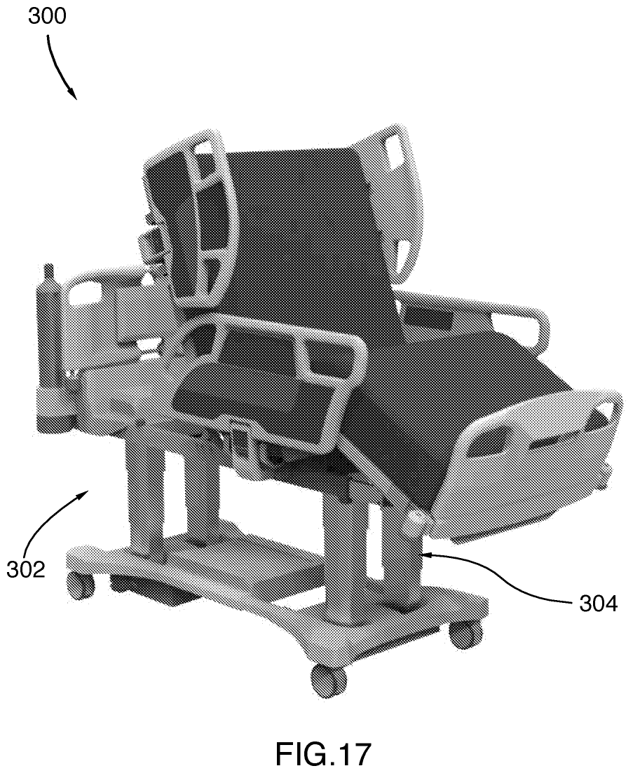

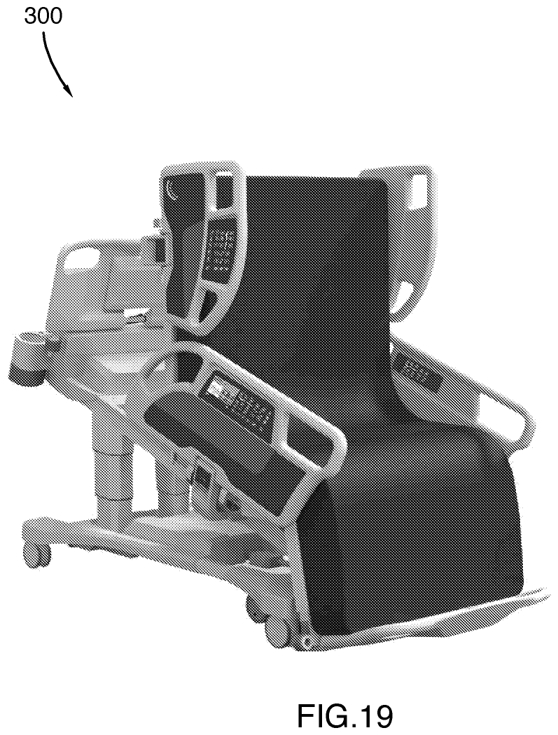

Referring now to FIGS. 17 to 19, another embodiment using four elevation columns on an ICU bed 300 will now be described. Such an embodiment may provide greater stability and/or improved lateral rigidity to the bed 300, particularly when the bed 300 is used with bariatric patients and/or when a length extension is used and the patient is sitting thereon. This improved rigidity may also enable to reduce the longitudinal space between head and foot elevation columns 302, 304, which may provide additional advantages for providing a ICU bed 300 offering a full chair position, as illustrated in FIG. 19 and further detailed below. Cost for the elevation system for a bed 300 may also be reduced. The general principles described above with reference to the two elevation columns configuration (i.e. elevation column 202, 204) are still applicable in this four elevation columns configuration.

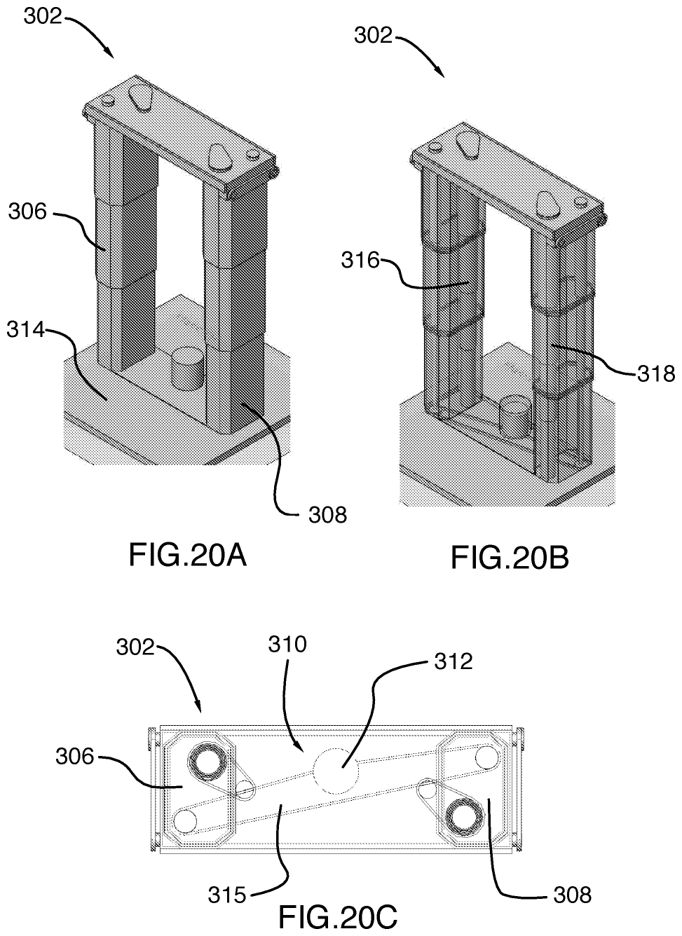

FIGS. 20A to 20C illustrate a head elevation column 302 using a double configuration. As illustrated, the two elevation columns 306, 308 are fixed together at their upper and lower ends to improved rigidity of the elevation assembly 302. In this embodiment, the driving system 310 has an electrical motor 312 fixedly attached to the base 314 extending between the two elevation columns 306, 308. The motor 312 drives a driving belt 315 which simultaneously drives the double stages lead screws 316, 318 of the two elevation columns 306, 308.

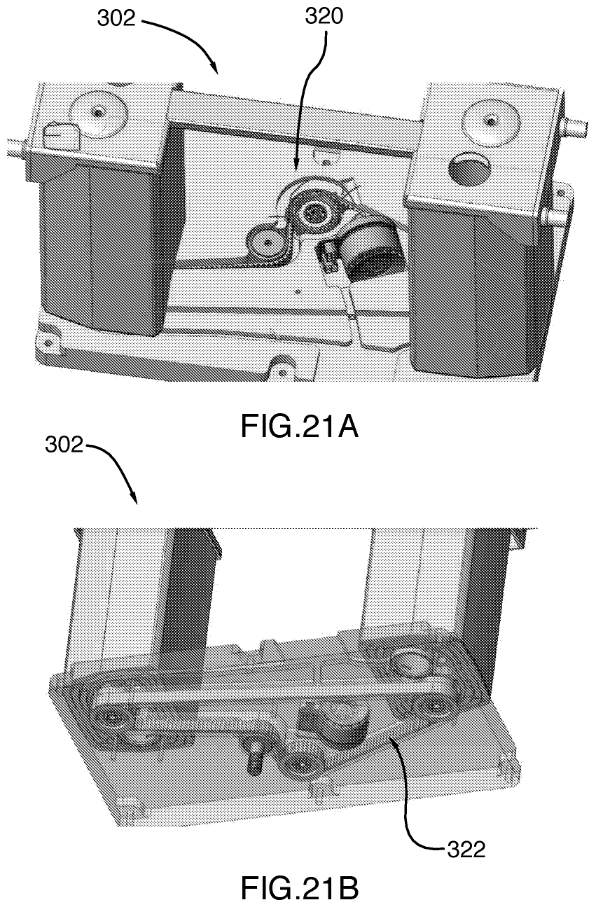

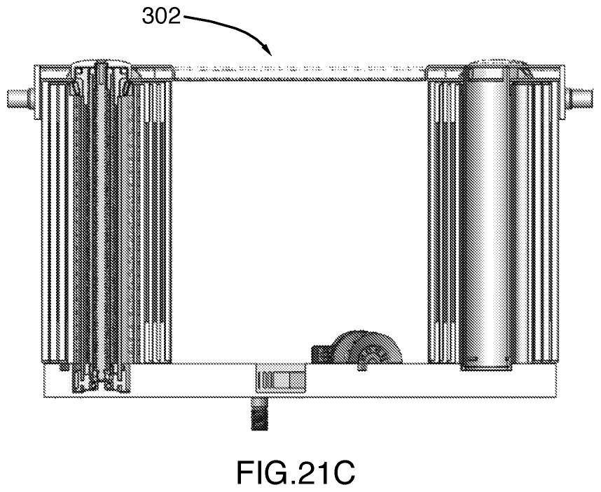

FIGS. 21A to 21C illustrate another driving system 320 according to another embodiment. In this embodiment, the driving belt 322 is operated through additional wheels. Replacing the above-described gear assembly 228 with the presently described driving belt 322 may enable to reduce noise associated with the operation of the elevation columns.

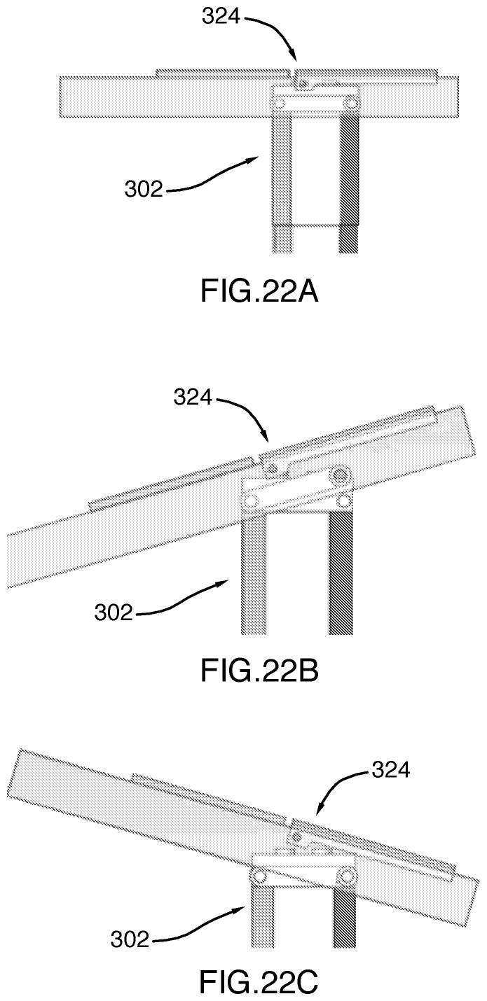

Referring to FIGS. 22A to 22C, a double pivot system 324 may be used on the upper portion of the elevation columns 302 for enabling longitudinal pivoting of the patient support surface on the elevation columns 302. This enables to use a larger built-in for the elevation columns 302, 304.

While in the above embodiments the bed are provided with elevation columns 202, 204 or 302, 304 to raise and lower the head and foot ends of the bed, it will be understood that other elevation mechanism could be used instead. For instance, the support surface could be mounted to the frame via an elevation mechanism such as the ones described in US Publication No. 2019/0358104 by the same Applicant, which is hereby incorporated by reference.

In a further embodiment, the bed 300 may be provided with a motorized wheel for propelling the bed 300 during transport. In this embodiment, the motorized wheel may be mounted centrally at the foot end of the bed 300, between two adjacent elevation columns 306, 308.

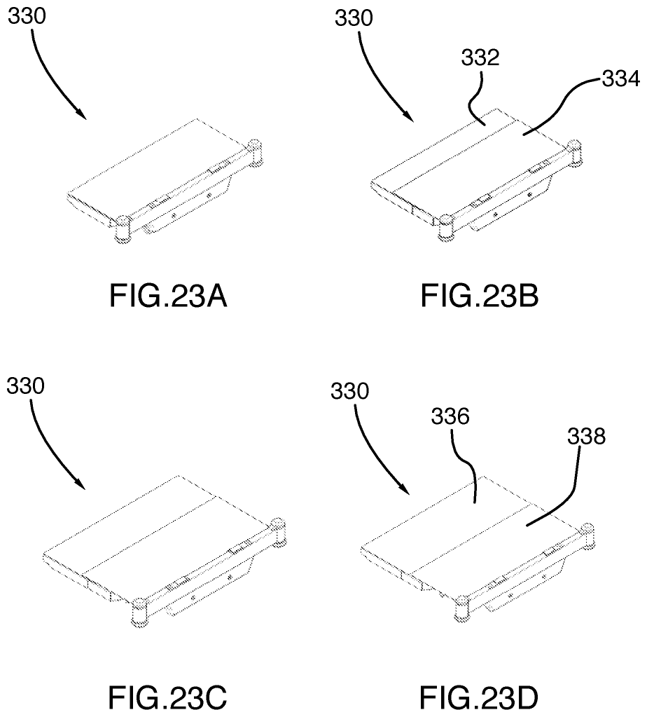

Referring now to FIGS. 23A to 23D, an expandable and retractable foot support panel 330 for a bed 300 will now be described, which may be used to adjust the length of the patient support surface. Indeed, for taller patient, a typical bed generally requires to be longitudinally expanded for accommodating the patient comfortably and prevent foot drop issue. However, during transport, bed might have to be shortened to fit smaller elevator. The present foot support panel 330 is motorized for ease of operation. Moreover, as it will become apparent below, the specific proposed arrangement may enable to provide a bed 300 whose chair position has a low seat height. This is of great advantage since it would help the patient during the chair egress procedure.

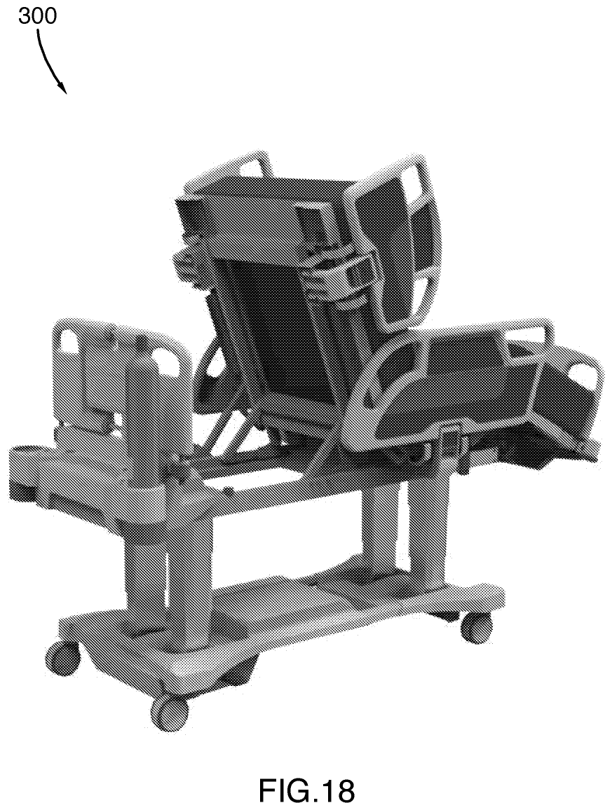

Various embodiments are proposed therewith. Some embodiments are powered with a single actuator arrangement and are particularly well adapted for use on a bed having a cardiac chair position as illustrated on FIG. 18. Other embodiments are powered with a double independent motorized mechanism and are well adapted for use on a bed having a full chair position as illustrated on FIG. 19 and more detailed below.

FIGS. 23A to 23D show a foot support panel 330 similar to the foot support panel 170 shown in FIG. 1 in various configurations but with the footboard 124 removed from the bed. FIG. 23A shows the foot support panel 330 fully retracted, FIG. 23B shows the foot support panel 330 slightly expanded, FIG. 23C shows the foot support panel 330 more expanded while FIG. 23D shows the foot support panel 330 fully expanded. In this embodiment, the width of the foot support panel 330 is 35 inches. When the foot support panel 330 is fully retracted, the bed 300 is 74 inches long. The foot support panel 330 is expandable to various positions to provide a bed 300 being 80 inches long, 84 inches long and 88 inches long, as illustrated, and as further detailed below. As detailed below, this foot support panel 330 enables a bed 300 to be operated in a full chair position as the one shown in FIG. 19.

The foot support panel 330 has a main section 332 pivotally connected to the thigh support panel 168, as shown in FIG. 3, and a length extension section 334 slidably connected to the main section 332, as shown in FIGS. 23A to 23D. The main section 332 is provided with an upper main sheet 336 connected thereto and the length extension section 334 is provided with an upper extension sheet 338 connected thereto. The upper extension sheet 338 overlaps the main sheet 336 in the illustrated embodiment. When the foot support panel 330 is extended, the length extension section 334 is pushed away from the main section 332 and the uppermost extension sheets 338 slides outwards on the main sheet 336. In the most extended position, the main sheet 336 and the extension sheet 338 are substantially coplanar and adjacent to each other without leaving any aperture therebetween.

FIGS. 24A to 24D show a similar embodiment of the foot support panel 340, but further provided with lateral width extensions 342, 344 for use on a bariatric bed, as it will become apparent below. The width extensions 342, 344, when fully expanded as illustrated, enable to reach a width of 45 inches. When retracted, the width extensions 342, 344 extends below the main patient support surface.

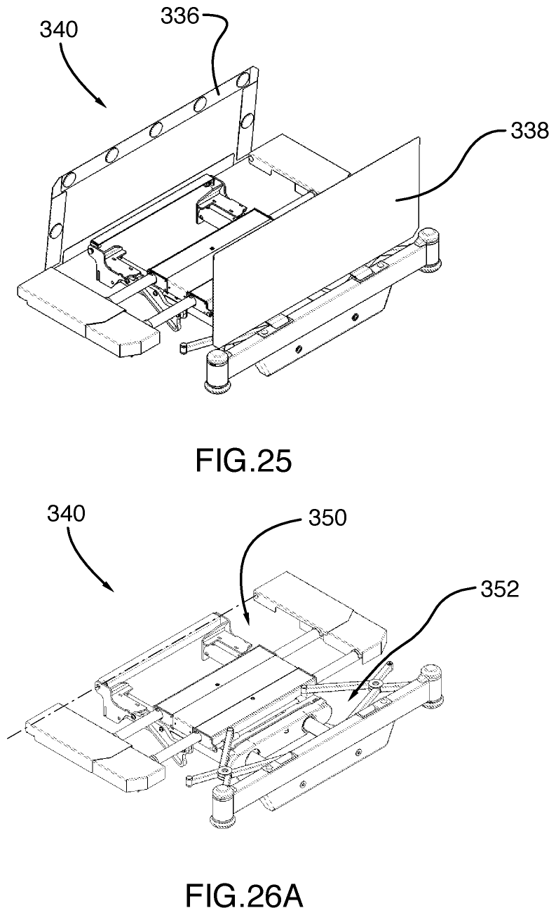

FIG. 25 shows the foot support panel 340 of FIG. 24D in the most extended position. As illustrated, the upper main sheet 336 is pivotally attached to the end of the main section 332 adjacent the thigh support panel 168. Additionally, the upper extension sheet 338 is pivotally attached to the end of the length extension section 334 adjacent the footboard 124 (shown in FIG. 1). Such arrangement enables easy access to the actuating system for cleaning and/or maintenance purposes.

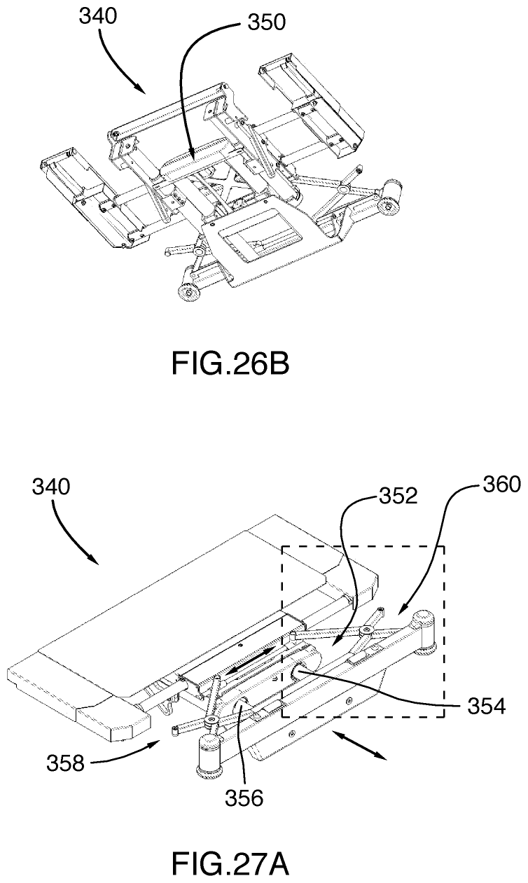

FIGS. 26A to 26B show the foot support panel 340 of FIG. 25, but with the main sheet 336 and the extension sheet 338 removed. This embodiment is provided with an extension frame 347 movably mounted to the foot support panel 340 and housing a double independent motorized mechanism, as mentioned above. More particularly, a first motorized extension mechanism 350 enables to extend the patient support surface such that the length of the bed 300 can be extended from 74 inches to 80 inches. A second motorized extension mechanism 352 enables to further extend the patient support surface such that the length of the bed 300 is extended from 80 inches to 88 inches. In FIGS. 26A and 26B each of the first and second motorized extension mechanisms 350, 352 have been extended to their longest position.

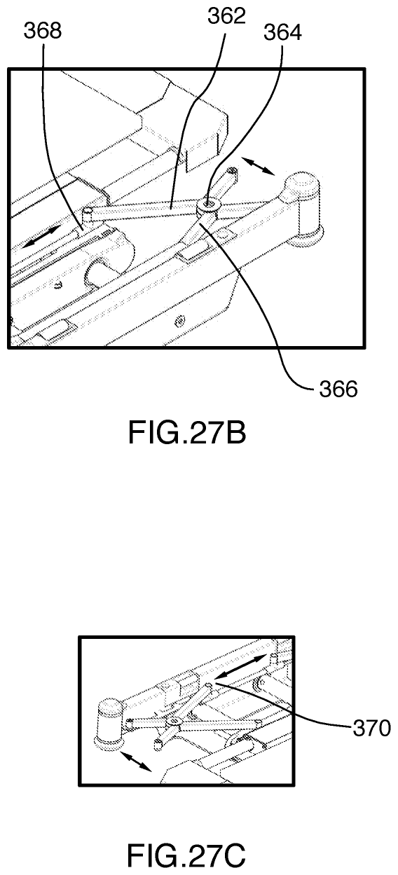

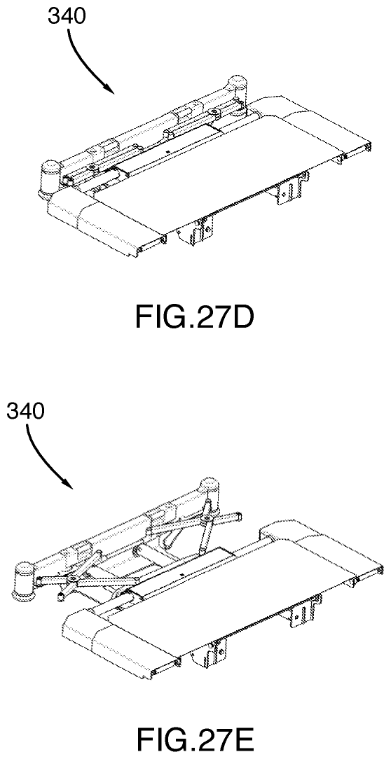

FIGS. 27A to 27F show the second motorized extension mechanism 352, according to one embodiment. The second motorized extension mechanism 352 has two linear actuators 354, 356 mounted in a parallel relationship between the main section 332 and the length extension section 334 of the foot support panel 340 for deploying and retracting the length extension section 334. As detailed below, in one embodiment, the linear actuators 354, 356 are operated simultaneously through an electrical motor.

The second motorized extension mechanism 352 also has a right and a left retractable support mechanisms 358, 360 mounted between the main section 332 and the length extension section 334 of the foot support panel 340 for providing support to the upper extension sheet 338 acting as a portion of the patient support surface. Each retractable support mechanism 358, 360 has two cross members 362, 364 pivotally connected about their central portion 366 to provide an extended position in the shape of a cross and a folded position where the two cross members 362, 364 are folded one against the other, as shown in FIG. 27D. As better shown in FIG. 27C, the ends of the cross members 362, 364 extending inwardly are pivotally connected to corresponding linear tracks 368, 370 provided on the main section 332 and the length extension section 334. When the two linear actuators 354, 356 are actuated, these inwards ends of the cross members 362, 364 are allowed to freely slide in their corresponding linear tracks 368, 370 during the folding and unfolding movement. The end of the cross member 362 extending proximate the length extension section 334 is pivotally connected thereto. As it can be understood, these right and left retractable support mechanisms 358, 360 may improve support and rigidity of the patient support surface, particularly when lateral width extensions 342, 344 are used. The skilled addressee will appreciate that these right and a left retractable support mechanisms 358, 360 may be omitted for a particular application.

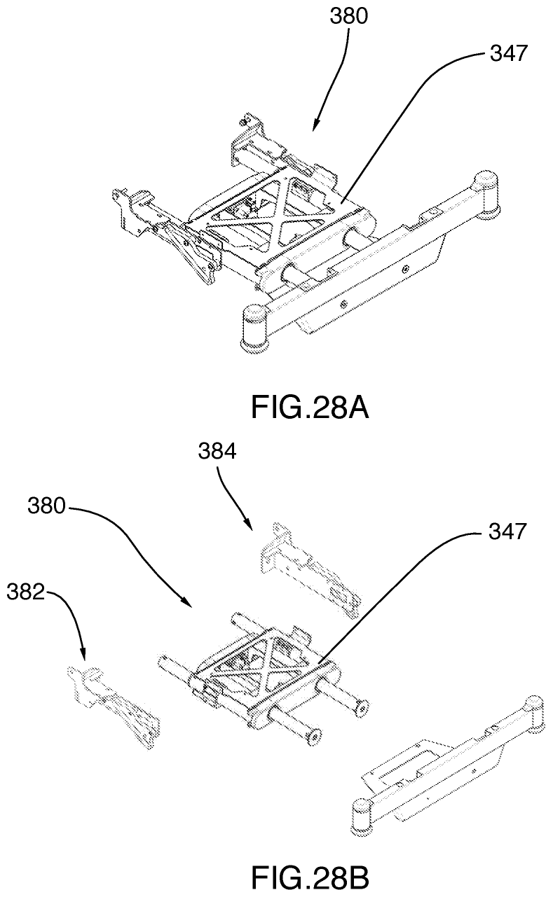

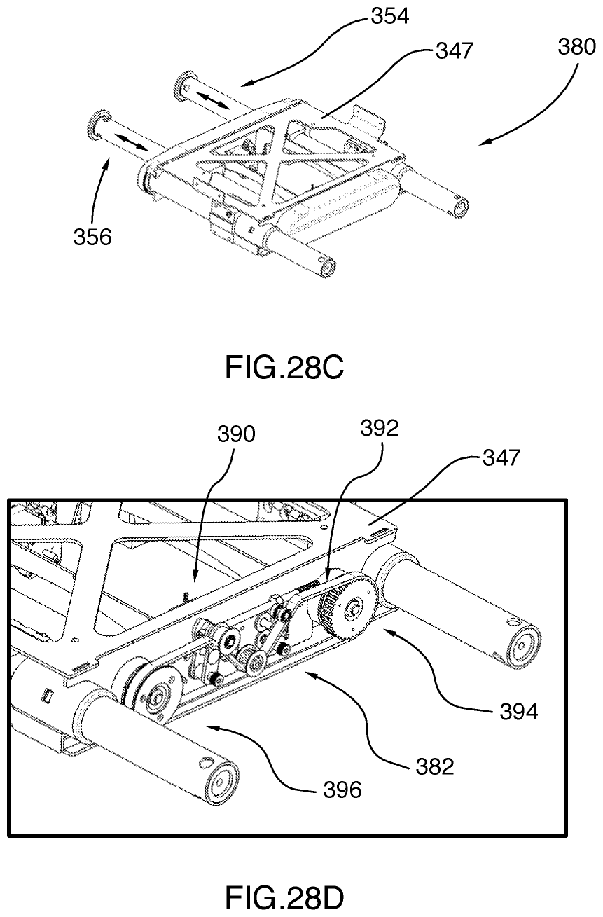

FIGS. 28A to 28D show another foot support panel 380, according to another embodiment. In this embodiment, the foot support panel 380 is not provided with width extensions 342, 344 and the retractable support mechanisms 358, 360 are thus omitted. As illustrated, the foot support panel 380 is provided with right and left transverse linear tracks 382, 384 adapted for connecting the foot support panel 380 to the thigh support panel 168 such that the angle between the foot support panel 380 and the thigh support panel 168 can be adjusted, as it should become apparent below.

FIG. 28D shows the motor arrangement 382 used for actuating the actuators 354, 356 of the second motorized extension mechanism 352 shown in FIG. 28C. The second motorized extension mechanism 352 has a step motor 390 driving a timing belt 392 connected to the two linear actuators 354, 356 through two corresponding pulleys 394, 396 connected to a corresponding lead screw (not shown) of the corresponding linear actuator 354, 356. As it should now be apparent, operation of the motor 390 drives the timing belt 392 which drive the pulleys 394, 396. Upon rotation of the pulleys 394, 396, the linear actuators 354, 356 are deployed or retracted.

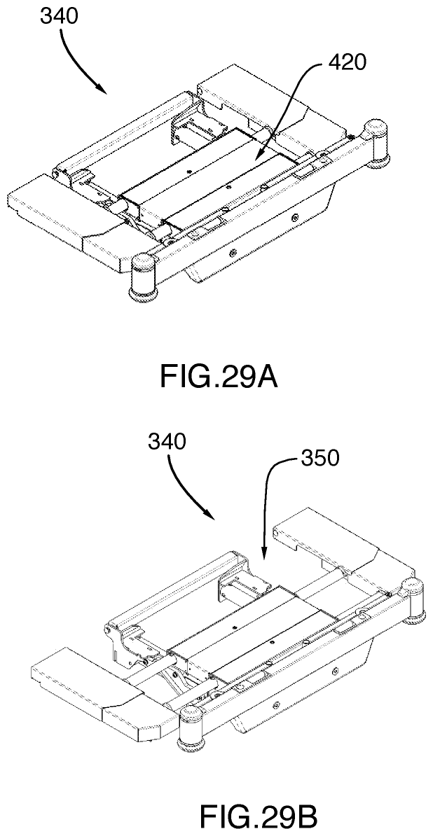

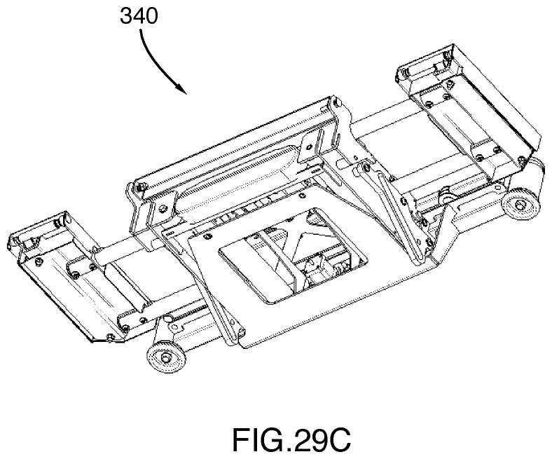

The first motorized extension mechanism 350 according to one embodiment will now be described with reference to FIGS. 28A, 28B and 29A to 30B. The first motorized extension mechanism 350 has two linear actuators 400, 402 mounted in a parallel relationship between the main section 332 of the foot support panel 380 and a mounting portion thereof connected to the thigh support panel 168 section for deploying and retracting the foot support panel 380 relative to the thigh support panel 168. In one embodiment, the linear actuators 400, 402 are operated simultaneously through an electrical motor. In FIGS. 29A and 29B, the first motorized extension mechanism 350 is in the extended position while in FIG. 29C, it is shown in the fully retracted position.

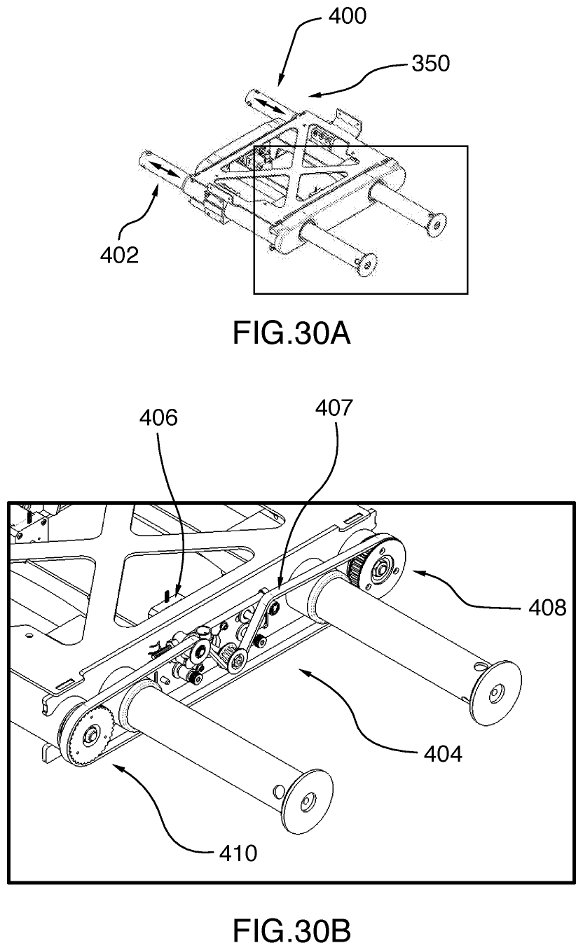

FIG. 30B shows the motor arrangement 404 used for actuating the actuators 400, 402 of the first motorized extension mechanism 350 shown in FIG. 30A. The first motorized extension mechanism 350 has a step motor 406 driving a timing belt 407 connected to the two linear actuators 400, 402 through two corresponding pulleys 408, 410 connected to a corresponding lead screw (not shown) of the corresponding linear actuator 400, 402. As it should now be apparent, operation of the motor 406 drives the timing belt 406 which drive the pulleys 408, 410. Upon rotation of the pulleys 408, 410, the linear actuators 400, 402 are deployed or retracted, as shown in FIG. 30A.

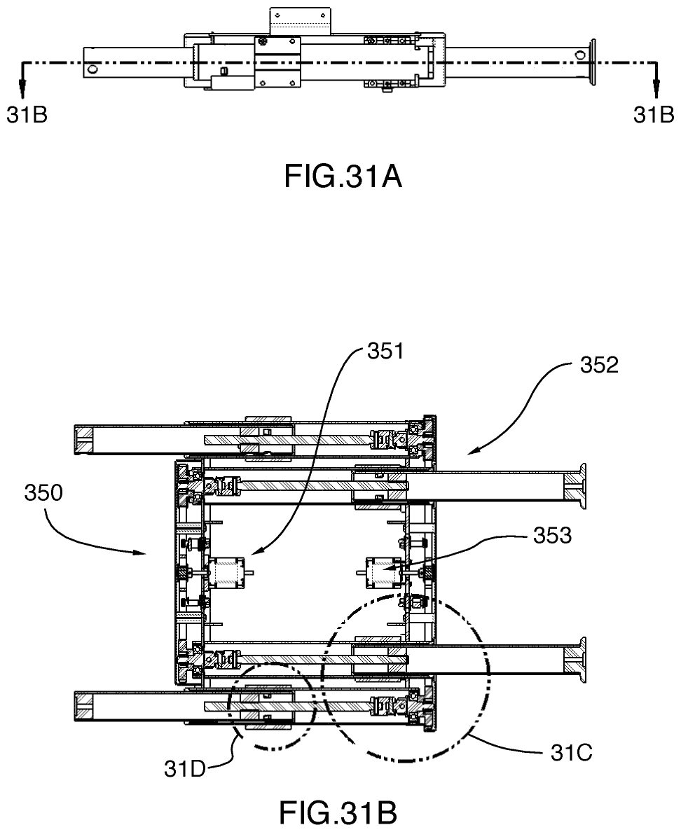

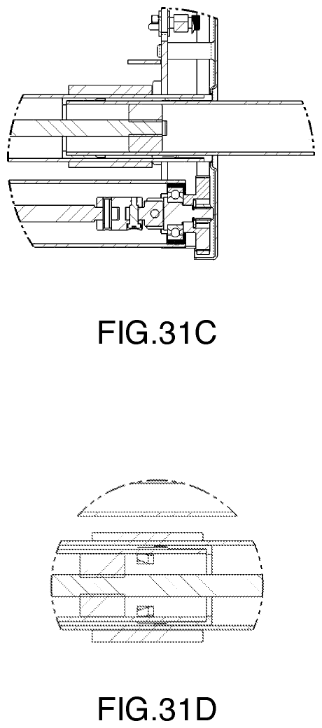

FIGS. 31A to 31D illustrate in greater details the first and second motorized extension mechanisms 350, 352. As it should be appreciated, the proposed arrangement provides an extra compact length in fully retracted position while enabling a length extension up to 14 inches. Moreover, the two motorized extension mechanisms 350, 352 can be operated simultaneously to provide a faster extension and retraction, as it should become apparent.

Referring back to FIGS. 29A and 29B and also to FIG. 32, a width extension mechanism 420 can be provided on the foot support panel 340. In this embodiment, an arrangement using mechanical cables and pulleys is used to synchronize the lateral extension of the foot support panel 340 with the lateral extension of the other patient support sections, similarly to the arrangement described in PCT patent application published under no. WO2017051386 by the same Applicant, which is hereby incorporated by reference.

Referring back to FIGS. 24A to 24D, in one embodiment, the lateral width extensions 342, 344 of the foot support panel 340 may also be provided with additional length extensions 420, 422 which can be extended when the length of the bed 300 is extended. Indeed, each lateral width extension 342, 344 has a length extension 420, 422 telescopically mounted therewith. In the fully retracted position of the length of the bed 300, the length extensions 420, 422 of the width extensions 342, 344 are retracted under the width extensions 342, 344, as shown in FIGS. 24A and 29C. This enables to provide a rectangular patient support surface that is 74 inches per 45 inches. In FIG. 24B, the length extensions 420, 422 of the lateral width extensions 342, 344 have been deployed to provide a rectangular patient support surface that is 80 inches per 45 inches.

FIGS. 45A to 45C illustrates the mounting of the foot support panel 340 or 380 with the thigh support panel 168 and the frame 160 of the bed 300, according to one embodiment, through the use of a sliding subframe assembly 450 mounted with the frame 160 and shown in FIGS. 46A to 46D. As better shown in FIGS. 46A and 46B, the sliding subframe assembly 450 is provided with two elongated spars 452, 454 that are adapted to be slidably mounted within the elongated spars 453, 455 of the frame 160. A linear actuator 456 fixedly attached to the frame 160 is used for sliding the subframe assembly 450 inside the frame 160.

The foot support panel 340 or 380 is pivotally connected to the sliding subframe assembly 450, as shown in FIG. 45A, and also to the thigh support panel 168. When the subframe assembly 450 is moved with respect to the frame 160, it drives a pivoting movement of the foot panel 340. As shown in FIG. 45B, the thigh support panel 168 will be pivoted too upon pivotal of the foot support panel 340. In other words, the angular position of the foot support panel 340 would drive a relative angle position of the thigh support panel 168. As it will become apparent below, such sliding subframe assembly 450 may be useful to provide a bed 300 having a full chair position, as greater detailed below.

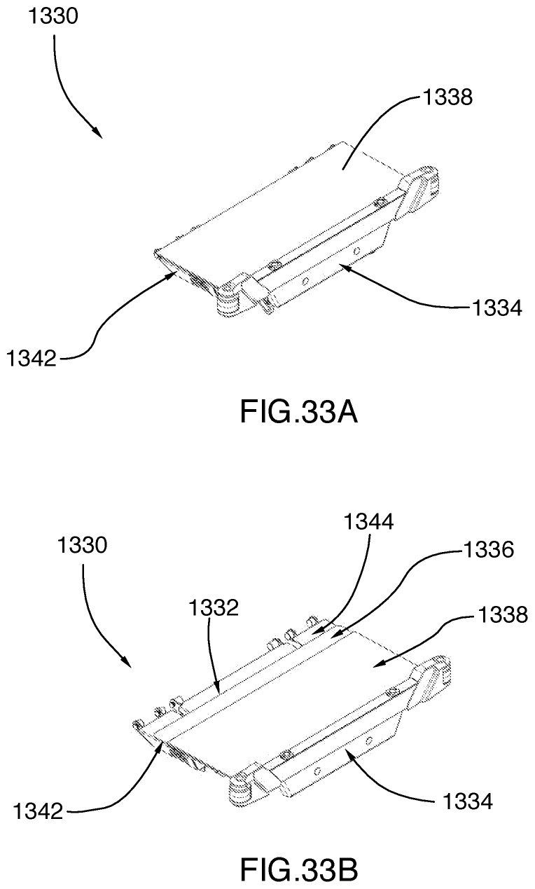

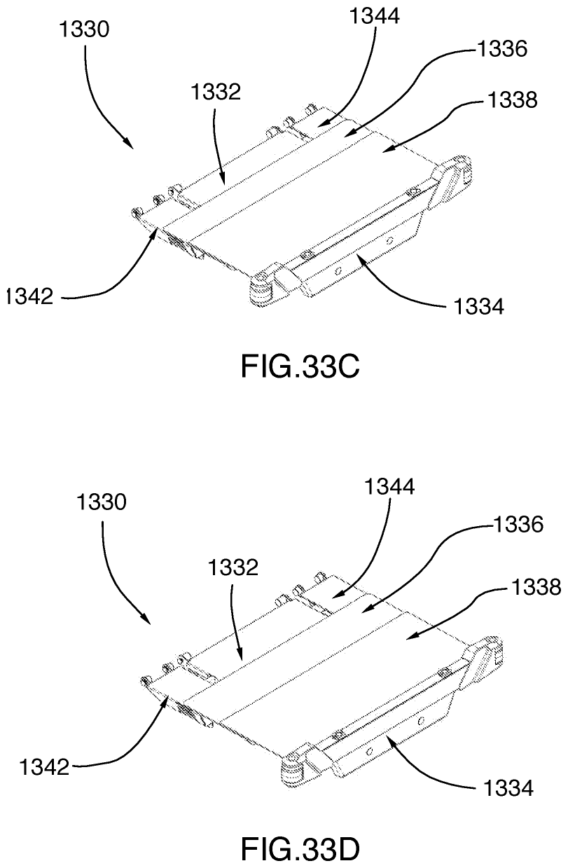

FIGS. 33A to 33D show a foot support panel 1330 according to another embodiment in various configurations but with the footboard 124 removed from the bed. FIG. 33A shows the foot support panel 1330 fully retracted, FIG. 33B shows the foot support panel 1330 slightly expanded, FIG. 33C shows the foot support panel 1330 more expanded while FIG. 33D shows the foot support panel 330 fully expanded. In this embodiment, the width of the foot support panel 1330 is 35 inches, lateral extensions 1342, 1344 being in a fully retracted position. When the foot support panel 1330 is fully retracted, the bed 300 is 74 inches long. The foot support panel 1330 is expandable to various positions to provide a bed 300 being 80 inches long, 84 inches long and 88 inches long, as illustrated, and as further detailed below. As detailed below, much like foot panel 300, this foot support panel 1330 enables a bed 300 to be operated in a full chair position as the one shown in FIG. 19.

The foot support panel 1330 has a main section 1332 pivotally connected to the thigh support panel 168 (as shown in FIG. 3), and a length extension section 1334 slidably connected to the main section 1332, as shown in FIGS. 33A to 33D. The length extension section 1334 is provided with an upper main sheet 1336 attached by a foot end thereof to a cross-member 1337 operatively coupled to left and right extension members 1358, 1360, the upper main sheet 1336 being slidably supported atop the main section 1332. The length extension section 1334 is also provided with an upper extension sheet 1338 connected thereto, the upper extension sheet 1338 overlapping the main sheet 1336 and being configured to slide over it. When the foot support panel 1330 is extended, the length extension section 1334 is pushed away from the main section 1332, the uppermost extension sheet 1338 slides outwards on the main sheet 1336, and the main sheet 1336 slides outwards of the main section. To facilitated sliding of the main sheet 1336 and upper extension sheet 1338 relative to one another or to the main section 1332, sliding cushions made of a material such as acetal, polytetrafluoroethylene or the like can be provided between the main section 1332, the main sheet 1336 and/or the uppermost extension sheet 1338. In the most extended position, the top surface of the main section 1332, the main sheet 1336 and the extension sheet 1338 are substantially coplanar and adjacent to each other without leaving any aperture therebetween.

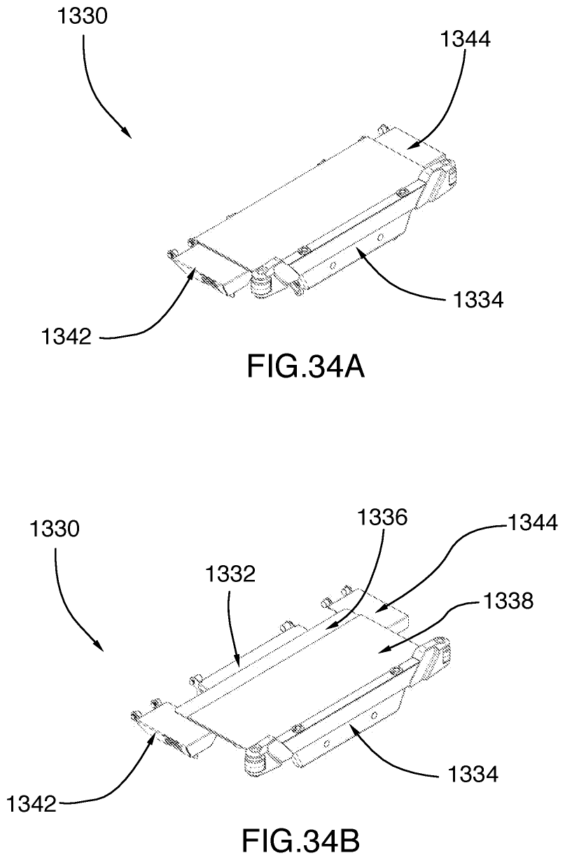

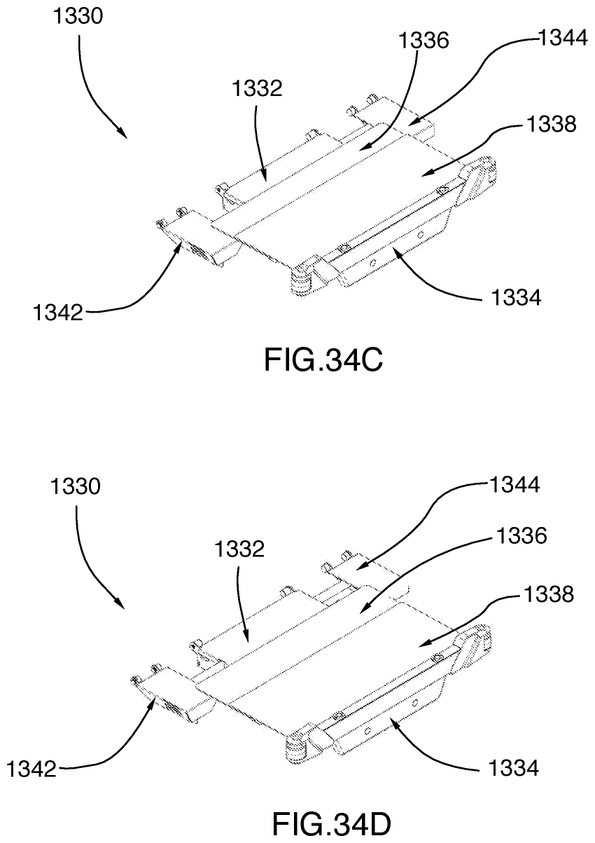

FIGS. 34A to 34D show the foot support panel 1330, but with the lateral width extensions 1342, 1344 in a fully extended position, as it will become apparent below. The width extensions 1342, 1344, when fully expanded as illustrated, enable to reach abed width of 45 inches. When retracted, the width extensions 1342, 1344 extends below the main patient support surface as shown in FIGS. 33A to 33D.

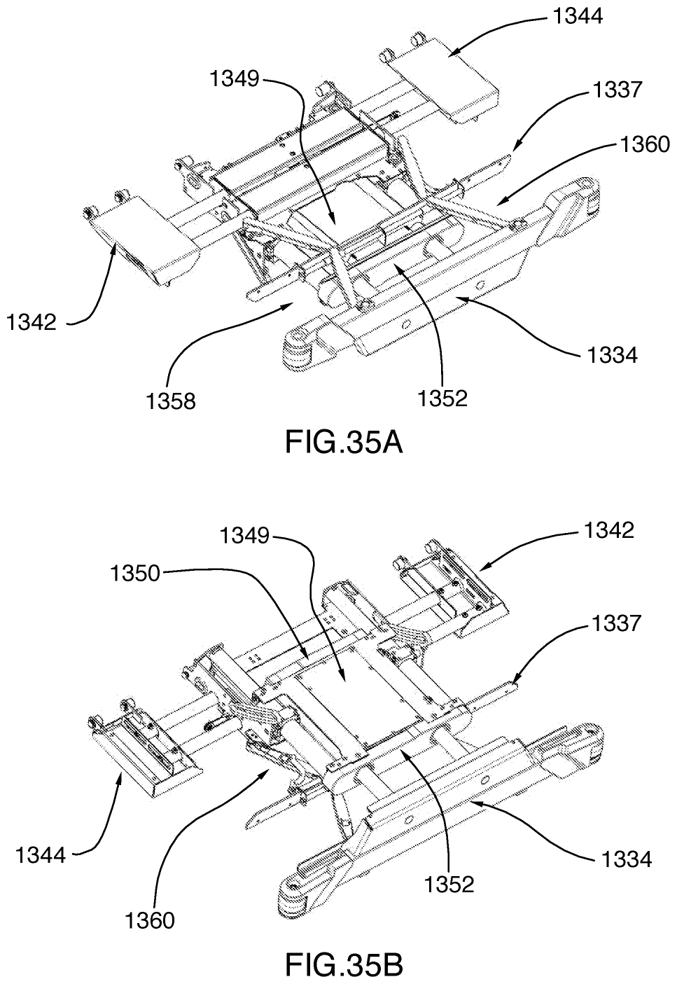

FIGS. 35A and 35B show the foot support panel 1330, but with the main sheet 1336 and the extension sheet 1338 removed. Much like foot support panel 330, this embodiment is provided with an extension frame 1347 movably mounted to the foot support 1330 and housing a double independent motorized mechanism 1349. More particularly, a first motorized extension mechanism 1350 enables to extend the patient support surface such that the length of the bed 300 can be extended from 74 inches to 80 inches. A second motorized extension mechanism 1352 enables to further extend the patient support surface such that the length of the bed 300 is extended from 80 inches to 84 inches and then 88 inches. In FIGS. 126A and 126B each of the first and second motorized extension mechanisms 1350, 1352 have been extended to their longest position. In one embodiment, instead of having distinct movements, the first and second motorized mechanisms 1350, 1352 could be simultaneously controlled to extend the patient support surface such that the operation of both motorized mechanism 1350, 1352 is required to extend the patient support surface from 74 inches to 80 inches, and then from 80 inches to 84 inches and 88 inches. Such embodiment may prove to be advantageous when cables or wires are routed through left and right extension members 1358, 1360 in order to avoid pinching or wear and tear due to asymmetry of the left and right extension members 1358, 1360 that would be caused by the operation of a single motorized mechanisms 1350 or 1352 fur urging extension.

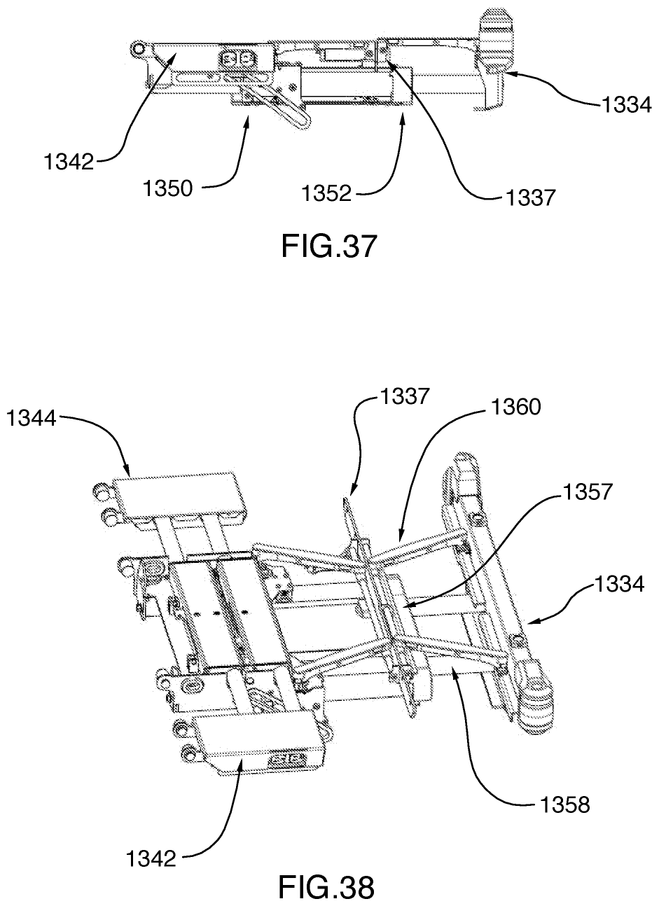

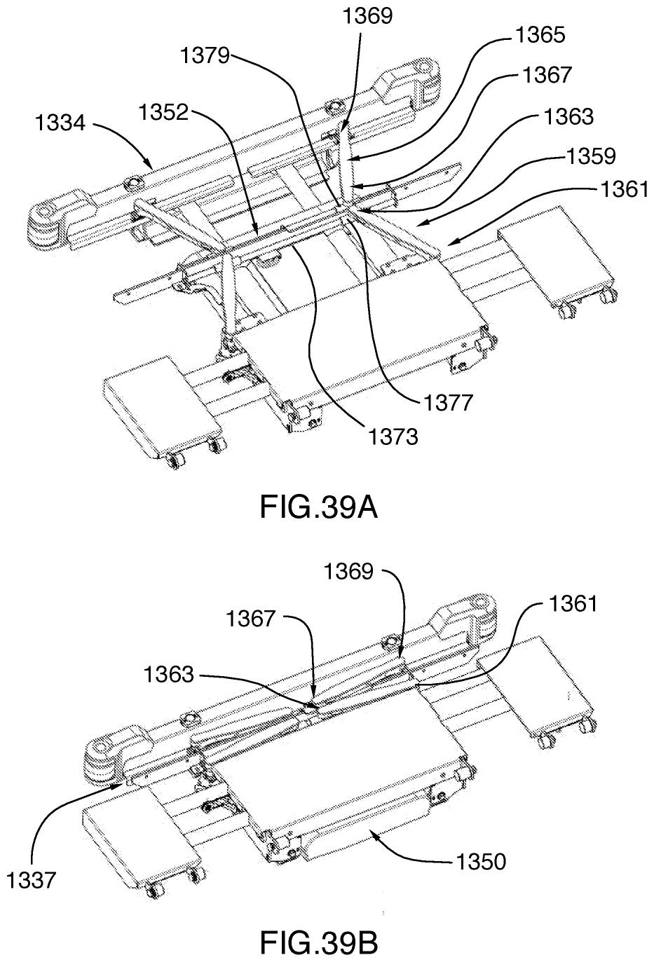

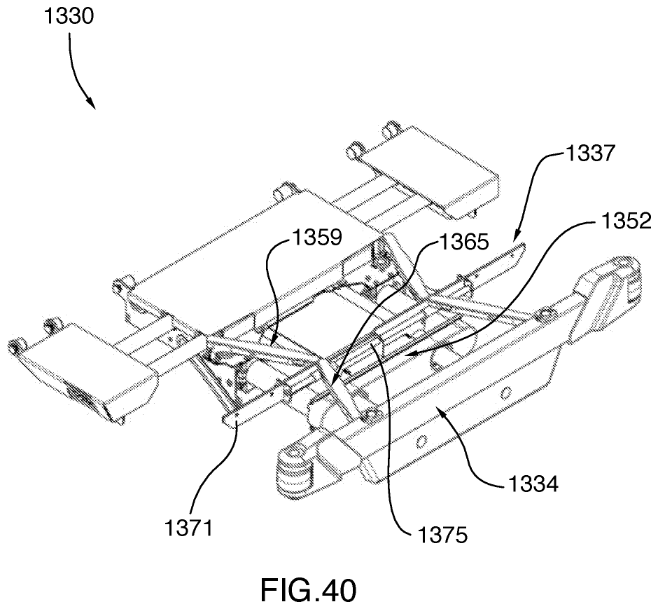

With reference to FIGS. 37 to 40, the foot support panel 1330 is also provided with a retractable support mechanism 1357 mounted between the main section 1332 and the length extension section 1334. In the illustrated embodiment, the retractable support mechanism 1357 is comprises of left and right extension members 1358, 1360 movably attached to the main section 1332, the length extension section 1334 and to the cross member 1337 to which is attached a foot end of the main sheet 1336 as it will become apparent. More specifically, each of the left and right extension members 1358, 1360 comprises a first rod 1359 having a head end 1361 pivotably attached to the main section 1332, and a foot end 1363 slidably and pivotably attached to the cross-member 1337. Each of the left and right extension members comprises a second rod 1365 having a head end 1367 slidably and pivotably attached to the cross-member 1337 and a foot end 1369 pivotably attached to the extension section 1334. Together, the first and second rods 1359, 1365 of each of the left and right extension members 1358, 1360 define a chevron shape when the length extension members 1358, 1360 are in an extended position (best shown in FIG. 39A) while when the length extension members 1358, 1360 are in a folded position, the first and second rods are folded one against the cross-member 1337, as shown in FIG. 39B. In the illustrated embodiment, the cross-member 1337 is provided with a central plate 1371 vertically positioned, as well as two slide members 1373, 1375, one on each of the head and foot sides of the central plate 1371. As better shown in FIG. 39A, the foot ends 1363 of the first rods 1359 and the head ends 1367 of the second rods 1365 are provided with sleeves 1377, 1379 slidably and pivotably engaging one of the slide members 1373, 1375. When the two linear actuators 1354, 1356 are actuated, these sleeves 1377, 1379 and therefore the foot ends 1363 of the first rods 1359 and the head ends 1367 of the second rods 1365 are allowed to freely slide along their corresponding side members 1373, 1375 during the folding and unfolding movement. As it can be understood, these right and left retractable extensions members 1358, 1360 may improve support and rigidity of the patient support surface, particularly when lateral width extensions 1342, 1344 are used. The skilled addressee will appreciate that these right and a left retractable extension members 1358, 1360 may be omitted for a particular application or replaced with support mechanisms having a different configuration.

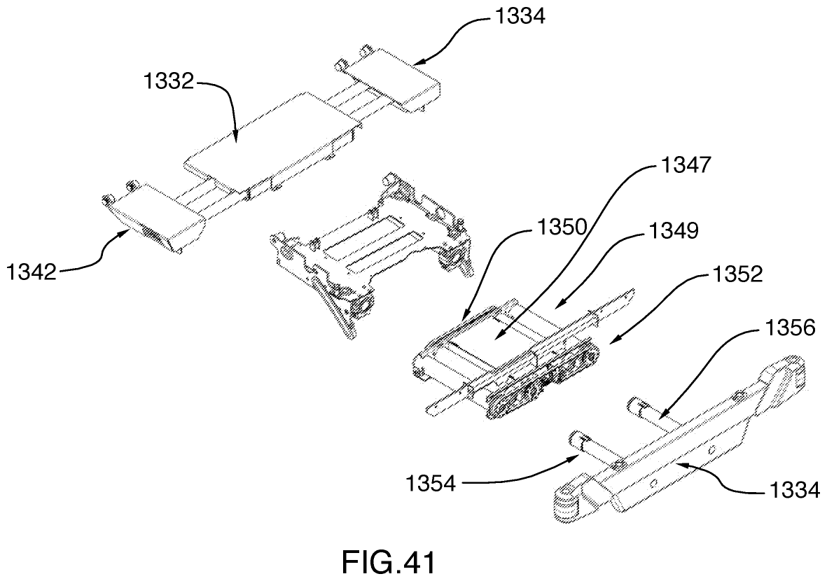

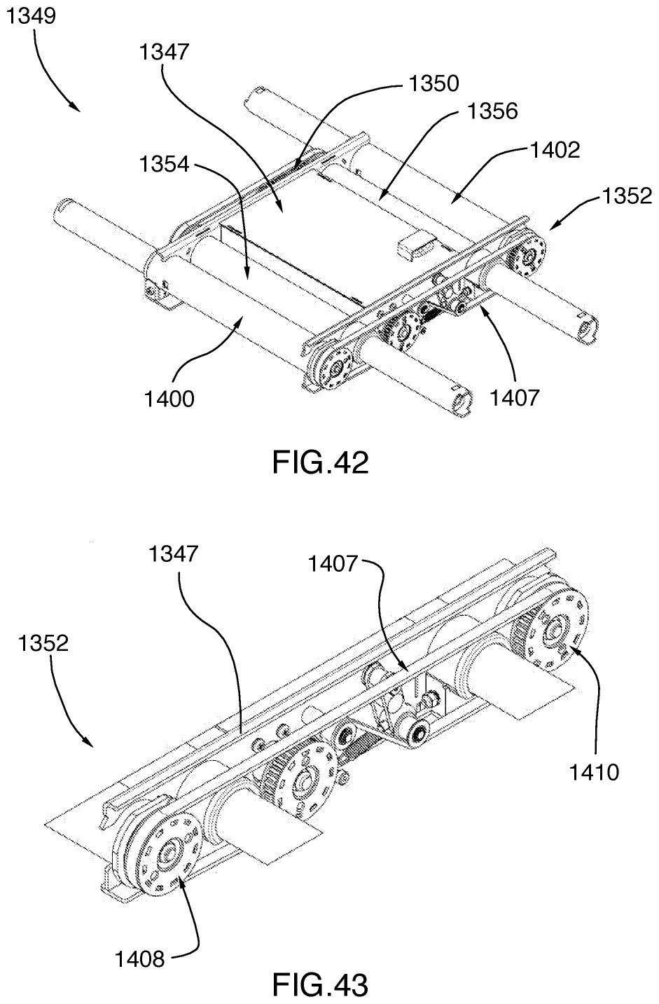

FIGS. 41 to 42B show the first motorized extension mechanism 1350, according to one embodiment. The first motorized extension mechanism 1350 has two linear actuators 1354, 1356 mounted in a parallel relationship between the main section 1332 and the length extension section 1334 of the foot support panel 1330 for deploying and retracting the length extension section 1334. As detailed below, in one embodiment, the linear actuators 1354, 1356 are operated simultaneously through a step motor 1355.

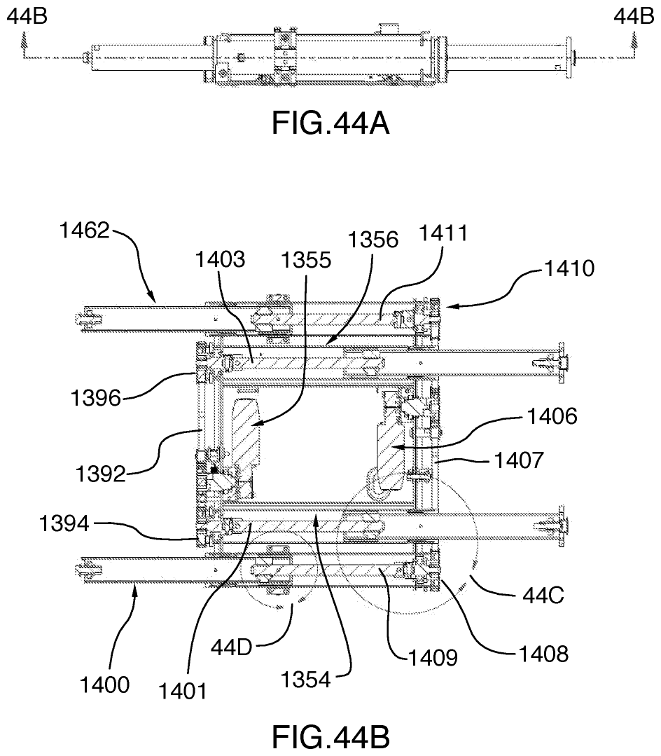

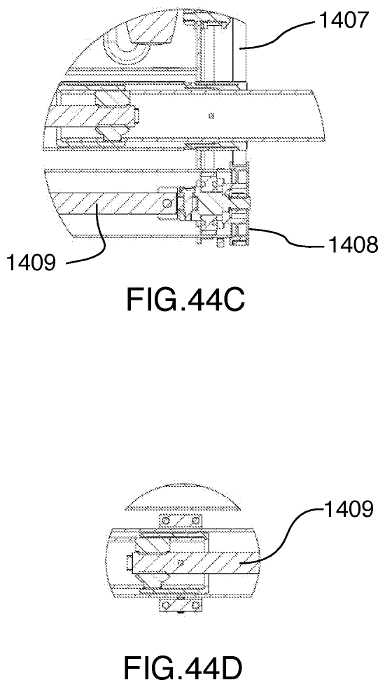

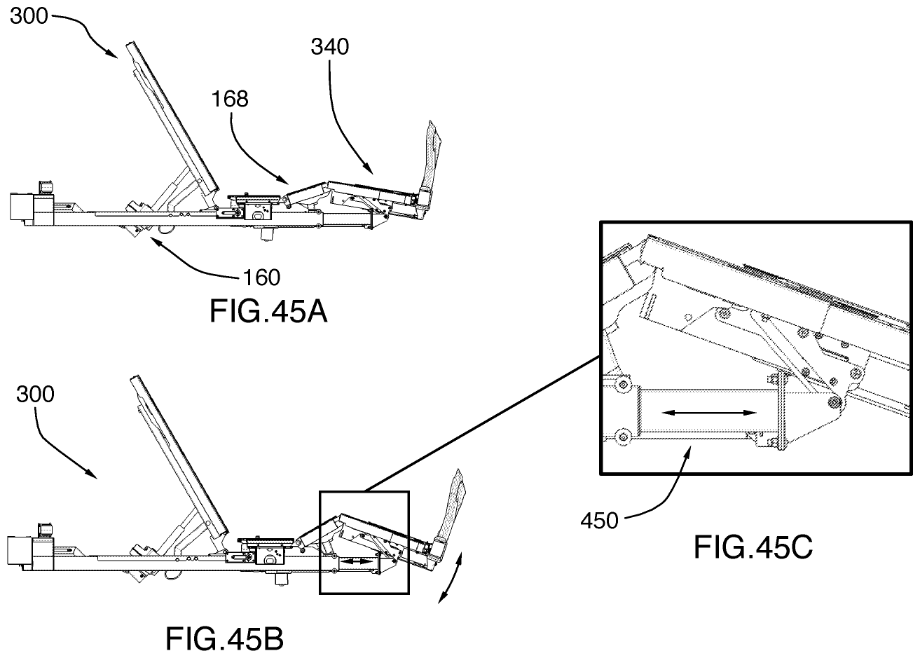

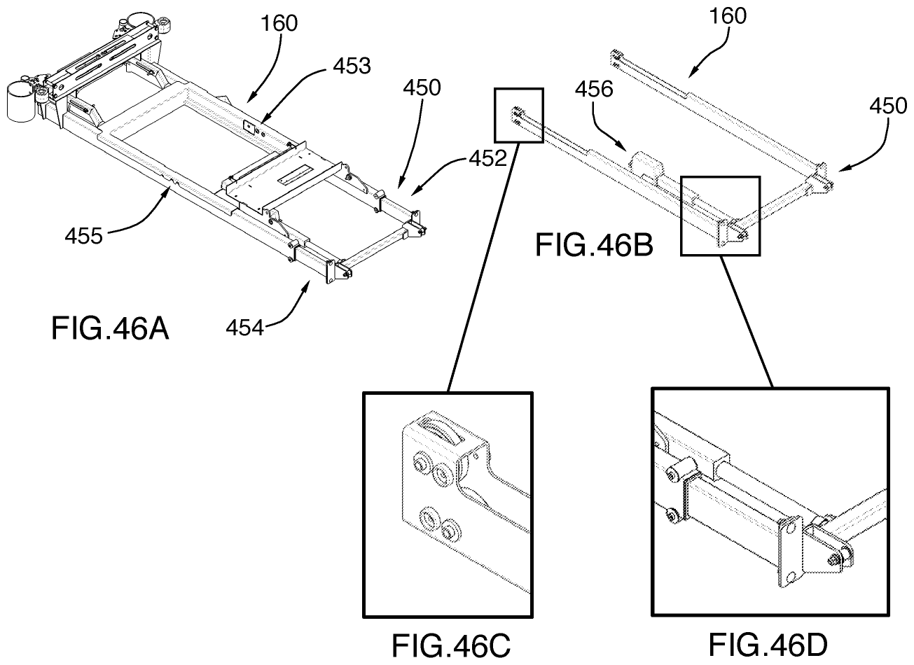

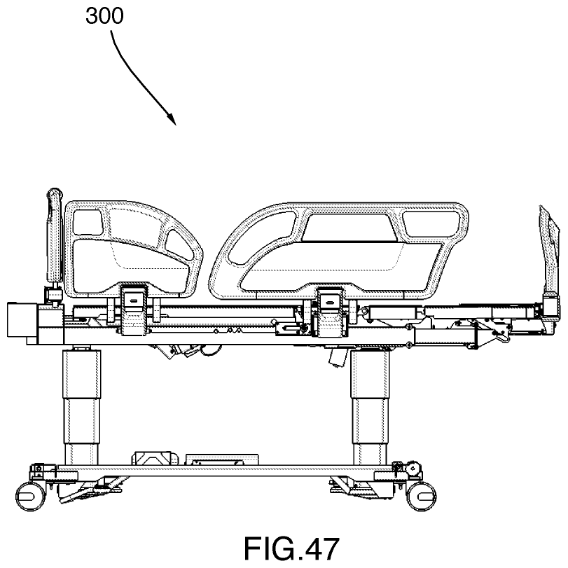

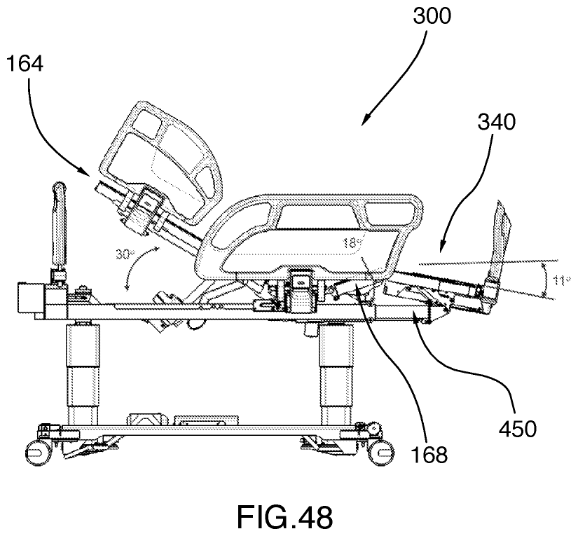

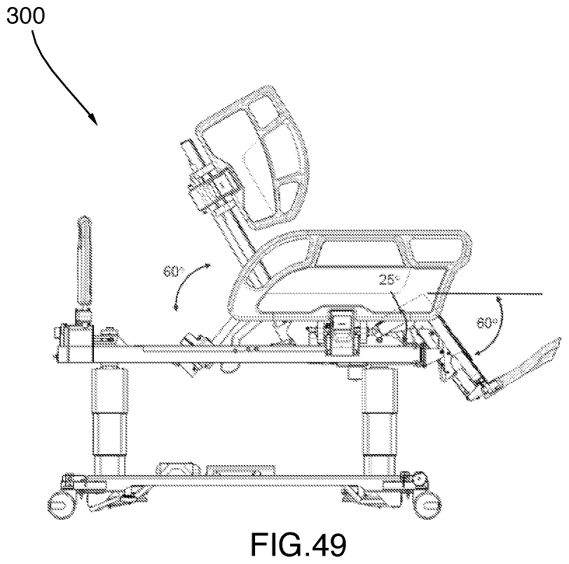

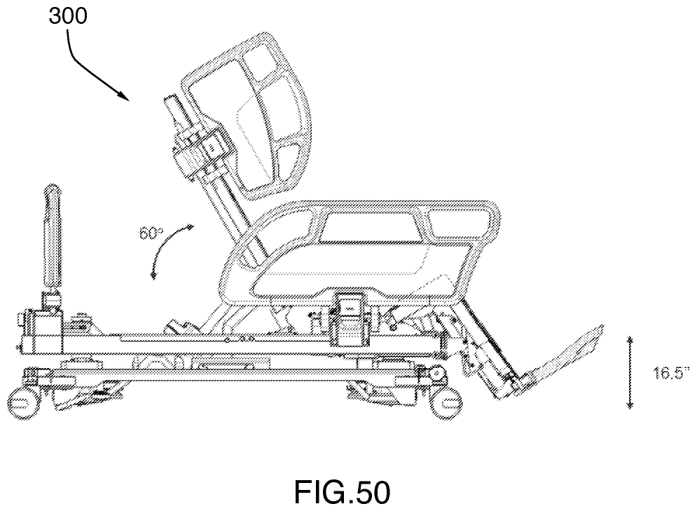

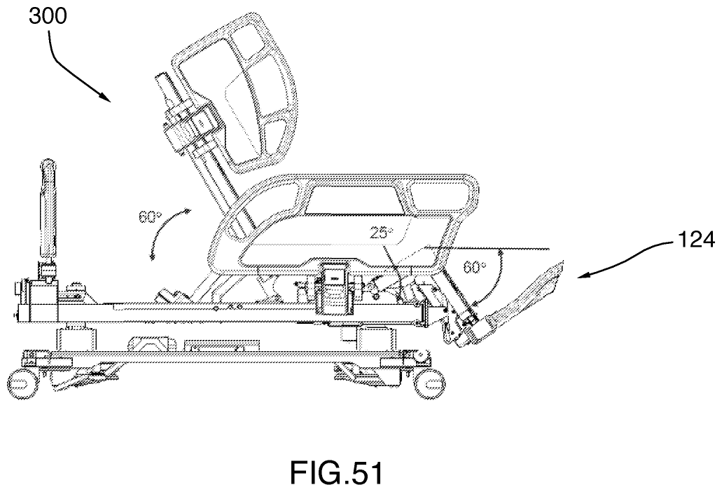

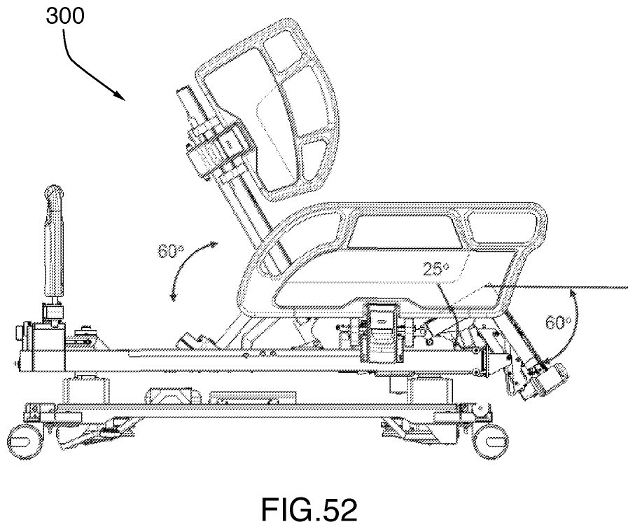

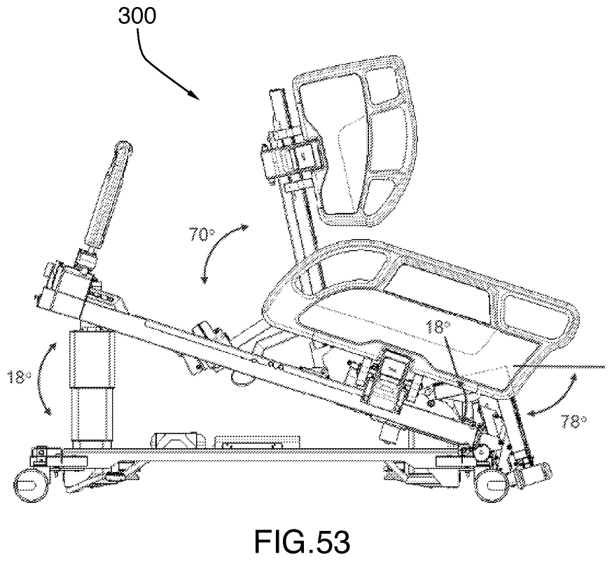

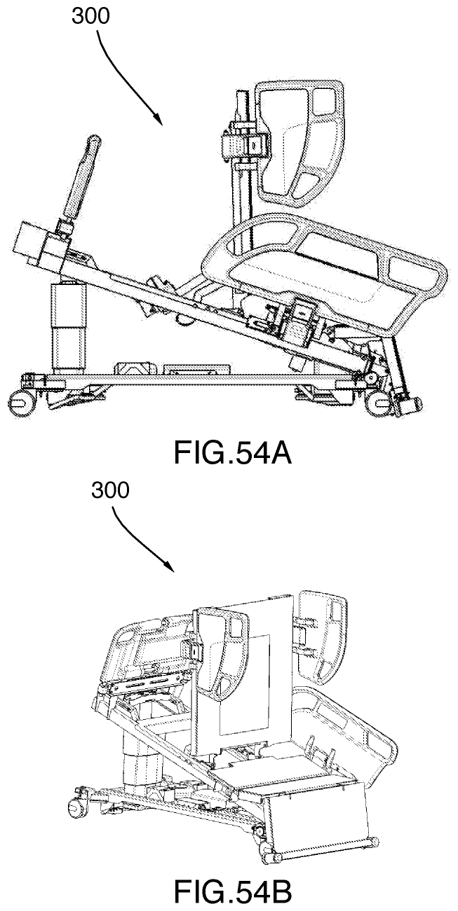

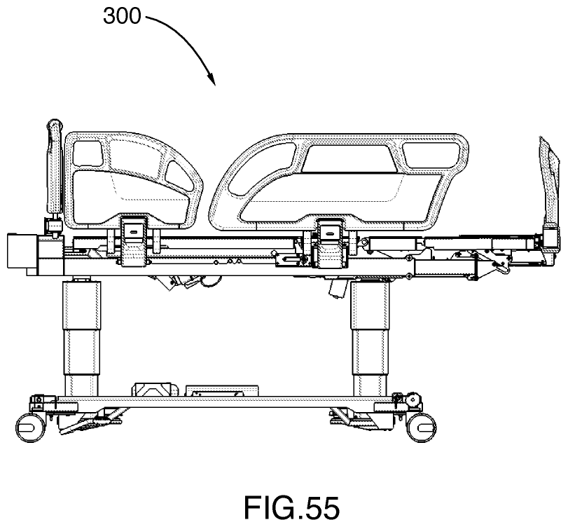

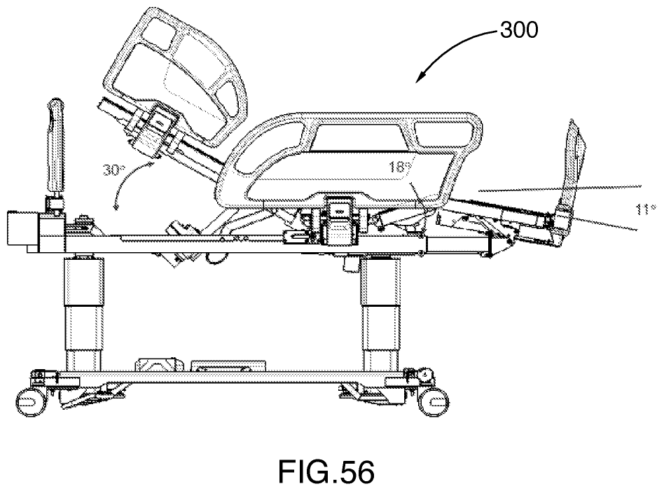

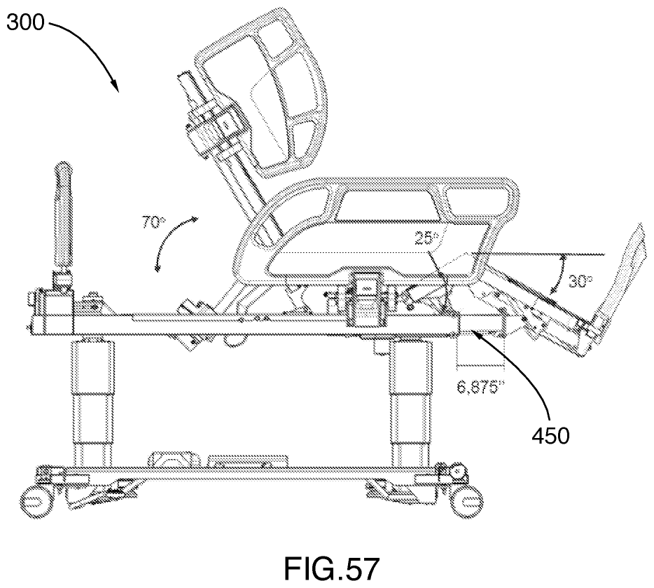

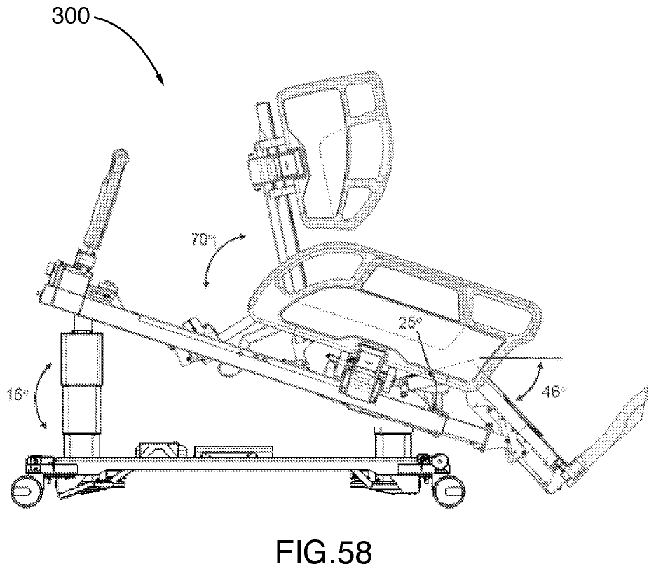

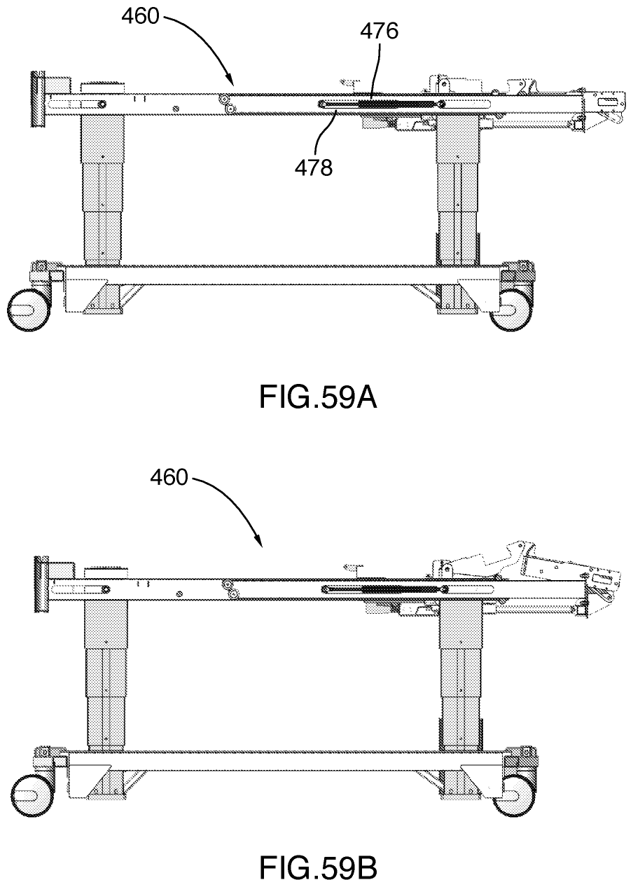

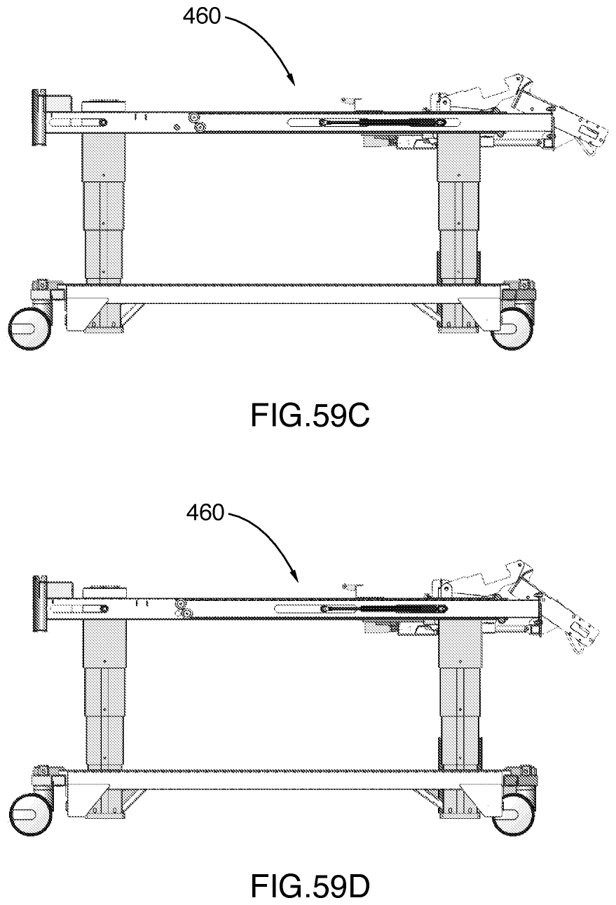

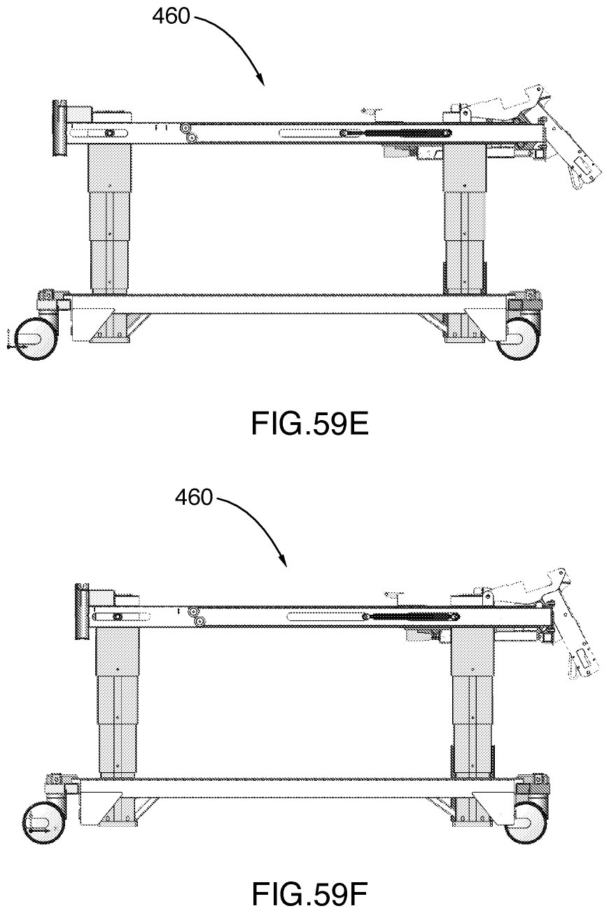

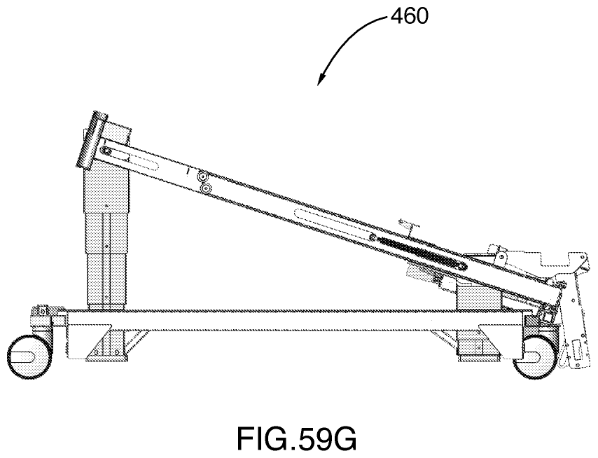

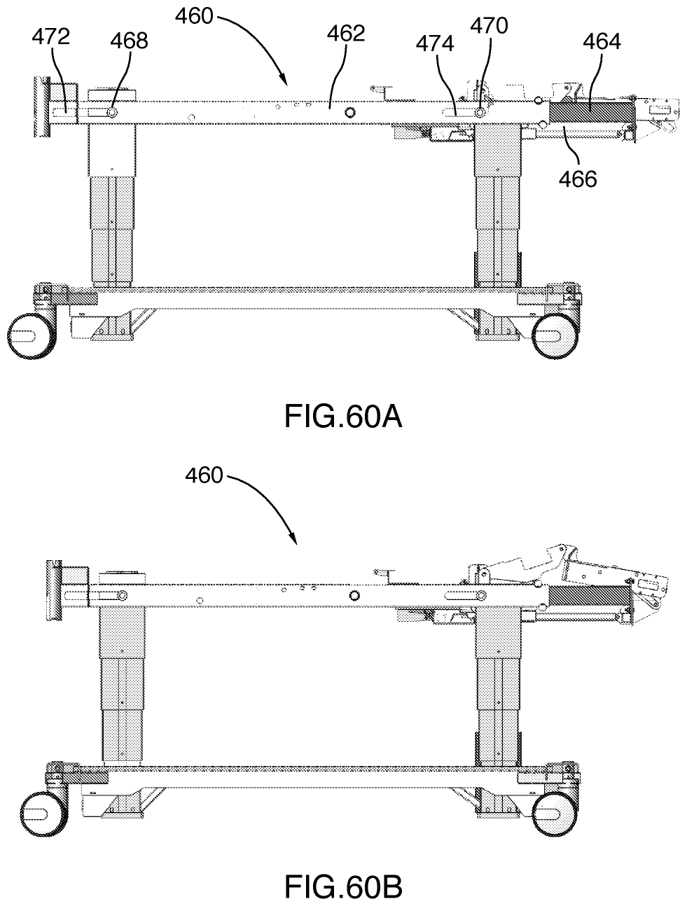

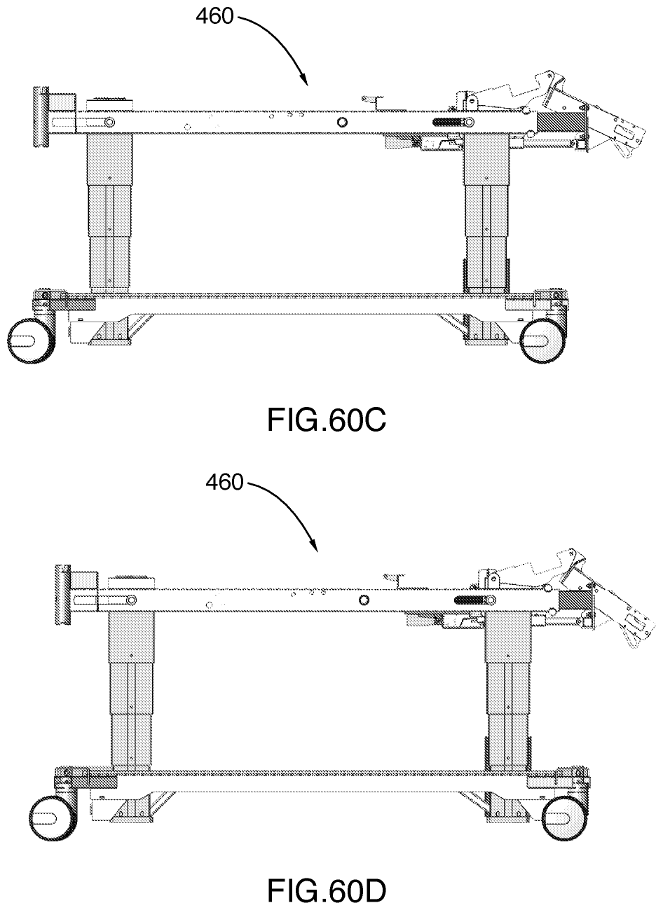

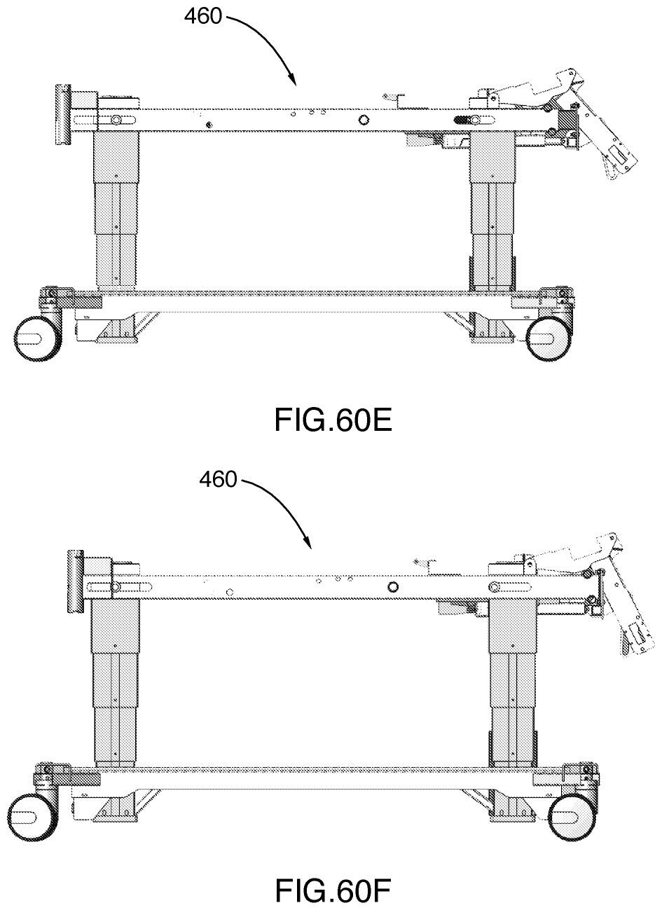

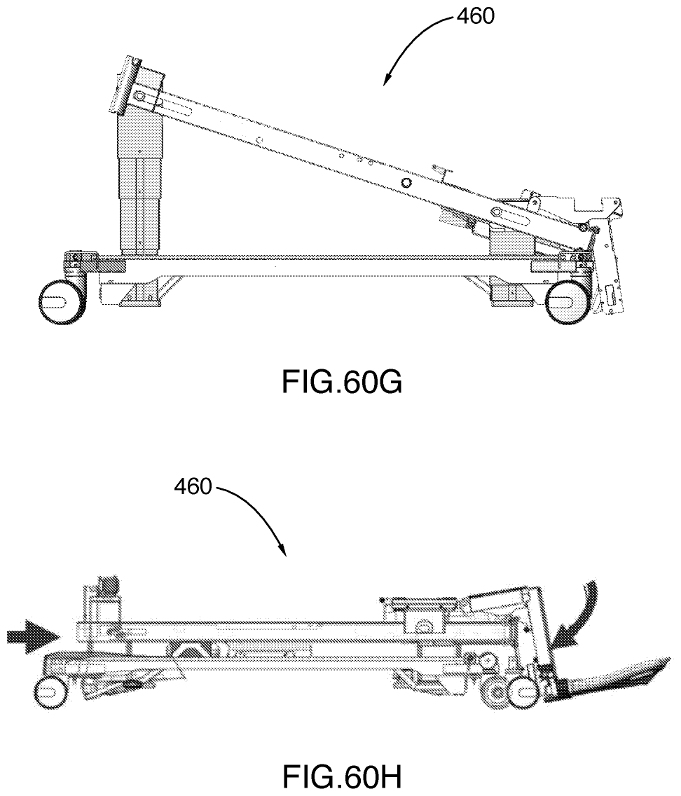

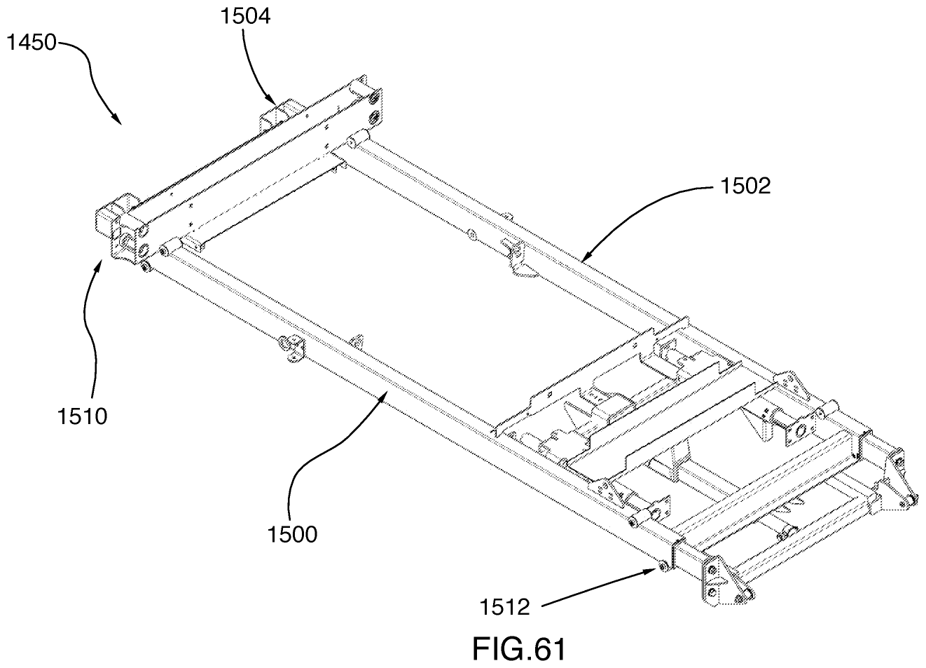

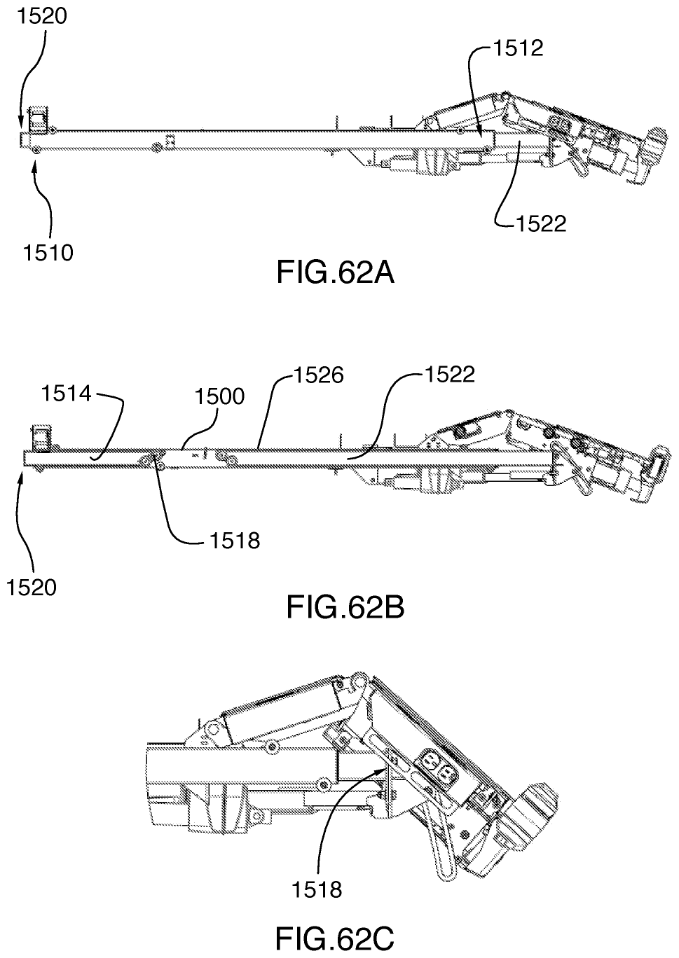

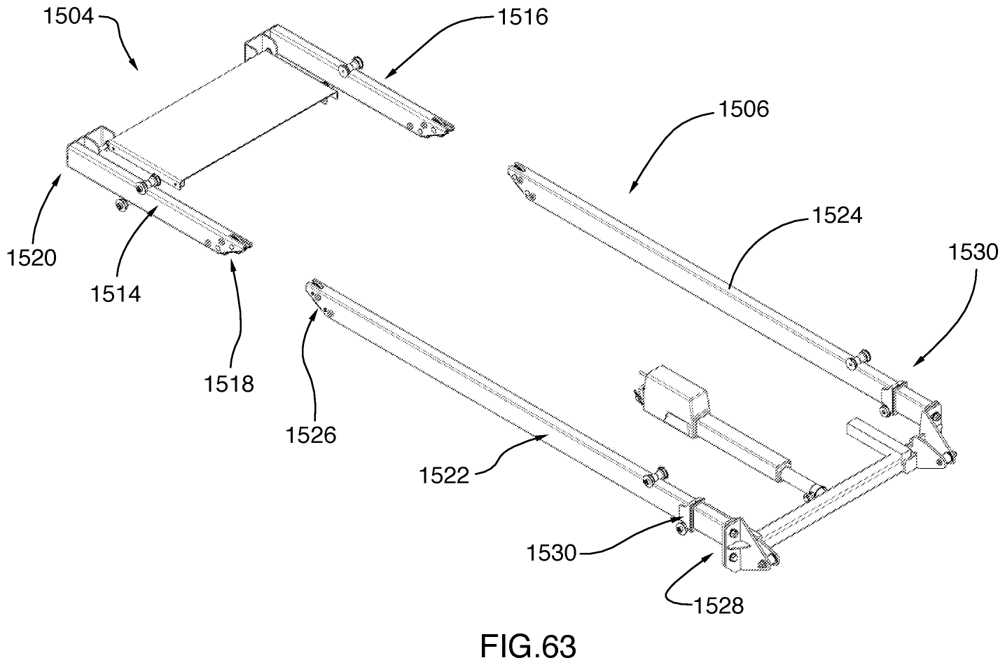

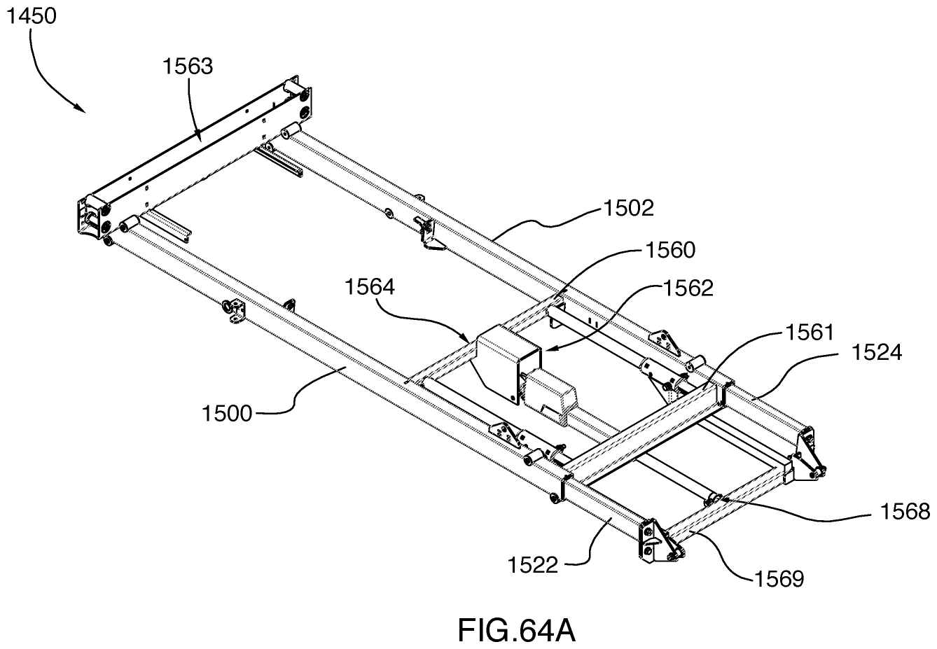

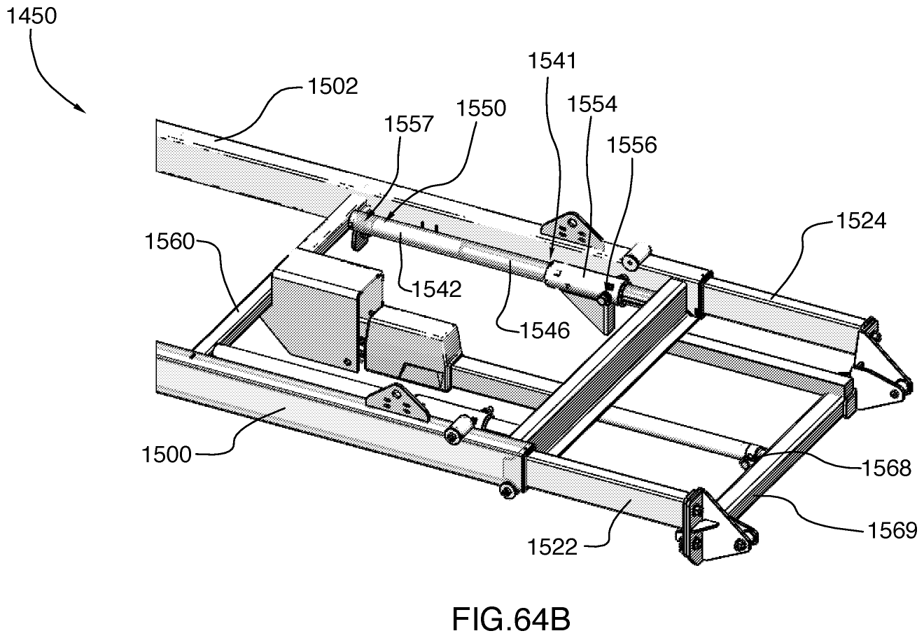

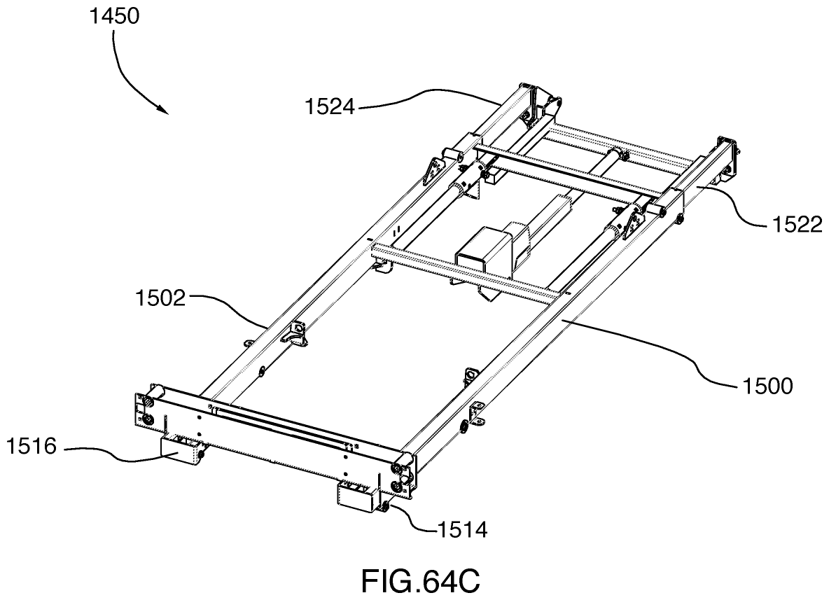

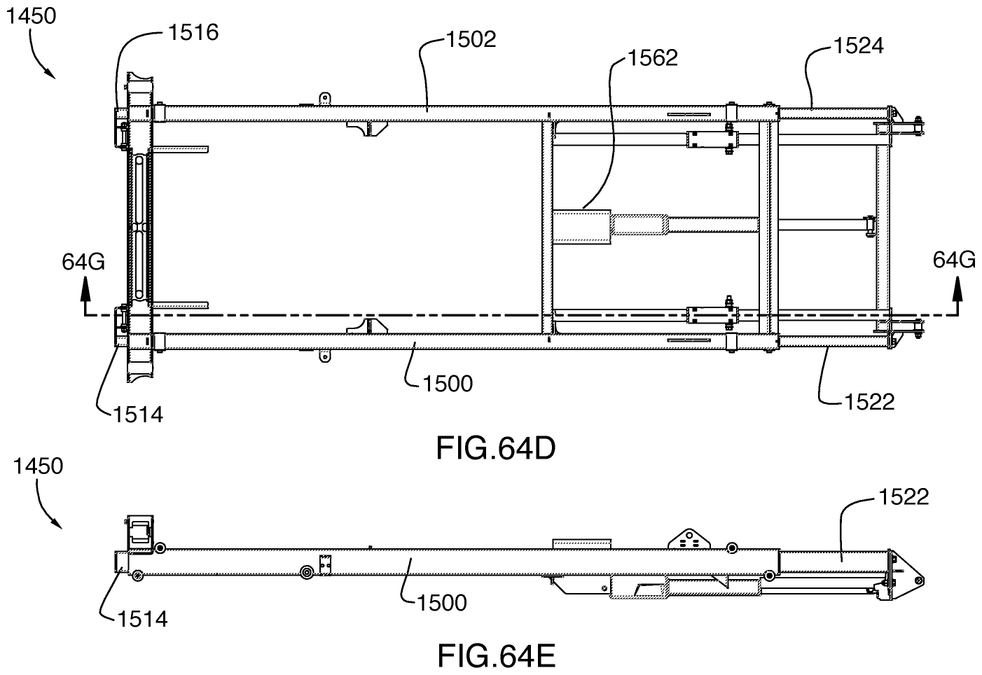

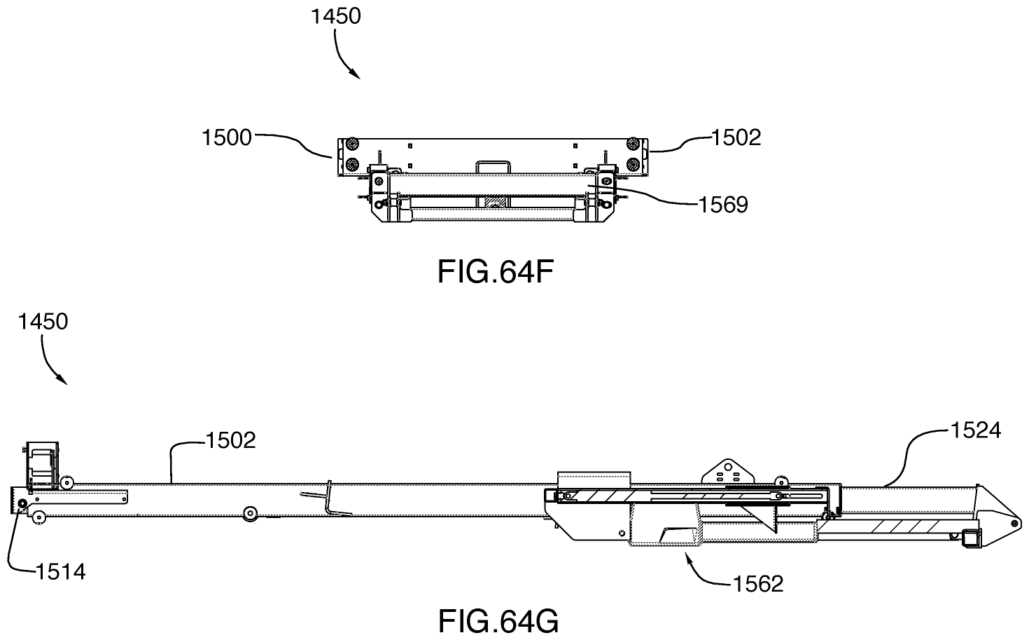

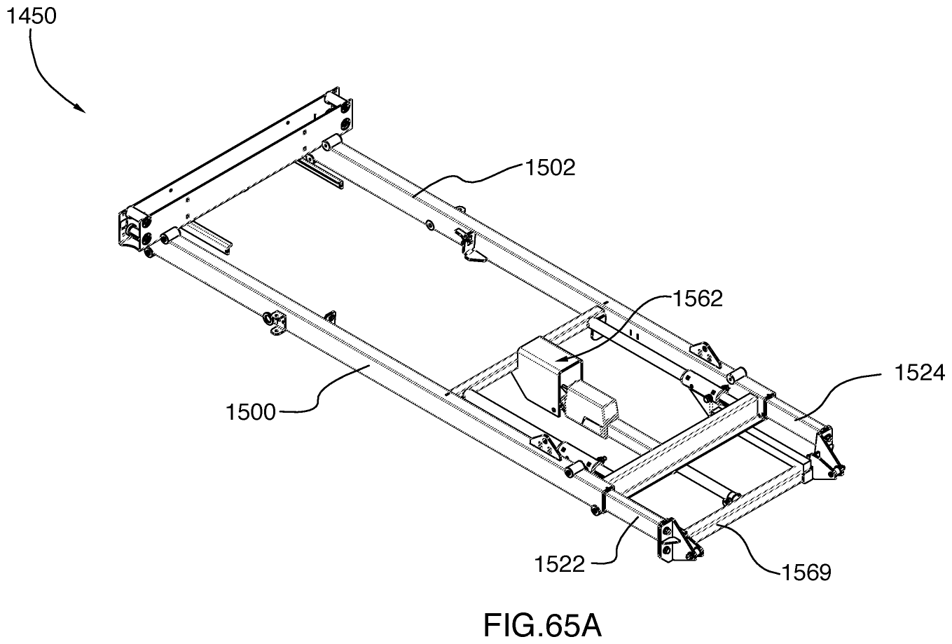

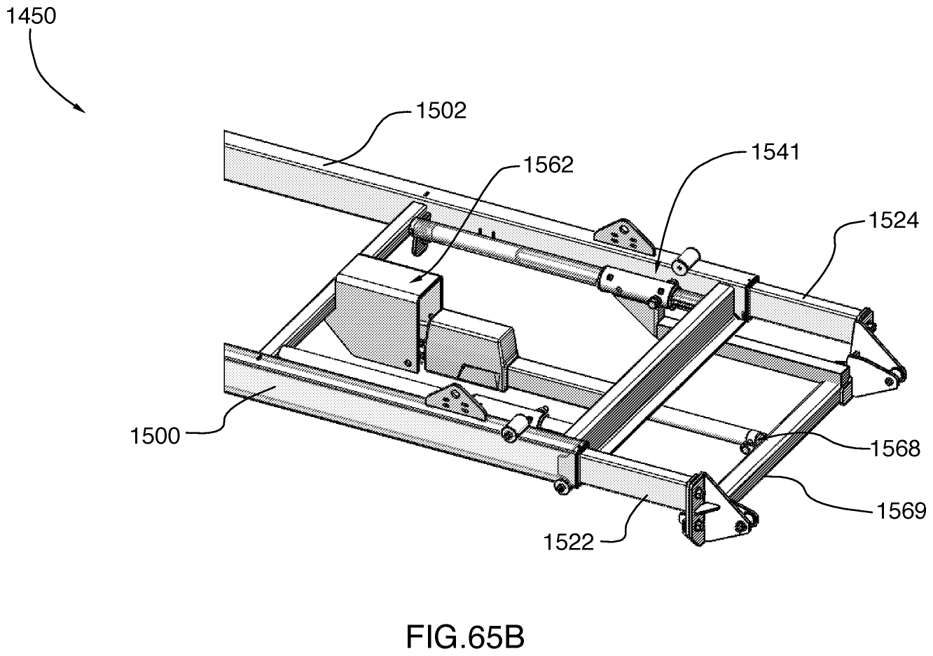

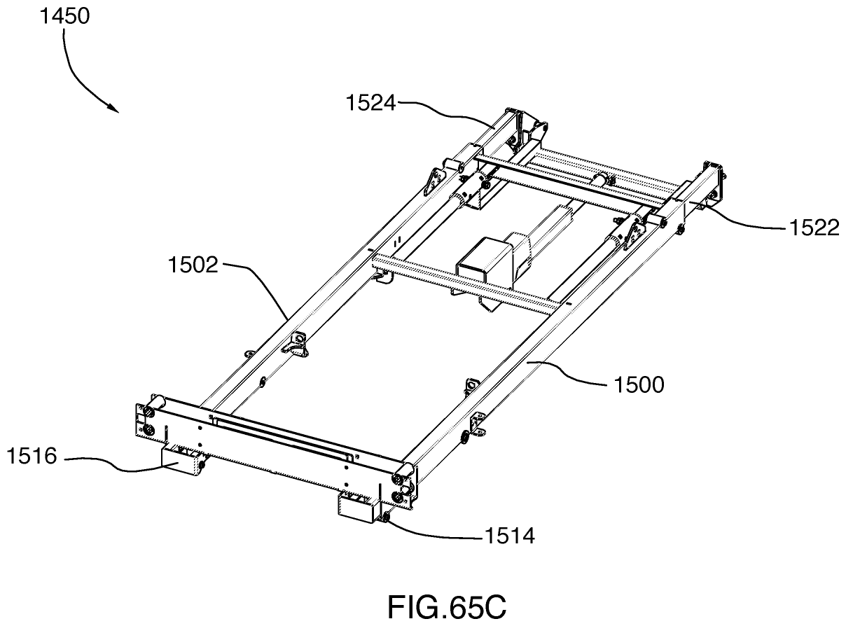

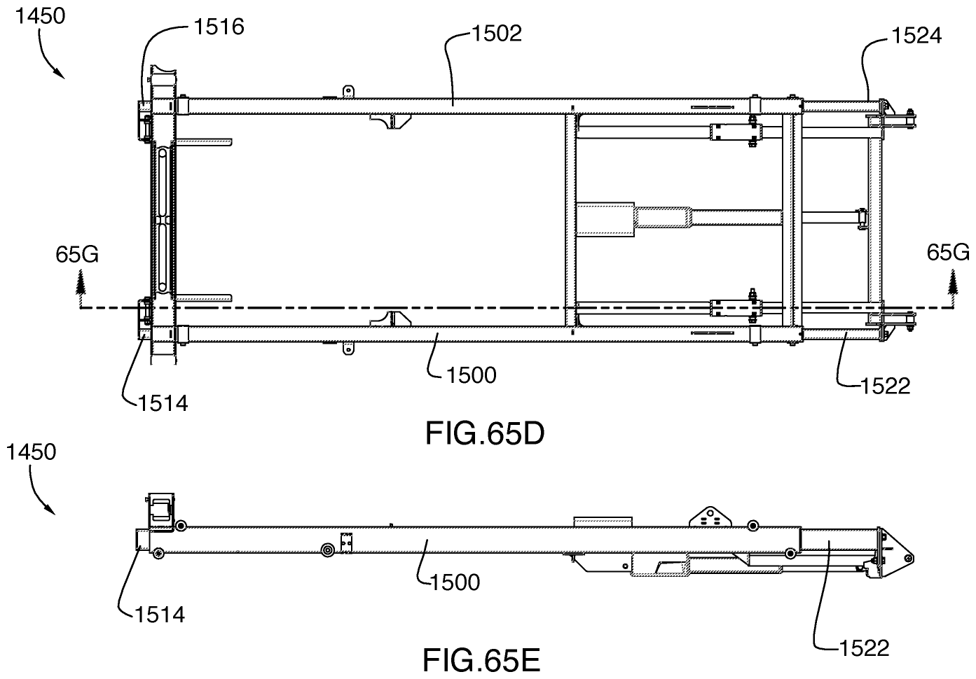

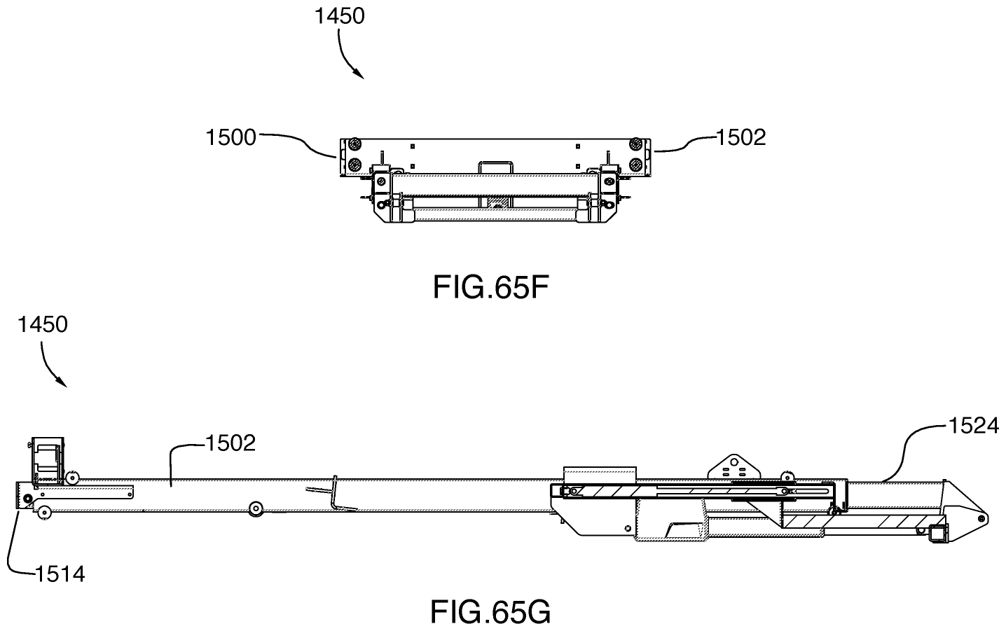

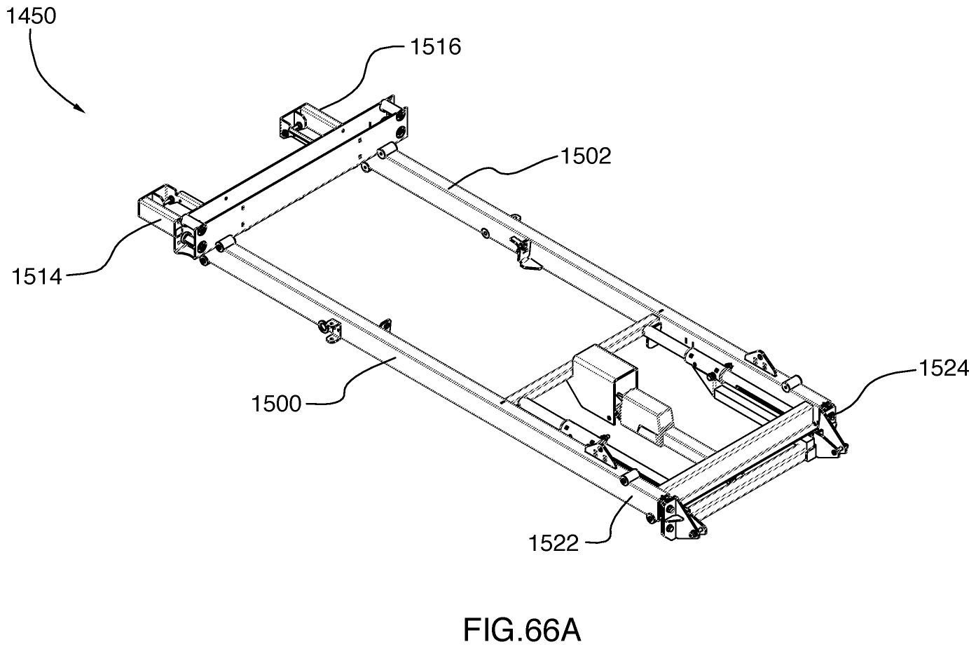

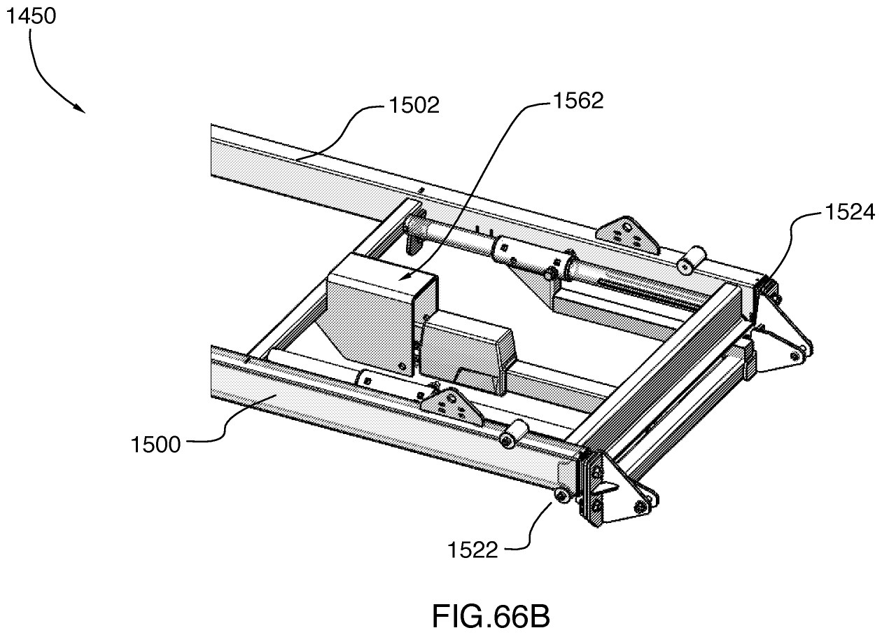

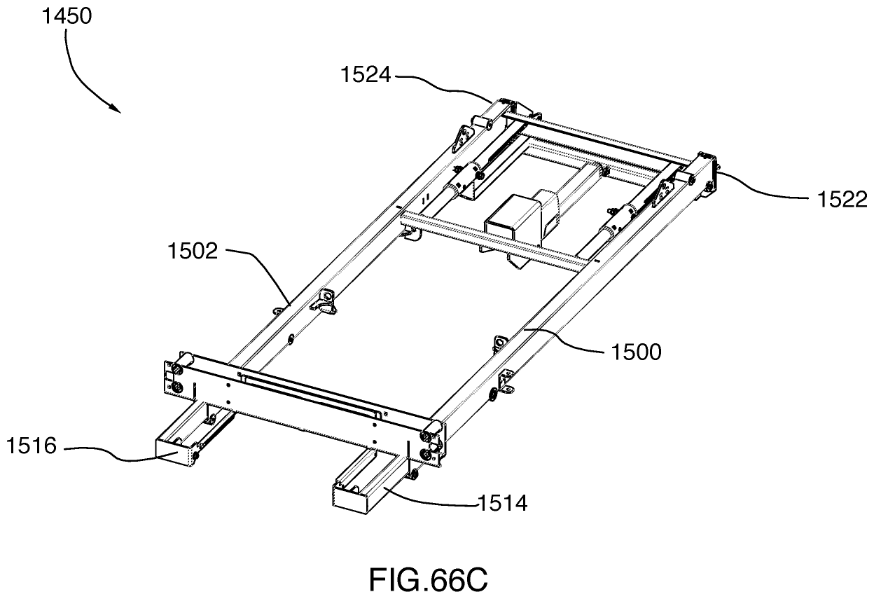

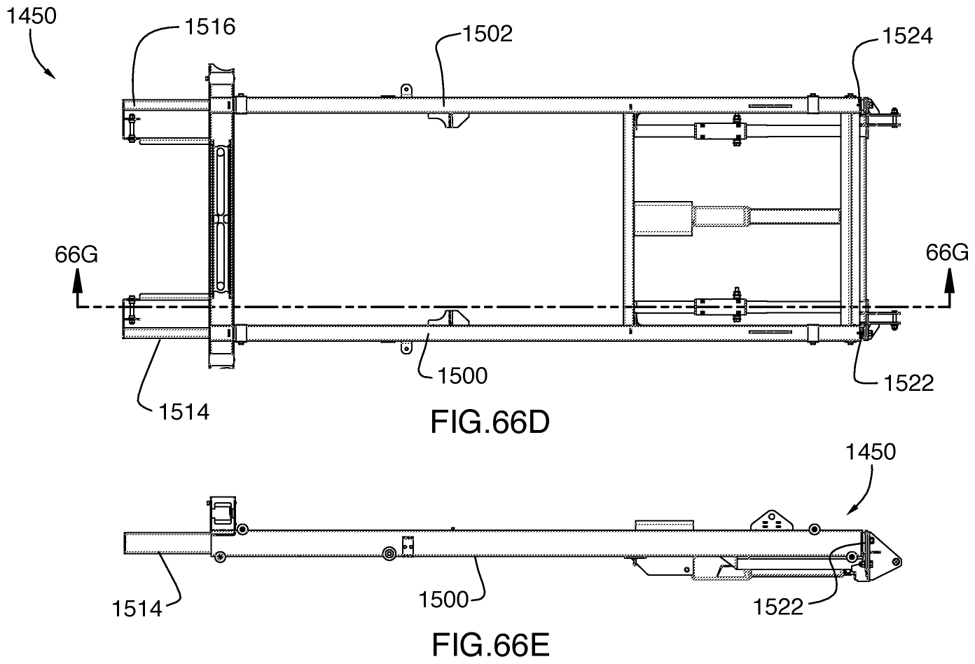

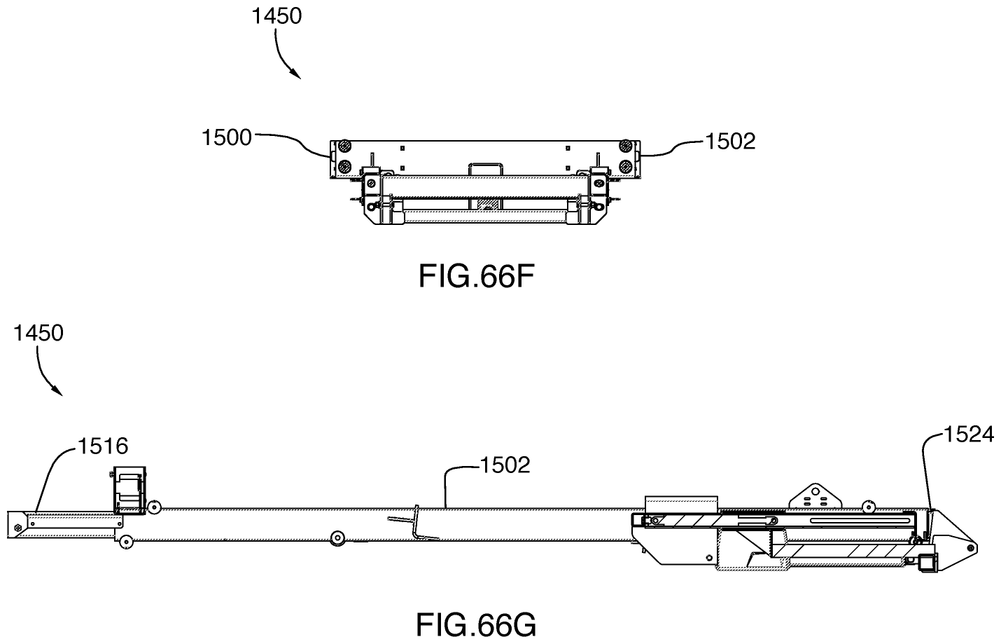

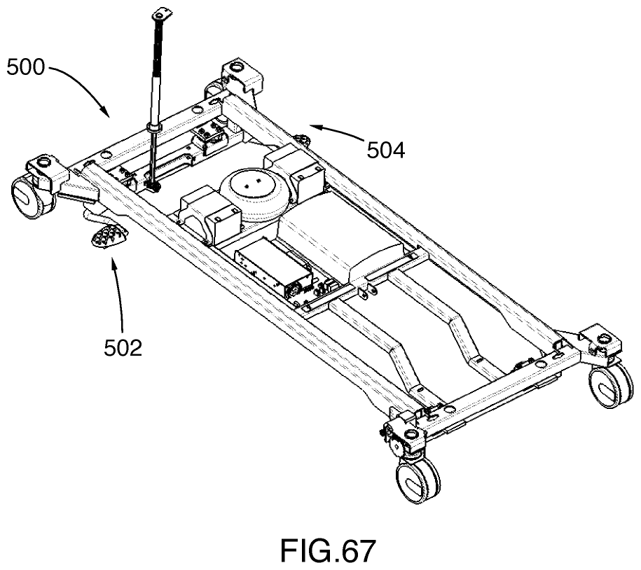

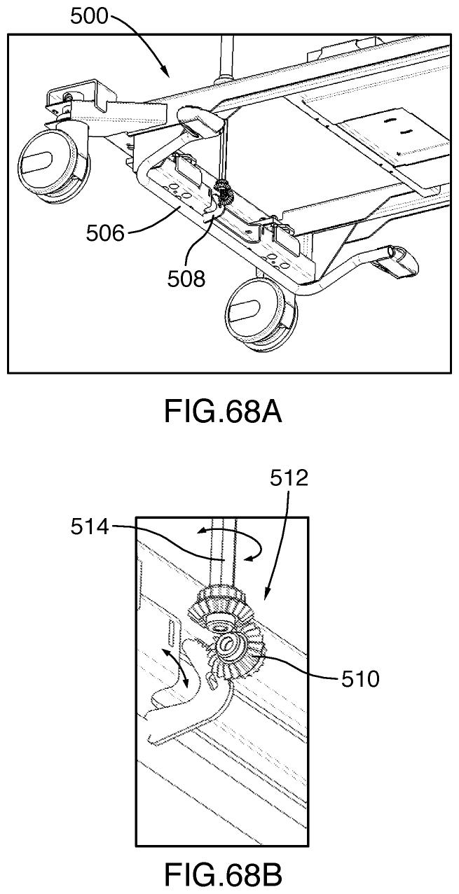

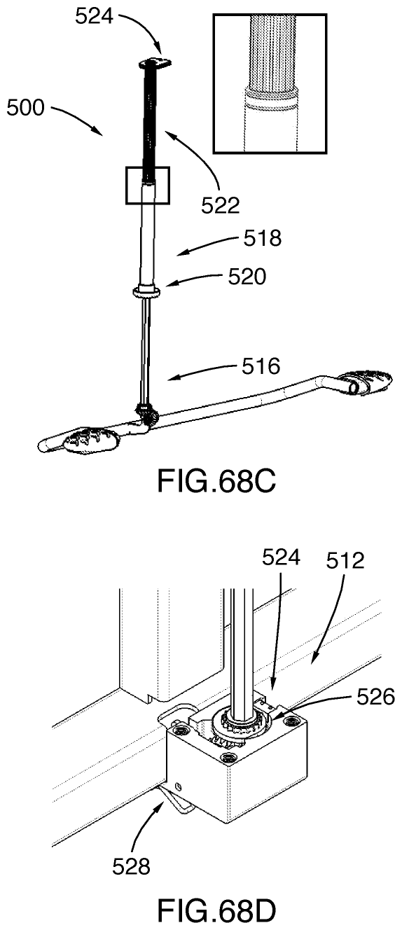

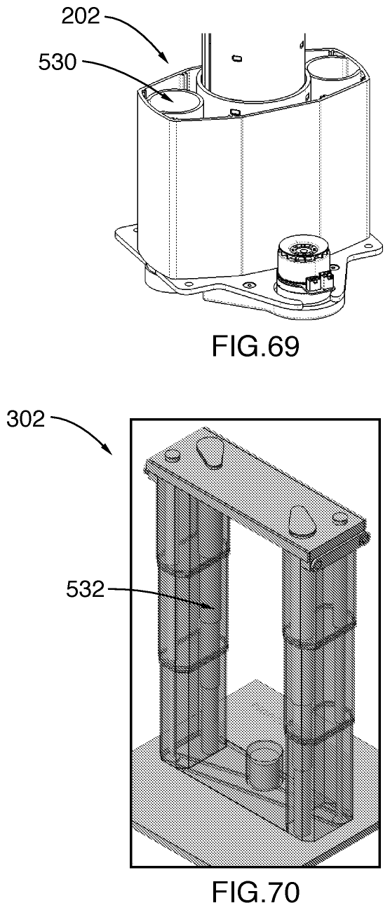

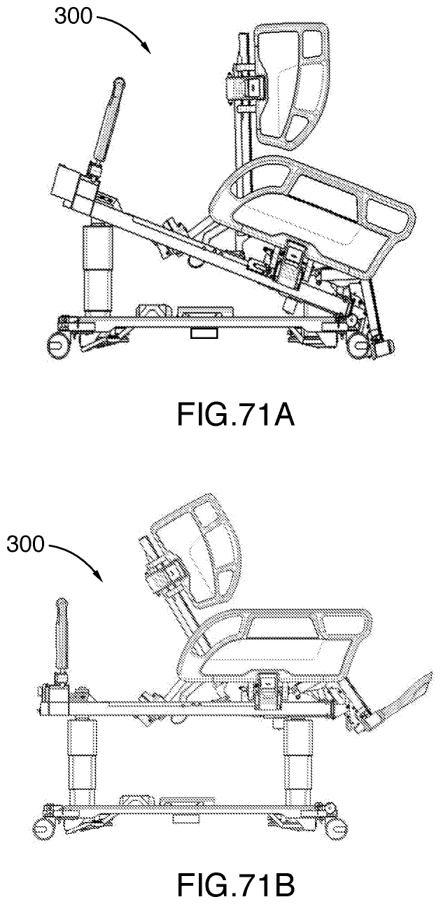

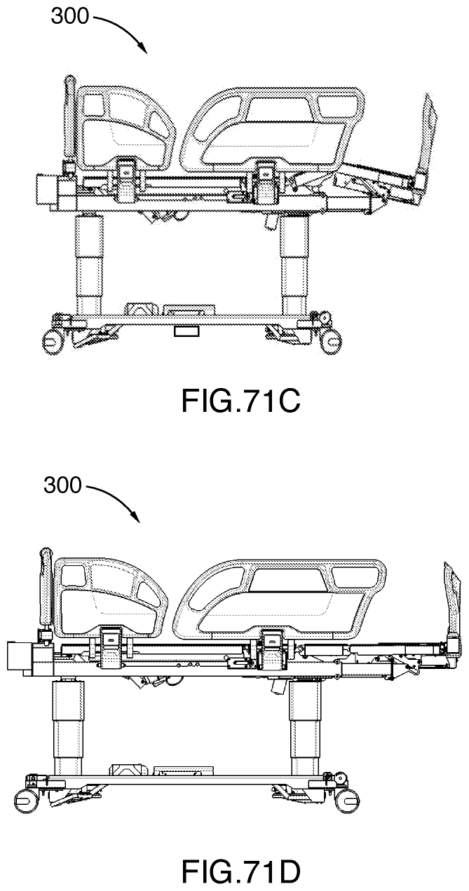

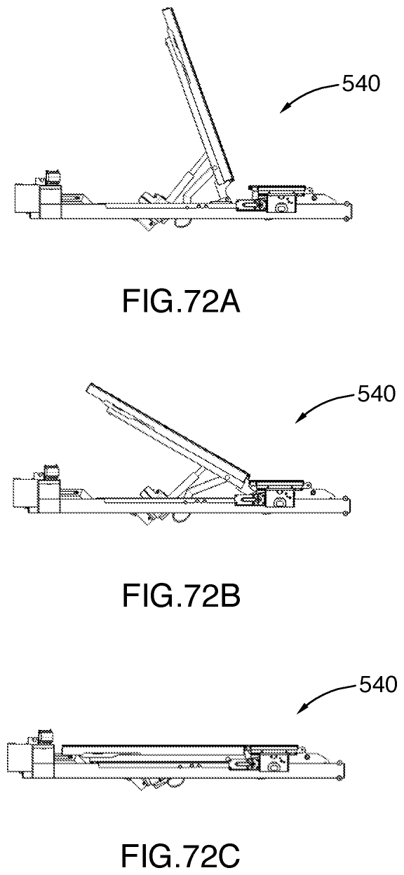

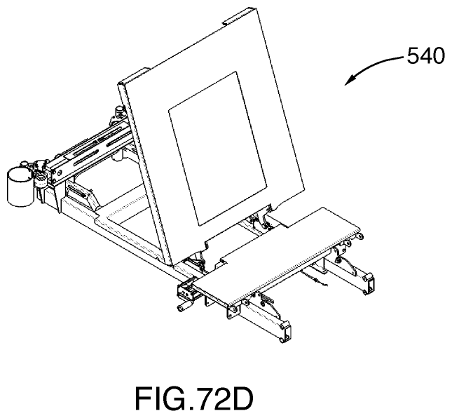

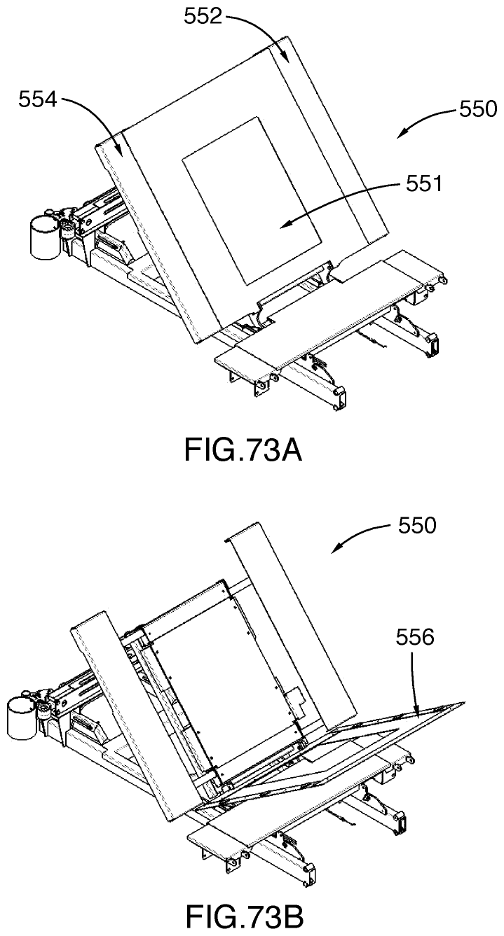

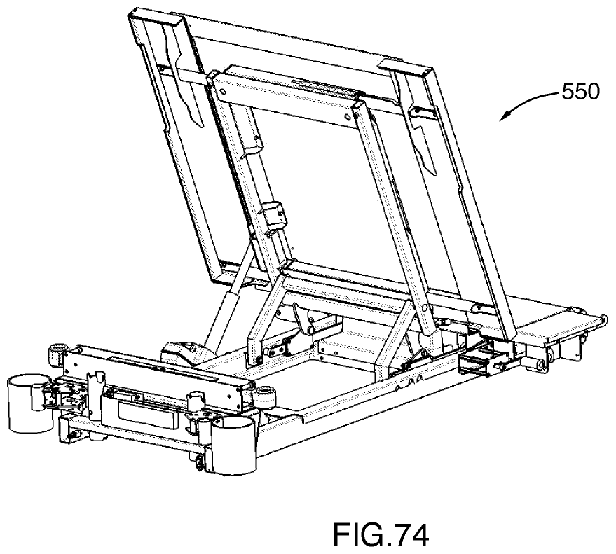

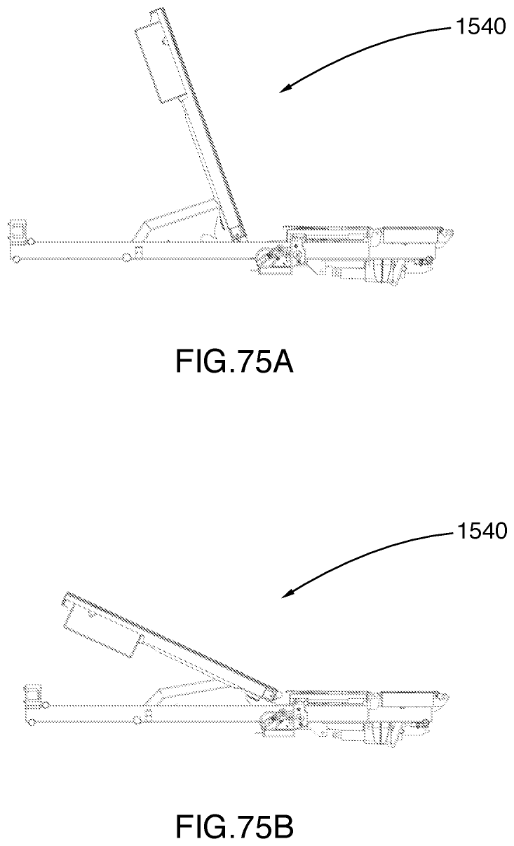

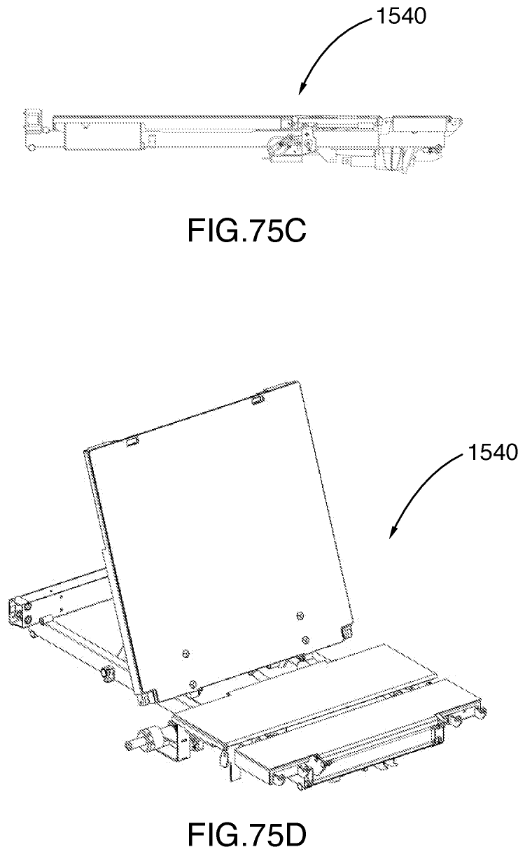

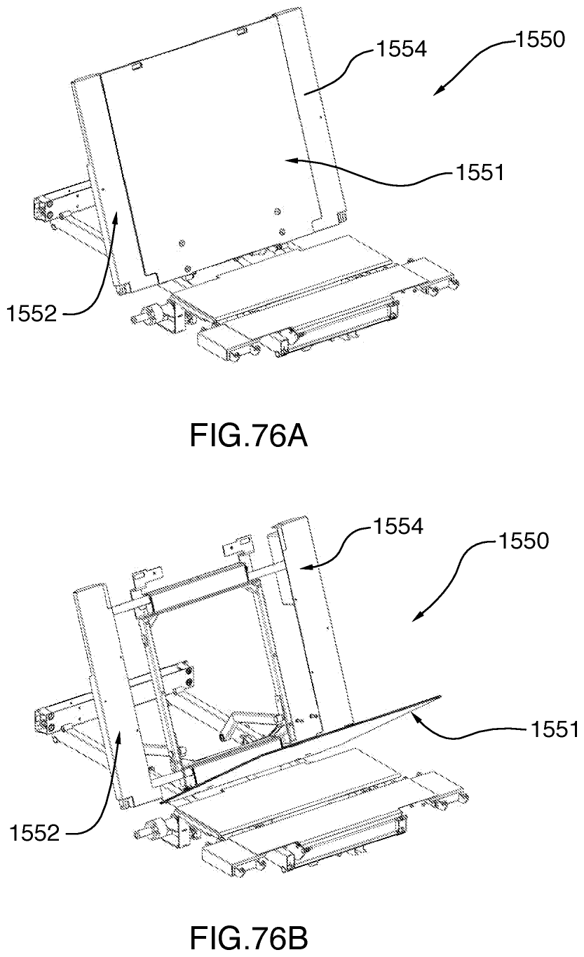

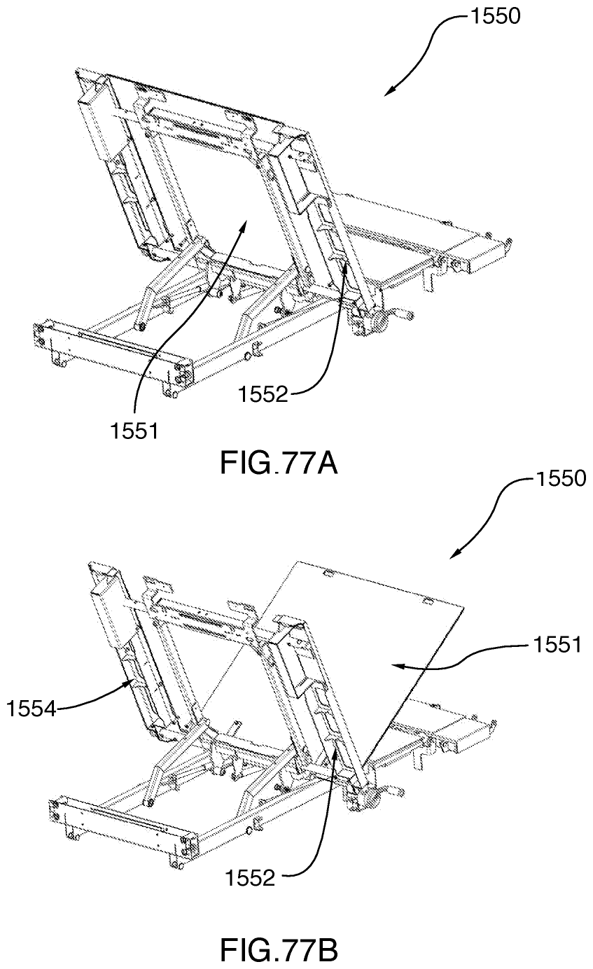

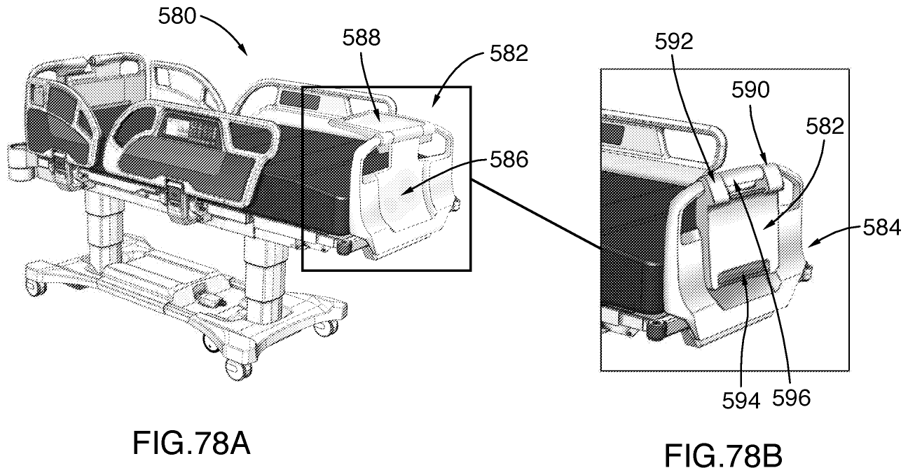

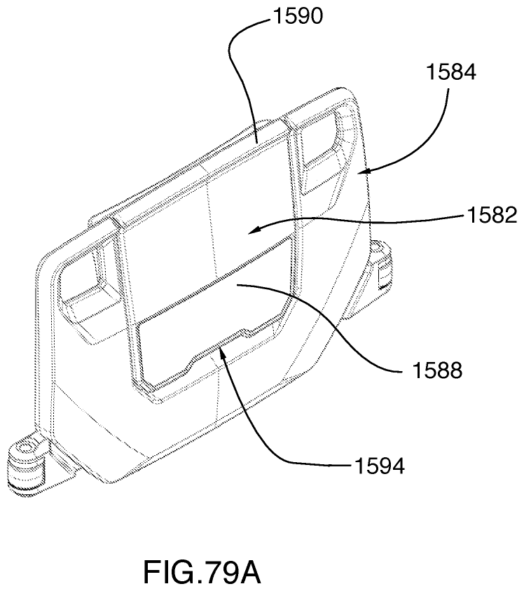

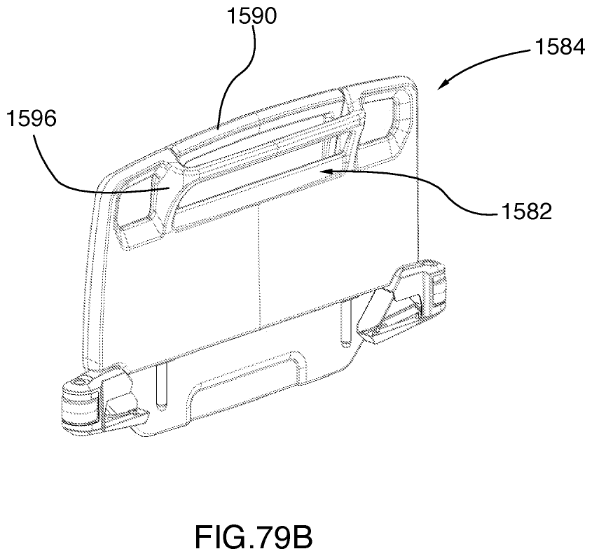

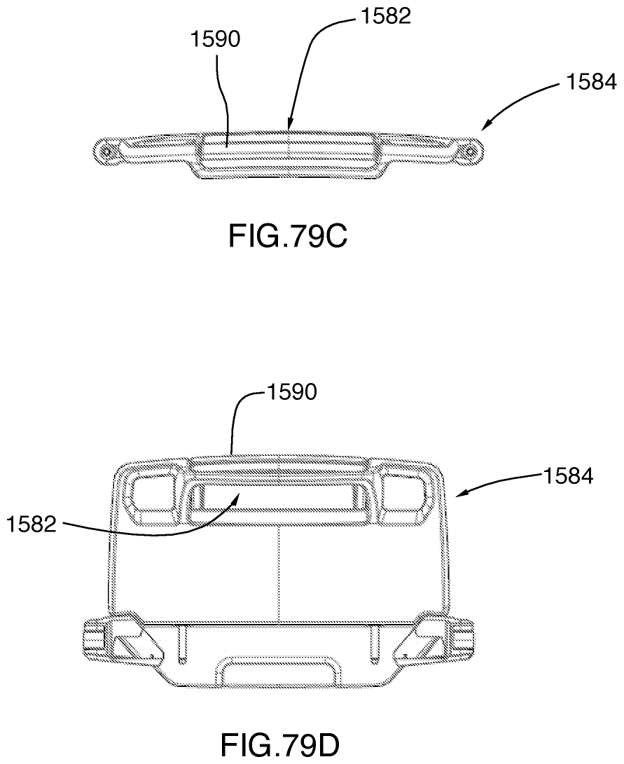

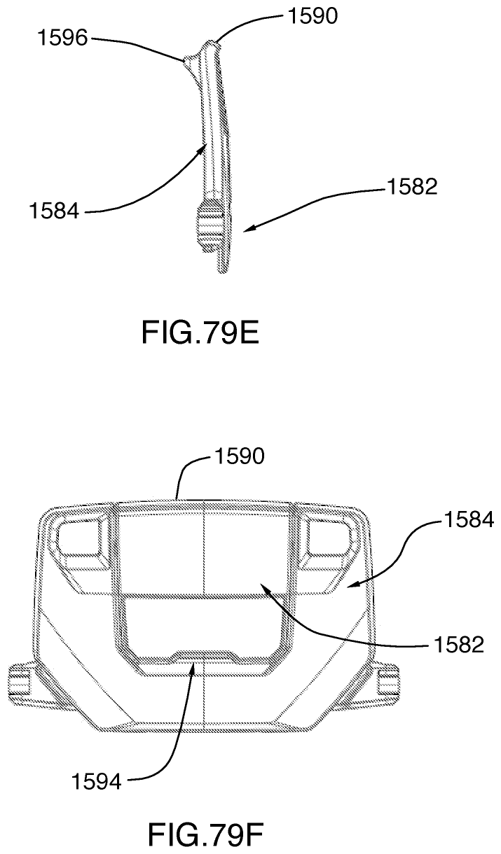

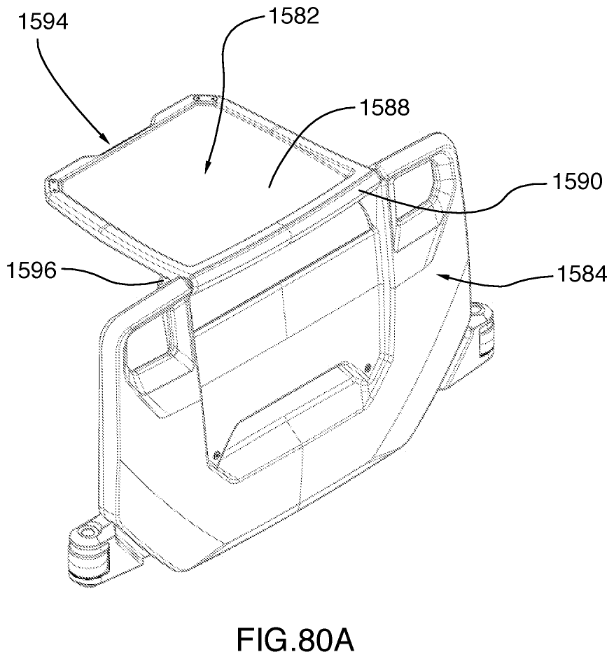

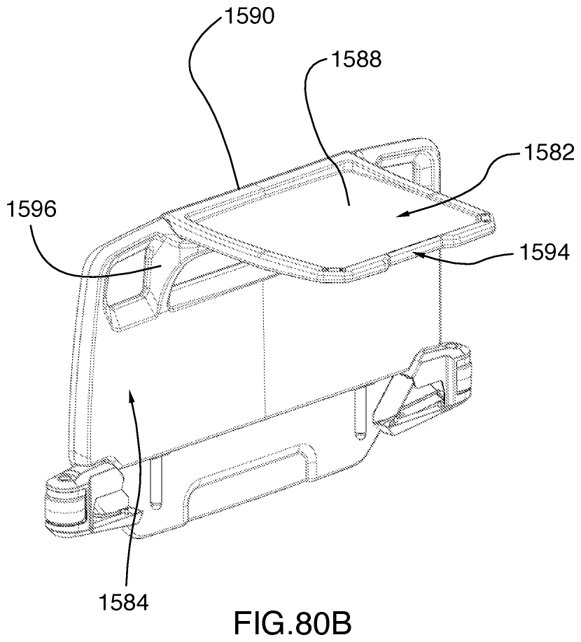

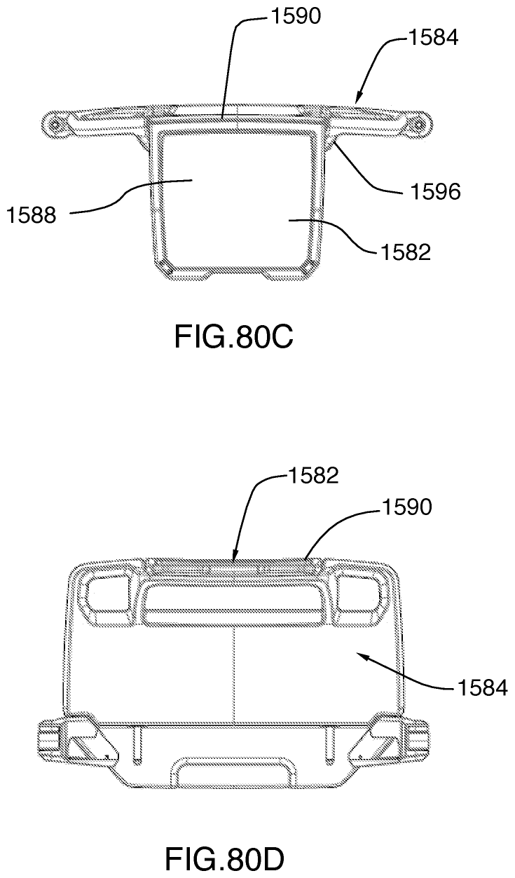

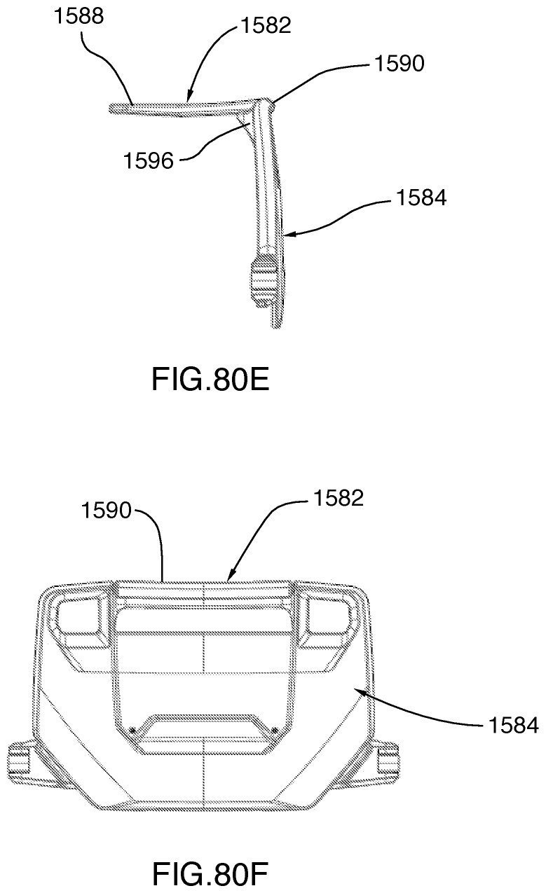

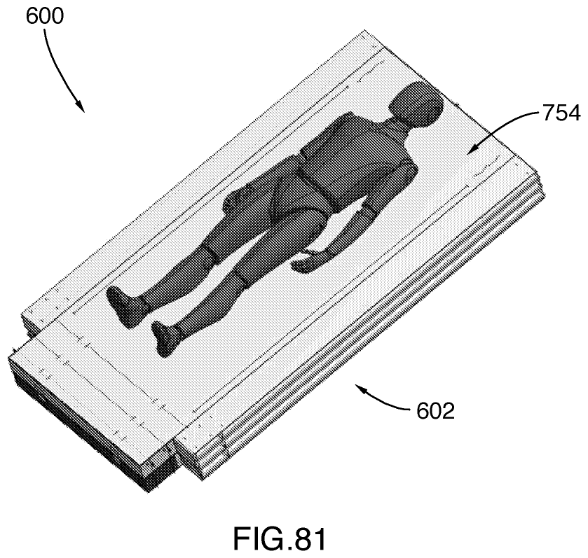

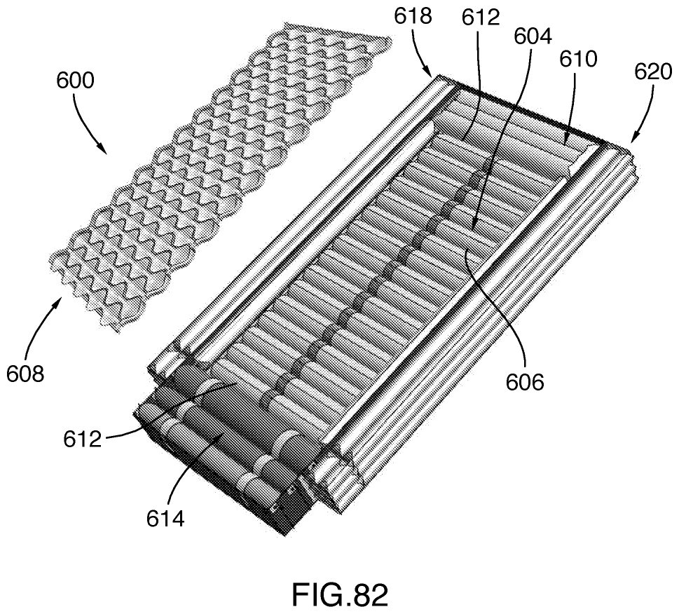

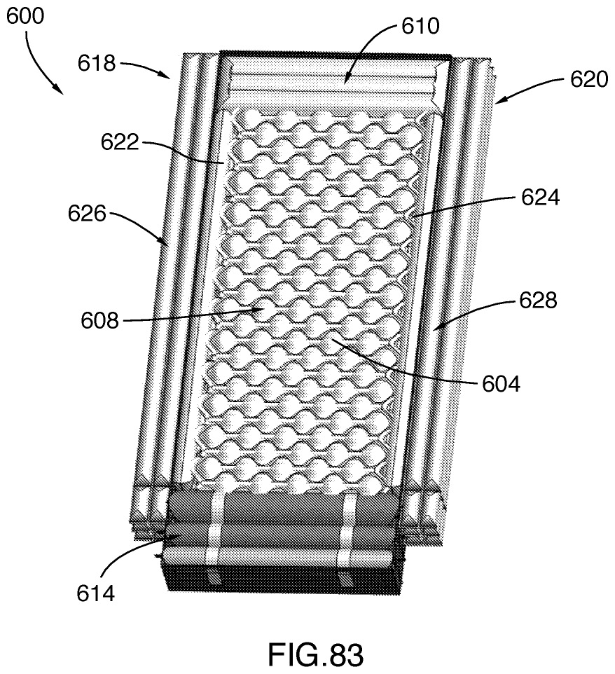

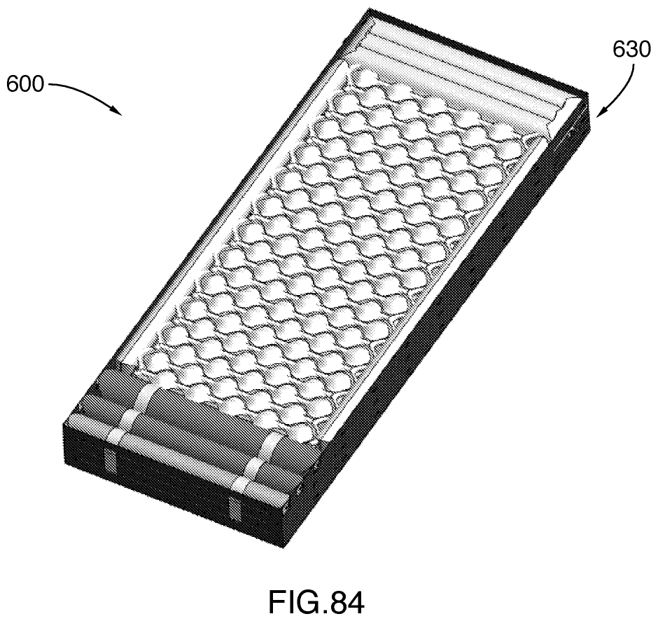

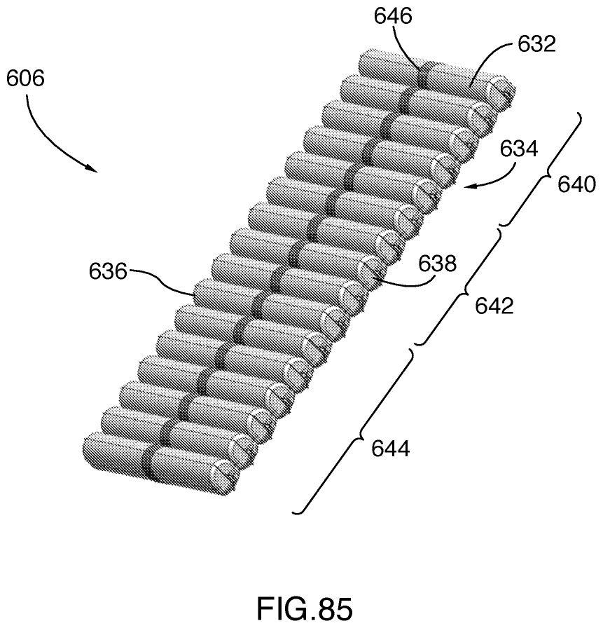

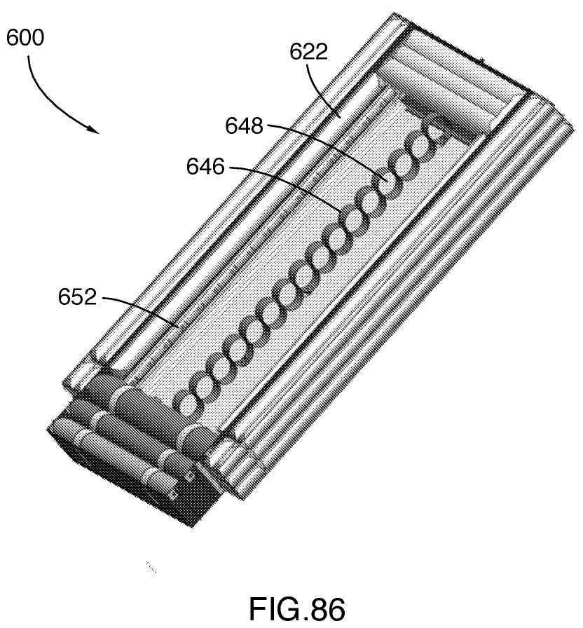

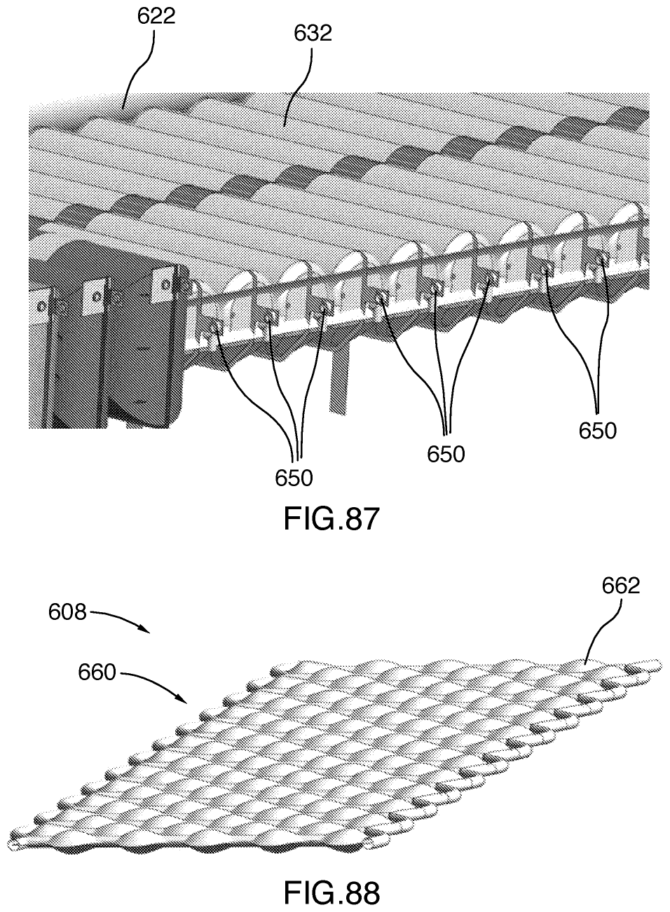

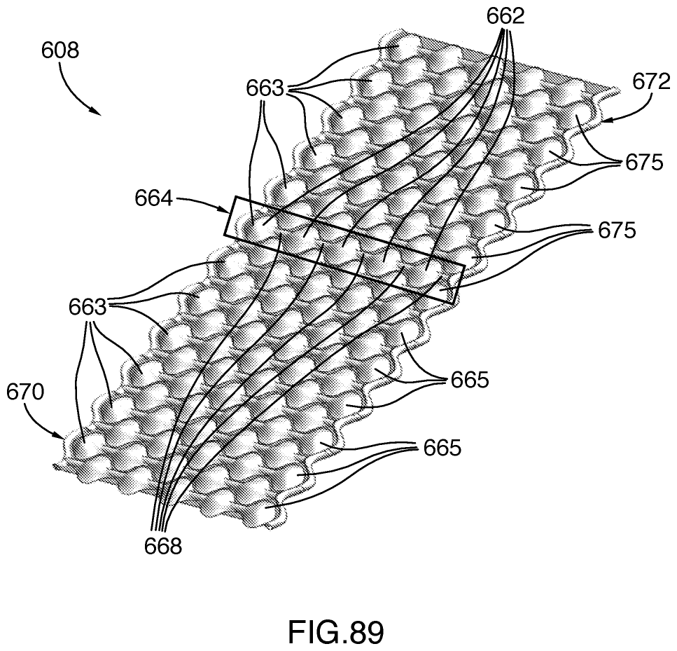

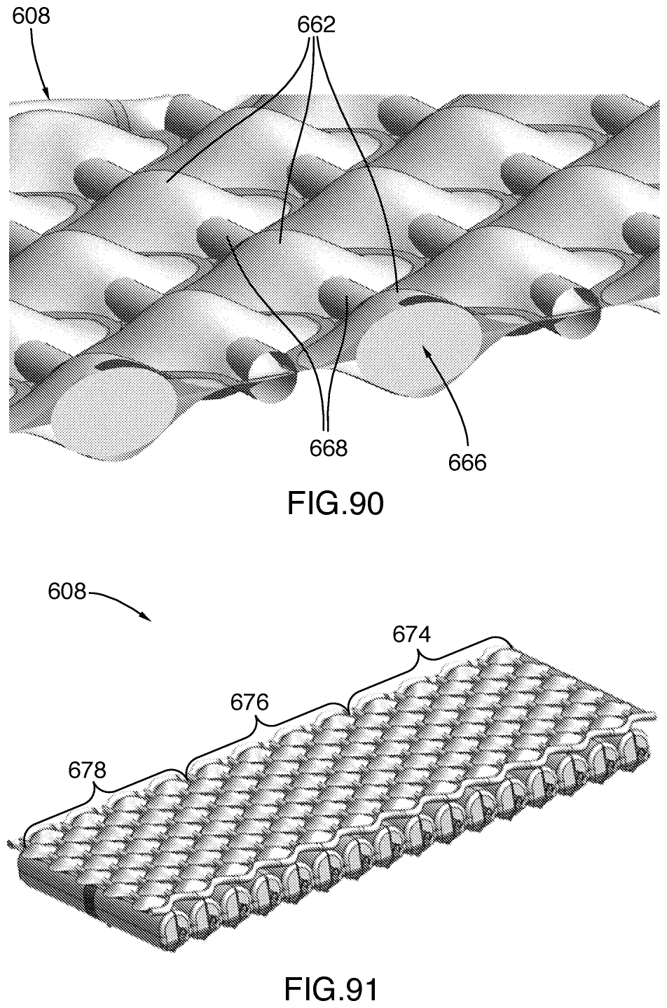

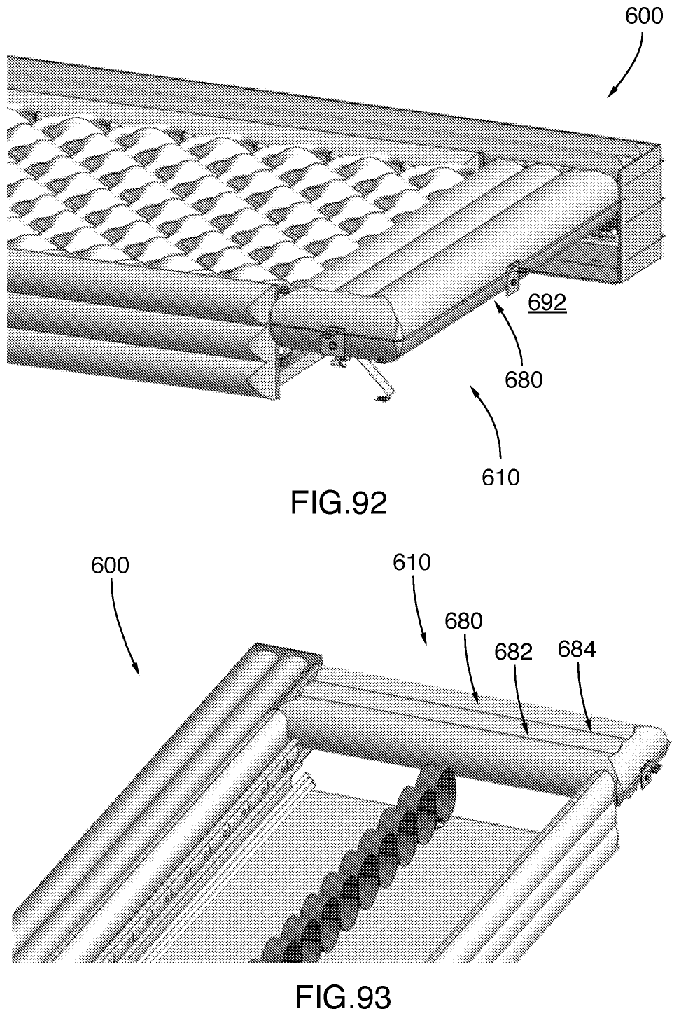

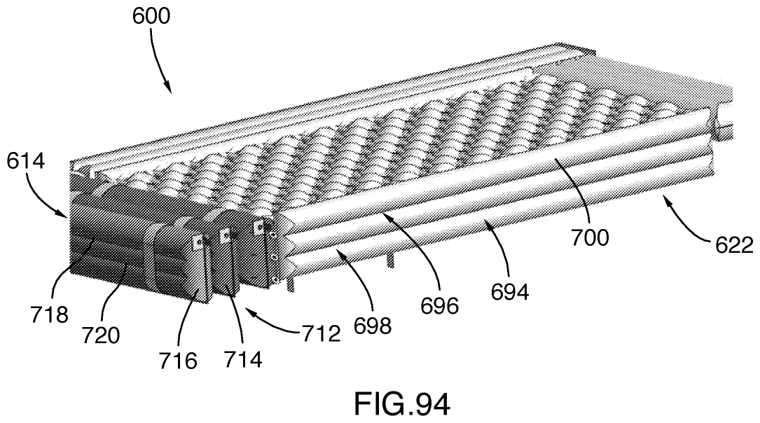

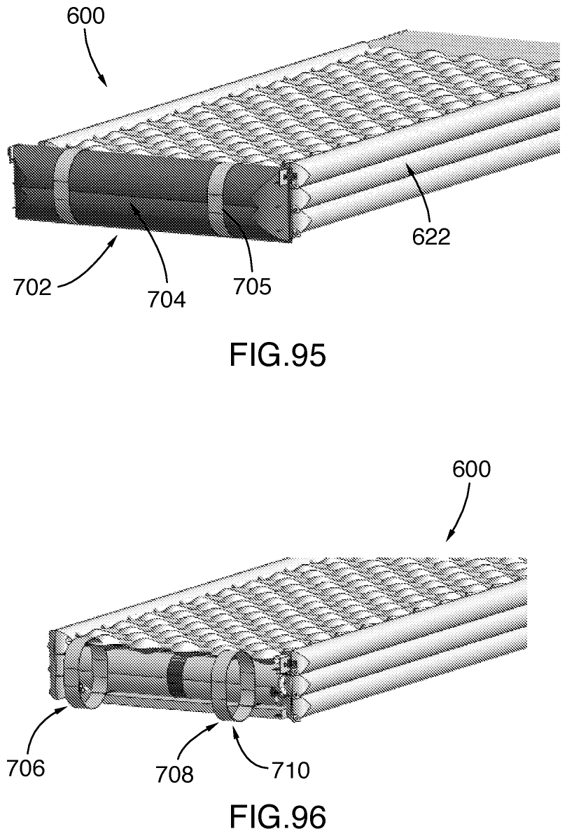

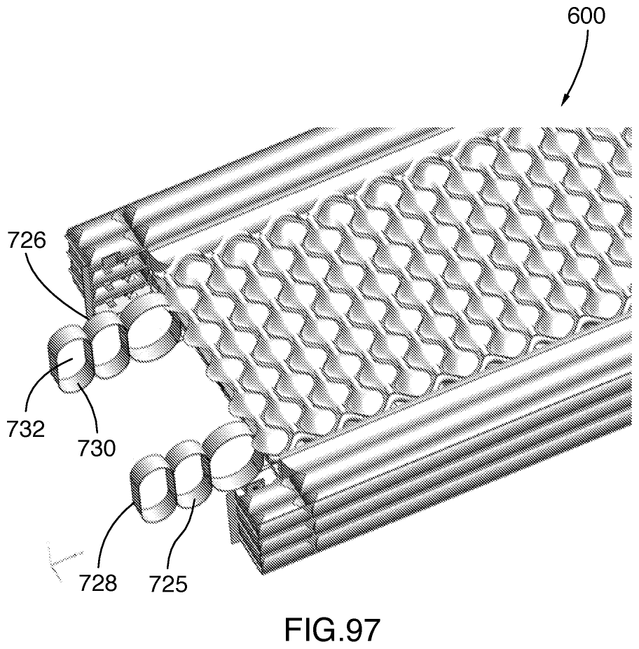

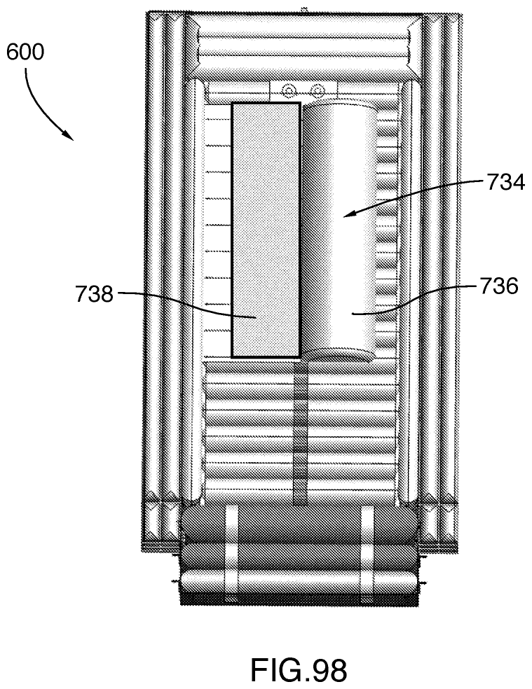

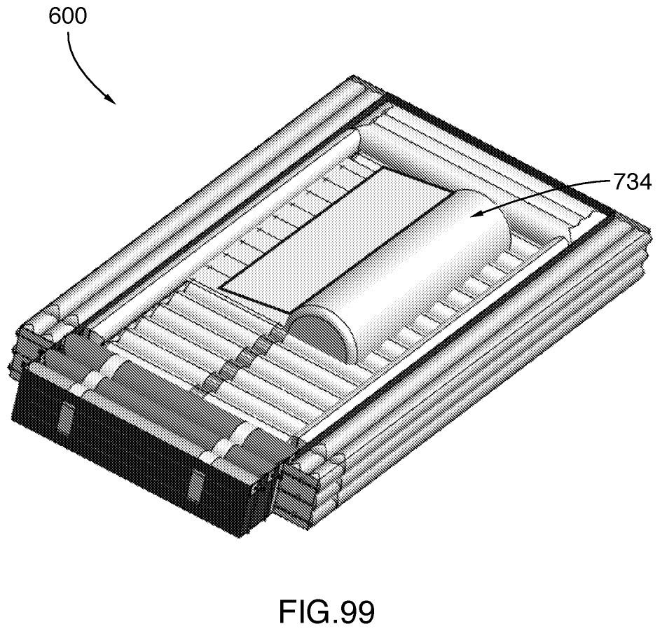

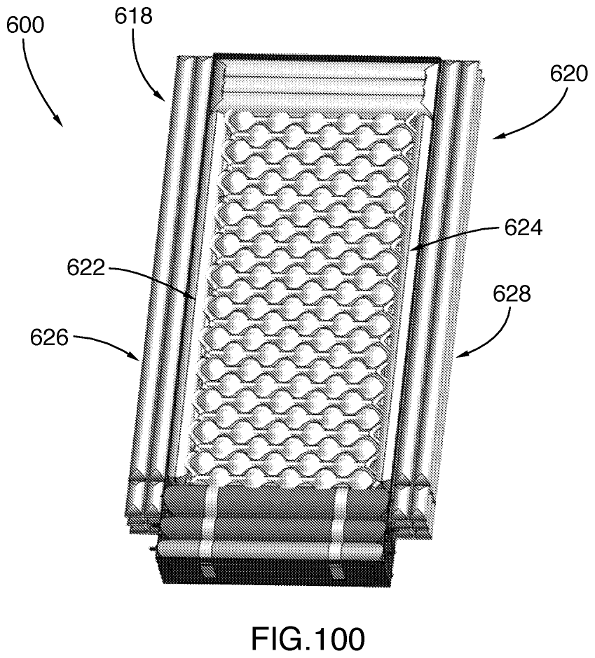

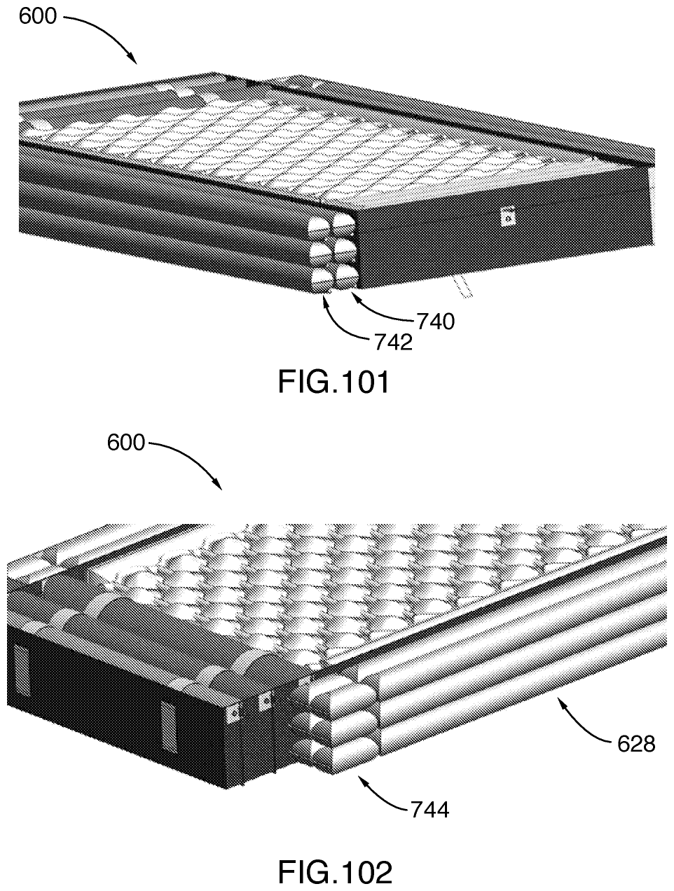

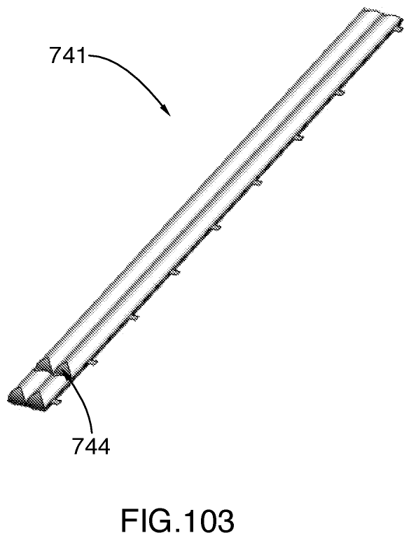

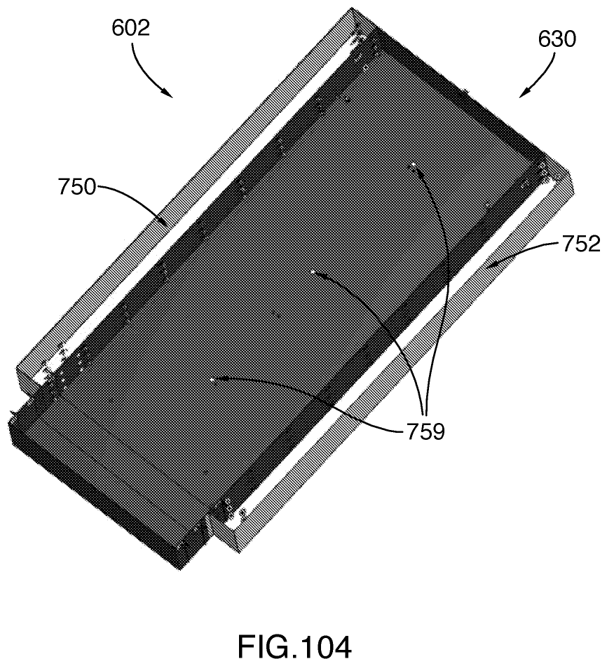

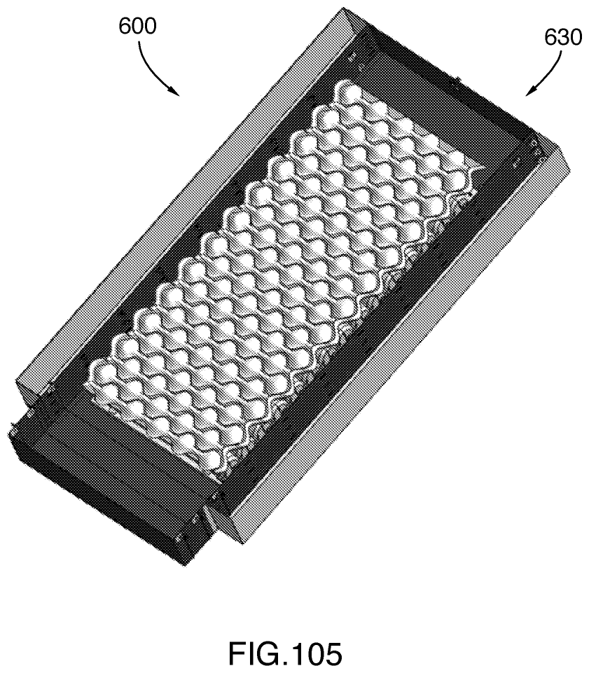

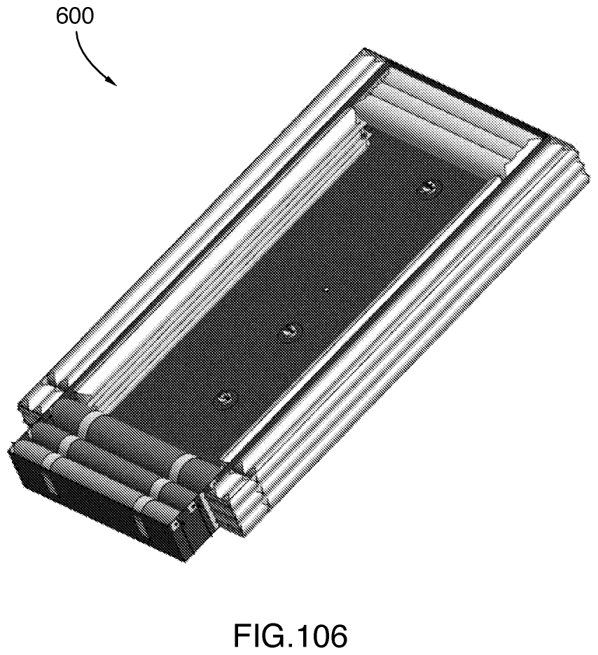

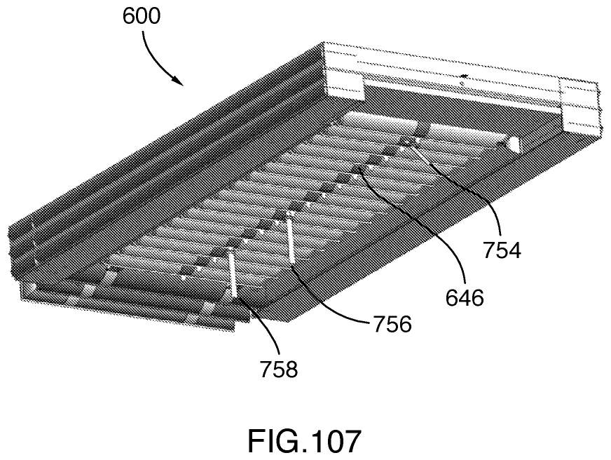

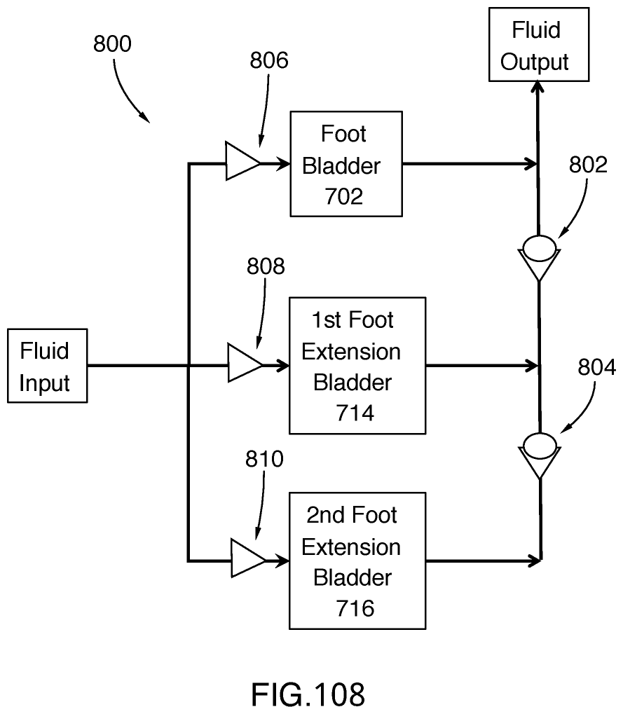

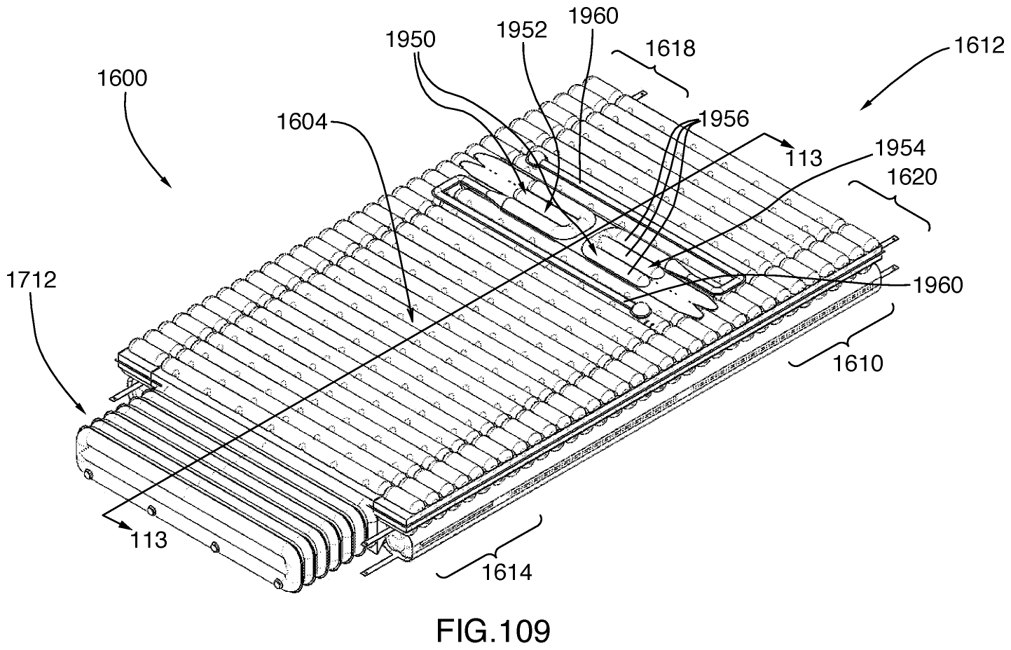

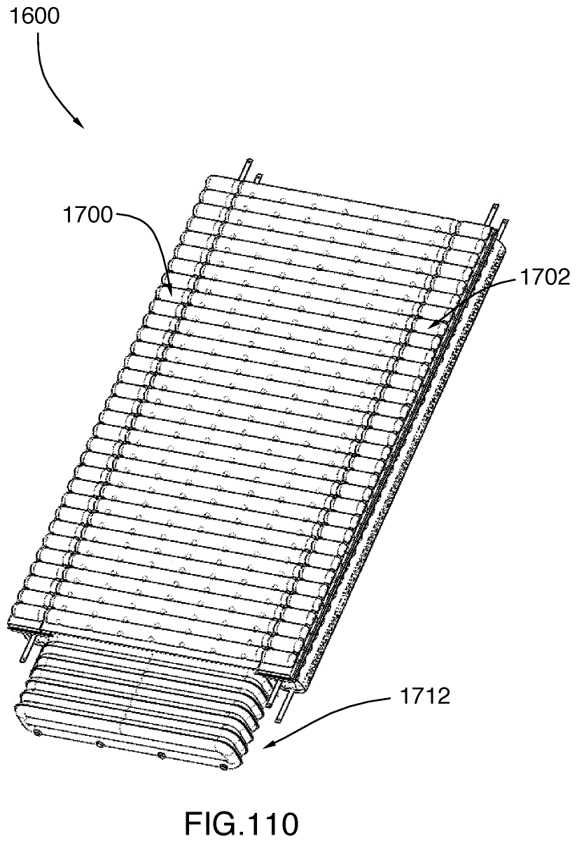

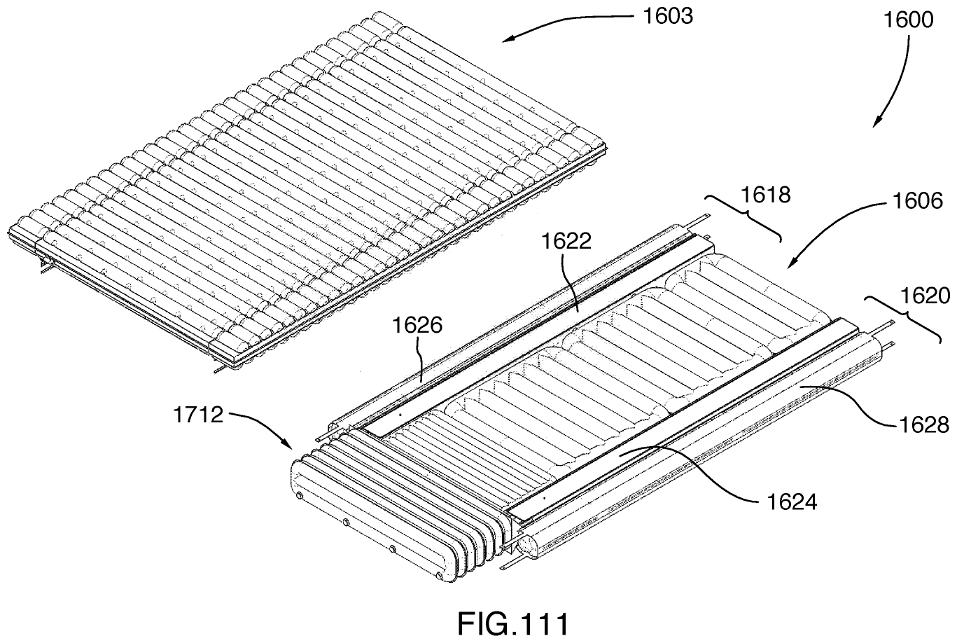

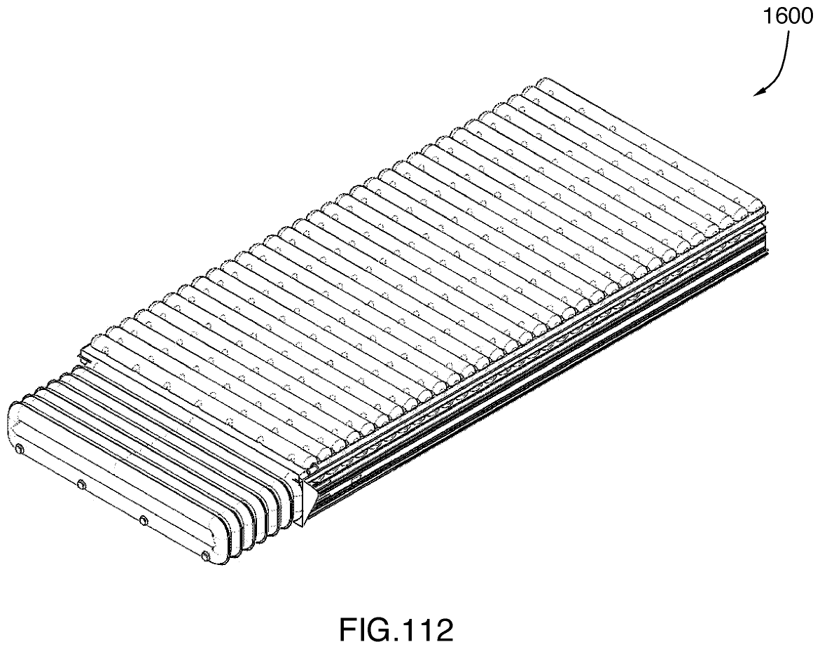

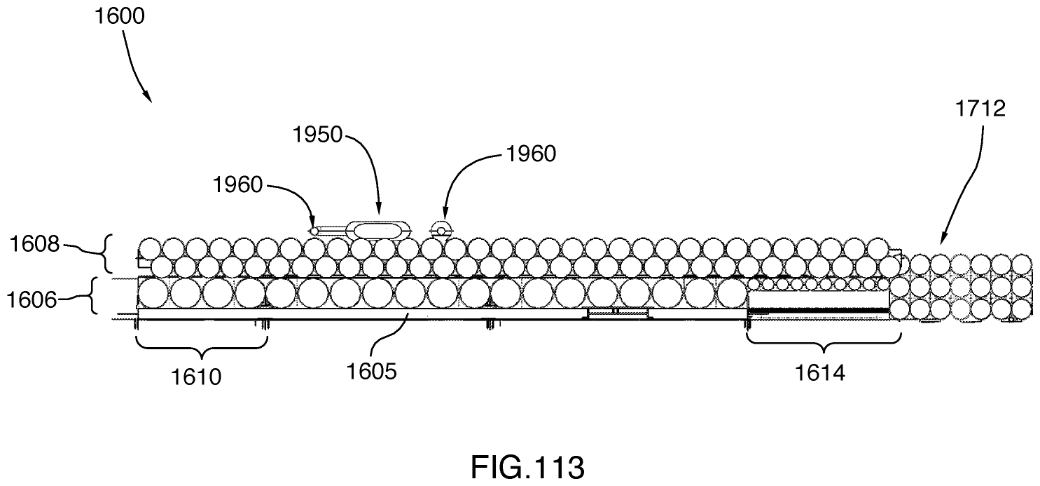

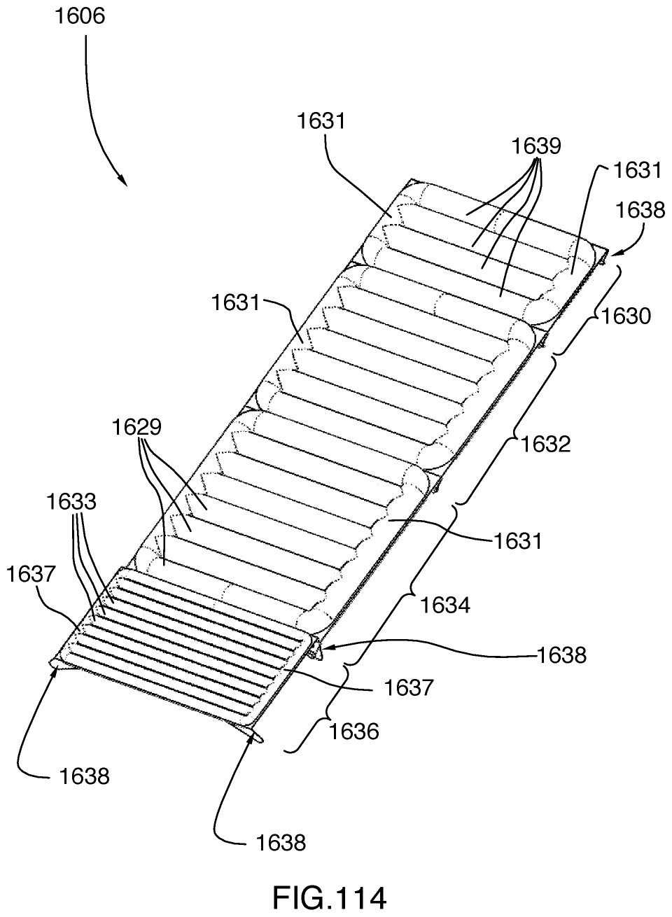

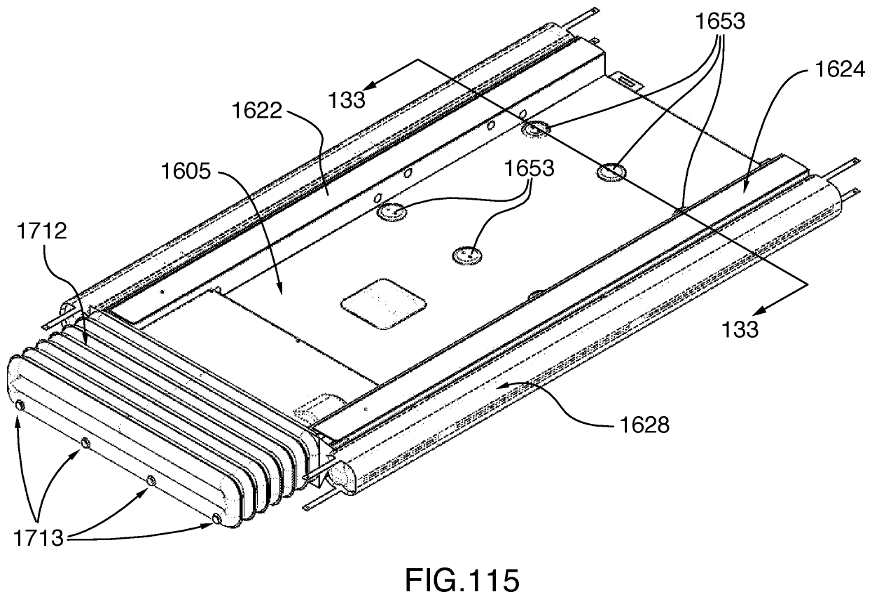

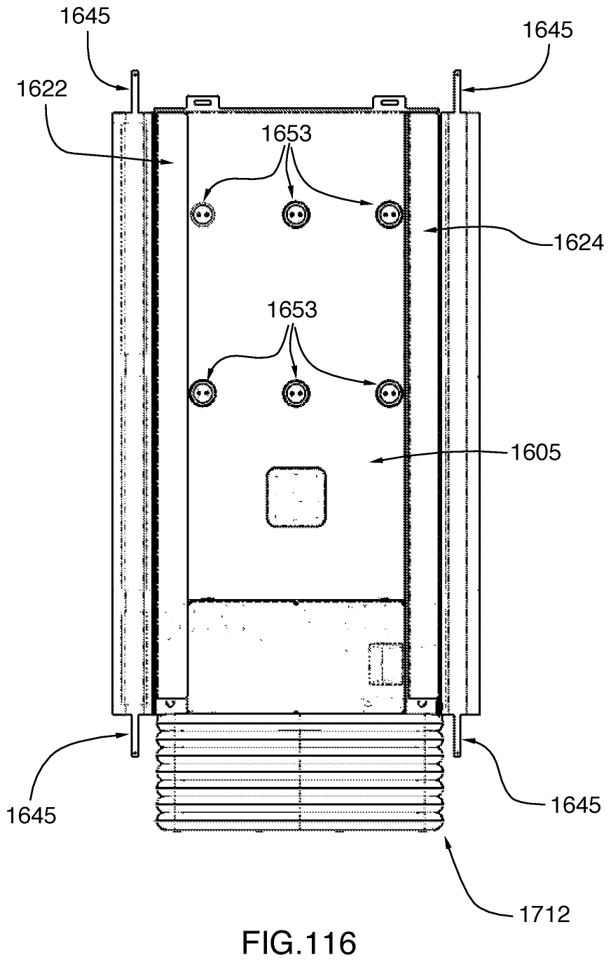

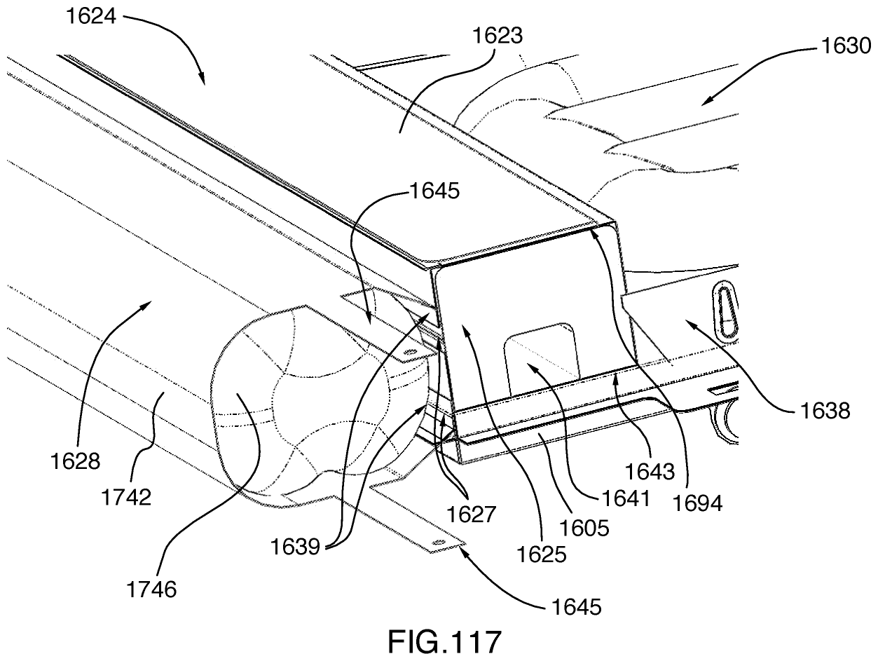

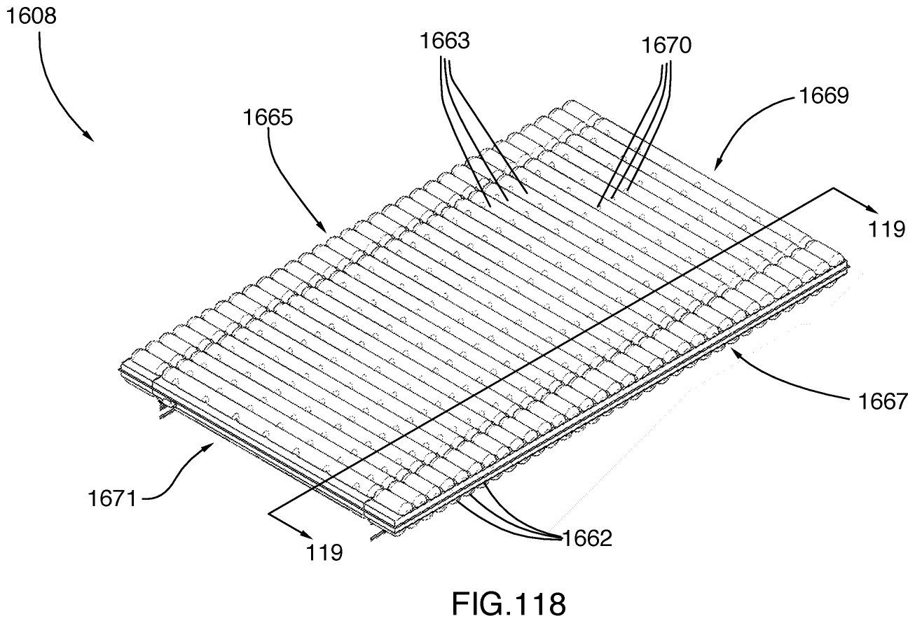

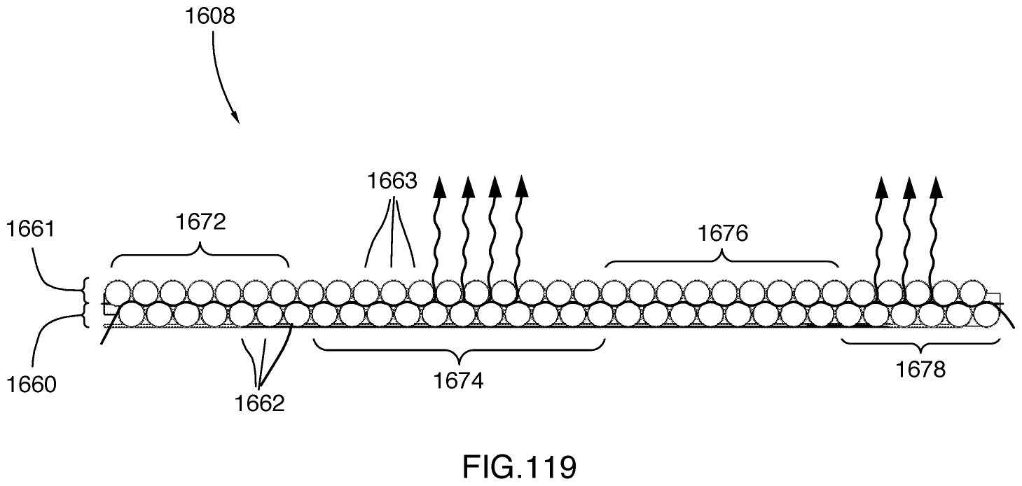

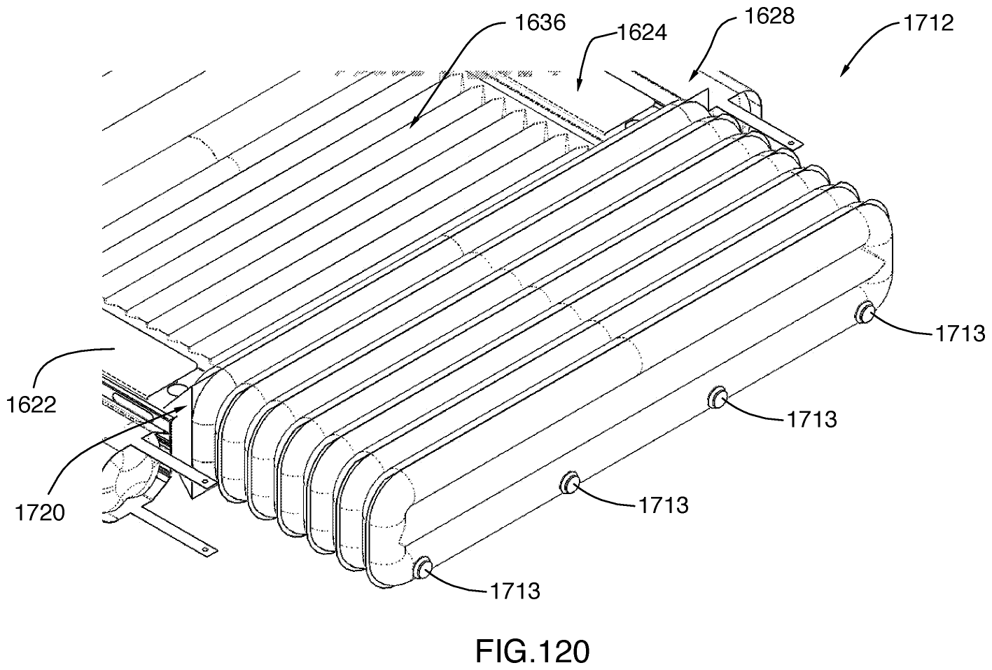

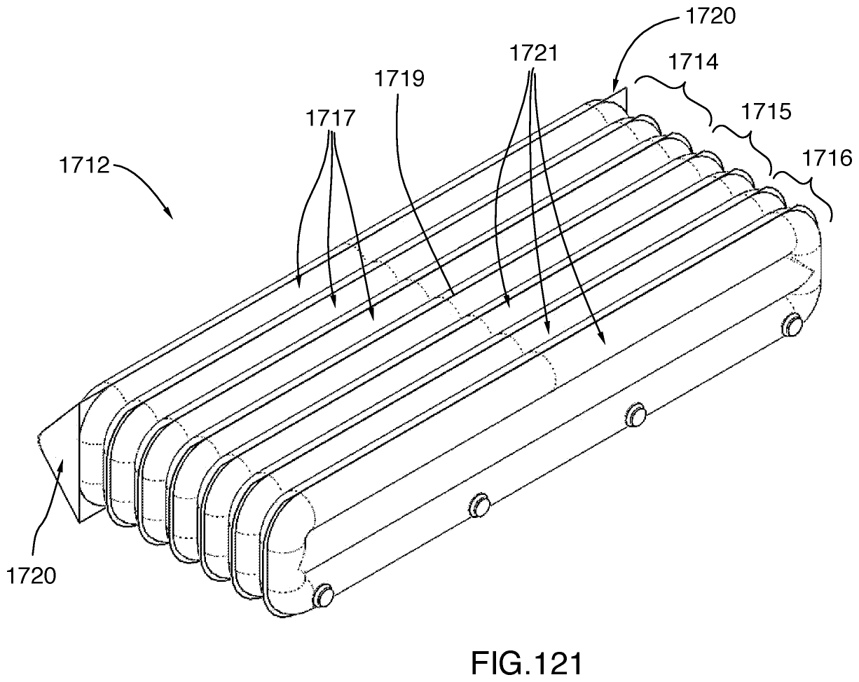

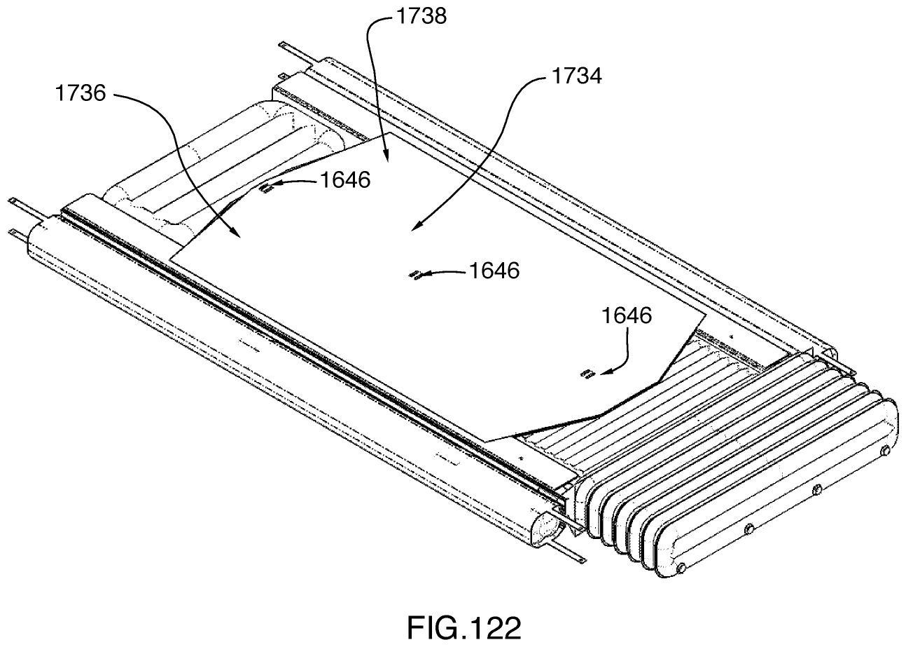

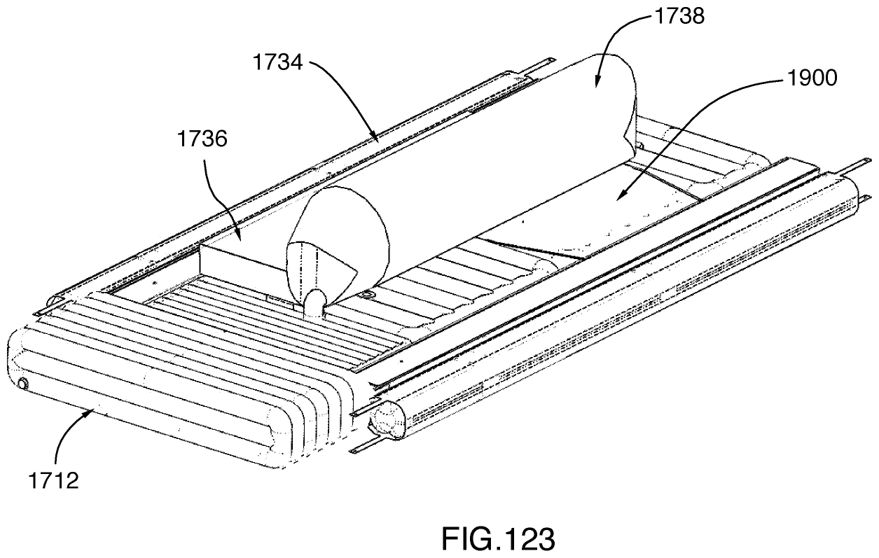

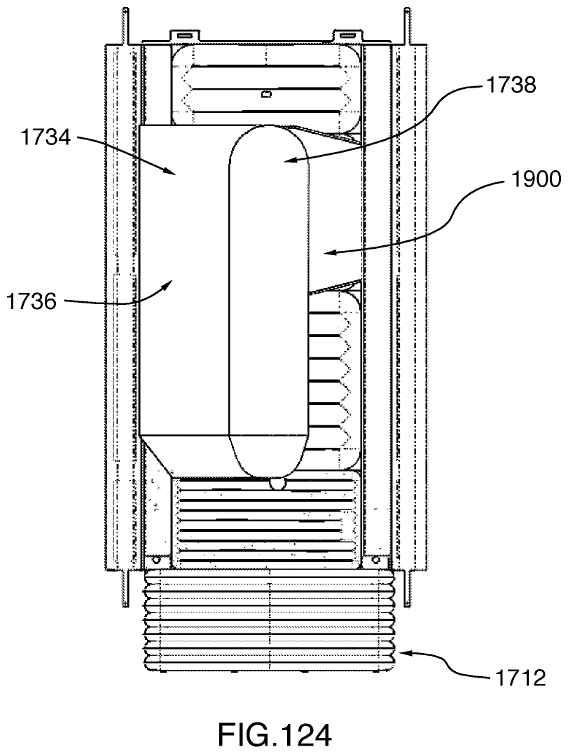

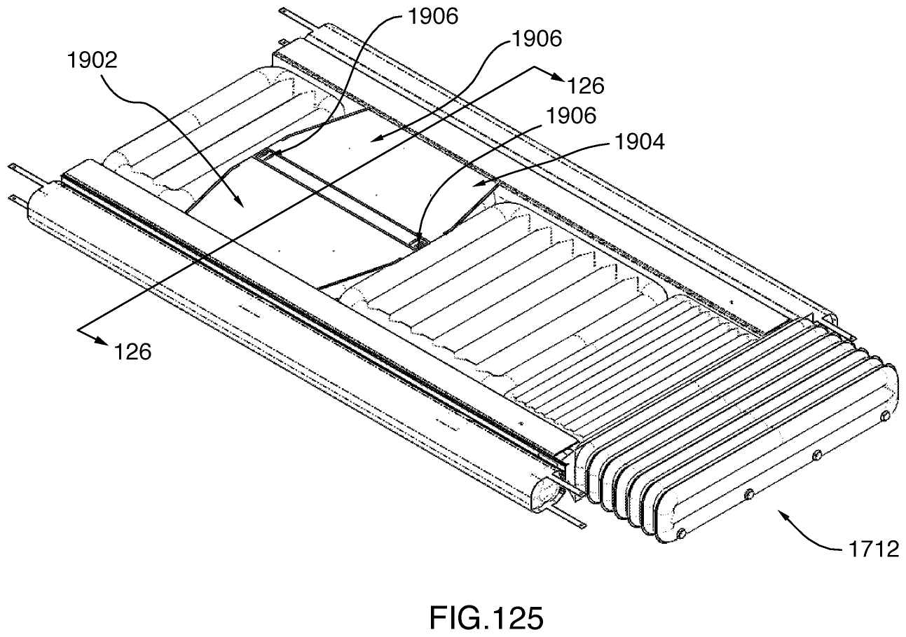

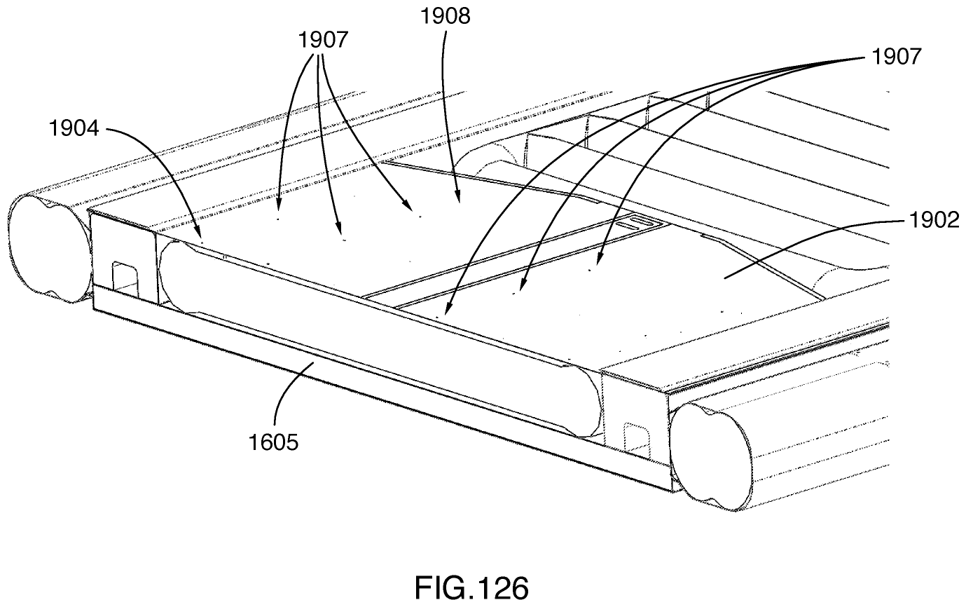

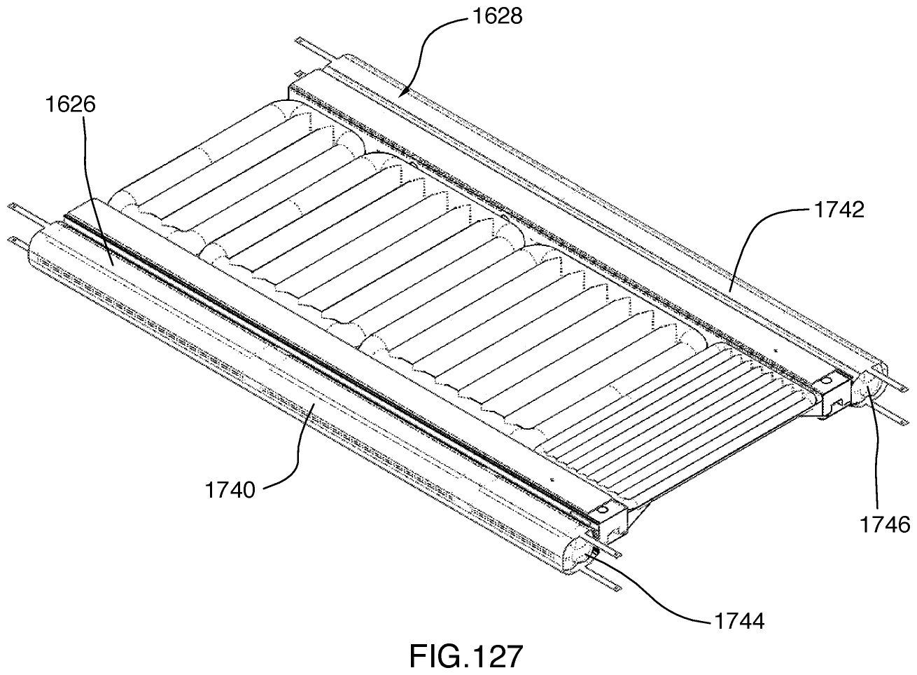

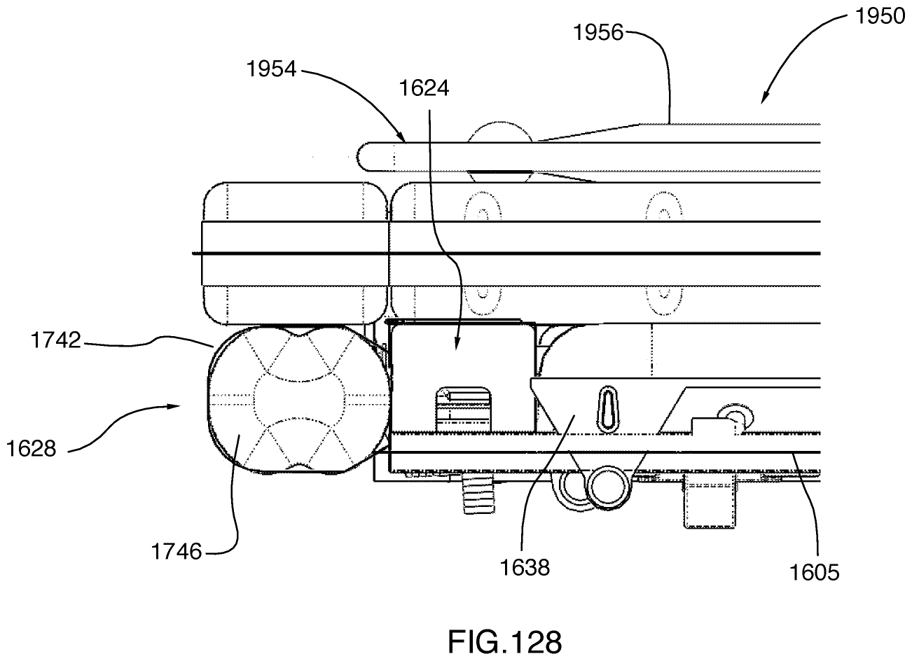

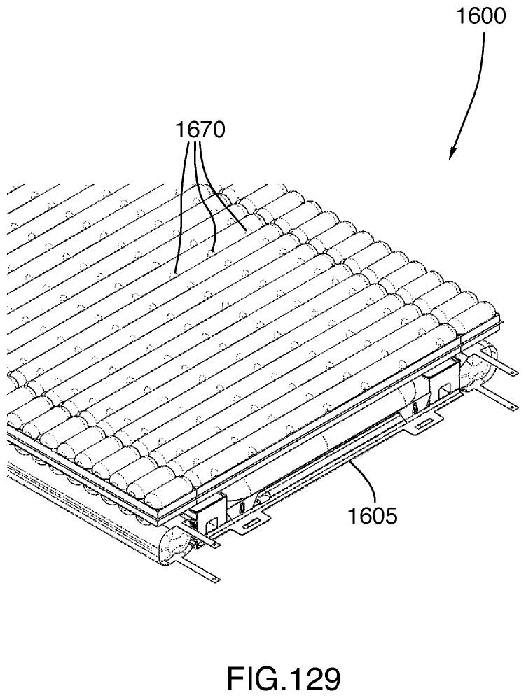

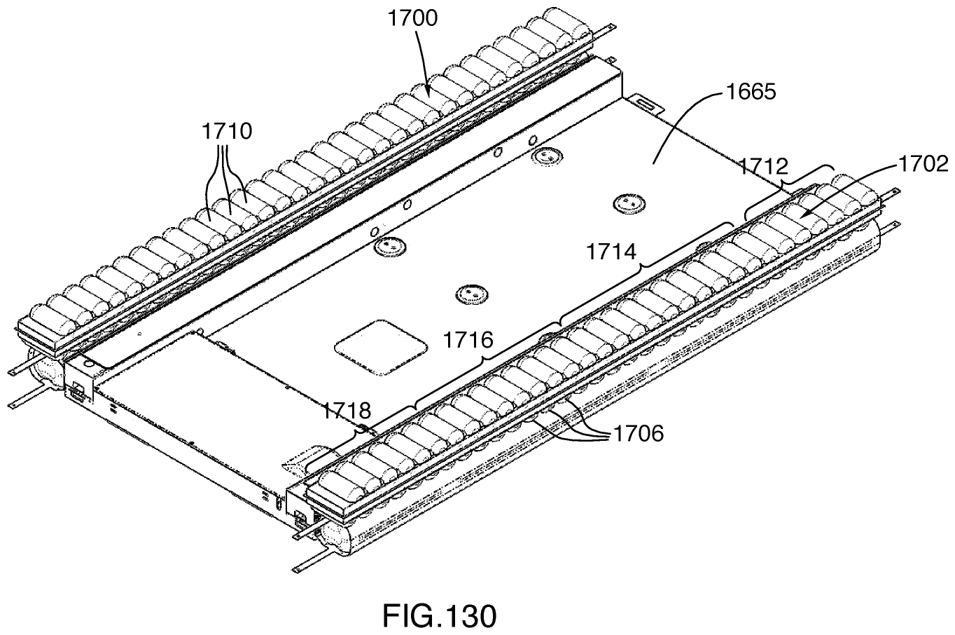

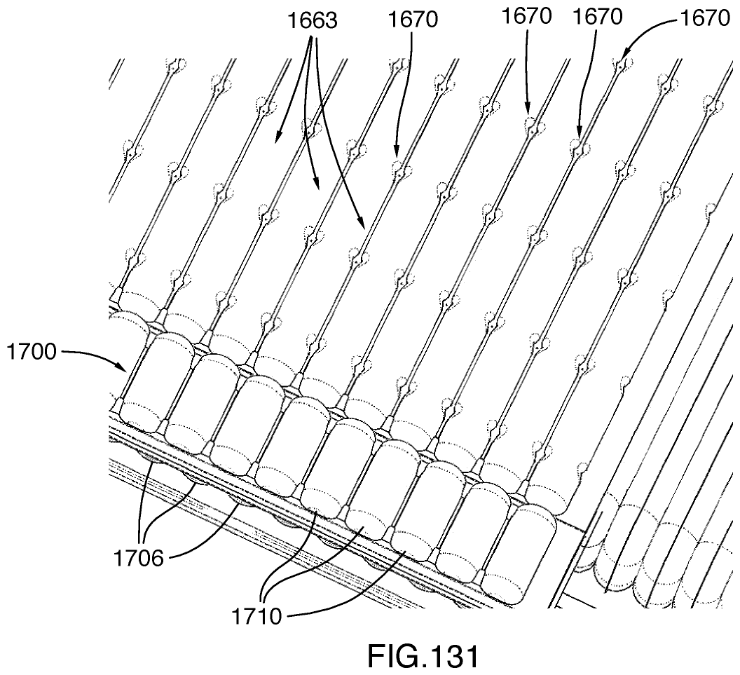

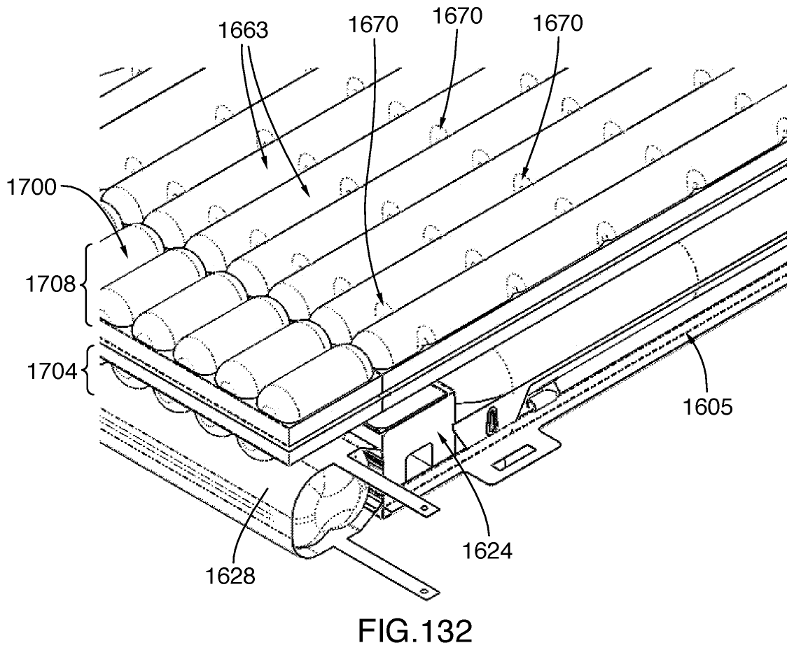

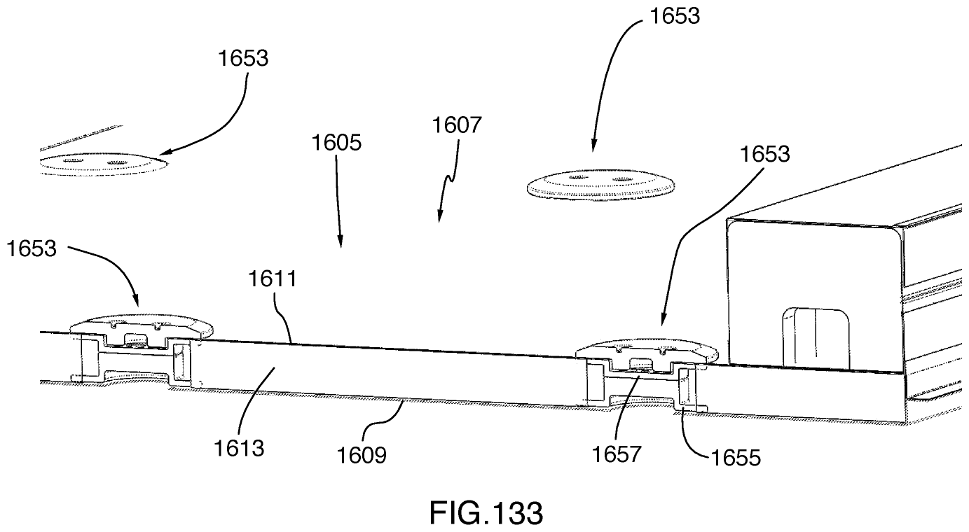

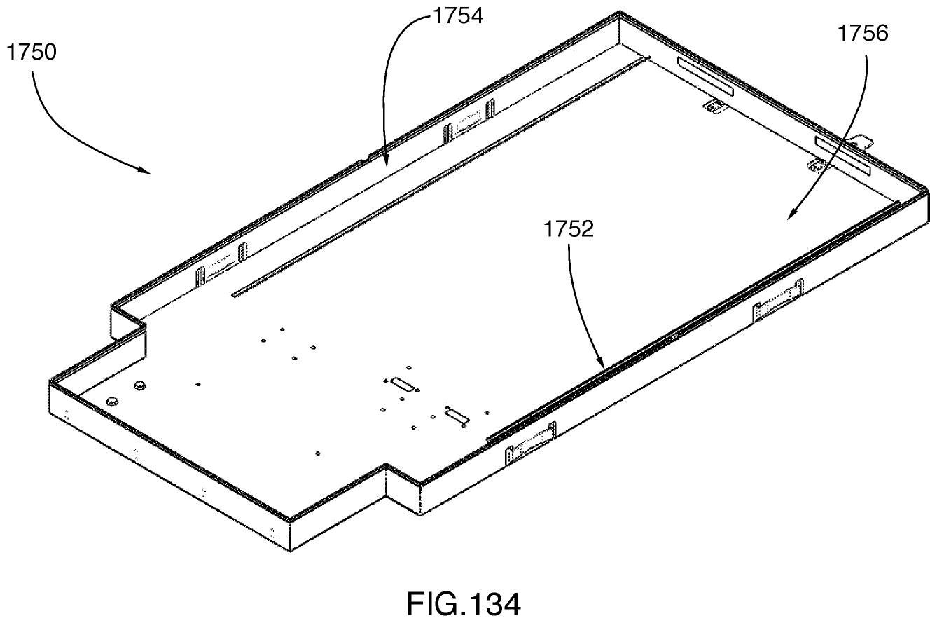

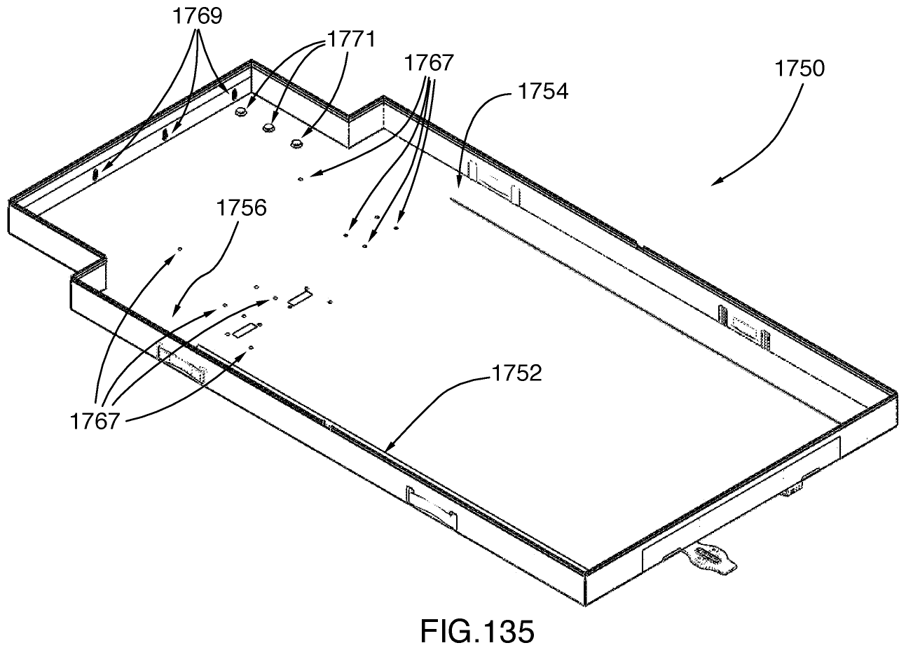

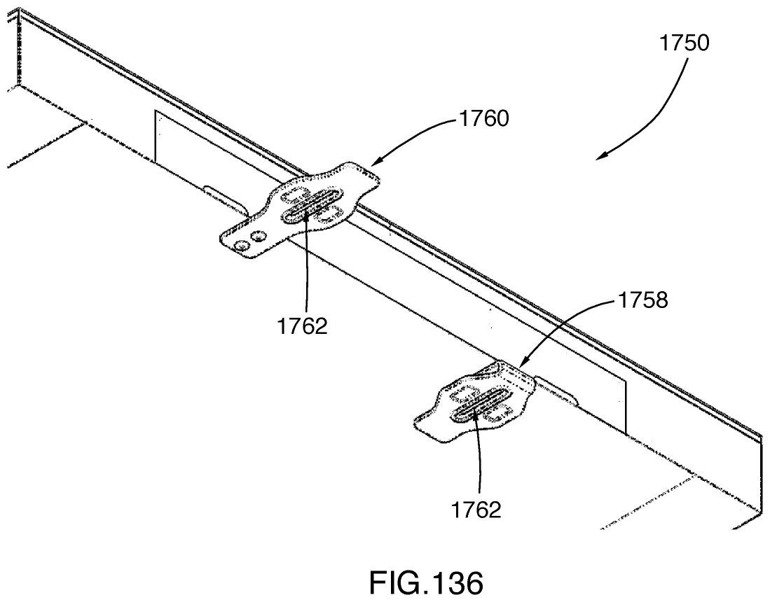

FIGS. 42A, 42B and 44B show the motor and pulley arrangement 1382 used for actuating the actuators 1354, 1356 of the first motorized extension mechanism 1350. The second motorized extension mechanism 1352 has a step motor 1355 driving a timing belt 1392 connected to the two linear actuators 1354, 1356 through two corresponding pulleys 1394, 1396 connected to a corresponding lead screw 1401, 1403 of the corresponding linear actuator 1354, 1356. As it should now be apparent, operation of the motor 1355 drives the timing belt 1392 which drive the pulleys 1394, 1396. Upon rotation of the pulleys 1394, 1396, the linear actuators 1354, 1356 are deployed or retracted.

The second motorized extension mechanism 1352 according to one embodiment will now be described with reference to FIGS. 42 to 44B. The first motorized extension mechanism 1350 has two linear actuators 1400, 1402 mounted in a parallel relationship between the main section 1332 of the foot support panel 1330 and amounting portion thereof connected to the thigh support panel 168 section for deploying and retracting the foot support panel 1330 relative to the thigh support panel 168. In one embodiment, the linear actuators 1400, 1402 are operated simultaneously through an electrical motor 1406.

FIG. 44B shows the motor and pulley arrangement 1404 used for actuating the actuators 1400, 1402 of the second motorized extension mechanism 1352 shown. The second motorized extension mechanism 1352 has a step motor 1406 driving a timing belt 1407 connected to the two linear actuators 1400, 1402 through two corresponding pulleys 1408, 1410 connected to a corresponding lead screw 1409, 1411 of the corresponding linear actuator 1400, 1402. As it should now be apparent, operation of the motor 1406 drives the timing belt 1407 which drive the pulleys 1408, 1410. Upon rotation of the pulleys 1408, 1410, the linear actuators 1400, 1402 are deployed or retracted.

As it should be appreciated, the proposed arrangement provides an extra compact length in fully retracted position while enabling a length extension up to 14 inches. Moreover, the two motorized extension mechanisms 1350, 1352 can be operated simultaneously to provide a faster extension and retraction, as it should become apparent.

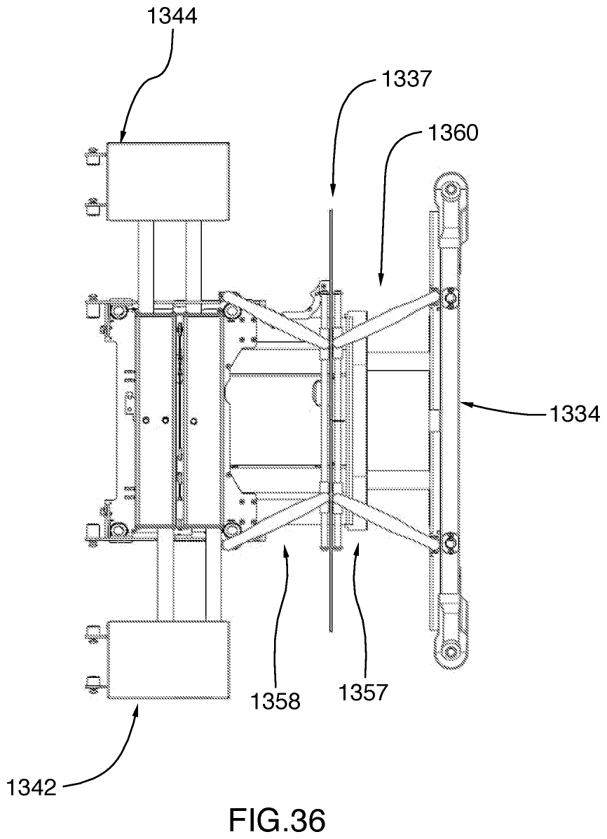

Referring back to FIGS. 34A to 34D and also to FIGS. 35A to 36, a width extension mechanism 1420 can be provided on the foot support panel 1330. In this embodiment, an arrangement using mechanical cables and pulleys is used to synchronize the lateral extension of the foot support panel 1330 with the lateral extension of the other patient support sections, similarly to the arrangement described in PCT patent application published under no. WO2017051386 by the same Applicant, which is hereby incorporated by reference in its entirety.

Turning now to FIGS. 45A to 45C and FIGS. 46A to 46D, the mounting of the foot support panel 330, 340, 380 or 1330 with the thigh support panel 168 and the frame 160 of the bed 300, according to one embodiment. In this embodiment, a sliding subframe assembly 450 mounted with the frame 160. As better shown in FIGS. 46A and 46B, the sliding subframe assembly 450 is provided with two elongated spars 452, 454 that are adapted to be slidably mounted within the elongated spars 453, 455 of the frame 160. A linear actuator 456 fixedly attached to the frame 160 is used for sliding the subframe assembly 450 inside the frame 160.

The foot support panel 330, 340, 380 of 1330 is pivotally connected to the sliding subframe assembly 450, as shown in FIG. 45A, and also to the thigh support panel 168. When the subframe assembly 450 is moved with respect to the frame 160, it drives a pivoting movement of the foot panel 340. As shown in FIG. 45B, the thigh support panel 168 will be pivoted too upon pivotal of the foot support panel 340. In other words, the angular position of the foot support panel 340 would drive a relative angle position of the thigh support panel 168. As it will become apparent below, such sliding subframe assembly 450 may be useful to provide a bed 300 having a full chair position, as greater detailed below.

Referring now to FIGS. 47 to 53, an operative sequence to move the bed 300 from a typical flat bed position to a chair position will now be described, according to one embodiment. In one embodiment, the sequence may be controlled through an input button on the control panel of the bed 300. Upon activation of the input button, the bed 300 will be automatically moved in the chair position from any initial bed position and any initial height, without requiring the user to perform any additional task.

FIG. 47 shows the bed 300 in an initial typical bed position before the chair sequence begins. FIG. 48 shows the first step of the sequence: The backrest support panel 164 is raised of 30 degrees while the thigh support panel 168 is simultaneously raised to 18 degrees, as illustrated. These two movements are simultaneously performed. At this point, the raising of the thigh support panel 168 has driven the pivotal of the foot support panel 340 of 11 degrees, as illustrated.

At this point, as illustrated on FIG. 49, the subframe assembly 450 is retracted inside the frame 160, which drive the pivotal raising movement of the foot support panel 340 connected thereto, as well as the pivotal raising movement of the thigh support panel 168 which is connected to the foot support panel 340. Additionally, the thigh support panel 168 is further raised to extend at an angle of 25 degrees with respect to the core support panel 166. The foot support panel 340 now extends at 60 degrees. The backrest support panel 164 is also further raised until about 60 degrees. These movements can be operated simultaneously.

Then, as illustrated on FIG. 50, the frame 160 is lowered to a low position through the retraction of the elevation columns 202, 204. As shown in FIG. 51, the foot support panel 340 is then retracted to its shortest position to provide support for the foot of the patient lying on the bed 300 which can thus slightly change his position for more comfort in taking support on the footboard 124. Then, as shown in FIG. 42, the footboard 124 is removed.

FIG. 53 shows the last step of the sequence to attain the full chair position. At this step, the head elevation column 202 is raised while the foot elevation column 204 is not operated to incline the frame 160 of 18 degrees relative to the horizontal. The thigh support panel 168 is lowered from 25 degrees to 18 degrees relative to the horizontal. The foot support panel 340 now extends at 78 degrees relative to the horizontal. The backrest support panel 164 is also further raised from 60 degrees to 70 degrees to extend at 88 degrees relative to the horizontal. In this last step and also during the entire chair sequence, pressures in the various sections of the mattress may also be varied since the distribution of the patient weight thereon changes. This may also help in preventing the patient from slipping towards the foot end of the bed 300. In one embodiment, at this last step, the foot section and the thighs section of the mattress may be deflated to ease chair egress. Additionally, the backrest portion of the mattress may be inflated to further ease the egress of the patient in providing a push motion on the backrest of the patient. All these operations can be simultaneously performed.

FIGS. 54A and 54B show the bed 300 in the final full chair position. At it should now be apparent, the backrest support panel 164 extends at 88 degrees relative to the horizontal and the foot support panel 340 extends at 78 degrees relative to the horizontal. The core support panel 166 which supports the seat of the patient is sufficiently low so as to further ease the patient egress from the chair. The skilled addressee will appreciate that the foot support panel 340 provided with the double independent motorized mechanism described above is of great advantage for reaching such a low height for the seat. As it should now be apparent, this foot support panel 340 enables a low height for the seat while offering variable length for the patient surface up to 88 inches.

Now that a full chair sequence has been described, a cardiac chair sequence will be described with reference to FIGS. 55 to 58. When the bed 300 is in a full chair position, the patient can egress from the foot end of the bed 300, as like getting up from a chair. For the cardiac chair position, the patient will not egress from the bed 300 from the front, but rather, from a side of the bed 300, after the corresponding siderail has been lowered, as it should be apparent to the skilled addressee.

FIG. 55 shows the bed 300 in an initial typical bed position before the cardiac chair sequence begins. FIG. 56 shows the first step of the sequence: the backrest support panel 164 is raised of 30 degrees while the thigh support panel is raised to 18 degrees, as illustrated. These two movements are simultaneously performed. At this point, the raising of the thighs support panel 168 has driven the pivotal of the foot support panel 340 of 11 degrees, as illustrated.

At this point, as illustrated on FIG. 57, the subframe assembly 450 is only partially retracted inside the frame 160, which drive the pivotal raising movement of the foot support panel 340 connected thereto, as well as the pivotal raising movement of the thigh support panel 168 which is connected to the foot support panel 340. Additionally, the thigh support panel 168 is further raised to extend at an angle of 25 degrees with respect to the core support panel 166. The foot support panel 340 now extends at 30 degrees. The backrest support panel 164 is also further raised until about 70 degrees. These movements can be operated simultaneously.

Then, as illustrated on FIG. 58, the elevation columns 202, 204 are operated to incline the frame 160 of 16 degrees relative to the horizontal, similarly to a reversed Trendelenbourg position. The thigh support panel 168 still extends at 25 degrees relative to the horizontal. The foot support panel 340 now extends at 46 degrees relative to the horizontal. The backrest support panel 340 now extends at 86 degrees relative to the horizontal. At it should be apparent to the skilled addressee, the cardiac chair position has been reached with a foot support panel 340 adapted for a patient support surface of 80 inches long.

Referring now to FIGS. 59A to 60G, there is shown another frame assembly 460 for a bed 300, according to one embodiment, that can provide improved stability to the bed, as it will become apparent below. This is of great advantage for use on a bariatric bed with lateral and longitudinal extensions where weight constraints may be complex and costly to handle. Moreover, as it will be detailed below, this may enable to further incline the foot panel 330, 340, 380 or 1330 proximate the vertical, to further enhance the full chair positioning.

FIGS. 60A to 60G show a main frame 462 and a sliding subframe 464 similar in some aspects to the ones previously described with reference to FIGS. 45A to 46D. However, in this illustrated embodiment, a mechanical structure is further provided for enabling a sliding movement of the main frame 462 with respect to the base 106 of the bed 300 onto which the elevation columns 202, 204 are fixedly mounted. FIGS. 60A to 60G are side views of a bed 300 illustrating an operating exemplary sequence of movement between a flat bed position and a full chair position. FIGS. 59A to 59G are similar to the side views of FIGS. 60A to 60G except that the subframe 464 is shown in a section view.

Accordingly, as shown in FIGS. 59A and 60A, the subframe actuator 466 is fully extended such that the subframe 464 is fully extended in the deployed position. The head and foot elevation columns 202, 204 are each provided with an attaching pivot 468, 470 on each side thereof cooperating with the main frame 462 for providing a pivotal connection therebetween. The main frame 462 has an elongated head slot 472 and an elongated foot slot 474, each for slidably receiving the corresponding attaching pivot 468, 470 therein. The subframe 464 is mounted into the main frame 462 through a gas spring 476 connected between the main frame 462 and the foot attaching pivot 470. The gas spring 476 is mounted in compression into a subframe slot 478 of the subframe 464 to keep the main frame in the illustrated position where the attaching pivots 468, 470 are pushed against the right portion of the corresponding elongated slot 472, 474 of the main frame 462. The gas spring 476 is chosen so as to maintain the main frame 462 in this position until the subframe actuator 466 is operated. It should be apparent to the skilled addressee that the structure described above is for one of the elongated spars of the main frame 462 and that the same structure is reproduced with the other elongated spars of the main frame 462.

As previously described, to reach the full chair position, the thigh support panel 168 is first raised to 18 degrees, as illustrated in FIGS. 59B and 60B. Then, the subframe 464 will be progressively retracted into the main frame 462, as shown in FIGS. 59C and 60C where the subframe 464 has been retracted of 4 inches into the main frame 462. At this point, the gas spring 476 still retains the main frame 462 in the same position relatively to the elevation columns 202, 204. In FIGS. 59D and 60D, the subframe 464 has been retracted of 6 inches into the main frame 462. At this point, the gas spring 476 still retains the main frame 462 in the same position relatively to the elevation columns 202, 204. However, it should be noted that at that point in the sequence, the foot attaching pivot 470 is now resting against the subframe slot 478, as better shown in FIG. 59D.

In FIGS. 59E and 60E, the subframe 464 has now been retracted of 2 additional inches to reach 8 inches into the main frame 462. Since the foot attaching pivot 470 is now resting against the subframe slot 478, the 2 additional inches of subframe retraction have slidably moved the main frame 462 of 2 inches onto the right with respect to the two elevation columns 202, 204. As illustrated, the gas spring 476 has been 2 inches compressed. In FIGS. 59F and 60F, the subframe 464 has now been retracted of 2 additional inches to reach 10 inches into the main frame 462 in its fully retracted position. In this fully retracted subframe position, the main frame 464 has slidably moved of 2 additional inches onto the right to reach a complete sliding distance of 4 inches. The foot attaching pivot 470 is still resting against the subframe slot 478 and the gas spring 476 is now 4 inches compressed.

In order to reach the final full chair position, the main frame 462 is now positioned in the inversed Trendelenburg position, as illustrated in FIGS. 59G and 60G. In this position, it should be noted that the elongated head slot 472 of the main frame 462 is configured to allow a further movement of the main frame 462 with respect to the head attaching pivot 468.

FIG. 60H illustrates a main frame 462 and subframe 464 assembly generally similar to the one previously described in the lowermost position of the elevation columns 202, 204 to show a typical encumberment of such bed.

With reference to FIGS. 61 to 66G, there is shown another embodiment of a sliding subframe assembly 1450. In this embodiment, the sliding subframe comprises a pair of sleeves 1500, 1502 extending longitudinally, a head sliding portion 1504 pivotably mounted onto head elevation column(s) 202 or 302 (or lever(s) if a lifting mechanism such as the ones described US Publication No. 2019/0358104 by the same Applicant, which is hereby incorporated by reference in its entirety), and a foot sliding portion 1506 coupled to foot support panel 330, 340, 380 or 1330. Each of the sleeves 1500, 1502 is an elongated rectangular tube having a head end 1510 and a foot end 1512. The head sliding portion 1504 is comprised of two head sliding members 1514, 1516, also having the general shape of rectangular tubes, but dimensioned slightly smaller than the sleeves 1500, 1502 so as to be slidably receivable therein. As best shown in FIGS. 62B and 63, a foot end 1518 of each of the head sliding members 1514, 1516 is slidably received in a corresponding sleeve 1500, 1502, allowing a sliding movement of each sleeve 1500, 1502 relative to its corresponding head sliding member 1514, 1516, while a head end 1520 of each of the head sliding member 1514, 1516 protrudes outwardly from the sleeves 1500, 1502, in order to allow pivotably mounting the head sliding portion 1504 to the head elevation column(s) 202 or 302 or lever(s), as the case may be. Since the head sliding member 1504 cannot effectuate a translation movement relative to the elevation column(s) 202 or 302 or lever(s), but allow sliding or translation of the sleeves 1500, 1502 relative thereto, the head sliding portion 1504 provides the sleeves 1500, 1502 of the sliding subframe assembly 1450 with the ability to slide or translate relative to elevation column(s) 202 or 302 or lever(s) in a longitudinal direction.

Much like the head sliding portion 1504, the foot sliding portion 1506 comprises a pair of foot sliding members 1522, 1524, also having the general shape of rectangular tubes, but dimensioned slightly smaller than the sleeves 1500, 1502 so as to be slidably receivable therein. As best shown in FIGS. 62B and 63, a head end 1526 of each of the foot sliding members 1522, 1524 is slidably received in a corresponding sleeve 1500, 1502, allowing a sliding movement of each foot sliding member 1522, 1524 relative to its corresponding sleeve 1500, 10502, while a foot end 1528 of each of the foot sliding members 1522, 1524 protrudes outwardly from the sleeves 1500, 1502, in order to allow coupling of the foot sliding portion 1506 with foot support panel 330, 340, 380 or 1330. Provided at the foot end 1528 of each foot sliding members 1522, 1524 is a stopper 1530 collaborating with the sleeves 1500, 1502 to restrict movement of the foot sliding members 1522, 1524 into the sleeves 1500, 1502, as it will become apparent below.

Mounted proximal to the foot end of each sleeve 1500, 1502 is a sliding bracket 1541 for pivotably and slidably mounting the foot elevation column(s) or lever(s) to the sleeves 1500, 1502 of the sliding subframe assembly 1450. Each slidable bracket 1541 comprises a cylinder 1542 provided with a pair of longitudinal slots 1544, and a spring element 1546 (e.g. gas cylinder) mounted inside the cylinder 1542, with the head end 1548 thereof attached to the head end 1550 of the cylinder 1542. A jacket 1554 coupled to the foot elevation column(s) is slidably mounted about the cylinder 1542, and a bolt 1556 engaging the jacket 1554 and extending transverse to the cylinder 1542, through the longitudinal slots 1544, engages the foot end 1558 of the spring element 1546. In this configuration, the spring element 1546 is configured to bias the bolt 1556, and therefore the jacket 1554 and the column(s) attached thereto, toward the foot end 104 of the bed 100 or, conversely, to bias the sleeves 1500, 1502 of the sliding subframe assembly 1450 toward the head end 102 of the bed 100, relative to the elevation column(s).

Extending between the sleeves 1500, 1502 are first cross-member 1560 located in an intermediate location between the head end and the foot end of the sleeves 1500, 1502, and second cross-member 1561 located at the foot end and a third cross-member 1563 located at the head end. The first cross-member 1650 is used to secure a head end 1564 of a linear actuator 1562. A foot end 1568 of the actuator 1562 is operatively coupled to the foot sliding assembly 1506 via a fourth cross-member 1569 (and thus to with foot support panel 330, 340, 380 or 1330). When the actuator 1562 is in an extended position (as shown in FIGS. 65A and 65B), the foot sliding assembly 1506 is in an extended position and the foot support panel 330, 340, 380 or 1330 is coplanar with the foot sliding members 1522, 1524. As the linear actuator 1562 is gradually moved toward a retracted position, it urges the foot sliding members 1504 inside the sleeves 1500, 1502, thus causing the foot support panel 330, 340, 380 or 1330 and the thigh support panel 168 toward one another, thus lifting them at their junction, until stoppers 1530 provided on the foot end 1528 of the foot sliding members 1522, 1524 abut against the foot ends of the sleeves 1500, 1502 (as shown in FIGS. 66A and 66B). At that point, the force of the linear actuator 1562 overcomes the spring bias of the spring element 1546, and the compression of the spring element 1546 allows the bolt 1556 and the jacket 1554 to move relative to the cylinder 1542, toward the head end 1552. Incidentally, this further movement of the actuator 1562 toward the retracted position (best shown in FIGS. 67A and 67B) urges the head end 1564 thereof, along with the cross member 1560 and the sleeves 1500, 1502 attached thereto towards the foot end 104 of the bed 100. In other words, the jacket 1554 mounted to the elevation column(s) 202 or 302 remain in position, and the sleeves 1500, 1502 translate or slide toward the foot end 104 of the bed 100, relative to the jacket 1554. As the sleeves 1500, 1502 move, and since the head sliding portion 1506 does not translate relative to the head elevation column(s) 202 or 302, the sleeves 1500, 1502 also translate relative the head sliding portion 1506, but also relative to the foot sliding portion 1504. As it will now be understood, the principles and advantages described in connection with sliding subframe 450 also apply to sliding subframe 1450, with proper adaptation.

As the skilled addressee will now appreciate, the sliding subframe arrangements 450 and 1450 previously described enables to have a longer base offering an improved stability when the bed extends in the fully flat extended position. This is especially useful for a bariatric bed designed for 800 lbs of load capacity. In fact, the inventors of the present invention realized that due to the desired load capacity of 800 lbs and the requirement of a short base to give space to the foot portion in the full chair position, the length of the base was constrained. Providing the above described sliding subframe arrangement in combination with a longer base would prevent any stability issues that could otherwise arrived. Indeed, by moving the frame towards the foot of the bed with the sliding subframe, it is possible to extend the base and thus bring the support point of the casters closer to the foot of the bed.

In addition to providing enhanced stability to the bed 300, the full chair position may also be improved. Indeed, instead of an angular position of the foot support panel 340 of 78 degrees, as mentioned above according to one embodiment, an angular position up to 85 degrees may be obtained. This is of great advantage to further facilitate the patient egress from the bed 300, as it should now be apparent. The skilled addressee will also appreciate that this arrangement may provide more freedom for the caster wheels positioning. Moreover, the possibility of using an extended base for a bed having a low height full chair position provides more volume available to place the various components required to operate and/or monitor the various functions which could be implemented in an ICU bed.

The skilled addressee will also appreciate that the bed 300 previously described can be laterally extended while extending in any bed position thereof. For example, the bed can be laterally extended even in the full chair position or in the cardiac chair position or in any other positions.

Referring now to FIGS. 67 to 68D, there is shown a CPR pedal mechanism 500 for mechanically activating the CPR system located above the frame 160 of the bed 300. During emergency procedure, the patient has to be quickly moved into a flat position for receiving cares. Typically, the caregiver has to activate a mechanical mechanism so that the various sections of the deck are moved into a flat position. This mechanical mechanism 500 activated with foot may free the hands of the caregiver busy with the urgent care procedure for the patient.

As shown in FIGS. 67 to 68B, the CPR pedal mechanism 500 has left and right CPR pedals 502, 504 extending on each side of the bed 300 and connected together through a transverse shaft 506. In the illustrated embodiment, the CPR pedals 502, 504 extend at the head end of the bed 300 but a central location along the bed 300 may be preferred. The CPR pedals 502, 504 have a rest position and an activated position where the transverse shaft 506 is pivoted with the CPR pedals 502, 504. The transverse shaft 506 has an integral projection 508 pivoting therewith that cooperates with a bevel gear 510 of a gear box 512 according to a rack and pinion principle to transmit the pivoting movement of the transverse shaft 506 to a vertical telescopic shaft 514 which is then rotated accordingly. In the illustrated embodiment, the vertical telescopic shaft 514 is a hexagonal and spline telescopic shaft. As better shown in FIG. 68C, in one embodiment, the vertical telescopic shaft 514 has a lower hexagonal portion 516 connected to the gear box 512, a middle portion 518 connected to the lower portion 516 through a plastic guide 520 and a upper spline tubing portion 522. A lever 524 is fixed at the top of the upper portion 522. The lever 524 pivots with the CPR pedals 502, 504 such that the CPR command can be mechanically transmitted from the base 106 of the bed 300 to above the frame 160 through the telescopic shaft 514. The lever 524 can be connected to a mechanical cable (not shown) operating the CPR sequence of the bed 300.

As better shown in FIG. 68D, the gear box 512 is provided with a limit switch 524 and a cam 526. FIG. 68D also shows a spring 528 mounted with the transverse shaft 506 for returning the CPR pedals 502, 504 to the rest position when the caregiver stops his activation.

In one embodiment, the vertical telescopic shaft 514 is mounted inside the head elevation column 202 and telescopically retract and deploy therewith. In FIG. 69, the vertical telescopic shaft 514 is mounted inside a telescopic guiding channel 530 provided inside the head elevation column 202, more particularly between the stages 240-248 and the cosmetic covers 210, 212, 214. In the embodiment of FIG. 70, similar telescopic guiding channels 532 provided proximate the stages 240-248 and inside the cosmetic covers 210, 212, 214 are also used.

FIGS. 71A to 71D illustrate a CPR bed sequence according to one embodiment when the bed 300 is in the full chair position. The caregiver will first press and hold one of the spring-loaded CPR pedals 502, 504. The pivotal movement of the CPR pedal 502, 504 is transmitted through the gear box 512 to a rotation of the vertical telescopic shaft 514. The vertical telescopic shaft 514 rotates the upper lever 524 at the top thereof that pulls on the mechanical cable attached to the head patient surface actuator (not shown). The quick release for the CPR on the head patient surface motor is engaged. Additionally, the cam 526 of the gear box 512 activates a toggle switch (not shown) which sends a signal to the main PCB that the CPR pedal 502, 504 have been activated.

If the bed 300 is in the chair position, as illustrated in FIG. 71A, or in the reverse Trendelenburg position, an electronic signal will be sent to the main PCB to immediately lower the head elevation column 202 and raise the foot elevation column 204 until the bed 300 is in a fully flat position. In the full chair position, the columns 202, 204 can be move before the backrest support panel 164 since it is almost perpendicular with the floor. The thigh and foot motor operating the thigh support panel 168 and the foot support panel 340 will be activated to bring the patient support surface to a complete flat position.

In a further embodiment, in parallel to the motor's activation, the main PCB will send a signal for inflating the mattress to a maximum inflated state, as detailed below. Depending on a particular application and corresponding mattress, it may alternatively be considered to deflate the mattress to maximum.

When the patient surface is fully flat and the head and foot elevation columns 202, 204 extend substantially at the same height, the two elevation columns 202, 204 begin to move toward the lower position. Releasing the CPR pedal 502, 504 will stop the lowering movement at the desired height. Such sequence may be completed in less than 45 seconds, irrelevant of the initial position of the bed 300. The bed 300 and the mattress will remain in this position until the CPR procedure is ended on the nurse control interface. If the CPR pedal 502, 504 is released at any time during the procedure, any movement immediately stops.

FIGS. 72A, 72B and 72C show a backrest support panel 540 similar to the one shown in FIG. 1, according to one embodiment, at 70 degrees, 30 degrees and 0 degree. FIGS. 73A, 73B and 74 show a similar backrest support panel 550 provided with lateral width extensions 552, 554 in the extended position. As better shown in FIG. 73A, the backrest support panel 550 is provided with a fluoroscopy window 551 extending substantially centrally therein. In one embodiment, the fluoroscopic window 551 is 18 inches per 24 inches. As it should now be apparent to the skilled addressee upon reading of the present description, the 24 inches width is not obstructed with the width extensions 552, 554 when in the fully retracted position, as illustrated in FIG. 72D.

As better shown in FIG. 73B the backrest support panel 550 is provided with a pivoting support sheet or cover 556 pivotally connected to the lower end of the backrest support panel 550 adjacent the core support panel 166. The fluoroscopic window 551 is embedded with this pivoting support sheet 556. This pivotal support sheet 556 allows access to the various part located therebelow for facilitated cleaning. As better shown in FIG. 74, the space located below the fluoroscopic window 551 when the bed 300 is in a flat position is free from any bed parts to enable a convenient fluoroscopy procedure.

FIGS. 75A, 75B and 75C show a backrest support panel 1540 according to another embodiment, at 70 degrees, 30 degrees and 0 degree, respectively. FIGS. 76A, 76B and 77A, 77B show a similar backrest support panel 1550 provided with lateral width extensions 1552, 1554 in the extended position. As better shown in FIGS. 76A to 77B, the backrest support panel 1550 is provided with a fluoroscopy window 1551 extending substantially centrally therein. In one embodiment, the fluoroscopic window 1551 is 35 inches wide per 35.5 inches long when the backrest support panel is resting flat. As it should now be apparent to the skilled addressee upon reading of the present description, the width of the fluoroscopic window is not obstructed by the width extensions 1552, 1554 when they are in the fully retracted position, as illustrated in FIG. 75D.

As better shown in FIGS. 76B and 77B the fluoroscopic window 1551 is pivotally connected to the lower end of the backrest support panel 1550 adjacent the core support panel 1166. The pivoting of the fluoroscopic window 1551 allows access to the various part located therebelow for facilitated cleaning. As better shown in FIGS. 77A and 77B, the space located below the fluoroscopic window 1551 when the bed 300 is in a flat position is free from any bed parts to enable a convenient fluoroscopy procedure.

FIGS. 78A and 78B show a build-in pivotable shelf 582 that is rotatably mounted to the footboard 584 of the bed 580. The pivotable shelf 582 has a rest position where the shelf 582 is pivoted downwardly and extends along the footboard 584, in a specially designed shelf recess 586, as shown in FIG. 78B. The pivotable shelf 582 also has an operative position where the shelf 582 is pivoted to 270 degrees to extend substantially horizontally above the bed 580. In the illustrated embodiment, the pivotable shelf 582 has a main tray 588 and two mounting projections 590, 592 adapted for connecting to the footboard 584. The footboard 584 has an upper bar 596 around which the two mounting projections 590, 592 are pivotally mounted. In this proposed embodiment, the pivotable shelf 582 is not removable and the pivotal mounting projections 590, 592 are built-in with the footboard 584 to ease cleaning of the bed 580. The pivotal shelf 582 is also provided with a stopper (not shown) embedded with the mounting projections 590, 592 for retaining the main tray 588 in the substantially horizontal operative position. Such built-in shelf 582 is easy to operate and provides the user with a support surface useful for supporting various medical apparatus during the transport of the patient between two locations. In a further embodiment, the pivotable shelf 582 may be provided with attaching means and/or specially designed apertures (not shown) devised to enable the attachment of straps which may be used for maintaining the medical apparatus on the tray 588 during transport. In still a further embodiment, the pivotal shelf 582 has a recessed gripping portion 594 for facilitating the operation thereof by a user between the rest position and the operative position.

FIGS. 79A to 80F show another embodiment of a build-in pivotable shelf 1582 that is rotatably mounted to a footboard 1584. Much like pivotable shelf 582, the pivotable shelf 1582 has a rest position where the shelf 1582 is pivoted downwardly and extends along the footboard 1584, in a specially designed shelf recess 1586, as shown in FIGS. 79A to 79F. The pivotable shelf 1582 also has an operative position where the shelf 1582 is pivoted to 270 degrees (in a counterclockwise direction having regard to FIGS. 80A to 80F from the rest position to extend substantially horizontally above the bed 580. In the illustrated embodiment, the pivotable shelf 1582 has a main tray 1588 and a mounting sleeve 1590 adapted for connecting to the footboard 1584. More specifically, the footboard 1584 has an upper bar (not shown) around to which is pivotally assembled the mounting sleeve 1590. In this proposed embodiment, the pivotable shelf 1582 is not removable and the pivotal mounting sleeve 1590, is built-in with the footboard 1584 to ease cleaning of the bed 580. The footboard 1584 is also provided with a stopper 1596 for retaining the main tray 1588 in the substantially horizontal operative position when the pivotable shelf 1582 is in open position. Like built-in shelf 582, built-in shelf 1582 is easy to operate and provides the user with a support surface useful for supporting various medical apparatus during the transport of the patient between two locations. In a further embodiment, the pivotable shelf 1582 may be provided with attaching means and/or specially designed apertures (not shown) devised to enable the attachment of straps which may be used for maintaining the medical apparatus on the tray 1588 during transport. In still a further embodiment, the pivotal shelf 1582 has a recessed gripping portion 1594 for facilitating the operation thereof by a user between the rest position and the operative position.

Referring now to FIGS. 81 to 107, an inflatable therapeutic mattress 600 usable in combination with a bed such as the ICU bed previously described as a non-limitative example will now be described. As it will become apparent below, the mattress 600 includes various controlled inflatable components in fluid communication with a pneumatic system (not shown) for providing enhanced comfort to the patient. In a further embodiment, the mattress 600 may also be configured to provide a range of therapeutic functionalities as well as other useful functionalities, as it would become apparent below. In one embodiment, a control unit and associated user interface (not shown) is integrated to the bed and enables to operate and control the mattress 600 as desired.

FIG. 81 illustrates a mattress 600 provided with an external cover 602 devised to be used on a supporting patient surface of a bed, according to one embodiment. FIG. 82 shows, in a partially exploded view, the same mattress 600 with the external cover 602 removed.

As better shown in FIG. 82, the mattress 600 is provided with a body section 604 having a lower support layer 606 and an upper comfort layer 608 mounted above the lower support layer 606. The mattress 600 also has a head section 610 adjacent a head end 612 of the body section 604 and a foot section 614 adjacent the foot end 616 of the body section 604. Right and left side sections 618, 620 are also provided on a corresponding longitudinal right and left side of the body section 604 of the mattress 600, as detailed below.

Referring now to FIG. 83, each of the right and left side sections 618, 620 has a longitudinal inflatable support bladder 622, 624 extending adjacent the body section 604, also called a longitudinal support bolster 622, 624. Each right and left side sections 618, 620 is also provided with a width extension 626, 628 extending adjacent the longitudinal inflatable support bladder 622, 624 outwardly therefrom, as described below. It will be appreciated throughout the present description that the width extensions 626, 628 may be omitted for a particular application.

Referring now to FIG. 84, there is shown a mattress 600 as previously described but without the width extensions 626, 628. As illustrated, the mattress 600 is provided with a main compartment 630 adapted for enclosing and retaining together the body section 604, the head section 610, the foot section 614, and the longitudinal inflatable support bladders 622, 624 of the side sections 618, 620. This main compartment 630 snuggly fits the mattress sections to thereby provide sufficient structural integrity and rigidity to the mattress 600, as it will become apparent below.

The lower support layer 606 will now be described with reference to FIGS. 82 and 85. The lower support layer 606 has a plurality of elongated support bladders 632, each having an inner chamber (not shown) that is inflatable. The illustrated elongated support bladders 632 have a cylindrical shape but other shapes may be used. The elongated support bladders 632 are mounted together side by side and extend transversally across the width of the body section 604 of the mattress 600. In one embodiment, the plurality of elongated support bladders 632 may be integral to each other, for example, they may be formed in the same material sheet with convenient separation welding lines. However, to ease maintenance of the mattress 600 and to allow a cost-effective replacement of an eventual defective elongated support bladder 632, it may be advantageous to provide independent elongated support bladders 632 that are attached together, as in the illustrated embodiment.

Each of the elongated support bladders 632 has at least one fluid communication port 634, such as a fluid inlet and/or a fluid outlet, in fluid communication with the corresponding inner chamber and a fluid distribution system (not shown) described below. In one embodiment, each of the elongated support bladders 632 has a single fluid communication port 634. In another embodiment as the one illustrated, a fluid inlet 636 and a fluid outlet 638 are provided on each opposed end of the elongated support bladders 632. As it should be understood, each elongated support bladders 632 may be controlled independently from the others.

As illustrated in FIG. 85, to ease control of the mattress 600 and provide optimal comfort to the patient in the various positions of the bed, in one embodiment, the elongated support bladders 632 may be grouped into a plurality of zones providing various firmness. For example, a torso zone 640, a seat zone 642 and a legs zone 644 may be defined. In this example, all the elongated support bladders 632 of a same zone are operated at the same pressure with corresponding pneumatic hardware, but distinct pressures may be obtained for each zone 640, 642, 644. Such embodiment enables distinct firmness controls for each zone, to better accommodate the pressure points of the patient and enhance his comfort.

In the illustrated embodiment, the lower support layer 632 has 16 elongated support bladders 632, 5 for the torso zone 640, 5 for the seat zone 642 and 6 for the leg zone 644 but various other arrangements could be considered. In an exemplary embodiment, the elongated support layers 632 have a length of about 30 inches and a thickness of about 5 inches when fully inflated. The elongated support bladders 632 may be operated at a fluid pressure varying between 0 and 60 mmHg, depending on the patient specificities and the various therapies or functionalities that can be activated, as it would become apparent below.

Still referring to FIG. 85 which shows the lower support layer 606 alone, and also to FIG. 86 showing a portion of the mattress 600 without the lower support layer 606, the lower support layer 606 has an attaching strap 646 configured to attach and retain the elongated support bladders 632 together and also to prevent spacing therebetween under load of the patient lying on the mattress 600. In the illustrated embodiment, the attaching strap 646 extends longitudinally between the head section 610 and the foot section 614 of the mattress 600 and is attached thereto. The attaching strap 646 is provided with a plurality of adjacent loops 648 connected together, each being devised to receive a corresponding elongated support bladder 632 therethrough. In one embodiment, the adjacent loops 648 are welded together. In a further embodiment, each loop 648 has a clip or button that is detachable to open the loop to allow easy removal of the elongated support bladder 632, should it be required. In one embodiment, the attaching strap 646 may further have additional clip or button to attach the lower support layer 606 to the bottom of the compartment 630, as detailed below.

In the illustrated embodiment, a single attaching strap 646 extending centrally with respect to the elongated support bladders 632 is used but it may be considered to attach the elongated support bladders 632 together with two or more elongated attaching straps 646.

Referring now to FIG. 87 and still to FIG. 86, each of the elongated support bladders 632 is also attached laterally to both of the two longitudinal support bolsters 622, 624 extending adjacent thereto. In the embodiment illustrated in FIG. 87, each of the elongated support bladders 632 is provided with first and second attaching elements 650 respectively extending at one of the longitudinal ends thereof, each being removably attachable to a corresponding attaching element 652 mounted with one of the two longitudinal support bolsters 622, 624, shown in FIG. 86, preferably on an inwards face thereof facing the elongated support bladders 632. In one embodiment, the first and second attaching elements 650 of the elongated support bladders 632 have a clip portion clippable with a corresponding clip portion of the corresponding attaching element 652 of the elongated support bladders 622. As it should be apparent, such arrangement enables easy replacement of any elongated support bladders 632. Various other arrangements may be considered to attach the elongated support bladders 632 to the two longitudinal support bolsters 622, 624.

In a further embodiment, the two longitudinal support bolsters 622, 624 are also attached to an inner side of the compartment 630, for example with similar attaching elements 650, 652 provided both on the inner side of the compartment 630 and the facing outwards face of the longitudinal support bolsters 622, 624, as it should now be understood to the skilled addressee.

FIGS. 88 to 91 show in more details the upper comfort layer 608 illustrated in FIG. 82. The upper comfort layer 608 has an integral sheet 660 provided with a plurality of comfort bladders 662 arranged side by side on the entire surface of the integral sheet 660. The upper comfort layer 608 is installed on the top of the support layer 606 and is devised to provide enhanced comfort to the patient lying on the mattress 600. In a further embodiment, the lower support layer 606 may also provide a therapy to the patient, as detailed below.

In the illustrated embodiment, the comfort bladders 662 have a diamond shape and are mounted in a plurality of lines 664 extending laterally across the upper comfort layer 608 in a staggered arrangement, as better shown in FIGS. 89 and 90. Each of the comfort bladders 662 defines an inner inflatable chamber 666 that is fluidically connected to an adjacent comfort bladder 662 of the same line 664 through a fluid passage 668 to define an inflatable line 664.

The upper comfort layer 608 also has first and second longitudinal fluid distribution channels 670, 672 respectively extending on both lateral side of the upper comfort layer 608 to provide fluid to the inflatable lines 664. In the illustrated embodiment, the first longitudinal fluid distribution channel 670 is fluidically connected to a first group 663 of a plurality of inflatable lines 664 while the other longitudinal fluid distribution channel 672 is fluidically connected to a second group 665 of the remaining of the inflatable lines 664, in an interspersed manner. In other words, the inflatable lines 664 “1, 3, 5 . . . ” are connected to the same longitudinal fluid distribution channel 670 while the inflatable lines 664 “2, 4, 6 . . . ” are connected to the other longitudinal fluid distribution channel 672. In the illustrated embodiment, the first and second longitudinal fluid distribution channels 670, 672 are integrally formed with the comfort bladders 662 within the integral sheet 660 but separated longitudinal fluid distribution channels 670, 672 may alternatively be used.

The two longitudinal fluid distribution channels 670, 672 are fluidically connectable to a pneumatic system (not shown), as detailed below. With such an arrangement, inflation and deflation of the first and second groups of inflatable lines 664 may be independently controlled.

The previously described arrangement may be useful for implementing an alternating pressure therapy to a patient. Indeed, to implement such therapy, the first and second groups of inflatable lines 664 are inflated and deflated according to a predetermined timed sequence in an alternating manner such that two adjacent lines 664 are not in the same state but rather in an opposed inflated/deflated state. Such alternating pressure therapy enables to minimize continuous pressure on the same pressure points between the patient and the mattress 600 to thereby reduce skin issues to the patient.

In a further embodiment, similarly to lower the support layer 606, the upper comfort layer 608 may be separated into a plurality of zones controllable independently. For example, a torso zone 674, a seat zone 676 and a legs zone 678 may be defined. In this example, all the inflatable lines 664 of a same zone can be operated at the same pressure with corresponding pneumatic hardware, but distinct pressures may be obtained for each zone. Such embodiment enables distinct firmness controls for each zone, to better accommodate the pressure points of the patient and enhance his comfort. In one embodiment, the three zones 674, 676, 678 are defined to be aligned with the same zones defined in the lower support layer 606. A valve arrangement using two levels of valves in series may be used to allow an alternating pressure therapy and a zones control.

Referring again to FIG. 83, in the illustrated embodiment, the upper comfort layer 608 is rectangular and is received between the side sections 618, 620, the head section 610 and the foot section 614. In one embodiment, the upper comfort layer 608 may be removably attached to at least one of the sides, head and foot sections 618, 620, 610, 614, with corresponding attaching elements similar to the ones used for attaching the lower support layer 606 to the side sections 618, 620, as previously described. In addition, or alternatively, the upper comfort layer 608 may be attached to the longitudinal attaching strap 646 retaining the elongated support bladders 632 of the lower support layer 606 together.

The upper comfort layer 608 may take various shape configurations. For example, instead of being nested between the adjacent side sections 618, 620, the upper comfort layer 608 may be configured to extend over the two longitudinal support bolsters 622, 624 of the side sections 618, 620. The upper comfort layer 608 may also be configured to extend over the head section 610 or the foot section 614 or both. Various configurations may be envisaged.

In the illustrated embodiment, the upper comfort layer 608 is provided with 24 inflatable lines 664 of 5 inflatable comfort bladders 632. In one embodiment, the inflatable comfort bladders 632 are about 5 inches in length, about 2 inches in width, and about 2 inches in thickness when fully inflated to provide an upper comfort layer 608 of about 2 inches when fully inflated. Various other configurations may be envisaged for a particular application without departing from the scope of the present invention.

In another embodiment, instead of being integrally formed together in a single sheet 660, the inflatable comfort bladders 662 may be unitary pieces conveniently attached together.

The inflatable comfort bladders 662 may be operated at a fluid pressure varying, for instance, between 0 and 60 mmHg, depending on the patient specificities and the various therapies or functionalities that can be activated, as it would become apparent below.

Indeed, the upper comfort layer 608 may also be used to implement an immersion-flotation mode and a maximum inflation mode. In the immersion-flotation mode, which is useful as pressure redistribution therapy, the fluid pressure of the inflatable comfort bladders 662 of the upper comfort layer 608 is reduced to about between 4 and 32 mm Hg. This increases the contact surface between the patient and the top face of the upper comfort layer 608, thereby reducing pressure point to the patient. In the maximal inflation mode, the fluid pressure of the upper comfort layer 608 is increased to about between 32 and 60 mm Hg. This may enable to flatten and rigidify the top face of the upper comfort layer 608 to facilitate moving or repositioning the patient by the medical personnel.

As it should now be apparent to the skilled addressee, the body section of the mattress 600 provided with the lower support layer 606 and the upper comfort layer 608, each having a plurality of predefined independent zones as previously described, may enable a better control of how the patient interfaces with the mattress 600 in order the minimize skin injuries and discomfort.

In a further embodiment, the upper comfort layer 608 may be configured to further provide a percussion and vibration therapy to the patient. In one embodiment, additional percussion and vibration bladders (not shown) may be integrally formed with the sheet 660 embedding the inflatable comfort bladders 662. The additional percussion and vibration bladders are independent from the inflatable comfort bladders 662 and are controlled with additional dedicated valves. In an alternative embodiment, the percussion-vibration bladders are provided in a separated layer disposed above the upper comfort layer 608.

Referring again to FIGS. 83 and 84 and also to FIGS. 92 and 93, the head section 610 of the mattress 600 will now be described. The head section 610 has an inflatable head bladder 680 defining an inflatable head chamber disposed transversely across the head section 610 of the mattress 600. The inflatable head bladder 680 is substantially rectangular in shape and has two longitudinal reinforcement members 682, 684 extending inside the inflatable head chamber thereof between a top face and a bottom face thereof, so that three adjacent bulges are formed between the longitudinal reinforcement members 682, 684. Such reinforcement members 682, 684 enable to provide a substantially rectangular chamber when inflated with a flat inflated top surface for receiving the head of the patient.

As better shown in FIG. 92, the inflatable head bladder 680 may be removably attached to the inner main compartment 630 with corresponding attaching elements similar to the ones previously described, as it should now be apparent. The head bladder 680 may be further removably attached to the longitudinal attaching strap 646 attaching the elongated support bladders 632 together.

Exemplary fluid pressure provided to the head bladder 680 is between about 0 and 60 mm Hg, depending on the intended use and/or functionalities of the mattress 600. Particularly, when the patient is in a prone position with the face directly contacting the head bladder 680, the fluid pressure of the head bladder 680 is adjusted to about between 0 and 32 mm Hg.

In the embodiment illustrated in FIG. 69, the head bladder 680 is about 11 inches in length, about 35 inches in width, and about 5 in thickness when fully inflated. In the illustrated embodiment, the head bladder 680 is mounted above a pneumatic space 692 devised to receive a pneumatic control box (not shown) configured to control the mattress 600. The pneumatic control box may also be provided elsewhere. In this case, the pneumatic space 692 may be filled with an additional lower head bladder supporting the head bladder 680. Other arrangements using a plurality of head bladders 680 stacked one onto the other and/or arranged side by side and conveniently attached together may also be envisaged. In a further embodiment, the pneumatic control box is integrated to the mattress 600 below the leg portion of the mattress 600.

FIG. 94 shows one of the longitudinal bolsters 622, 624, the main compartment 630 of the external cover 602 being omitted. The longitudinal bolster 622 has an inflatable bolster bladder 694 defining an inflatable bolster chamber disposed longitudinally along the body section of the mattress 600. The inflatable bolster bladder 694 is substantially rectangular in shape and has two longitudinal reinforcement members 696, 698 extending inside the inflatable bolster chamber thereof between two opposed side faces thereof, so that three stacked bulges 700 are formed. Such reinforcement members 696, 698 enable to provide a substantially rectangular chamber when inflated, as illustrated. The longitudinal bolster 622 is attached to the other components of the mattress 600 with attaching elements, as previously described.

Exemplary fluid pressure provided to the two longitudinal bolsters 622, 624 is between about 0 and 60 mm Hg, depending on the intended use and/or functionalities of the mattress 600. For example, to provide structural rigidity to the mattress 600, including the body section, the two longitudinal bolsters 622, 624 may be inflated at a relatively high fluid pressure, such as about between 32 and 60 mm Hg. To facilitate egress of the patient from the left and right ends of the mattress 600 in a cardiac chair configuration, the two longitudinal bolsters 622, 624 may also be deflated at a relatively lower fluid pressure, such about between 0 and 32 mm Hg.

In the illustrated embodiment, the two longitudinal bolsters 622, 624 are about 2.5 to 3 inches in width, and about 7 to 8 in thickness when fully inflated. Other arrangements using a plurality of longitudinal bolsters stacked one onto the other and/or arranged side by side and conveniently attached together may also be envisaged.

FIG. 95 shows an inflatable foot bladder 702 of the foot section 614, the main compartment 630 of the cover 602 being omitted, according to one embodiment. The inflatable foot bladder 702 defines an inflatable foot chamber disposed transversally adjacent the foot end 612 of the body section of the mattress 600. The inflatable foot bladder 702 is substantially rectangular in shape and has one longitudinal reinforcement member 704 extending inside the inflatable foot chamber thereof between two opposed side faces thereof, so that two stacked bulges 705 are formed. The reinforcement member 704 enables to provide a substantially rectangular chamber when inflated, as illustrated.

The foot bladder 702 is attached at each of its longitudinal ends to the longitudinal side bolsters 622, 624 with attaching elements, as previously described. In a further embodiment, the foot bladder 702 is also attached at each of its longitudinal ends to the main compartment 630 with other similar attaching elements, as it should now be apparent and as better shown in FIG. 84. To further enhance the structural rigidity of the mattress 600, as better shown in FIG. 96, two longitudinal foot attaching straps 706, 708 may be used to attach the foot bladder 702 to the lower support layer 606, as illustrated. In this embodiment, each foot attaching strap 706, 708 define a loop 710 devised to receive the foot bladder 702 therethrough. Each foot attaching strap 706, 708 is also provided with attaching elements cooperating with corresponding attaching elements provided on the lower support layer 606 for retaining the various inflatable bladders together.

Exemplary fluid pressure provided to the foot inflatable bladder 702 is between about 0 and 60 mm Hg. However, in the case the patient heels are lying on this foot inflatable bladder 702, the foot bladder 702 may be inflated to a relatively low fluid pressure between about 0 and 32 mm Hg to provide an immersion mode for the heels of the patient to thereby minimize occurrence of pressure ulcers.

As already mentioned, the mattress 600 previously described may be used on an ICU bed having a full chair position. In this case, the foot bladder 702 may be completely deflated. As it will become apparent below, such configuration may enable to provide an ICU bed whose full chair position is advantageously sufficiently low to ease chair egress and ingress for the patient.

In the illustrated embodiment, the foot bladder 702 is about 8 inches in width, and about 8 inches in thickness when fully inflated. Other arrangements using a plurality of inflatable bladders stacked one onto the other and/or arranged side by side and conveniently attached together may also be envisaged.

To provide a mattress 600 accommodating taller patients, the foot section 614 of the mattress 600 may be further provided with an inflatable and deflatable foot extension section 712, as illustrated in FIGS. 71 and 61 showing the foot section 712 inflated. In the illustrated embodiment, the foot extension section 712 is provided with first and second foot extension bladders 714, 716, each defining an inflatable foot chamber therein. The first and second foot extension bladders 714, 716 are elongated bladders mounted transversally to the mattress 600, adjacent to the foot bladder 702, and are attached thereto. The first and second foot extension bladders 714, 716 can be independently inflated and controlled from each other, according to a particular application and as better detailed below. In some cases, the first foot extension bladder 714 only may be inflated to accommodate the patient.

Each of the first and second foot extension bladders 714, 716 is substantially rectangular in shape and has two longitudinal reinforcement members 718, 720 extending inside the inflatable foot chamber thereof between two opposed side faces thereof, so that three stacked bulges are formed. The reinforcement members 718, 720 enable to provide a substantially rectangular chamber when inflated, as illustrated.

Each of the first and second foot extension bladders 714, 716 is attached at each of its longitudinal ends to the main compartment 630 with attaching elements similar to the ones previously described, as better shown in FIG. 84. To further enhance the structural rigidity of the mattress 600, as better shown in FIGS. 94 and 97, two longitudinal first foot extension attaching straps 724, 726 may be used to attach the first foot extension bladder 714 to the foot bladder 702. Moreover, two longitudinal second foot extension attaching straps 728, 730 may be used to attach the second foot extension bladder 716 to the first foot extension bladder 714, as better shown in FIG. 97. In this embodiment, each foot extension attaching strap 724, 726, 728, 730 defines a loop 732 devised to receive the corresponding foot extension bladder 714, 716 therethrough. In one embodiment, the loops 732 longitudinally adjacent to each other are welded together. In a further embodiment, each loop 732 has a clip or button that is detachable to open the loop to allow easy replacement of the corresponding foot extension bladder 714, 716, should it be required. In a further embodiment, as illustrated in FIG. 84, the two longitudinal second foot extension attaching straps 728, 730 are also attached to the main compartment 630 through corresponding slot provided therein.

Exemplary fluid pressure provided to the foot extension bladders 714, 716 is between about 0 and 60 mm Hg. However, in the case the patient heels are lying on one foot extension bladder, the foot extension bladder may be inflated to a relatively low fluid pressure between about 0 and 32 mm Hg to provide an immersion mode for the heels of the patient.

In the illustrated embodiment, each of the first and second foot extension bladders 714, 716 is about 4 inches in width, and about 8 inches in thickness when fully inflated. Other arrangements using a plurality of inflatable bladders stacked one onto the other and/or arranged side by side and conveniently attached together may also be envisaged.

As already mentioned, the mattress 600 previously described may be used on an ICU bed having a full chair position. In this case, the foot extension bladders 714, 716 have to be completely deflated before reaching the full chair position.

Referring now to FIGS. 98 and 99, there is shown another embodiment of a mattress 600 that is provided with a rotation assist layer 734 that may be used to implement a continuously lateral rotation therapy (CLRT) and a turn-assist function (also known as tilt-assist function) to the patient. The CLRT is useful for administering pulmonary therapy to the patient, while the turn-assist function allows the caregivers to turn or reposition the patient more easily.

In the illustrated embodiment, the rotation assist layer 734 has left and right rotation bladders 736, 738, each defining an independent inflatable chamber therein. In the exemplary embodiment, the left rotation bladder 736 is shown in an inflated state while the right rotation bladder 738 is shown in a deflated state. As it should now be apparent, when used for CLRT, the left and right rotation bladders 736, 738 are alternatively inflated and deflated according to a predetermined sequence. When used for a turn assist function, a single rotation bladder is inflated.

The left and right rotation bladder 736, 738 are integrally formed within the same material sheet and are separated with a welding line. The illustrated rotation assist layer 734 has a rectangular shape providing the two elongated left and right rotation bladders 736, 738. In the illustrated embodiment, the rotation assist layer 734 does not extend on the whole length of the body section of the mattress 600 but is rather limited to the torso section and seat section of the lower support layer 606 of the mattress 600.

In the illustrated embodiment, the rotation assist layer 734 is positioned between the lower support layer 606 and the upper comfort layer 608. The rotation assist layer 734 can be removably attached to the lower support layer 606 through the longitudinal attaching strap 646 used for retaining the elongated support bladders 632 of the lower support layer 606 together. In such a case, the rotation assist layer 734 may be provided with attaching elements distributed on the bottom side of the central welding line thereof that cooperate with corresponding attaching elements distributed on the longitudinal attaching strap 646.

The skilled addressee will appreciate that the upper comfort layer 608 should not be attached to the longitudinal side bolsters 622, 624 when the rotation assist layer 734 previously described is used to allow free movement of the upper comfort layer 608 above the rotation assist layer 734. In a further embodiment, the upper comfort layer 608 may be attached on the top of the rotation layer 734, on the central welding line, through cooperating attaching elements as the ones previously described, as it should become apparent to the skilled addressee.

In one embodiment, each of the left and right rotation bladders 736, 738 is about between 30 and 55 inches in length and about between 5 and 15 inches, preferably 11 inches, in diameter when fully inflated. When fully inflated, such rotation bladders 736, 738 may rotate the patient at an angle of about 40 degrees.

Instead of using an integral sheet to provide the left and right rotation bladders 736, 738, it could be considered to provide two separated rotation bladders, either attached together, either attached to the lower support layer 606 only, or both. Each left and right rotation bladder 736, 738 may also be provided with additional rotation bladders, for example a first one of a smaller diameter proximate the longitudinal central portion of the mattress, a second one of a greater diameter adjacent thereto on a side thereof, and a third one of a greater diameter proximate the corresponding side section 618, 620 of the mattress 600.

The skilled addressee will appreciate that, in one embodiment, the upper comfort layer 608 may also be controllably inflated in conjunction with the rotation assist layer 734 for further enhancing the CLRT or turn assist function.

Referring now to FIGS. 100 to 102, the width extensions 626, 628 of each of the right and left side sections 618, 620 will now be described. As previously mentioned, these width extensions 626, 628 may be omitted for a particular application. In one embodiment, the width extensions 626, 628 are operated simultaneously to provide an extension of the mattress 600 on each side thereof, but it should be understood that a single width extension may be activated while the other is kept retracted. With the arrangement described below, the mattress 600 may be extended from a typical 35 inches width to an intermediate 40 inches width, and further to a 45 inches width.

In the illustrated embodiment, each width extension 626, 628 is provided adjacent the corresponding longitudinal support bolster 622, 624, outwardly therefrom. As better shown in FIG. 101, each width extension 626, 628 is provided with a first set 740 of stacked longitudinal inflatable bladders adjacent the longitudinal support bolster 622 and a second set 742 of stacked longitudinal inflatable bladders adjacent the first set 740. Each of the first and second sets 740, 742 has 3 stacked bladders in the illustrated embodiment but other arrangements may be considered. Each inflatable bladder may be independently inflated and deflated. In one embodiment, the width extension 626, 628 is arranged in three superposed integral inflatable layers 741, each layer 741 embedding a corresponding bladder of the first set 740 and a corresponding bladder of the second set 740, as illustrated in FIG. 103.

The width extensions 626, 628 are attached to the main compartment 630 previously described. More particularly, each width extension 626, 628 is attached to a corresponding longitudinal wall of the main compartment 630, outwardly thereto but adjacently to the longitudinal support bolster 622 mounted on the same longitudinal wall but inwardly therefrom. Attaching elements as previously described or attaching straps conveniently distributed and arranged may be used. FIG. 84 illustrates attaching portions provided on the main compartment 630 and devised to attach the width extension 626 thereto.

As better shown in FIGS. 102 and 103, the width extensions 626, 628 are further provided with foot width extensions 744 that are similar to the bladders arrangement previously described, i.e. they are arranged in a first and second sets of stacked bladders. They extend in longitudinal alignment with the longitudinal width extension bladders of the first and second set 740, 742. In one embodiment, as shown in FIG. 103, each of the stacked foot width extension portions 744 may be integrally formed with a corresponding one of the superposed integral inflatable layers.

As it should now be apparent, when a user activates the width extensions 626, 628, the corresponding foot width extensions 744 are similarly operated in order to provide a mattress 600 of a rectangular shape (without the length extension of the mattress). However, as previously detailed, in order to allow a full chair position of the bed on which the mattress 600 is mounted that is sufficiently low for the patient, the foot extension bladders 714, 716 have to be deflated. In this case, the foot width extensions 744 are also deflated. This arrangement enables to provide a combination of a bed and an associated mattress 600 that may be extended in width while being still adapted for a full chair position of a low height.

In one embodiment, in any of the width configurations, the more outwards longitudinal bladder of the side section 618, 620 is inflated at a higher pressure than the other longitudinal bladders of the side section. This provides an enhanced comfort to the user in providing rigid side bolsters. Thus, in the fully width retracted position, the width extensions 626, 628 are fully deflated while the longitudinal side bolsters 622, 624 are inflated at a predetermined pressure offering rigid side bolsters. When the mattress 600 is extended in width with the width extensions 626, 628, the longitudinal support bolsters 622, 624 of the side sections 618, 620 are slightly deflated at a lower pressure. The outwardly extending elongated bladders of the side sections 618, 620 are inflated at a higher pressure. With this configuration, the longitudinal side bolsters 622, 624 may be used as a conventional bolster which is more rigid, but may also be used as a part of the body section of the mattress 600.

Referring now to FIGS. 84 and 104 to 106, the external cover 602 encasing the various parts of the mattress 600 will now be described. As detailed above, the external cover 602 has a main compartment 630 enclosing most parts of the mattress 600. As better shown in FIG. 104, the external cover 602 also has two lateral compartments 750, 752 devised for receiving the lateral width extensions 626, 628. Various attaching element portions used for retaining the various bladders together are shown.

As better illustrated in FIG. 81, the external cover 602 has a top cover 754 extending on top of the mattress 600 and attached to the bottom portion thereof defined by the main compartment 630 and lateral compartments 750, 752. This attachment may be a zipper for a non-limitative example, and may extend partially or totally along the periphery of the bottom portion in order to allow access to various parts of the mattress 600.

In one embodiment, the external cover 602 is made of a material that is partially rigid and that may include fluid permeable and/or impermeable material as well as fire-resistant or retardant material (i.e., a fire barrier). The external cover 602 may be further provided with elastic material portions (not shown) configured for compressing the excess of fabric from the width extensions 626, 628 and foot extensions 714, 716 when deflated.

Referring now to FIGS. 106 and 107, the mattress 600 may further be provided with attaching straps for attaching the mattress 600 onto a receiving surface of a bed. As better shown in FIG. 107, three attaching straps 754, 756, 758 connected to the longitudinal attaching strap 646 may be provided. These straps 754, 756, 758 may be installed through corresponding openings 759 (shown in FIG. 84) provided on the bottom surface of the main compartment 630 of the external cover 602 to connect to corresponding attaching elements (not shown) provided on the receiving surface of the bed.

As it should now be apparent to the skilled addressee, the mattress 600, when used on a bed, is configurable into various positions, such as a flat or substantially flat position, a cardiac/dining chair position, and a full chair position. The mattress 600 in combination with the bed may be adjusted, i.e., extended and retracted, in width in any of the flat or substantially flat position, cardiac/dining chair position, and full chair position.

The mattress 600 is adapted for facilitating egress of a patient by the foot end of the mattress and bed when in the full chair position (also known as “front exit”). In such full chair position, the foot extension bladders 714, 716 are totally deflated as well as the foot bladder 702. To facilitate egress at the foot end, the mattress 600 may further have a dorsal bladder (not shown) disposed between the lower support layer 606 and the upper comfort layer 608 in the torso section. In the full chair position, the dorsal bladder may be inflated to push the backrest of the patient forwards and thus facilitate the patient exit. In one embodiment, the rotation assist layer 734 may be used for that purpose, in inflating the two rotation bladders 736, 738 simultaneously.

Since some of the bladders of the lower support layer 606 and the upper comfort layer 608 can be independently inflated and deflated, various inflation and deflation sequences of the bladders may be used to further facilitate the patient's exit. For example, once the bed is configured in the full chair position, the seat section and the legs section of the mattress 600 may be deflated to further ease the patient exit, as previously described.

In a further embodiment, the mattress 600 may also be controlled for facilitating egress of the patient by the side of the bed when in the cardiac/dinning chair position (also known as side exit). For the side exit, the corresponding foot siderail has to be lowered first. In order to help the patient, the seat section of the lower support layer 606 may be inflated to the maximum such that the patient extends above the siderail. The seat section of the upper comfort layer 608 may be fully deflated to provide sufficient rigidity to the mattress 600 which will help the patient exit. Pressure in the longitudinal support bolsters 622, 624 and in the longitudinal width extensions 626, 628 may also be modulated to help patient exit. For example, they may be slightly deflated.

Various modifications may be implemented. For example, the longitudinal bolsters 622, 624 and the width extension bladders 714, 716 may be provided with portions of reduced thickness conveniently distributed therealong to facilitate the partial folding of the mattress 600. When present, such portions of reduced thickness, for example a V-groove, may improve conforming the mattress shape to the bed shape when in a corresponding chair position.

In one embodiment, the elongated support bladders 632 of the lower support layer 606 may be arranged to provide a slope at the foot end of the mattress 600 for accommodating the heels of a patient. In another embodiment, the elongated support bladders 632 of the lower support layer 606 may be provided with foam extending inside the inflatable chambers. In another embodiment, a base layer of foam may be provided under the lower support layer 606 and may serve as a bottoming out layer.

In one embodiment, the mattress 600 may be configured with an X-Ray sleeve (not shown) adapted to receive an X-Ray cassette therein.

In one embodiment, the bladders of the mattress 600 are made of fabric or material such as fiber containing TPU or Vinyl material, and are formed by radiofrequency (RF) welding, sewing, and/or any other technique known in the art for producing bladders that are fluid tight.

In order to control the various inflatable components of the mattress 600, a pneumatic system (not shown) and a control unit are provided, according to one embodiment. Various controls and functions are accessible to the patient or the caregiver to position the bed and the mattress in a chosen position and provide various therapies and functions.

In one embodiment, the pneumatic system includes a fluid source such as a pump or a blower, a valve assembly connected to the fluid source, a plurality of pressure sensors and various tubing connecting the valves to the corresponding bladders. In one embodiment, the pneumatic system is integrated in a pneumatic box. The pneumatic box may be a separate unit but is preferably integrated with the mattress or the bed, as detailed below.

In one embodiment, the fluid source is chosen for producing a fluid pressure about between 0 and 80 mm Hg as well as fluid flow rates about between 600 and 800 L/min. The fluid source is further adapted for varying the fluid flow rate and output. Preferably, the fluid source is a blower, which speed may be varied to vary the flow rate of the fluid. For example, a fluid of a relatively low flow rate may be used to gradually inflate any of the rotation bladders for CLRT according to any given inflation/deflation cycle. It will therefore be appreciated that variation in fluid pressure and fluid flow rate may be used to modulate any of the therapy and function of the mattress 600.

In one embodiment, the plurality of valves includes a first set of low flow rate valves and a second set of high flow rate valves. While the flow rate of a fluid inputted to the inflatable components of the mattress 600 depends on the fluid source and/or the valve assembly, the flow rate of a fluid outputted from the inflatable components of the mattress depends mostly on the first set of low flow valves and a second set of high flow valves of the valve assembly. The low flow rate valves and a second set of high flow rate valves may be cyclically opened and closed to regulate further the flow rate of a fluid outputted from the inflatable components of the mattress 600. The valve assembly further includes a cardiopulmonary resuscitation (CPR) valve activatable via a corresponding CPR pedal such as the one described above and manually, as a manual backup, via a pull strap by a user.

In one embodiment, in addition to the ones of the valve assembly, the pneumatic system may further include additional valves located outside of the valve assembly, such as check valves. The check valves may be configured for deflating some of the inflatable components of the mattress simultaneously, while keeping the inflation of these same inflatable components independents, as illustrated in FIG. 108. Particularly, in one embodiment, the pneumatic system 800 further includes two outlet check valves 802, 804 each located at a respective outlet of the first and second foot extension bladders 714, 716. The fluid outlet of the foot bladder 702 is fluidically coupled to the fluid outlet of the first foot extension bladder 714 via the first outlet check valve 802, which is configured for flowing a fluid only from the first foot extension bladder 714 towards the foot bladder 702. Similarly, the fluid outlet of the first foot extension bladder 714 is fluidically coupled to the fluid outlet of the second foot extension bladder 716 via a second check valve 804, which is configured for flowing a fluid only from the second foot extension bladder 716 towards the first foot extension bladder 714.

Accordingly, in operation, when a fluid is provided to the foot bladder 702 via the first inlet valve 806, the outlet thereof blocks the fluid from flowing to the first foot extension bladder 714. When a fluid is provided to the fluid inlet of the first foot extension bladder 714 via a second inlet valve 808, the outlet thereof blocks the fluid from flowing to the second foot extension bladder 716 while the foot bladder 702, being already filled, prevents the fluid of the first feet extension bladder 714 to flow thereto. When a fluid is provided to the fluid inlet of the second foot extension bladder 716 via a third inlet valve 810, the first foot extension bladder 714 being already filled prevents the fluid of the second foot extension bladder 716 to flow thereto. However, when the foot bladder 702 is deflated, the fluid from the second foot extension bladder 716 flows to the first foot extension bladder 714 via the second outlet check valve 804 and the fluid from the first foot extension bladder 714 flows to the foot bladder 702 via the first outlet check valve 802, resulting in an emptying of the foot bladder 702 as well as the first and second foot extension bladders 714, 716.

Advantageously, such arrangement of check valves further enables an optimal control, adjustment, and modulation of the inflatable components of the mattress 600 without impacting the patient comfort while maintaining a minimal number of valves and thus valve assembly of a minimal size.

Referring back to FIG. 92, in one embodiment, the pneumatic box is integrated within the mattress 600, for example into the pneumatic space 692 defined below the head section 610. In such a case, the pneumatic box is insulated to reduce the noise and/or heat that could otherwise be perceived by the patient.

As it should now be apparent to the skilled addressee, the mattress 600 may include several pneumatically distinct zones that are independently controllable from one another by the valve assembly and the associated control unit.

Referring now to FIGS. 109 to 136, another inflatable therapeutic mattress 1600 usable in combination with a bed will now be described. As it will become apparent below, much like mattress 600, the mattress 1600 includes various controlled inflatable components in fluid communication with a pneumatic system (not shown) for providing enhanced comfort to the patient. In a further embodiment, the mattress 1600 may also be configured to provide a range of therapeutic functionalities as well as other useful functionalities, as it will become apparent below. In one embodiment, a control unit and associated user interface (not shown) is integrated to the bed and enables to operate and control the mattress 1600 as desired.

As better shown in FIG. 109, the mattress 1600 is provided with a body section 1604 having a bottom structural layer 1605, a lower support layer 1606 and an upper comfort layer 1608 mounted above the lower support layer 1606. The mattress 1600 also has a head section 1610 adjacent a head end 1612 of the body section 1604 and a leg section 1614 adjacent the foot end 1616 of the body section 1604. Right and left side sections 1618, 1620 are also provided on a corresponding longitudinal right and left side of the body section 1604 of the mattress 1600, as detailed below.

Referring now to FIG. 111, each of the right and left side sections 1618, 1620 has a longitudinal support bolster 1622, 1624, which will be described in greater details below. Each right and left side sections 1618, 1620 is also provided with a width extension 1626, 1628 extending adjacent the longitudinal support bolster 1622, 1624 outwardly therefrom, as described below. It will be appreciated throughout the present description that the width extensions 1626, 1628 may be omitted for a particular application. For instance, FIG. 112 illustrates an embodiment of the mattress 1600 as previously described but without the width extensions 1626, 1628.

The bottom structural layer 1605 will now be described with reference to FIGS. 115, 116, 126 and 133. In one embodiment, the bottom structural layer 1605 comprises a fabric envelope 1607 comprising a bottom layer 1609 and a top layer 1611 welded together about their periphery, as well as a foam layer 1613 sandwiched between the bottom and top layers 1609, 1611. In one embodiment, the structural layer 1605 has a width of 35 inches, a length of 74 inches, and has a thickness between about 0.5 and 3 inches, preferably about 1 inch. Provided at various locations on the structural layer 1605 are retaining elements 1653, for securing the various elements of the mattress 1600 to the structural layer 1605, as it will become apparent below. In one embodiment, best shown in FIG. 133, each retaining element has a bottom portion 1655 and a top portion 1657 engaging the bottom portion 1655 to sandwich the bottom, top and foam layers 1609, 1611, 1613 of the structural therebetween, as well as a removable cover 1659 removably securable to the top portion 1657 of the retaining element 1653. In one embodiment, the removable cover 1659 can removed to position straps of the various sections of the mattress 1600 into the top portion 1657 of the various retaining elements 1653, and then closed to secure these straps to the retaining elements. 1653, at it will be described in greater details below.

The lower support layer 1606 will now be described with reference to FIG. 114. The lower support layer 1606 is comprised of a head section 1630, a torso section 1632, a seat section 1634 and a leg section 1636. In the illustrated embodiment, the head section 1630, torso section 1632, seat section 1634 and leg section 1636 of the lower support layer 1606 are separated from one another, to ease maintenance of the mattress 1600 and to allow a cost-effective replacement of an eventual defective section or portions of the lower support layer 1606. It will be understood however that in some embodiments, the head section 1630, torso section 1632, seat section 1634 and foot section 1636, or some of these sections, could be attached to one another to form a single, integral structure.

Each of the head section 1630, torso section 1632 and seat section 1634 has a plurality of elongated support bladders 1629 and two spaced-apart longitudinal bladders 1631 extending traverse to the elongated support bladders 1629, at their extremities each bladder 1629 or 1631 having an inner chamber (not shown) that is inflatable. Likewise, the leg section 1636 has a plurality of elongated support bladders 1633 and two spaced-apart longitudinal bladders 1637 extending traverse to the elongated support bladders 1633, at their extremities. The bladders 1633 and 1637 of the leg section 1636 together have the same width than elongated support bladders 1632 and 1635 assembled together but have a smaller diameter. The illustrated elongated support bladders 1629, 1631, 1633 and 1637 have a cylindrical shape but other shapes may be used. The elongated support bladders 1629 and 1633 are mounted together side by side and extend transversally across the width of the head section 1630, torso section 1632, seat section 1634 and leg section 1636 of the mattress 1600. In one embodiment, the plurality of elongated support bladders 1629, 1631, 1633 and 1637 of a given section may be integral to each other, for example, they may be formed in the same material sheet with convenient separation welding lines. However, to ease maintenance of the mattress 1600 and to allow a cost-effective replacement of an eventual defective elongated support bladder 1629, 1633 or portions of the lower support layer 1606, it may be advantageous to provide independent elongated support bladders 1632 that are attached together via straps or the like.

The elongated support bladders 1629 and 1631 of each of the head section 1630 torso section 1632 and seat section 1634 and the elongated and longitudinal support bladders 1633 and 1637 of the leg section 1636 have at least one fluid communication port (not shown), such as a fluid inlet and/or a fluid outlet, in fluid communication with the corresponding inner chamber and a fluid distribution system (not shown). In one embodiment, each of the elongated and longitudinal support bladders 1629, 1631, 1633 and 1637 has a single fluid communication port (similar to a fluid inlet 636 and a fluid outlet 638 provided on each opposed end of the elongated support bladders 632 of mattress 600 described above). As it should be understood, each elongated or longitudinal support bladders 1629, 1631, 1633 and 1637 may be controlled independently from the others, or, alternatively, the elongated support bladders 1629 or 1633 of the head section 1630, torso section 1632, seat section 1634 and leg section 1636 may inflated and deflated differently for each section for providing various firmness in order to ease control of the mattress 1600 and provide optimal comfort to the patient in the various positions of the bed. For example, all the elongated support bladders 1629 of a same section (e.g. the torso section 1632) could be operated at the same pressure with corresponding pneumatic hardware, but distinct pressures may be obtained for of the head section 1630, torso section 1632, seat section 1634 and foot section 1636. Such embodiment enables distinct firmness controls for each section, to better accommodate the pressure points of the patient and enhance his comfort.

In the illustrated embodiment, the lower support layer 1606 has 19 elongated support bladders 1629 (4 for the head section 1630, 7 for the torso section 1632 and 9 for the seat section 1634) and 10 elongated support bladders 1633 for the leg section 1636. In an exemplary embodiment, the elongated support bladders 1629, together with the longitudinal bladders 1631 have a width of about 27 inches and a thickness of about 3 inches when fully inflated, while support bladders 1633 of the leg section 1636, together with longitudinal bladders 1637, have a width of about 27 inches and a thickness of about 1⅛ inch when fully inflated. As it will become apparent below, the fact that the support bladders 1633 of the leg section 1636 have a smaller diameter than elongated support bladders 1629 of the other sections provides a space beneath the leg section 1636 for receiving a portion of a pneumatic system for controlling inflation, deflation, vibration and percussion of the mattress 1600 while providing a generally co-planar top surfaces of the head section 1630, torso section 1632, seat section 1634 and foot section 1636. The elongated support bladders 1629 and 1633 and longitudinal bladders 1631, 1637 may be operated at a fluid pressure varying between 0 and 60 mmHg, depending on the patient specificities and the various therapies or functionalities that can be activated, as it would become apparent below.

For securing the head section 1630, torso section 1632, seat section 1634 and leg section 1636 of the support layer 1606 to the patient surface of the bed, in one embodiment, each of the head section 1630, torso section 1632, seat section 1634 and leg section 1636 is provided with a series of slots or holes (not shown) defined in sewing lines between a pair of adjacent bladders 1629 or 1633, for receiving therein straps or other securing means of the comfort layer 1608 or other layers, which straps or securing means are used to secure the comfort layer 1608 or other layers to the patient support surface hence, sandwiching the support layer 1606 between the comfort layer 1608 and the patient support surface, as it will be described in greater details below. In one embodiment, each of the head section 1630, torso section 1632, seat section 1634 and leg section 1636 of the support layer 1606 is provided with downwardly extending tabs 1638 that are engageable in retaining elements 1653 of the structural layer 1605 of the mattress.

With reference to FIGS. 115 to 117, the bolsters 1622, 1624 will now be described. FIG. 117 shows one of the longitudinal bolsters 1624. It will be appreciated that a similar description also applies to longitudinal bolster 1622. The longitudinal bolster 1624 includes an elongated sleeve 1623 housing an elongated foam portion 1625 and a longitudinal bolster bladder 1694 received atop the elongated foam portion 1625. In one embodiment, the sleeve 1623 is made of fabric or material such as fiber containing TPU or Vinyl material, although it could be made from any suitable material. The sleeve 1623 is provided with an attaching element 1627 to attach to a complementary attaching element 1639 provided on the side extension 1628 to secure the side extension 1628 to the bolster 1624. The elongated foam portion 1625 is received in the sleeve 1623, on the bottom thereof, and fills most of the space defined within the sleeve 1623, as best shown in FIG. 117. In the illustrated embodiment, the elongated foam portion 1625 has a generally square cross-section and is provided with a longitudinal channel 1641 defined along a bottom face 1643 thereof, the channel 1641 being sized and shaped for receiving therein and routing tubes or pipes of the air system to provide air to the various bladders of the mattress 1600 (not shown in FIG. 117). The bolster bladder 1694 is also elongated, its length generally corresponding to the length of the elongated foam portion 1625 and the sleeve 1623. The bolster bladder 1694 is also received in the sleeve 1623 and is sandwiched between a top face of the elongated foam portion 1625 and the sleeve 1623. When the bolster bladder 1694 is in a deflated state (as shown in FIG. 117, it lies flat on the elongated foam portion 1626 and exert not pressure thereon. In some instance where added rigidity must be provided to the bolster 1624, such as during side exit, the bolster bladder 1694 is inflated, the increased volume causing the bolster bladder 1694 to gradually engage the sleeve 1623 and the elongated foam portion 1625, therefore compressing the foam portion 1625 while providing increased rigidity to the bolster 1624. As it will be appreciated, inflating the bolster bladder 1694 also helps protecting the tubes or pipes of the fluid system in such circumstances. In one embodiment, the bolsters 1622, 1624 are secured to the structural layer 1605 of the mattress 1600. In this embodiment, the sleeve 1623 of the bolsters 1622, 1624 attached to the top layer 1611 of the structural foam layer 1605, along its right and left sides, by way of zippers or other attaching elements. In an alternate embodiment, the sleeve 1623 of the bolsters 1622, 1624 could be welded to the top layer 1611 of the structural foam layer 1605, along its right and left sides.

Exemplary fluid pressure provided to the bolster bladders 1694 of the two longitudinal bolsters 1622, 1624 is between about 0 and 60 mm Hg, depending on the intended use and/or functionalities of the mattress 1600. For example, to provide structural rigidity to the mattress 1600, including the body section, the two longitudinal bolsters 1622, 1624 may be inflated at a relatively high fluid pressure, such as about between 32 and 60 mm Hg. To facilitate egress of the patient from the left and right ends of the mattress 1600 in a cardiac chair configuration, the two longitudinal bolsters 1622, 1624 may also be deflated at a relatively lower fluid pressure, such about between 0 and 32 mm Hg.

In the illustrated embodiment, the two longitudinal bolsters 1622, 1624 are about 4 inches in width and have a variable thickness. More specifically, when the bolster bladders 1694 are deflated, the elongated foam portion of the bladder have a thickness of about 3 inches in thickness and hence, the bolsters 1622, 1624 have a corresponding thickness of about 3 inches. When the bolster bladders 1694 are fully inflated, they reach a diameter of about 2 inches, which causes a 1-inch compression of the elongated foam layer 1625, to reach an overall thickness of bolsters 1622, 1624 of about 4 inches. Other arrangements using a plurality of longitudinal bolsters stacked one onto the other and/or arranged side by side and conveniently attached together may also be envisaged.

Turning now to FIGS. 118 and 119, the upper comfort layer 1608 will now be described. The upper comfort layer 1608 is installed on the top of the support layer 1606 and of the bolsters 1622, 1624 (see FIG. 109) and is devised to provide enhanced comfort to the patient lying on the mattress 1600. In the illustrated embodiment, the upper comfort layer 1608 includes a lower integral sheet 1660 provided with a plurality of comfort bladders 1662, and a top integral sheet 1661 also provided with a plurality of comfort bladders 1663. In the illustrated embodiment, the comfort bladders 1662 and 1663 have an elongated shape and are assembled in a side-by-side relationship to extend laterally across the upper comfort layer 1608, the comfort bladders 1662 of the lower integral sheet 1660 being arranged in quincunx with those of the top integral sheet 1661, as best shown in FIG. 119.

In one embodiment, the lower integral sheet 1660 and the top integral sheet 1661 are attached to one another at the side ends 1665, 1667, top end 1669 and foot end 1671 to define a pocket (not shown) therebetween, the pocket the pocket defining a Low-Air-Loss (LAL) space between the lower integral sheet 1660 and the top integral sheet 1661. In one embodiment, a fluid supply is provided to the comfort layer 1608, and the air travels between the lower integral sheet 1660 and the top integral sheet 1661 to exit the top surface of the top integral sheet 1661 via a plurality of pores 1670 defined in the sewing or welding lines, between adjacent comfort bladders 1663 of the top integral sheet 1661, as best shown in FIGS. 129, 131 and 132.

In another embodiment, the lower integral sheet 1660 and the top integral sheet 1661 may be attached to one another at the side ends 1665, 1667 and top end 1669 to define a pocket (not shown) therebetween, the pocket having an opening at the foot end 1671 of the upper comfort layer 1608. In one embodiment, the pocket defined between the lower integral sheet 1660 and the top integral sheet 1661 is used to position a LAL layer made of a 3D material, between the lower integral sheet 1660 and the top integral sheet 1661, which LAL layer may be used to help dissipating humidity in the mattress 1600, as it would be appreciated by a person skilled. In one embodiment, the opening of the pocket found at the foot end 1671 of the upper comfort layer can be closed with attaching elements such as zippers or hook and loop fasteners such as Velcro™.

In a further embodiment, similarly to lower the support layer 1606, the upper comfort layer 1608 may be separated into a plurality of zones controllable independently. For example, a head zone 1672, a torso zone 1674, a seat zone 1676 and a leg zone 1678 may be defined. In this example, comfort bladders 1662, 1663 of a same zone can be operated at the same pressure with corresponding pneumatic hardware, but distinct pressures may be obtained for each zone. Such embodiment enables distinct firmness controls for each zone, to better accommodate the pressure points of the patient and enhance his comfort. In one embodiment, communication ports are provided between adjacent bladders 1662 or 1663 of a corresponding zone to allow fluid communication therebetween. In one embodiment, the four zones 1672, 1674, 1676, 1678 are defined to be aligned with the corresponding sections (i.e. head section 1630, torso section 1632, seat section 1634 and leg section 1636) defined in the lower support layer 1606. A valve arrangement using two levels of valves in series may be used to allow an alternating pressure therapy and a zones control.

Referring again to FIGS. 109 and 118, in the illustrated embodiment, the upper comfort layer 1608 has a generally rectangular shape, although the upper comfort layer 1608 may take various shape configurations. For example, in the illustrated embodiment, the upper comfort layer 1608 is configured to extend over the two longitudinal support bolsters 1622, 1624 of the side sections 1618, 1620, as well as the head section 1630, torso section 1632, seat section 1634 and foot section 1636 of the support layer 1606.

In the illustrated embodiment, the upper comfort layer 1608 is provided with 32 comfort bladders 1662 in the lower integral layer 1660 and 32 comfort bladders 1663 in the top integral layer 1661. In one embodiment, the inflatable comfort bladders 1662, 1663 are about 2⅛ inches in diameter, and have a width of 35 inches when fully inflated to provide an upper comfort layer 1608 of about 4 inches when fully inflated, since the inflatable comfort bladders 1662, 1663 of the lower integral layer 1660 and the top integral layer 1661 are positioned in quincunx. Various other configurations may be envisaged for a particular application without departing from the scope of the present invention. For instance, in other embodiments, instead of being integrally formed together in a lower layer 1660 and top layer 1661, the inflatable comfort bladders 1662 and 1663 may be arranged in a unitary piece.

The inflatable comfort bladders 1662, 1663 may be operated at a fluid pressure varying, for instance, between 0 and 60 mmHg, depending on the patient specificities and the various therapies or functionalities that can be activated, as it would become apparent below.

The upper comfort layer 1608 may also be used to implement an immersion-flotation mode and a maximum inflation mode. In the immersion-flotation mode, which is useful as pressure redistribution therapy, the fluid pressure of the inflatable comfort bladders 1662 and 1663 of the upper comfort layer 1608 is reduced to about between 4 and 32 mm Hg. This increases the contact surface between the patient and the top face of the upper comfort layer 1608, thereby reducing pressure point to the patient. In the maximal inflation mode, the fluid pressure of the upper comfort layer 1608 is increased to about between 32 and 60 mm Hg. This may enable to flatten and rigidify the top face of the upper comfort layer 1608 to facilitate moving or repositioning the patient by the medical personnel.

In one embodiment, the inflatable comfort bladders 1662 and 1663 of the lower lower layer 1660 and top layer 1661 of the comfort layer 1608 may be controlled to implement an alternating pressure therapy. In one embodiment, the fluid pressure of the comfort bladders 1663 of the top layer 1661 or the is set at a given value while the fluid pressure of the comfort bladder of the lower layer 1660 is set at a reduced value, preferably half the value of the fluid pressure in the inflatable comfort bladders 1663 of the top layer 1661, for a preset period of time, after which the pressure of in the inflatable comfort bladders 1662, 1663 of the lower layer 1660 and top layer 1661 repetitively for a number of preset periods, hence providing the alternating therapy. As it will be appreciated, the fact that the alternating therapy is achieved by alternating the pressure of the bladders 1662, 1163 of the lower and top layers 1660, 1161 (as opposed to alternating pressure of adjacent bladders on a same layer), may be advantageous in some instances since the bladders 1662 or 1663 of a same layer 1660 or 1661 are closer to one another and the pressure may be more evenly distributed across the surface onto which the patient lies.

In one embodiment, the upper comfort layer 1608 may be removably attached to structural layer 1605 of the mattress 1600 by using a system of straps (not shown) strategically positioned to be receivable through the slots or holes defined in the support layer 1606, and to engage retaining elements 1653 defined on the structural foam layer 1605. As such, the upper comfort layer 1608 with its straps engaged in the retaining elements 1653 rests atop the support layer 1606 and retains it into position against the structural foam layer 1605.

As it should now be apparent to the skilled addressee, the body section of the mattress 1600 provided with the lower support layer 1606 and the upper comfort layer 1608, each having a plurality of predefined independent sections or zones as previously described, may enable a better control of how the patient interfaces with the mattress 1600 in order the minimize skin injuries and discomfort. Referring again to FIGS. 109, 113 114 and 119, the head section 1610 of the mattress 1600 is comprised of the head section 1630 of the support layer 1606 and the head zone 1672 of the comfort layer 1608. In the embodiment illustrated in FIG. 113, the head portion 1610 is about 12.5 inches in length, about 35 inches in width, and about 7 inches in thickness when fully inflated (i.e. when the head section 1630 of the support layer 1606 and the head zone 1672 of the comfort layer 1608).

Exemplary fluid pressure provided to the bladders 1629, 1631 of the head section 1630 of the support layer 1606 is between about 0 and 60 mm Hg while fluid pressure provided to the bladders 1662, 1663 of the head zone 1672 of the comfort layer 1608 is between about 0 and 60 mm Hg, depending on the intended use and/or functionalities of the mattress 1600. Particularly, when the patient is in a prone position with the face directly contacting the bladders the bladders 1663 of the head zone 1672 of the comfort layer 1608, the fluid pressure of the bladders 1629, 1631 of the head section 1630 of the support layer 1606 is adjusted to about between 0 and 32 mm Hg while the fluid pressure of the bladders 1662, 1663 of the head zone 1672 of the comfort layer 1608 is adjusted to about between 0 and 32 mm Hg.

To provide a mattress 1600 accommodating taller patients, the mattress 1600 may be further provided with an inflatable and deflatable foot extension section 1712, positioned adjacent to the foot section 1614, as illustrated in FIGS. 109, 120 and 121 showing the foot section 1712 inflated. In the illustrated embodiment, the foot extension section 1712 is provided with first, second and third foot extension portions 1714, 1715 and 1716, each defining an inflatable foot chamber therein. The first, second and third foot extension portions 1714, 1715, 1716 each includes a plurality of elongated bladders mounted transversally to the mattress 1600, are adjacent to the foot section 1614 of the support layer 1606, and are attached thereto. The first, second and third extension portions 1714, 1715 and 1716 can be independently inflated and controlled from each other, according to a particular application, for variably lengthening the mattress 1600. In some cases, the first foot extension portion 1714 only may be inflated to accommodate the patient.

Each of the first, second and third foot extension portions 1714, 1715, 1716 is substantially rectangular in shape and include a plurality of bladders 1717, 1719, 1721 namely 3 bladders 1717 in the foot extension portion 1714 adjacent to the foot portion 1636 of the support layer 1606, 2 bladders 1719 in the foot extension portion 1715 and 2 bladders 1721 in the foot extension portion 1716. As best shown in FIG. 111, the foot extension section 1712 has a width generally corresponding to the combined width of the support layer 1606 and the bolsters 1622, 1624. In one embodiment, each of the bladders 1717, 1719, 1721 has a thickness ranging between about 6 inches and 8 inches, a width of about 35 inches, and a length of about 2 inches. As such, the foot extension portion 1714 has a length of 6 inches, and each of the foot extensions portions 1715, 1716 has a length of 4 inches. Therefore, by controlling the inflation of the various foot extensions portions 1714, 1715 and 1716, it is possible to extend the mattress 1600 from its typical 74 inches in length to 80 inches by inflating only extension portion 1714, to 84 inches by inflating extensions portions 1714 and 1715, or to 88 inches by inflating all foot extension portions 1714, 1715 and 1716.

To secure the foot extension section 1712 to the other elements of the mattress 1600, the foot extension section 1712 is provided with a pair of tabs 1720. The tabs 1720 are provided with attaching elements (not shown) which collaborate with complementary attaching elements (not shown) provide at the foot end of the bolsters 1622, 1624, hence allowing attachment of the foot extension section 1712 to the bolsters 1622, 1624. Provided at the foot end of the foot extension section 1712 is a plurality of attaching element 1713 for securing the foot extension section 1712 to an external cover of the mattress 1600, as it will be described in greater details below.

Exemplary fluid pressure provided to foot extension portions 1714, 1715, 1716 is between about 0 and 60 mm Hg. However, in the case the patient heels are lying on one foot extension bladder, the foot extension bladder may be inflated to a relatively low fluid pressure between about 0 and 32 mm Hg to provide an immersion mode for the heels of the patient. As already mentioned, the mattress 1600 previously described may be used on an ICU bed having a full chair position. In this case, the foot extension portions 1714, 1715, 1716 have to be completely deflated before reaching the full chair position. As it will be understood, other arrangements using a plurality of inflatable bladders stacked one onto the other and/or arranged side by side and conveniently attached together may also be envisaged.

Referring now to FIGS. 122 to 124, there is shown another embodiment of a mattress 1600 that is provided with a rotation assist layer 1734 that may be used to implement a continuously lateral rotation therapy (CLRT) and a turn-assist function (also known as tilt-assist function) to the patient. The CLRT is useful for administering pulmonary therapy to the patient, while the turn-assist function allows the caregivers to turn or reposition the patient more easily.

In the illustrated embodiment, the rotation assist layer 1734 has right and left rotation bladders 1736, 1738, each defining an independent inflatable chamber therein, shown both shown in a deflated state in FIG. 122. In the exemplary embodiment, the left rotation bladder 1738 is shown in an inflated state while the right rotation bladder 1736 is shown in a deflated state in FIGS. 123 and 124. As it should now be apparent, when used for CLRT, the right and left rotation bladders 1736, 1738 are alternatively inflated and deflated according to a predetermined sequence. When used for a turn assist function, a single rotation bladder is inflated.

In one embodiment, the right and left rotation bladder 1736, 1738 are integrally formed within the same material sheet and are separated with a welding line. The illustrated rotation assist layer 1734 has somewhat of an elongated octagonal shape providing the two elongated right and left rotation bladders 1736, 1738. In the illustrated embodiment, the rotation assist layer 1734 does not extend on the whole length of the body section of the mattress 1600 but is rather limited to the torso section 1632 and seat section 1634 of the lower support layer 1606 of the mattress 1600.

In the illustrated embodiment, the rotation assist layer 1734 is positioned between the lower support layer 1606 and the upper comfort layer 1608. The rotation assist layer 1734 can be removably attached to the structural layer 1605 of the mattress 1600 through attaching straps 1646 received in the slots or holes of defined in the lower support layer 1606 and engaged in retaining elements 1653 of the structural layer. As it will be appreciated, in one embodiment, it may be preferable to provide the attaching straps 1646 in central locations, between the right and left rotation bladders 1736, 1738, for enabling free inflation and deflation without inducing unwanted movement of the rotation assist layer 1734 relative to the other elements of the mattress 1600 during its operation.

In a similar manner, and since the torso zone 1674 and the seat zone 1676 of the upper comfort layer 1608 also need to be raised and lowered together with the left or right rotation bladders 1736, 1736, it is also advantageous to secure at least the torso zone 1674 and the seat zone 1676 of the upper comfort layer 1608 through strap (not shown) centrally positioned between the right and left sides of the comfort layer 1608. Further, the skilled addressee will appreciate that the upper comfort layer 1608 should not be attached to the longitudinal side bolsters 1622, 1624 when the rotation assist layer 1734 previously described is used to allow free movement of the upper comfort layer 1608 above the rotation assist layer 1734. In a further embodiment, the upper comfort layer 1608 may be attached on the top of the rotation layer 1734, on the central welding line, through cooperating attaching elements as the ones previously described, as it should become apparent to the skilled addressee.

In one embodiment, each of the right and left rotation bladders 1736, 1738 is about between 30 and 55 inches, and preferably about 50 inches in length and about between 5 and 15 inches, preferably 11 inches, in diameter when fully inflated. When fully inflated, such rotation bladders 1736, 1738 may rotate the patient at an angle of about 40 degrees.

Instead of using an integral sheet to provide the left and right rotation bladders 1736, 1738, it could be considered to provide two separated rotation bladders, either attached together, either attached to the lower support layer 1606 only, or both. Each left and right rotation bladder 1736, 1738 may also be provided with additional rotation bladders, for example a first one of a smaller diameter proximate the longitudinal central portion of the mattress, a second one of a greater diameter adjacent thereto on a side thereof, and a third one of a greater diameter proximate the corresponding side section 1618, 1620 of the mattress 1600.

The skilled addressee will appreciate that, in one embodiment, the upper comfort layer 1608 may also be controllably inflated in conjunction with the rotation assist layer 1734 for further enhancing the CLRT or turn assist function.

In one embodiment, illustrated in FIGS. 124 to 126, the mattress 1600 may further have a bed exit assist layer 1900 disposed between the lower support layer 1606 and the upper comfort layer 1608 in the torso section 1632 to facilitate egress at the foot end. In a full chair position, the bed exit assist layer 1900 may be inflated to push the backrest of the patient forwards and thus facilitate the patient exit.

In the illustrated embodiment, the bed exit assist layer 1900 has right and left exit bladders 1902, 1904, each defining an independent inflatable chamber therein, shown both shown in a deflated state in FIGS. 124 to 126. As it should now be apparent, when used for assisting a patent to exit the bed, the right and left exit bladders 1902, 1904 are both inflated simultaneously.

In one embodiment, the right and left exit bladder 1902, 1904 are integrally formed within the same material sheet and are separated with a welding line. The illustrated bed exit assist layer 1900 has somewhat of an octagonal shape providing the two right and left exit bladders 1902, 1904. In the illustrated embodiment, the bed exit assist layer 1900 does not extend on the whole length of the body section of the mattress 1600 but is rather limited to the torso section 1632 of the lower support layer 1606 of the mattress 1600. In one embodiment, the right and left exit bladders 1902, 1904 have a length between about 20 to 30 inches, preferably 24 inches, and a diameter between about 6 inches to 12 inches, preferably 9.5 inches, when fully inflated.

In the illustrated embodiment, the bed exit assist layer 1900 is positioned between the lower support layer 1606 and the upper comfort layer 1608, underneath the rotation assist layer 1734, although it will be understood that it could be positioned on top of the rotation assist layer. The bed exit assist layer 1900 can be removably attached to the lower support layer 1606 through attaching straps 1906 received in the slots or holes of defined in the lower support layer 1606 and engaged in retaining elements 1653 of the structural layer 1605. As it will be appreciated, in one embodiment, it may be preferable to provide the attaching straps 1906 in central locations (much like attaching straps 1646 of rotation assist layer 1734), between the right and left rotation bladders 1902, 1904, for enabling free inflation and deflation without inducing unwanted movement of the bed exist assist layer relative to the other elements of the mattress 1600 during its operation. Although the bed exit assist layer 1900 has been described in connection with this embodiment, it will be understood that it could be configured differently, without departing from the scope of the embodiment. For instance, the bed exit assist layer could be provided with a different number of bladders (e.g. a single bladder or more than two bladders) and could be attached differently. In one embodiment, the bed exit assist layer is provided with a plurality of pores 1907 defined in the right and left exit bladder 1902, 1904 (best shown in FIG. 126). The pores 1907 contribute to ensure that the bed exist assist layer 1900 is completely deflated when it is not operated, and provided a LAL feature when the bed exit assist layer is in operation.

Further, while in the illustrated embodiment the mattress 1600 is provided with bed exist assist layer 1900, in an alternate embodiment, it could be omitted, and the rotation assist layer 1734 could be used to execute the function of the bed exist assist layer 1900. In another embodiment, where both the rotation assist layer 1734 and the bed exit assist layer 1900 are present, the action of the rotation assist layer 1734 could complement the action the bed exit assist layer 1900 to further facilitate bed exit. In such cases, whether the rotation assist layer 1734 is used alone or together with the bed exit assist layer 1900, the two rotation bladders 1736, 1738 of the rotation assist layer 1734 would preferably be inflated simultaneously.

Referring now to FIGS. 117, 127 and 128, the width extensions 1626, 1628 of each of the right and left side sections 1618, 1620 of the support layer 1606 will now be described. As previously mentioned, these width extensions 1626, 1628 may be omitted for a particular application. In one embodiment, the width extensions 1626, 1628 are operated simultaneously to provide an extension of the mattress 1600 on each side thereof, but it should be understood that a single width extension may be activated while the other is kept retracted. Together with side extensions 1700, 1702 of the comfort layer 1608, width extensions 1626, 1628 of the support layer 1606 allow the mattress 1600 to be extended from a typical 35 inches width to an intermediate 40 inches width, and further to a 45 inches width, as it will become apparent below.

In the illustrated embodiment, each width extension 1626, 1628 is provided adjacent the corresponding longitudinal support bolster 1622, 1624, outwardly therefrom. As better shown in FIGS. 117 and 128, each width extension 1626, 1628 is provided with a sleeve 1740, 1742 housing a longitudinal inflatable bladder 1744, 1746 adjacent the longitudinal support bolsters 1622, 1624, respectively. Each inflatable bladder 1744, 1746 may be independently inflated and deflated.

Each sleeve 1740, 1742 of width extensions 1626, 1628 is attached to a corresponding sleeve 1623 of the longitudinal support bolster 1622, 1624. Attaching elements 1639 as previously described or attaching straps conveniently distributed and arranged may be used to attach the sleeves 1740, 1742 to complementary attaching elements 1627 provided on the sleeves 1623 of the bolsters 1622, 1624.

In the fully width retracted position, the width extensions 1626, 1628 of the support layer 1606 are fully deflated while the longitudinal side bolsters 1622, 1624 are inflated at a predetermined pressure offering rigid side bolsters. When the mattress 1600 is extended in width with the width extensions 1626, 1628, the longitudinal support bolsters 1622, 1624 of the side sections 1618, 1620 are slightly deflated at a lower pressure while the outwardly longitudinal inflatable bladder 1744, 1746 of the width extensions 1626, 1628 and/or bladders 1706, 1710 of side extensions 1700, 1702 of the comfort layer 1608 are inflated at a higher pressure. With this configuration, the longitudinal side bolsters 1622, 1624 may be used as a conventional bolster (i.e. in a more rigid configuration), but may also be used as a part of the body section of the mattress 1600 (i.e. in a less rigid configuration).

In one embodiment, and referring to FIGS. 109, 113 and 128, a percussion and vibration assembly 1950 is provided on top of the upper comfort layer 1608 to further provide a percussion and vibration therapy to the patient. In one embodiment, the percussion and vibration assembly 1950 comprises right and left portions 1952, 1954, each comprising 3 longitudinal bladders 1956 receivable between adjacent bladders 1662 of the torso zone 1674 of the comfort layer 1608, as best shown in FIG. 109. In one embodiment, the percussion and vibration bladders 1956 are independent from the inflatable comfort bladders 1662, 1663 and are controlled with additional dedicated valves (not shown). Indeed, to implement such therapy, the first and second groups of inflatable lines 1960 are inflated and deflated according to a predetermined timed sequence in an alternating manner such that two adjacent lines 1960 are not in the same state but rather in an opposed inflated/deflated state. Such alternating pressure therapy enables to minimize continuous pressure on the same pressure points between the patient and the mattress 1600 to thereby reduce skin issues to the patient.

In one embodiment, the comfort layer 1608 is provided with the side extensions 1700, 1702. As best shown in FIGS. 129 to 132, the side extensions 1700, 1702 are installed on the top of the width extensions 1626, 1628 and are devised to provide enhanced comfort to the patient lying on the mattress 1600. Much like the comfort layer 1608 described above, each of the side extensions 1700, 1702 of the upper comfort layer 1608 includes a lower integral sheet 1704 provided with a plurality of comfort bladders 1706, and a top integral sheet 1708 also provided with a plurality of comfort bladders 1710. In the illustrated embodiment, the comfort bladders 1706 and 17010 have an elongated shape and are assembled in a side-by-side relationship to extend laterally across each of the side extensions 1700, 1702, the comfort bladders 1706 of the lower integral sheet 1704 being arranged in quincunx with those of the top integral sheet 1708.

In one embodiment, the lower integral sheet 1704 and the top integral sheet 1708 are attached to one another at their periphery.

In a further embodiment, similarly to comfort layer 1608, each of the side extensions 1700, 1702 may be separated into a plurality of zones controllable independently. For example, a head zone 1712, a torso zone 1714, a seat zone 1716 and a leg zone 1718 may be defined. In this example, comfort bladders 1706, 1710 of a same zone can be operated at the same pressure with corresponding pneumatic hardware, but distinct pressures may be obtained for each zone. Such embodiment enables distinct firmness controls for each zone, to better accommodate the pressure points of the patient and enhance his comfort. In one embodiment, communication ports are provided between adjacent bladders 1706 or 1710 of a corresponding zone to allow fluid communication therebetween. In one embodiment, the four zones 1712, 1714, 1716 and 1718 of each of the side extensions 1700, 1700 are defined to be aligned with each other, and with corresponding zones 1672, 1674, 1676, 1678 of the comfort layer 1608. A valve arrangement using two levels of valves in series may be used to allow an alternating pressure therapy and a zones control.

Referring again to FIG. 130, in the illustrated embodiment, the side extensions 1700, 1702 each have a generally rectangular shape to generally match the shape and size of the width extensions 1626, 1628 and the general configuration of the comfort layer 1608, although side extensions 1700, 1702 may take various shape configurations. In the illustrated embodiment, each side extension 1700, 1702 is provided with 32 comfort bladders 1706 in the lower integral layer 1704 and 32 comfort bladders 1710 in the top integral layer 1708. In one embodiment, the inflatable comfort bladders 1708, 1710 are about 2⅛ inches in diameter, and have a width of 5 inches when fully inflated to provide side extensions 1700, 1702 of about 4 inches thick when fully inflated since the comfort bladders 1706, 1710 of the lower integral layer 1704 and top integral layer 1709 are positioned in quincunx. Various other configurations may be envisaged for a particular application without departing from the scope of the present invention. For instance, in other embodiments, instead of being integrally formed together in a lower layer 1704 and top layer 1708, the inflatable comfort bladders 1706, 1710 may be arranged in a unitary piece.

The inflatable comfort bladders 1706, 1708 may be operated at a fluid pressure varying, for instance, between 0 and 60 mmHg, depending on the patient specificities and the various therapies or functionalities that can be activated, as it would become apparent below.

Much like the comfort layer 1608, the side extensions 1700, 1702 may also be used to implement an immersion-flotation mode and a maximum inflation mode. In the immersion-flotation mode, which is useful as pressure redistribution therapy, the fluid pressure of the inflatable comfort bladders 1707 and 1710 of the side extensions 1700, 1702 is reduced to about between 4 and 32 mm Hg. This increases the contact surface between the patient and the top face of the upper comfort layer 1608 and side extensions 1700, 1702, thereby reducing pressure point to the patient. In the maximal inflation mode, the fluid pressure of the upper comfort layer 1608 and side extensions 1700, 1702 is increased to about between 32 and 60 mm Hg. This may enable to flatten and rigidify the top face of the upper comfort layer 1608 and side extensions 1700, 1702 to facilitate moving or repositioning the patient by the medical personnel.

In one embodiment, the side extensions 1700, 1702 may be removably attached the comfort layer 1608 using complementary attaching elements such as zippers. In another embodiment, the side extensions 1700 and 1702 may be integrally formed with comfort layer 1608, although the bladders 1706 and 1710 can be controlled independently of bladders 1662, 1663 of the comfort layer 1608. Still in another one embodiment, the side extensions 1700, 1702 may be removably attached to the structural layer 1605 or other portions of the mattress 1600 by using a system of straps (not shown) strategically positioned in order to engage retaining elements 1653 and to rest atop width extensions 1626, 1628. In one embodiment, the side extensions 1700, 1702, the comfort layer 1608 and the other elements of the mattress 1600 including bladders are made of fabric or material such as fiber containing TPU or Vinyl material, and are formed by radiofrequency (RF) welding, sewing, and/or any other technique known in the art for producing bladders that are fluid tight.

Referring now to FIGS. 133 to 135, a bottom portion 1750 of an external cover encasing the various parts of the mattress 1600 will now be described. Much like external cover 602, the external cover of mattress 1600 defines a main compartment enclosing most parts of the mattress 1600. As such, the bottom portion 1750 of external cover defines a main compartment 1752 to house most parts of the mattress 1600, as well as two lateral compartments 1754, 1756 devised for receiving the lateral width extensions 1626, 1628, and a foot compartment 1755 devised for receiving the foot extension section 1712 therein.

Much like external cover 602, the bottom portion 1750 of the external cover is attached to a top cover (not shown) extending on top of the mattress 1600 and attached to the bottom portion 1750 by way of a zipper for a non-limitative example, and may extend partially or totally along the periphery of the bottom portion in order to allow access to various parts of the mattress 1600.

In one embodiment, the bottom portion 1750 and the remaining portions of the external cover of mattress 1600 are made of a material that is partially rigid and that may include fluid permeable and/or impermeable material as well as fire-resistant or retardant material (i.e., a fire barrier). The external cover of mattress 1600 may be further provided with elastic material portions (not shown) configured for compressing the excess of fabric from the width extensions 1626, 1628 and foot extensions 1714, 1716 when deflated.

Referring now to FIGS. 133 to 135, the mattress 1600 may further be provided with attaching straps for attaching the mattress 1600 onto a receiving surface of a bed. As better shown in FIG. 135, two attaching straps 1758, 1760 are provided at the head end of the bottom portion 1750 of the external cover. These straps 1758, 1760 connect to corresponding attaching elements (not shown) provided on the patient support surface 162 of the bed 100. In one embodiment, each of the straps 1758, 1760 is provided with a slit 1762 sized and shaped to allow the straps 1758, 1760 to removably engage corresponding knobs (not shown) provided underneath the patent support surface 162 of the bed 100.

Still referring to FIGS. 133 and 134, the bottom portion 1750 of the external cover is also provided with a pair of slots 1764, 1766, as well as holes 1767 to allow portions of the pneumatic system (not shown in FIGS. 133 and 134) positioned under the leg section 1636 of the support layer 1606 to extend through the bottom portion of the external cover 1602 and to engage the patient support surface 162 of the bed 100. In one embodiment, the bottom portion 1750 of the external cover is further provided with foot attaching elements 1769 at the foot end of the foot compartment 1755, as well as lateral attaching elements 1771 extending along each sides of the foot compartment 1755. The foot attaching elements 1769 of the foot compartment 1755 collaborate with attaching elements 1713 provided on the foot extension 1712 while lateral attaching elements 1771 collaborated with the attaching elements (not shown) provided underneath the foot extension section 1712 to secure the foot extension section 1712 to the foot compartment 1755 of the bottom portion 1750 of the external cover. As it will be appreciated, the fact that the foot extension section 1712 is attached to the foot compartment 1755 of the bottom portion 1750 of the external cover causes the foot compartment 1755 to move along with the foot extension section 1712 when it is inflated and deflated.

As it should now be apparent to the skilled addressee, the mattress 1600, when used on a bed, is configurable into various positions, such as a flat or substantially flat position, a cardiac/dining chair position, and a full chair position. The mattress 1600 in combination with the bed may be adjusted, i.e., extended and retracted, in width in any of the flat or substantially flat position, cardiac/dining chair position, and full chair position.

Since some of the bladders of the lower support layer 1606 and the upper comfort layer 1608 can be independently inflated and deflated, various inflation and deflation sequences of the bladders may be used to further facilitate the patient's exit. For example, once the bed is configured in the full chair position, the seat section and the legs section of the mattress 1600 may be deflated to further ease the patient exit, as previously described.

In a further embodiment, the mattress 1600 may also be controlled for facilitating egress of the patient by the side of the bed when in the cardiac/dinning chair position (also known as side exit). For the side exit, the corresponding foot siderail has to be lowered first. In order to help the patient, the seat section of the lower support layer 1606 may be inflated to the maximum such that the patient extends above the siderail. The seat section of the upper comfort layer 1608 may be fully deflated to provide sufficient rigidity to the mattress 1600 which will help the patient exit. Pressure in the longitudinal support bolsters 1622, 1624 and in the longitudinal width extensions 1626, 1628 may also be modulated to help patient exit. For example, they may be slightly deflated.

Various modifications may be implemented. For example, the longitudinal bolsters 1622, 1624 and the width extension bladders 1714, 1716 may be provided with portions of reduced thickness conveniently distributed therealong to facilitate the partial folding of the mattress 1600. When present, such portions of reduced thickness, for example a V-groove, may improve conforming the mattress shape to the bed shape when in a corresponding chair position.

In one embodiment, the elongated support bladders 1632 of the lower support layer 1606 may be arranged to provide a slope at the foot end of the mattress 1600 for accommodating the heels of a patient. In another embodiment, the elongated support bladders 1632 of the lower support layer 1606 may be provided with foam extending inside the inflatable chambers. In another embodiment, a base layer of foam may be provided under the lower support layer 1606 and may serve as a bottoming out layer.

In one embodiment, the mattress 1600 may be configured with an X-Ray sleeve (not shown) adapted to receive an X-Ray cassette therein.

In one embodiment, the bladders of the mattress 1600 are made of fabric or material such as fiber containing TPU or Vinyl material, and are formed by radiofrequency (RF) welding, sewing, and/or any other technique known in the art for producing bladders that are fluid tight.

In order to control the various inflatable components of the mattress 1600, a pneumatic system (not shown) and a control unit are provided, according to one embodiment. Various controls and functions are accessible to the patient or the caregiver to position the bed and the mattress in a chosen position and provide various therapies and functions.

In one embodiment, the pneumatic system includes a fluid source such as a pump or a blower, a valve assembly connected to the fluid source, a plurality of pressure sensors and various tubing connecting the valves to the corresponding bladders. In one embodiment, the pneumatic system is integrated in a pneumatic box. The pneumatic box may be a separate unit but is preferably integrated with the mattress or the bed, as detailed below.

In one embodiment, the fluid source is chosen for producing a fluid pressure about between 0 and 80 mm Hg as well as fluid flow rates about between 600 and 800 L/min. The fluid source is further adapted for varying the fluid flow rate and output. Preferably, the fluid source is a blower, which speed may be varied to vary the flow rate of the fluid. For example, a fluid of a relatively low flow rate may be used to gradually inflate any of the rotation bladders for CLRT according to any given inflation/deflation cycle. It will therefore be appreciated that variation in fluid pressure and fluid flow rate may be used to modulate any of the therapy and function of the mattress 1600.

In one embodiment, the plurality of valves includes a first set of low flow rate valves and a second set of high flow rate valves. While the flow rate of a fluid inputted to the inflatable components of the mattress 1600 depends on the fluid source and/or the valve assembly, the flow rate of a fluid outputted from the inflatable components of the mattress depends mostly on the first set of low flow valves and a second set of high flow valves of the valve assembly. The low flow rate valves and a second set of high flow rate valves may be cyclically opened and closed to regulate further the flow rate of a fluid outputted from the inflatable components of the mattress 1600. The valve assembly further includes a cardiopulmonary resuscitation (CPR) valve activatable via a corresponding CPR pedal such as the one described above and manually, as a manual backup, via a pull strap by a user.

In one embodiment, in addition to the ones of the valve assembly, the pneumatic system may further include additional valves located outside of the valve assembly, such as check valves. The check valves may be configured for deflating some of the inflatable components of the mattress simultaneously, while keeping the inflation of these same inflatable components independents, as illustrated in FIG. 108 relating to mattress 600, which is also applicable to mattress 1600 with proper adaptations.

As it should now be apparent to the skilled addressee, the mattress 1600 may include several pneumatically distinct zones that are independently controllable from one another by the valve assembly and the associated control unit.

The embodiments described above are intended to be exemplary only.

1. A patient support apparatus comprising:
a patient support surface for receiving a patient thereon;
an extension frame;
a first actuator mechanism comprising at least one actuator having a first end operatively coupled to the patient support surface and a second end operatively coupled to the extension frame, the at least one actuator of the first actuator mechanism being movable between a retracted position in which the extension frame is close to the patient support surface and an extended position in which the extension frame is away from the patient support surface;
a second actuator mechanism comprising at least one actuator having a first end operatively coupled to the extension frame and a second end operatively coupled to an extension, the at least one actuator of the second actuator mechanism being movable between a retracted position in which the extension is close to the extension frame and an extended position in which the extension is away from the extension frame;
at least one extension plate operatively coupled to the extension, the at least one being coplanar with the patient support surface and moving relative to the patient support surface when the first or second actuator mechanisms are operated; and
a control for controlling the movement of the linear actuators of the first and second actuator mechanisms between their respective retracted positions and extended positions.

2. The patient support apparatus of claim 1, further comprising at least one support mechanism operatively coupled to the patient support and to the extension.

3. The patient support apparatus of claim 2, wherein the at least one support mechanism comprises a first support member having a first end pivotably and slidably connected to the patient support surface and a second end and a second support member having a first end pivotably connected to the second end of the first support member and a second end pivotably and slidably connected to the extension.

4. The patient support apparatus of claim 2, wherein the at least one support mechanism comprises a first support member having a first end pivotably coupled to the patient support surface and a second end pivotably and slidably coupled to the extension frame, and a second support member having a first end pivotably and slidably connected to the extension frame and a second end pivotably connected to the extension.

5. The patient support apparatus of claim 4, wherein the extension frame comprises a cross-member to which are attached the second end of the first support member and the first end of the second support member, the cross-member allowing sliding movement the second end of the first support member and the first end of the second support member in a direction transverse to a movement direction of the first and second actuator mechanisms.

6. The patient support apparatus of claim 5, wherein the at least one extension plate comprises a first extension plate having a first end slidably resting atop the patient support surface and a second end fixedly secured to the cross-member, and a second plate having a first end slidably resting atop the first plate and a second end fixedly secured to the extension.

7. The patient support apparatus of claim 1, wherein the at least one actuator of the first actuator mechanism comprises a first linear actuator and a second linear actuator, the first and second linear actuators extending parallel to one another and each having a first end operatively coupled to the patient support surface and a second end operatively coupled to the extension frame.

8. The patient support apparatus of claim 7, wherein each of the first and second linear actuators of the first actuator mechanism is provided with a pulley at its a second end for urging movement thereof between the extended position and the retracted position, the first actuator mechanism further comprising a first motor mounted to the extension frame, the first motor being operatively coupled to the pulleys of the first and second linear actuators for urging movement therefor between the extended position and the retracted position.

9. The patient support apparatus of claim 1, wherein the at least one actuator of the second actuator mechanism comprises a first linear actuator and a second linear actuator, the first and second linear actuators extending parallel to one another and each having a first end operatively to the extension frame and a second end operatively coupled to the extension.

10. The patient support apparatus of claim 9, wherein each of the first and second linear actuators of the second actuator mechanism is provided with a pulley at its a first end for urging movement thereof between the extended position and the retracted position, the second actuator mechanism further comprising a second motor mounted to the extension frame, the second motor being operatively coupled to the pulleys of the first and second linear actuators of the second actuator mechanism for urging movement therefor between the extended position and the retracted position.

11.-12. (canceled)

13. The patient support apparatus of claim 1, wherein the patient support comprises a head end, a foot end and a longitudinal direction between the head end and the foot end, and wherein when the first and second actuator mechanisms are operated, the extension moves in the longitudinal direction.

14. The patient support apparatus of claim 13, wherein the extension frame, the first and second actuator mechanisms, the extension and the at least one plate are provided at the foot end of the patient support surface.

15. The patient support apparatus of claim 1, wherein the extension frame is mounted underneath the patient support surface.

16. A frame assembly for a patient support apparatus having a base and an elevation mechanism mounted to the base and supporting the frame assembly for raising and lowering the same assembly, the frame assembly comprising:
a pair of spaced-apart sleeves extending longitudinally between a front end of the patient support apparatus and a foot end, each sleeve comprising an open head end and an open foot end;
a head sliding assembly attached to a head portion of the elevation mechanism and allowing a translation movement of the sleeves relative to the head portion of the elevation mechanism;
a foot sliding assembly comprising head sliding members, each foot sliding member having a head end and a foot end, each foot sliding member being slidably received into the foot end of a corresponding sleeve, from the head end of the foot sliding member to an intermediate location between the head end and the foot end thereof, each foot sliding member being capable of translation relative to its corresponding sleeve, the foot sliding assembly further comprising a stopper for stopping sliding movement of the foot sliding members into their corresponding sleeves;
a sliding mechanism connected to the sleeves proximal to the foot end thereof, the sliding mechanism attaching the sleeves to a foot portion of the elevation mechanism, the sliding mechanism comprising a spring element for biasing the foot portion of the elevation mechanism towards the foot end of the sleeves;
an actuator having a head end connected to the sleeves and a second end connected to the foot ends of the foot sliding members; the actuator being movable between an extended position and a retracted position;
wherein when the actuator is moved from the extended position towards the retracted position, the actuator forces the foot sliding members of the foot assembly into their corresponding sleeves until the stopper stops further movement of the foot sliding members into their corresponding sleeves, at which point further movement of the actuator toward the retracted position overcomes the biasing force of the spring element, thus causing the foot portion of the elevation mechanism to move towards the head end of the sleeve and the simultaneous movement of the sleeves towards the foot end and away from the head portion of the elevation mechanism.

17. The frame assembly of claim 16, further comprising:
a first cross-member connecting the spaced-apart sleeves in an intermediate location between the head end and the foot end of the sleeves
a second cross-member connecting the spaced-apart sleeves at the foot end thereof,
a third cross-member secured to the foot ends of the foot sliding members for connecting the same together;
wherein the sliding mechanism connected to the sleeves proximal to the foot end thereof extends between the first cross-member and the second cross-member connecting the spaced-apart sleeves, and wherein the head end of the actuator is connected to the sleeves via the first cross-member and the foot end of the actuator is connected to foot ends of the foot sliding members via the third cross-member.

18. The frame assembly of claim 16, wherein the head sliding assembly comprises a pair of head sliding members, each head sliding member having a head end and a foot end, each head sliding member being slidably received into the head end of a corresponding sleeve, from the foot end of the head sliding member to an intermediate location between the foot end and the head end thereof, each head sliding member being capable of translation relative to its corresponding sleeve, the head end of the head sliding members protruding outwardly from the head end of the sleeves and attaching the head portion of the elevation mechanism, wherein when the actuator is moved from the extended position towards the retracted position, the actuator forces the foot sliding members of the foot assembly into their corresponding sleeves until the stopper stops further movement of the foot sliding members into their corresponding sleeves, at which point further movement of the actuator toward the retracted position overcomes the biasing force of the spring element, thus causing the foot portion of the elevation mechanism to move towards the head end of the sleeve and the simultaneous exit of the head sliding members from the head end of the sleeves.

19. The frame assembly of claim 16, wherein each of the head portion and the foot portion of the elevation mechanism comprises one of an elevation column or an elevation lever.

20. The frame assembly of claim 16, wherein the actuator comprises a linear actuator.

21. The frame assembly of claim 16, further comprising a fourth cross-member connecting the spaced-apart sleeves, at the head end thereof.

22. The frame assembly of claim 16, wherein each of the sleeves comprises a rectangular tube and each of the head and foot sliding members comprises a rectangular tube sized to slidably fit into the rectangular tubes of the sleeves.

23.-47. (canceled)
